(19) United States
(12) Patent Application Publication
(10) Pub. No.: US 2002/0005787 A1
(43) Pub. Date: Jan. 17, 2002

(54) APPARATUS AND METHODS FOR CONTROLLING HOUSEHOLD APPLIANCES

(76) Inventors: OZ GABAI, TEL AVIV (IL); JACOB GABAI, TEL AVIV (IL); NIMROD SANDLERMAN, RAMAT GAN (IL)

Correspondence Address: ABELMAN FRAYNE & SCHWAB, 150 EAST 42ND STREET, NEW YORK, NY, 100175612

(21) Appl. No.: 09/062,502

(22) Filed: Apr. 17, 1998

(30) Foreign Application Priority Data
May 19, 1997 (IL) 120855

(51) Int. Cl. G08C 19/00

(52) U.S. Cl. 340/825.69

(57) ABSTRACT

A wireless computer controlled household appliance system including a computer system including a first wireless transmitter and a first wireless receiver and operative to transmit a first transmission via the first wireless transmitter, and at least one household appliance including a second wireless transmitter and a second wireless receiver, the household appliance receiving the first transmission via the second wireless receiver and operative to carry out at least one action based on the first transmission, the household appliance being operative to transmit a second transmission via the second wireless transmitter and the computer system is operative to receive the second transmission via the first wireless receiver.

### FIELD OF THE INVENTION

The present invention relates to household appliances and methods for their operation.

### BACKGROUND OF THE INVENTION

U.S. Pat. No. 5,109,222 to Welty describes a remote control system for control of electrically operable equipment in people occupiable structures which has an essentially unlimited command format. A signal receiving sensor such as an IR sensor receives a signal from a remote control unit, typically hand-held. The IR signal is processed to be compatible with electrically operable equipment such as a sound entertainment system or electrical appliances. A central computer or microprocessor is associated with the dwelling structure and receives a signal from the remote control unit, via the signal receiving sensor. The computer generates a control signal to control the electrically operable equipment. Signals may be sent from the electrically operable equipment through the computer to the remote control unit for providing feedback information to the user of the remote control unit.

Also well known in the art are toys which are remotely controlled by wireless communication and which are not used in conjunction with a computer system. Typically, such toys include vehicles whose motion is controlled by a human user via a remote control device.

U.S. Pat. No. 4,712,184 to Haugerud describes a computer controlled educational toy, the construction of which teaches the user computer terminology and programming and robotic technology. Haugerud describes computer control of a toy via a wired connection, wherein the user of the computer typically writes a simple program to control movement of a robot.

U.S. Pat. No. 4,840,602 to Rose describes a talking doll responsive to an external signal, in which the doll has a vocabulary stored in digital data in a memory which may be accessed to cause a speech synthesizer in the doll to simulate speech.

U.S. Pat. No. 5,021,878 to Lang describes an animated character system with real-time control.

U.S. Pat. No. 5,142,803 to Lang describes an animated character system with real-time control.

U.S. Pat. No. 5,191,615 to Aldava et al. describes an interrelational audio kinetic entertainment system in which movable and audible toys and other animated devices spaced apart from a television screen are provided with program synchronized audio and control data to interact with the program viewer in relationship to the television program.

U.S. Pat. No. 5,195,920 to Collier describes a radio controlled toy vehicle which generates realistic sound effects on board the vehicle. Communications with a remote computer allows an operator to modify and add new sound effects.

U.S. Pat. No. 5,270,480 to Hikawa describes a toy acting in response to a MIDI signal, wherein an instrument-playing toy performs simulated instrument playing movements.

U.S. Pat. No. 5,289,273 to Lang describes a system for remotely controlling an animated character. The system uses radio signals to transfer audio, video and other control signals to the animated character to provide speech, hearing vision and movement in real-time.

U.S. Pat. No. 5,388,493 describes a system for a housing for a vertical dual keyboard MIDI wireless controller for accordionists. The system may be used with either a conventional MIDI cable connection or by a wireless MIDI transmission system.

German Patent DE 3009-040 to Neuhierl describes a device for adding the capability to transmit sound from a remote control to a controlled model vehicle. The sound is generated by means of a microphone or a tape recorder and transmitted to the controlled model vehicle by means of radio communications. The model vehicle is equipped with a speaker that emits the received sounds.

The disclosures of all publications mentioned in the specification and of the publications cited therein are hereby incorporated by reference.

### SUMMARY OF THE INVENTION

The present invention seeks to provide improved household appliances with psychological added value such as entertainment value. Because of the considerable drudgery involved in the majority of household tasks, psychologically stimulating features in household appliances are extremely useful in providing a pleasant, supportive, entertaining and/or empathic experience to users of household appliances, rather than a neutral, negative or boring experience.

According to a preferred embodiment of the present invention, a first household appliance communicates with a second appliance which senses the communication and acts upon it. According to another preferred embodiment of the present invention, a household appliance is provided which is capable of holding a dialogue with a user of the appliance and acting upon verbal inputs provided by the user in the course of the dialog.

A particular advantage of a household appliance which is capable of holding and acting upon a dialog with a user is that homemakers, like drivers, are often in a situation in which senses other than hearing are occupied, and/or in a situation in which their hands are occupied or are dirty. Therefore, it may be useful for a user of an appliance to have a recipe read to her, and/or to have a complicated cooking operation coordinated for her in that the appliance alerts the user of the appropriate time to perform various cooking operations. For example, the user of an oven might be alerted each time it is necessary to baste a chicken. Optionally, a computer system is provided which generates oral messages regarding each appliance or each function of each appliance or each particular task (for example cooking chicken) in a different voice, e.g. a simulation of voices of different celebrities, in order to aid the user in differentiating between oral messages pertaining to different appliances or tasks.

Household appliances include but are not limited to kitchen equipment such as refrigerators, cooking devices, mixing devices and food processing devices; entertainment equipment such as VCRs and televisions, housekeeping equipment such as washing machines, dryers and vacuum cleaners, gardening equipment such as power lawn mowers and electric tools such as electric drills.

There is thus provided, in accordance with a preferred embodiment of the present invention, a wireless computer controlled household appliance system including a computer system including a first wireless transmitter and a first wireless receiver and operative to transmit a first transmission via the first wireless transmitter, and at least one household appliance including a second wireless transmitter and a second wireless receiver, the household appliance receiving the first transmission via the second wireless receiver and operative to carry out at least one action based on the first transmission, the household appliance being operative to transmit a second transmission via the second wireless transmitter and wherein the computer system is operative to receive the second transmission via the first wireless receiver.

Also provided, in accordance with a preferred embodiment of the present invention, is household appliance apparatus including at least one functional unit operative to perform a household operation, and an appliance personifier operative to simulate a personification of the functional unit for a user of the functional unit.

Further provided, in accordance with another preferred embodiment of the present invention, is a household appliance including a functional unit operative to perform a household operation, and an entertainment generator operative to provide entertainment to a user of the functional unit.

Additionally provided, in accordance with still another preferred embodiment of the present invention, is speaking household appliance apparatus including a functional unit operative to perform a household operation, and a speech generator operative to generate speech specimens audible to a user of the functional unit.

Further in accordance with a preferred embodiment of the present invention, the speech generator is operative to generate speech specimens having entertainment value for the user of the functional unit.

Still further in accordance with a preferred embodiment of the present invention, the functional unit includes at least one sensor operative to sense at least one ambient condition relevant to the functionality of the functional unit and wherein the speech generator is operative responsive to the at least one sensor.

Further in accordance with a preferred embodiment of the present invention, the speaking household appliance apparatus also includes an inter-appliance communication unit operative to receive messages from at least one other household appliance and the speech generator is operative responsive to the messages.

Still further in accordance with a preferred embodiment of the present invention, the entertainment generator includes a random entertainment generator operative to provide entertainment selected at least partly randomly from an entertainment repertoire.

Further in accordance with a preferred embodiment of the present invention, the appliance personifier includes a celebrity simulator operative to generate outputs causing a perception, on the part of the user of at least one functional units, that the at least one functional units behave similarly to a celebrity.

Still further in accordance with a preferred embodiment of the present invention, the functional unit includes a loudspeaker and the celebrity simulator includes a personified audio message provider operative to provide verbal messages in a voice resembling the voice of a celebrity, to the loudspeaker.

Also provided, in accordance with another preferred embodiment of the present invention, is a computerized household appliance system including a plurality of household chore performing appliances distributed in a corresponding plurality of rooms throughout a dwelling-place, each household chore performing appliance including a functional unit, and a loudspeaker for conveying audio messages to a user, and a computer operative to generate audio messages for a user, and to convey the audio messages to the user using at least one of the plurality of loudspeakers.

Further in accordance with a preferred embodiment of the present invention, each appliance also includes a sensor operative to sense presence of the user and wherein the computer is operative to monitor the user's location by receiving information from the plurality of sensors and to convey the audio messages to the user using only those ones of the plurality of loudspeakers which are proximate to the user's current location as defined by the information received from the plurality of sensors.

Still further in accordance with a preferred embodiment of the present invention, the sensor includes a microphone.

Further in accordance with a preferred embodiment of the present invention, the computer system includes a computer, a computer radio interface communicating commands to the at least one household appliance, and a sound board device having at least one audio channel and transmitting commands from the computer to the computer radio interface over the at least one audio channel.

Further in accordance with a preferred embodiment of the present invention, the at least one audio channel also includes an audio channel from the computer radio interface to the sound board device over which digital information arriving from at least one appliance is transmitted to the computer.

Further in accordance with a preferred embodiment of the present invention, the functional unit includes a loudspeaker and the appliance personifier includes a personified audio message provider operative to provide personified audio messages to the loudspeaker.

Still further in accordance with a preferred embodiment of the present invention, the functional unit includes a food-related appliance and wherein the appliance personifier is operative to simulate a diet-facilitating personification of the food-related appliance.

Also provided, in accordance with another preferred embodiment of the present invention, is a wireless computer controlled household appliance system including a computer system including a wireless transmitter for transmitting a command to perform at least one appliance action, and at least one household appliance including a wireless receiver, the receiver receiving the command from the transmitter, the appliance being operative to carry out at least one action based on the command.

Further provided, in accordance with a further preferred embodiment of the present invention, is a wireless computer controlled household appliance system including a computer system including a wireless receiver, and at least one household appliance including a wireless transmitter, the household appliance being operative to transmit a transmission via the wireless transmitter to the wireless receiver, the computer system being operative to receive the transmission via the wireless receiver and to perform at least one action based on the transmission.

Also provided, in accordance with another preferred embodiment of the present invention, is a method for wireless computer control of household appliances including transmitting a first transmission from a computer via a first wireless transmitter, receiving the first transmission at at least one household appliance and carrying out at least one action based on the first transmission, and transmitting a second transmission from the at least one household appliance to the computer.

Additionally provided, in accordance with yet another preferred embodiment of the present invention, is a household appliance personification method including providing a household appliance including a functional unit operative to perform a household operation, and using the household appliance to simulate a personification of the functional unit for a user of the functional unit.

Also provided, in accordance with another preferred embodiment of the present invention, is a household entertainment method including providing a household appliance including a functional unit operative to perform a household operation, and using the household appliance to provide entertainment to a user of the functional unit.

Additionally provided, in accordance with yet another preferred embodiment of the present invention, is a method for performing household operations including providing a household appliance including a functional unit operative to perform a household operation, and generating speech specimens audible to a user of the functional unit.

Further provided, in accordance with another preferred embodiment of the present invention, is a computerized household appliance running method including distributing a plurality of household chore performing appliances in a corresponding plurality of rooms throughout a dwelling-place, each household chore performing appliance including a functional unit and a loudspeaker for conveying audio messages to a user, using a computer to generate audio messages for a user, and conveying the audio messages to the user using at least one of the plurality of loudspeakers.

Also provided, in accordance with another preferred embodiment of the present invention, is a wireless computer controlled household appliance communication method including transmitting a command to perform at least one appliance action from a computer system including a wireless transmitter to at least one household appliance including a wireless receiver, and using the appliance to carry out at least one action based on the command.

Also provided, in accordance with yet another preferred embodiment of the present invention, is a wireless computer controlled household appliance communication method including transmitting a message to a computer system including a wireless receiver from at least one household appliance including a wireless transmitter, and using the computer to perform at least one computer action based on the transmission.

There is also provided in accordance with a preferred embodiment of the present invention a wireless computer controlled toy system including a computer system operative to transmit a first transmission via a first wireless transmitter and at least one toy including a first wireless receiver, the toy receiving the first transmission via the first wireless receiver and operative to carry out at least one action based on the first transmission.

The computer system may include a computer game. The toy may include a plurality of toys, and the at least one action may include a plurality of actions.

The first transmission may include a digital signal. The first transmission includes an analog signal and the analog signal may include sound.

Additionally in accordance with a preferred embodiment of the present invention the computer system includes a computer having a MIDI port and wherein the computer may be operative to transmit the digital signal by way of the MIDI port.

Additionally in accordance with a preferred embodiment of the present invention the sound includes music, a pre-recorded sound and/or speech. The speech may include recorded speech and synthesized speech.

Further in accordance with a preferred embodiment of the present invention the at least one toy has a plurality of states including at least a sleep state and an awake state, and the first transmission includes a state transition command, and the at least one action includes transitioning between the sleep state and the awake state.

A sleep state may typically include a state in which the toy consumes a reduced amount of energy and/or in which the toy is largely inactive, while an awake state is typically a state of normal operation.

Still further in accordance with a preferred embodiment of the present invention the first transmission includes a control command chosen from a plurality of available control commands based, at least in part, on a result of operation of the computer game.

Additionally in accordance with a preferred embodiment of the present invention the computer system includes a plurality of computers.

Additionally in accordance with a preferred embodiment of the present invention the first transmission includes computer identification data and the second transmission includes computer identification data.

Additionally in accordance with a preferred embodiment of the present invention the at least one toy is operative to transmit a second transmission via a second wireless transmitter and the computer system is operative to receive the second transmission via a second wireless receiver.

Moreover in accordance with a preferred embodiment of the present invention the system includes at least one input device and the second transmission includes a status of the at least one input device.

Additionally in accordance with a preferred embodiment of the invention the at least one toy includes at least a first toy and a second toy, and wherein the first toy is operative to transmit a toy-to-toy transmission to the second toy via the second wireless transmitter, and wherein the second toy is operative to carry out at least one action based on the toy-to-toy transmission.

Further in accordance with a preferred embodiment of the present invention operation of the computer system is controlled, at least in part, by the second transmission.

Moreover in accordance with a preferred embodiment of the present invention the computer system includes a computer game, and wherein operation of the game is controlled, at least in part, by the second transmission.

The second transmission may include a digital signal and/or an analog signal.

Still further in accordance with a preferred embodiment of the present invention the computer system has a plurality of states including at least a sleep state and an awake state, and the second transmission include a state transition command, and the computer is operative, upon receiving the second transmission, to transition between the sleep state and the awake state.

Still further in accordance with a preferred embodiment of the present invention at least one toy includes sound input apparatus, and the second transmission includes a sound signal which represents a sound input via the sound input apparatus.

Additionally in accordance with a preferred embodiment of the present invention the computer system is also operative to perform at least one of the following actions: manipulate the sound signal; and play the sound signal.

Additionally in accordance with a preferred embodiment of the present invention the sound includes speech, and the computer system is operative to perform a speech recognition operation on the speech.

Further in accordance with a preferred embodiment of the present invention the second transmission includes toy identification data, and the computer system is operative to identify the at least one toy based, at least in part, on the toy identification data.

Still further in accordance with a preferred embodiment of the present invention the first transmission includes toy identification data. The computer system may adapt a mode of operation thereof based, at least in part, on the toy identification data.

Still further in accordance with a preferred embodiment of the present invention the at least one action may include movement of the toy, movement of a part of the toy and/or an output of a sound. The sound may be transmitted using a MIDI protocol.

There is also provided in accordance with another preferred embodiment of the present invention a game system including a computer system operative to control a computer game and having a display operative to display at least one display object, and at least one toy in wireless communication with the computer system, the computer game including a plurality of game objects, and the plurality of game objects includes the at least one display object and the at least one toy.

Further in accordance with a preferred embodiment of the present invention the at least one toy is operative to transmit toy identification data to the computer system, and the computer system is operative to adapt a mode of operation of the computer game based, at least in part, on the toy identification data.

The computer system may include a plurality of computers.

Additionally in accordance with a preferred embodiment of the present invention the first transmission includes computer identification data and the second transmission includes computer identification data.

There is also provided in accordance with a preferred embodiment of the present invention a data transmission apparatus including first wireless apparatus including musical instrument data interface (MIDI) apparatus operative to receive and transmit MIDI data between a first wireless and a first MIDI device and second wireless apparatus including MIDI apparatus operative to receive and transmit MIDI data between a second wireless and a second MIDI device, the first wireless apparatus is operative to transmit MIDI data including data received from the first MIDI device to the second wireless apparatus, and to transmit MIDI data including data received from the second wireless apparatus to the first MIDI device, and the second wireless apparatus is operative to transmit MIDI data including data received from the second MI.DI device to the first wireless apparatus, and to transmit MIDI data including data received from the first wireless apparatus to the second MIDI device.

Further in accordance with a preferred embodiment of the present invention the second wireless apparatus includes a plurality of wirelesses each respectively associated with one of the plurality of MIDI devices, and each of the second plurality of wirelesses is operative to transmit MIDI data including data received from the associated MIDI device to the first wireless apparatus, and to transmit MIDI data including data received from the first wireless apparatus to the associated MIDI device.

The first MIDI device may include a computer, while the second MIDI device may include a toy.

Additionally in accordance with a preferred embodiment of the present invention the first wireless apparatus also includes analog interface apparatus operative to receive and transmit analog signals between the first wireless and a first analog device, and the second wireless apparatus also includes analog interface apparatus operative to receive and transmit analog signals between the second wireless and a second analog device, and the first wireless apparatus is also operative to transmit analog signals including signals received from the first analog device to the second wireless apparatus, and to transmit analog signal including signals received from the second wireless apparatus to the first analog device, and the second wireless apparatus is also operative to transmit analog signals including signals received from the second analog device to the first wireless apparatus, and to transmit analog signals including data received from the first wireless apparatus to the second analog device.

There is also provided in accordance with another preferred embodiment of the present invention a method for generating control instructions for a computer controlled toy system, the method includes selecting a toy, selecting at least one command from among a plurality of commands associated with the toy, and generating control instructions for the toy including the at least one command.

Further in accordance with a preferred embodiment of the present invention the step of selecting at least one command includes choosing a command, and specifying at least one control parameter associated with the chosen command.

Still further in accordance with a preferred embodiment of the present invention the at least one control parameter includes at least one condition depending on a result of a previous command.

Additionally in accordance with a preferred embodiment of the present invention at least one of the steps of selecting a toy and the step of selecting at least one command includes utilizing a graphical user interface.

Still further in accordance with a preferred embodiment of the present invention the previous command includes a previous command associated with a second toy.

Additionally in accordance with a preferred embodiment of the present invention the at least one control parameter includes an execution condition controlling execution of the command.

The execution condition may include a time at which to perform the command and/or a time at which to cease performing the command. The execution condition may also include a status of the toy.

Additionally in accordance with a preferred embodiment of the present invention the at least one control parameter includes a command modifier modifying execution of the command.

Still further in accordance with a preferred embodiment of the present invention the at least one control parameter includes a condition dependent on a future event.

Additionally in accordance with a preferred embodiment of the present invention the at least one command includes a command to cancel a previous command.

There is also provided for in accordance with a preferred embodiment of the present invention a signal transmission apparatus for use in conjunction with a computer, the apparatus including wireless transmission apparatus; and signal processing apparatus including at least one of the following analog/digital sound conversion apparatus operative to convert analog sound signals to digital sound signals, to convert digital sound signals to analog sound signals, and to transmit the signals between the computer and a sound device using the wireless transmission apparatus; a peripheral control interface operative to transmit control signals between the computer and a peripheral device using the wireless transmission apparatus; and a MIDI interface operative to transmit MIDI signals between the computer and a MIDI device using the wireless transmission apparatus.

There is also provided in accordance with another preferred embodiment of the present invention a computer system including a computer, and a sound card operatively attached to the computer and having a MIDI connector and at least one analog connector, wherein the computer is operative to transmit digital signals by means of the MIDI connector and to transmit analog signals by means of the at least one analog connector.

Further in accordance with a preferred embodiment of the present invention the computer is also operative to receive digital signals by means of the MIDI connector and to receive analog signals by means of the at least one analog connector.

It is also noted that throughout the specification and claims the term “radio” includes all forms of “wireless” communication.

In the illustrated embodiments, the central computer is shown as being separate from the appliances. However, it is appreciated that, alternatively, a computer may reside within one or more of the appliances or may be integrally formed therewith.

### BRIEF DESCRIPTION OF THE DRAWINGS

The present invention will be understood and appreciated from the following detailed description, taken in conjunction with the drawings in which:

FIGS. 1-32C illustrate a toy system for use in conjunction with a computer system wherein:

FIG. 1A is a partly pictorial, partly block diagram illustration of a computer control system including a toy, constructed and operative in accordance with a preferred embodiment of the present invention;

FIG. 1B is a partly pictorial, partly block diagram illustration a preferred implementation of the toy 122 of FIG. 1A;

FIG. 1C is a partly pictorial, partly block diagram illustration of a computer control system including a toy, constructed and operative in accordance with an alternative preferred embodiment of the present invention;

FIGS. 2A-2C are simplified pictorial illustrations of a portion of the system of FIG. 1A in use;

FIG. 3 is a simplified block diagram of a preferred implementation of the computer radio interface 110 of FIG. 1A;

FIG. 4 is a more detailed block diagram of the computer radio interface 110 of FIG. 3;

FIGS. 5A-5D taken together comprise a schematic diagram of the apparatus of FIG. 4;

FIG. 5E is an schematic diagram of an alternative implementation of the apparatus of FIG. 5D;

FIG. 6 is a simplified block diagram of a preferred implementation of the toy control device 130 of FIG. 1A;

FIGS. 7A-7F, taken together with either FIG. 5D or FIG. 5E, comprise a schematic diagram of the apparatus of FIG. 6;

FIG. 8A is a simplified flowchart illustration of a preferred method for receiving radio signals, executing commands comprised therein, and sending radio signals, within the toy control device 130 of FIG. 1A;

FIGS. 8B-8T, taken together, comprise a simplified flowchart illustration of a preferred implementation of the method of FIG. 8A;

FIG. 9A is a simplified flowchart illustration of a preferred method for receiving MIDI signals, receiving radio signals, executing commands comprised therein, sending radio signals, and sending MIDI signals, within the computer radio interface 110 of FIG. 1A;

FIGS. 9B-9N, taken together with FIGS. 8D-8M, comprise a simplified flowchart illustration of a preferred implementation of the method of FIG. 9A;

FIGS. 10A-10C are simplified pictorial illustrations of a signal transmitted between the computer radio interface 110 and the toy control device 130 of FIG. 1A;

FIG. 11 is a simplified flowchart illustration of a preferred method for generating control instructions for the apparatus of FIG. 1A;

FIGS. 12A-12C are pictorial illustrations of a preferred implementation of a graphical user interface implementation of the method of FIG. 11;

FIG. 13 is a block diagram of a first sub-unit of a multi-port multi-channel implementation of the computer radio interface 110 of FIG. 1A, which sub-unit resides within computer 100 of FIG. 1A;

FIG. 14 is a block diagram of a second sub-unit of a multi-port multi-channel implementation of the computer radio interface 110 of FIG. 1A, which sub-unit complements the apparatus of FIG. 13 and resides exteriorly to computer 100 of FIG. 1A;

FIGS. 15A-15E, taken together, form a detailed electronic schematic diagram of the toy control device of FIG. 6, suitable for the multi-channel implementation of FIGS. 13 and 14;

FIG. 16 is a simplified flowchart illustration of a preferred method by which a computer selects a control channel pair in anticipation of a toy becoming available and starts a game-defining communication over the control channel each time both a toy and a transceiver of the computer radio interface are available;

FIG. 17 is a simplified flowchart illustration of a preferred method for implementing the “select control channel pair” step of FIG. 16;

FIG. 18A is a simplified flowchart illustration of a preferred method for implementing the “select information communication channel pair” step of FIG. 16;

FIG. 18B is a simplified flowchart illustration of a preferred method for performing the “locate computer” step of FIG. 18A;

FIG. 19 is a simplified flowchart illustration of a preferred method of operation of the toy control device 130;

FIG. 20 is a simplified illustration of a remote game server in association with a wireless computer controlled toy system which may include a network computer;

FIG. 21 is a simplified flowchart illustration of the operation of the computer or of the network computer of FIG. 20, when operating in conjunction with the remote server;

FIG. 22 is a simplified flowchart illustration of the operation of the remote game server of FIG. 20;

FIG. 23 is a semi-pictorial semi-block diagram illustration of a wireless computer controlled toy system including a proximity detection subsystem operative to detect proximity between the toy and the computer;

FIGS. 24A-24E, taken together, form a detailed electronic schematic diagram of a multi-channel implementation of the computer radio interface 110 of FIG. 3 which is similar to the detailed electronic schematic diagrams of FIGS. 5A-5D except for being multi-channel, therefore capable of supporting full duplex applications, rather than single-channel;

FIGS. 25A-25F, taken together, form a detailed schematic illustration of a computer radio interface which connects to a serial port of a computer rather than to the sound board of the computer;

FIGS. 26A-26D, taken together, form a detailed schematic illustration of a computer radio interface which connects to a parallel port of a computer rather than to the sound board of the computer.;

FIGS. 27A-27J are preferred flowchart illustrations of a preferred radio coding technique which is an alternative to the radio coding technique described above with reference to FIGS. 8E, 8G-8M and 10A-C;

FIGS. 28A-28K, taken together, form a detailed electronic schematic diagram of the multi-port multi-channel computer radio interface sub-unit of FIG. 13;

FIGS. 29A-29I, taken together, form a detailed electronic schematic diagram of the multi-port multi-channel computer radio interface sub-unit of FIG. 14;

FIG. 30 is a partly pictorial, partly block diagram illustration of a computer control system including a toy, constructed and operative in accordance with a further preferred embodiment of the present invention;

FIG. 31 is a block diagram is a simplified block diagram illustrating the combination of the computer radio interface and the toy control device as used in the embodiment of FIG. 30; and

FIGS. 32A, 32B and 32C taken together form a simplified block diagram of the EPLD chip of FIG. 28H; and

FIGS. 33-53 illustrates embodiments of the toy system of FIGS. 1-32C wherein:

FIG. 33 is a pictorial illustration of personified household appliances associated with a central computer 2100 by means of two-way radio communication;

FIG. 34 is a pictorial illustration of a modification of the apparatus of FIG. 33 in which a first appliance is associated by means of a wire with the computer and other appliances communicate with the computer via the first appliance, communication between the first appliance and the other appliances being wireless;

FIG. 35 is a pictorial illustration of personified household appliances associated with a central computer by means of an existing electrical household wiring system;

FIGS. 36A-36C, taken together, form a simplified flowchart illustration of a preferred method by which the computer controls the transceiver/controller 2130 of the refrigerator 2122 and the washing machine 2126 of FIG. 33;

FIG. 37 is an example of a portion of a user interface by which the computer is set up by a user of an appliance, to provide the user of the appliance with infotainment or entertainment;

FIGS. 38A-38B, taken together, form a simplified flowchart illustration of a preferred method of operation by which the computer provides the user of a washing machine with infotainment or entertainment;

FIG. 39 is a simplified diagram of the interface between computer radio interface and a soundboard of the computer;

FIG. 40 is a simplified block diagram of a preferred implementation for the computer radio interface of FIG. 33;

FIG. 41 is a simplified flowchart illustration of a preferred communication method allowing one of the computer radio interface and the computer to receive commands over the audio channel, rather than over the MIDI channel, from the other one of the computer radio interface and the computer;

FIG. 42 is a diagram of the analog and digital representation of the SYNC, SQ, zero-valued bit and the one-valued bit signals;

FIGS. 43A-43E, taken together, form a detailed electronic schematic diagram of a preferred implementation of the apparatus of FIG. 40;

FIG. 44 is an example of a dialogue between a personified microwave oven and a personified dishwasher culminating in a verbal message emitted by a television;

FIG. 45 is a simplified flowchart illustration of a method of operation for a central computer according to a first preferred implementation of an inter-appliance dialogue such as the dialog of FIG. 44;

FIG. 46 is a flowchart illustration of a method of operation for an appliance according to a second preferred implementation of the dialogue of FIG. 45;

FIG. 47 is a pictorial illustration of a central computer 2100 accumulating information from users, via microphone bearing appliances, regarding consumable supplies to be replenished;

FIG. 48 is a script for the flowchart of FIG. 45 by which the computer 2100 implements the refrigerator's role in the interaction of FIG. 47;

FIG. 49 is a script for the flowchart of FIG. 45 by which the computer 2100 implements the washing machine's role in the interaction of FIG. 47;

FIG. 50 is a pictorial illustration of a scenario in which a central computer is accumulating information regarding household chore monitoring and timing;

FIG. 51 is a script for the flowchart of FIG. 45 by which the computer 2100 implements the washing machine's role in the interaction of FIG. 50;

FIG. 52 is a script for the flowchart of FIG. 45 by which the computer 2100 implements the dryer's role in the interaction of FIG. 50; and

FIG. 53 is a script for the flowchart of FIG. 45 by which the computer 2100 implements the microwave oven's role in the interaction of FIG. 50.

Attached herewith is a microfiche appendix labeled “1 of 2,” “2 of 2,” “1 of 4,” “2 of 4,” “3 of 4,” and “4 of 4” and comprising appendices A-W wherein:

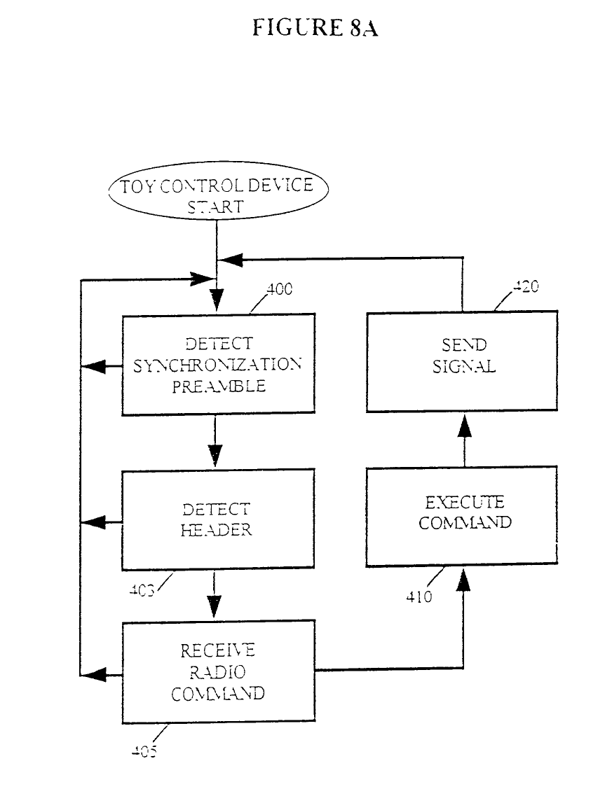

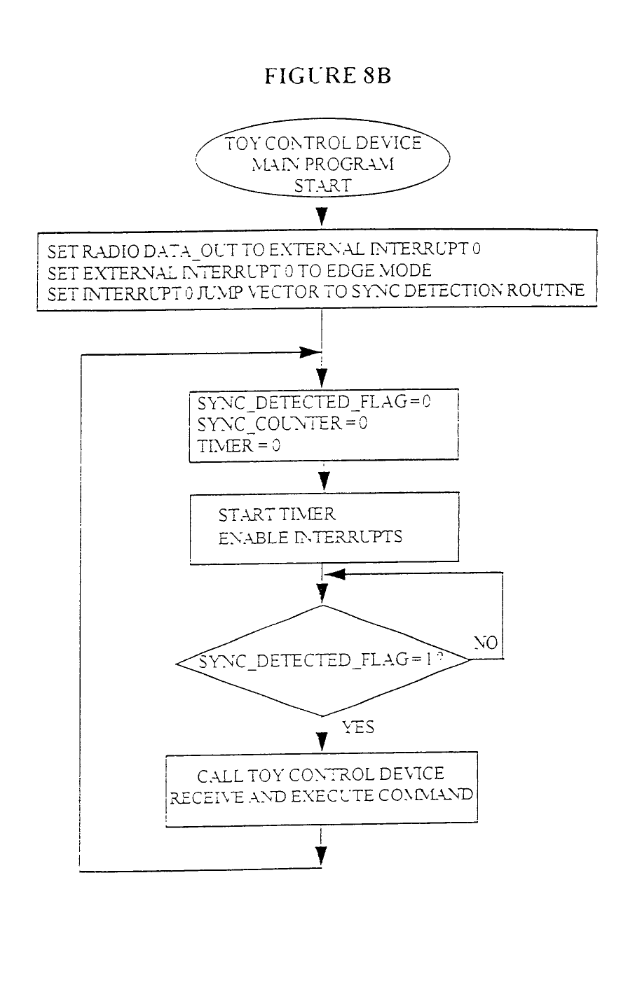

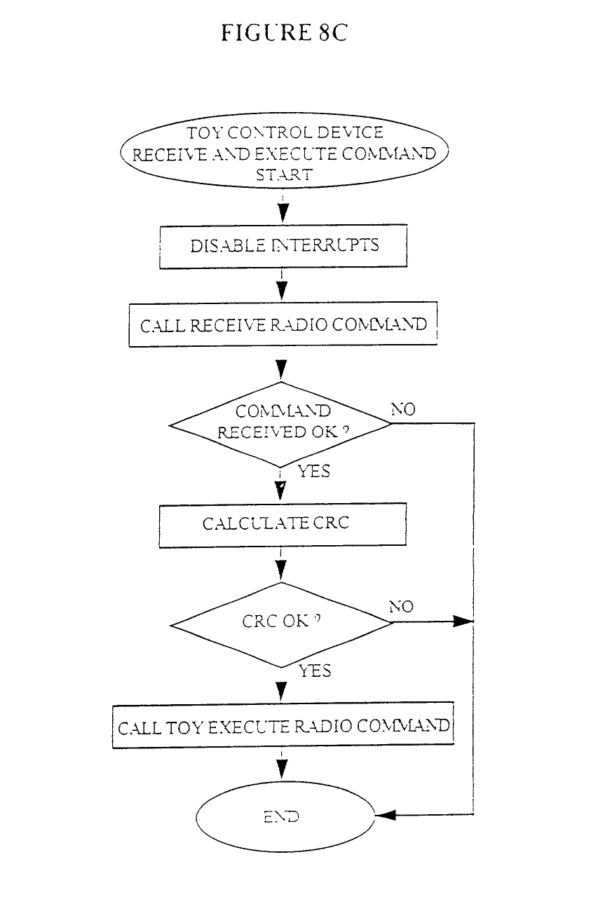

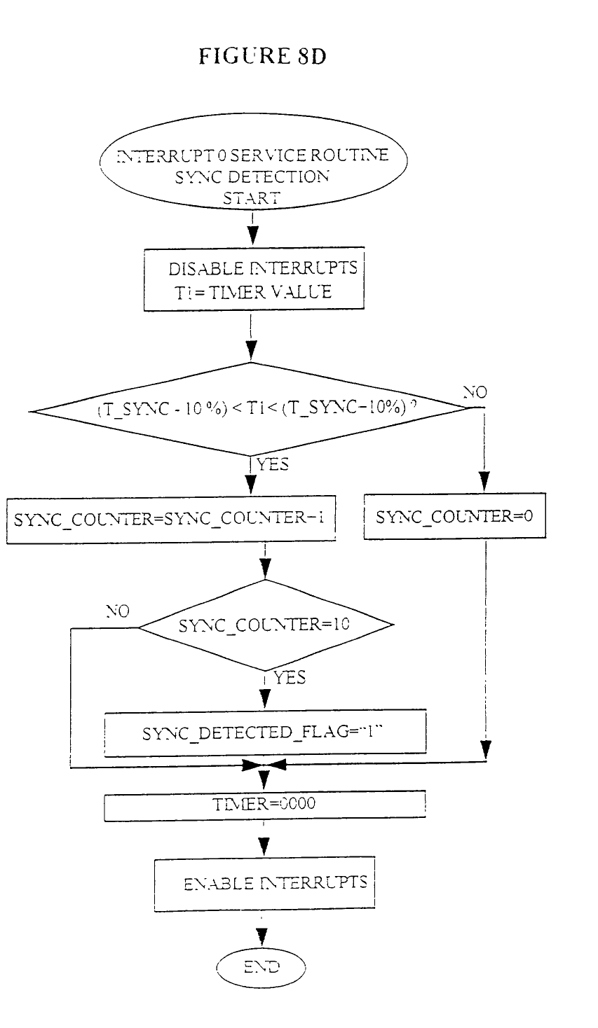

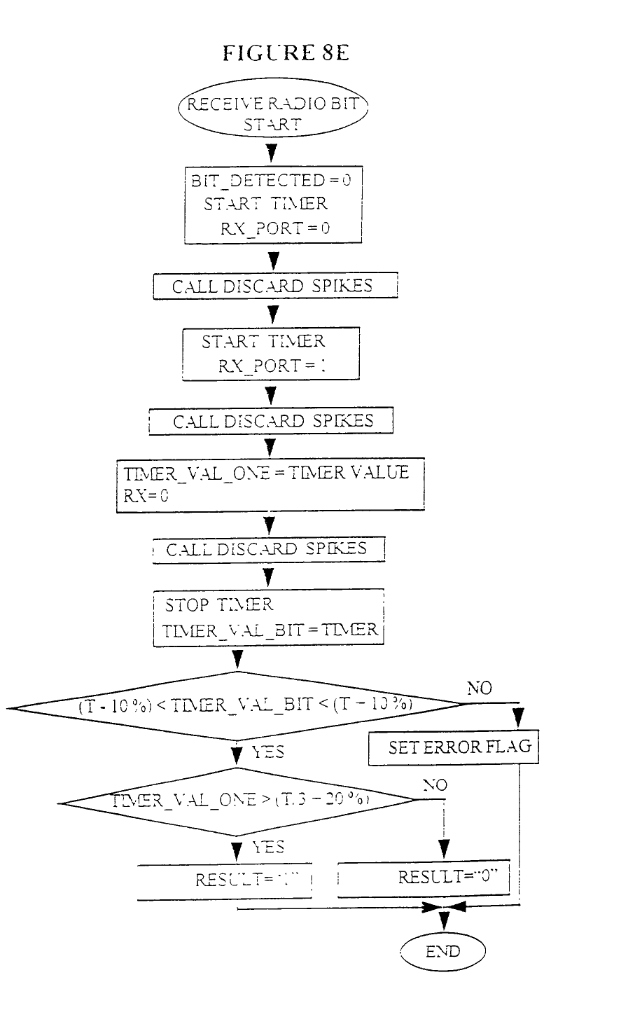

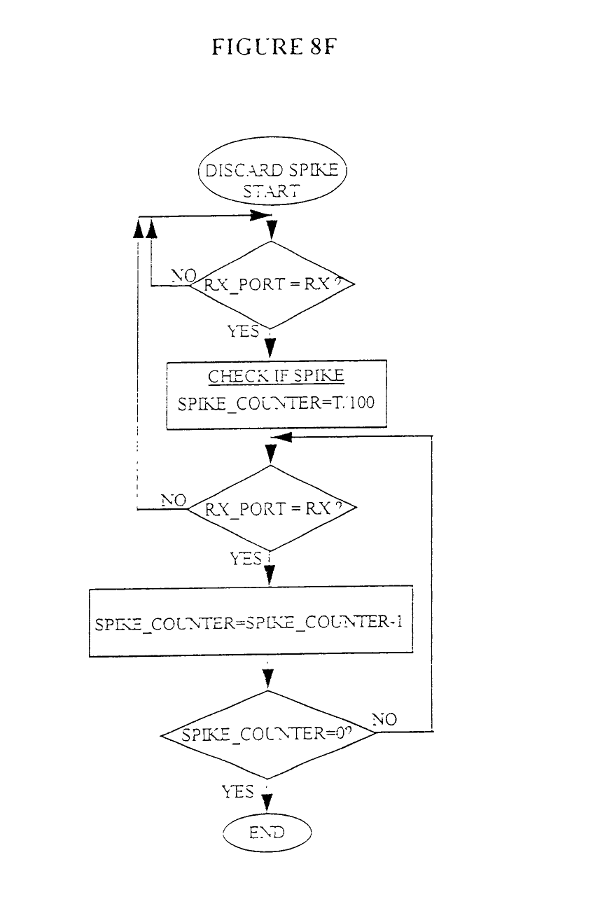

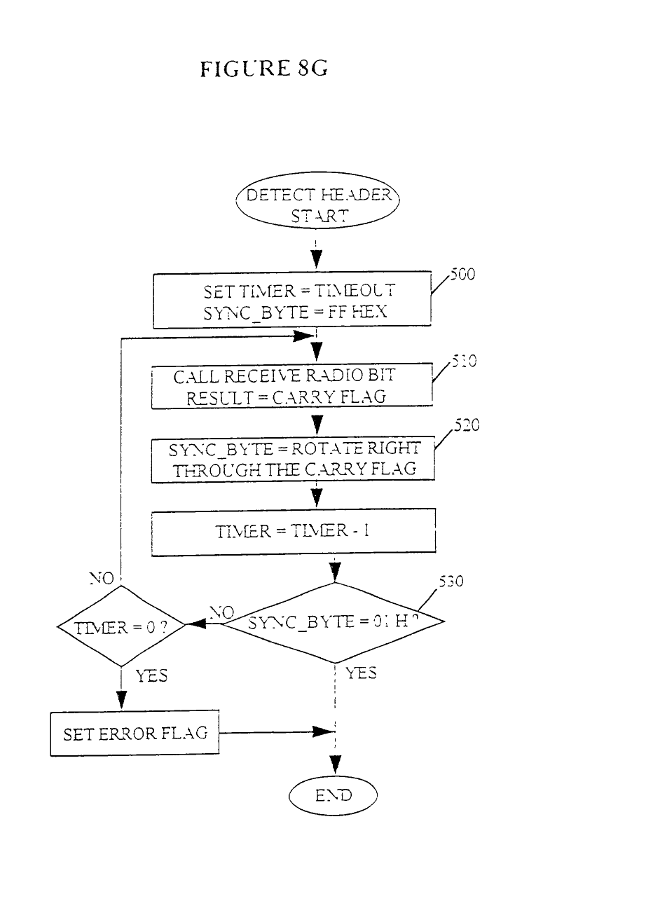

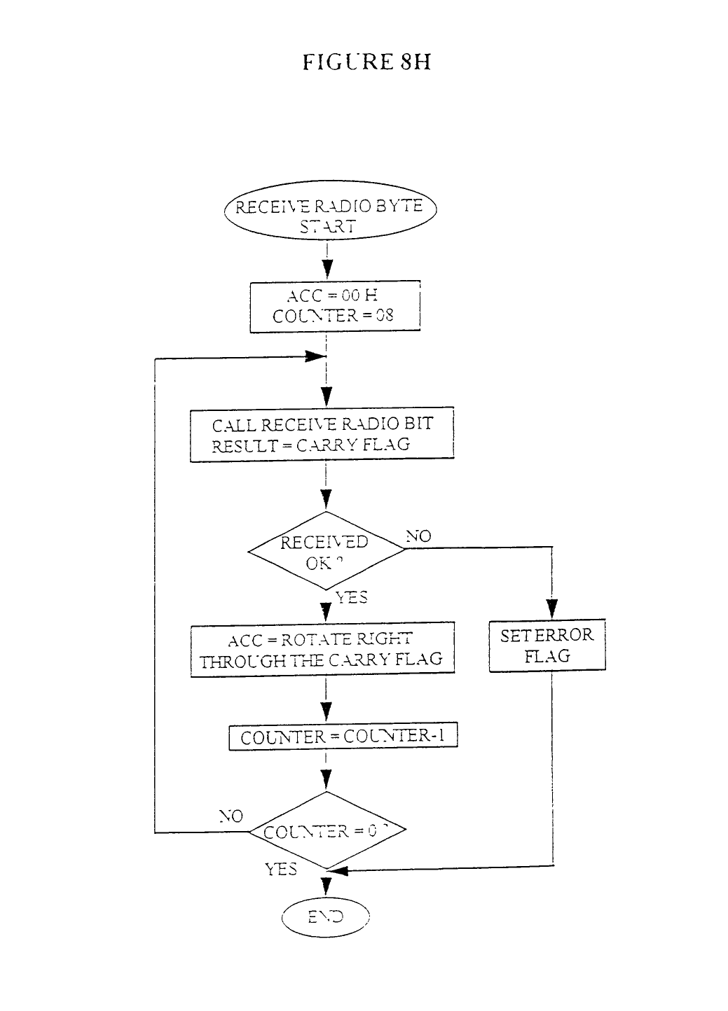

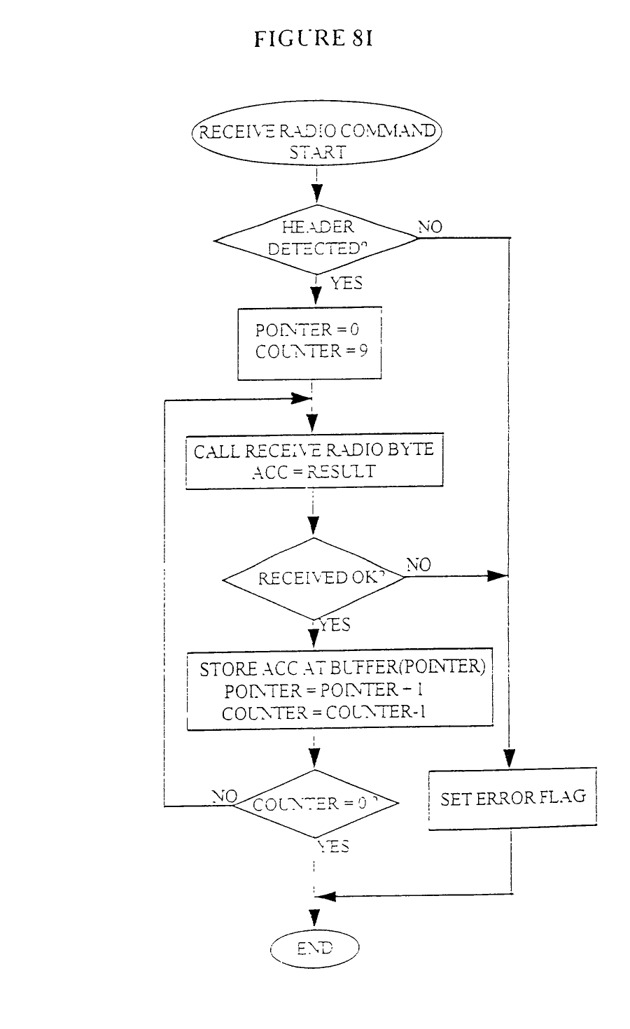

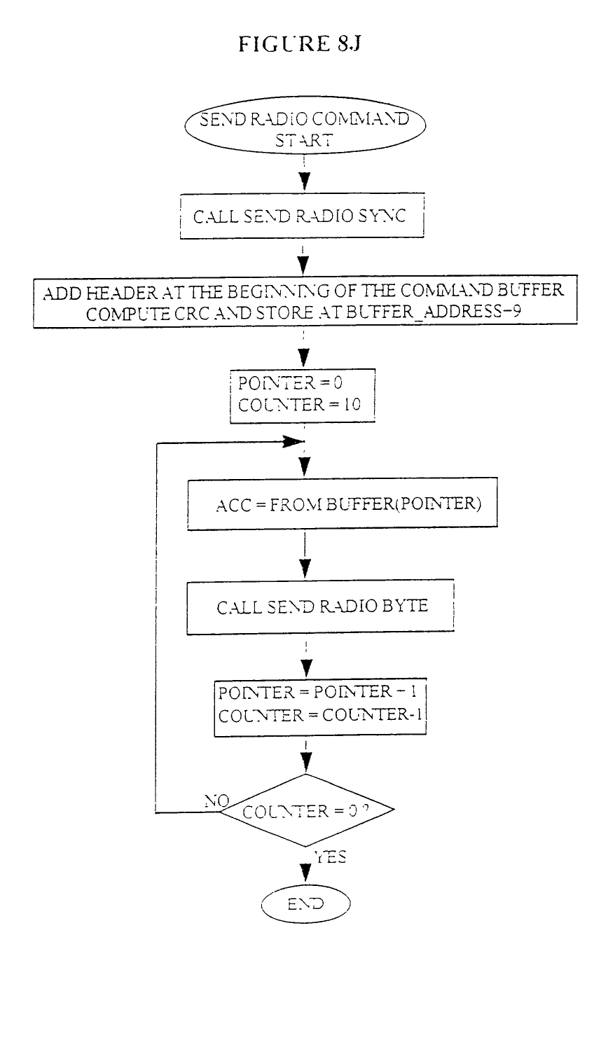

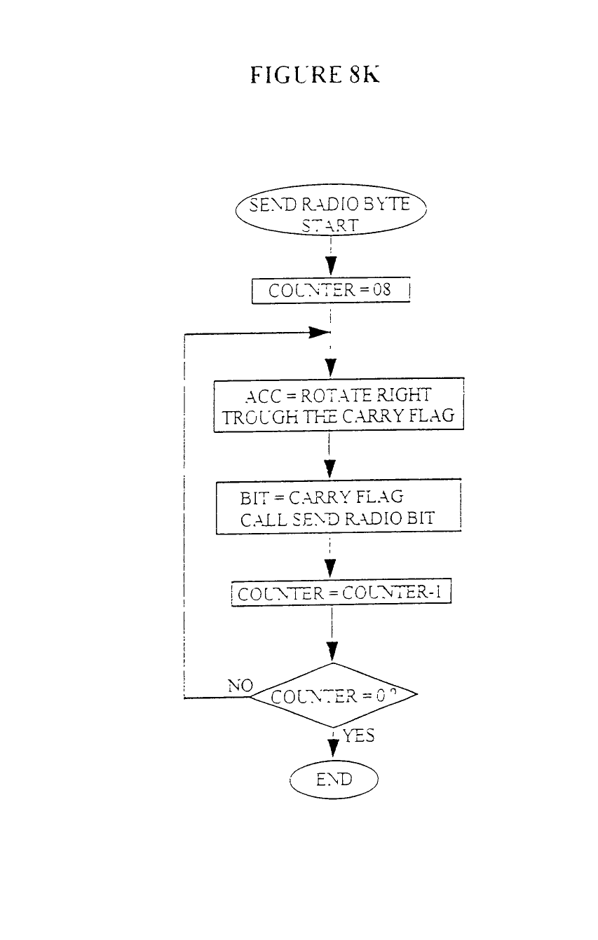

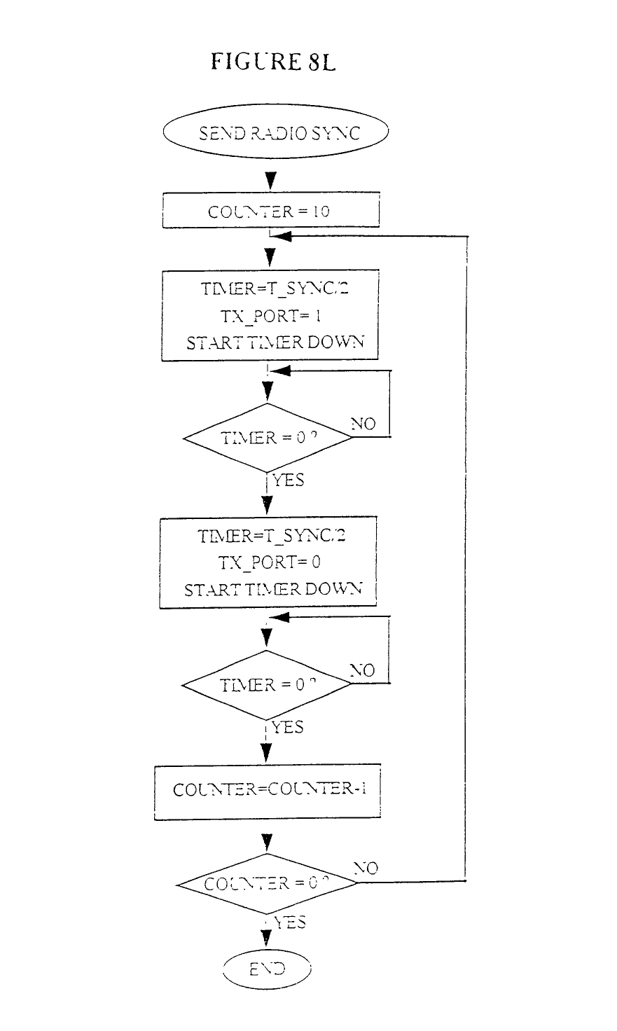

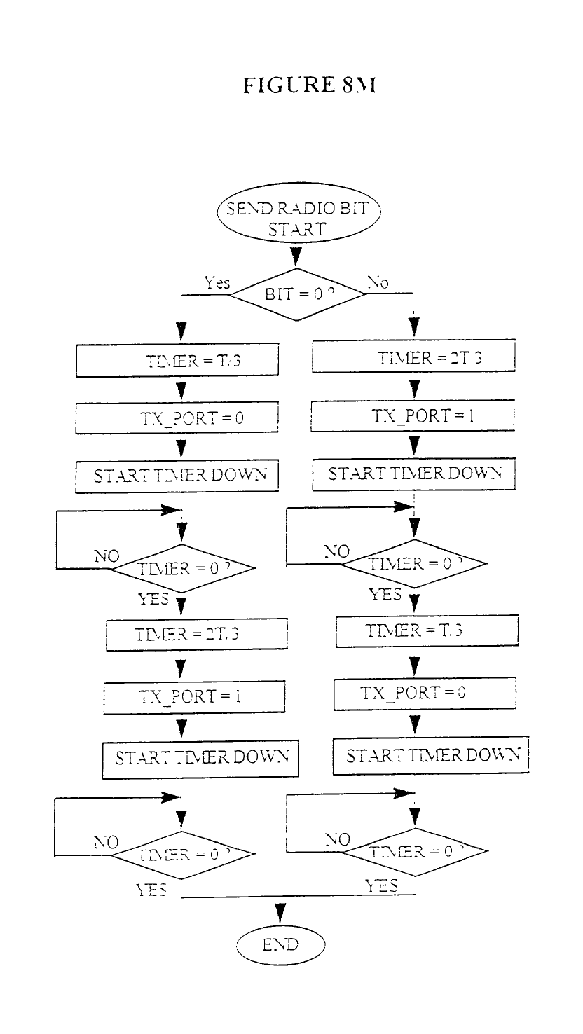

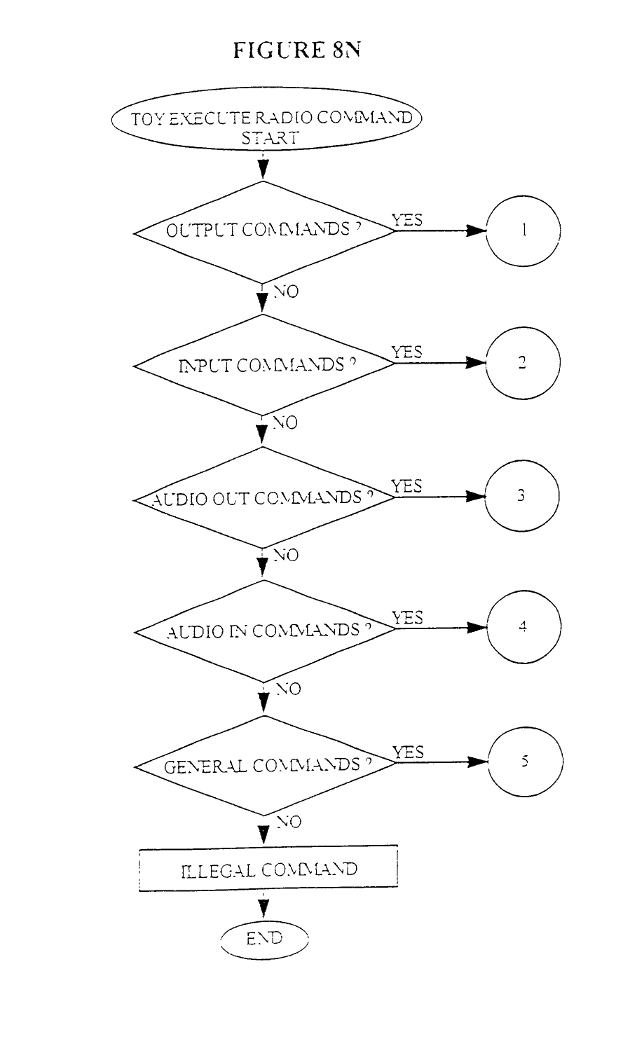

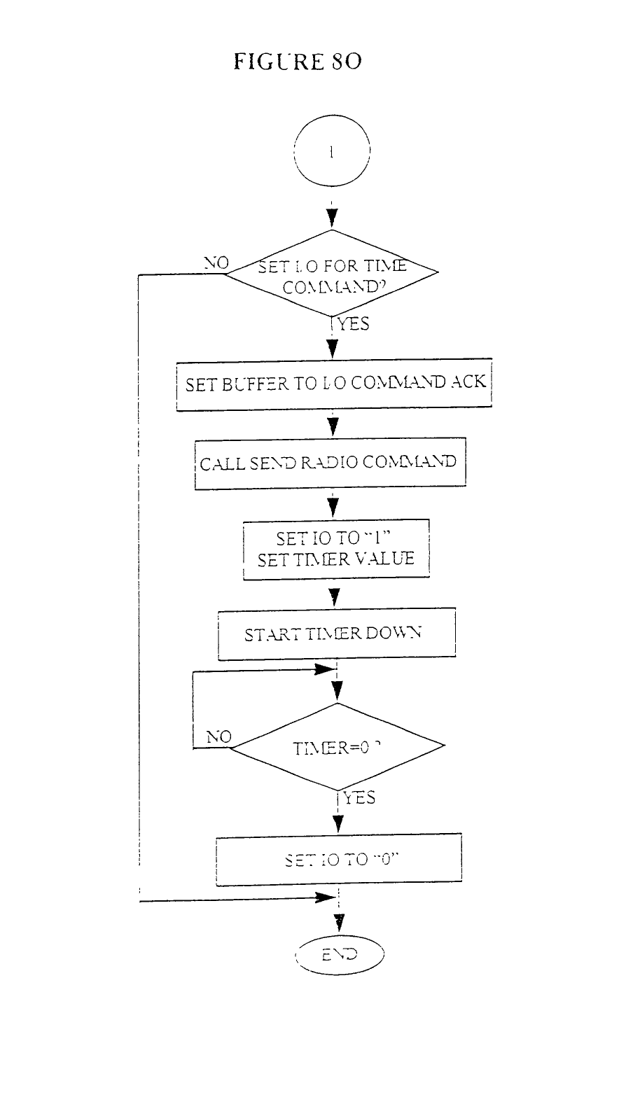

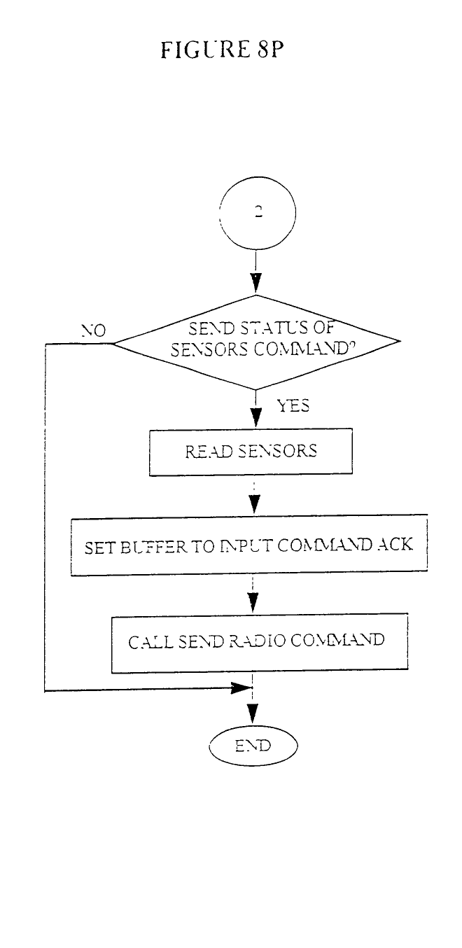

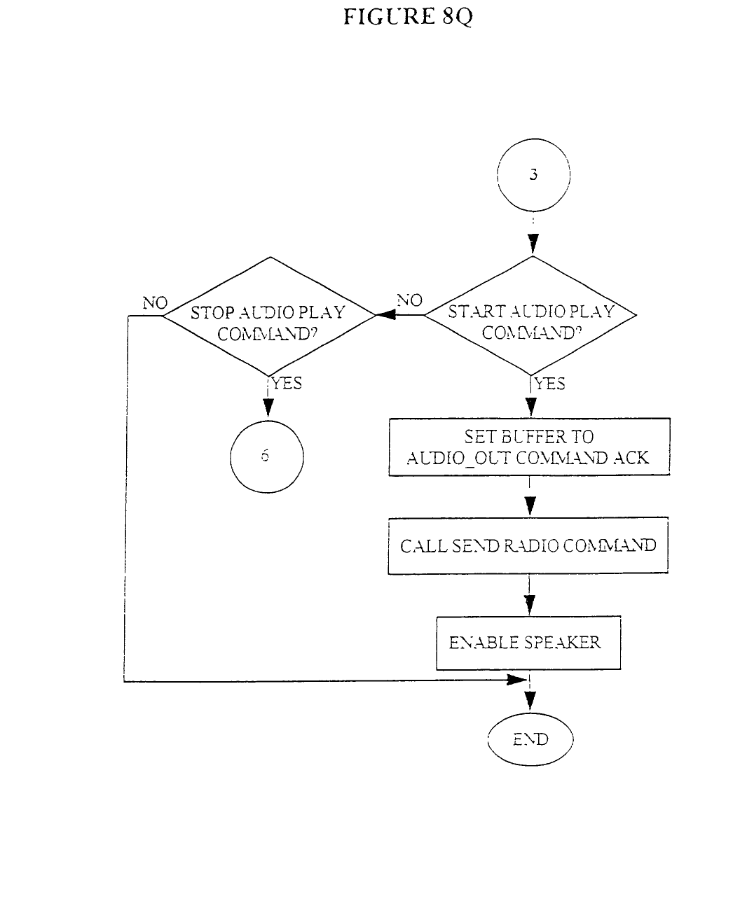

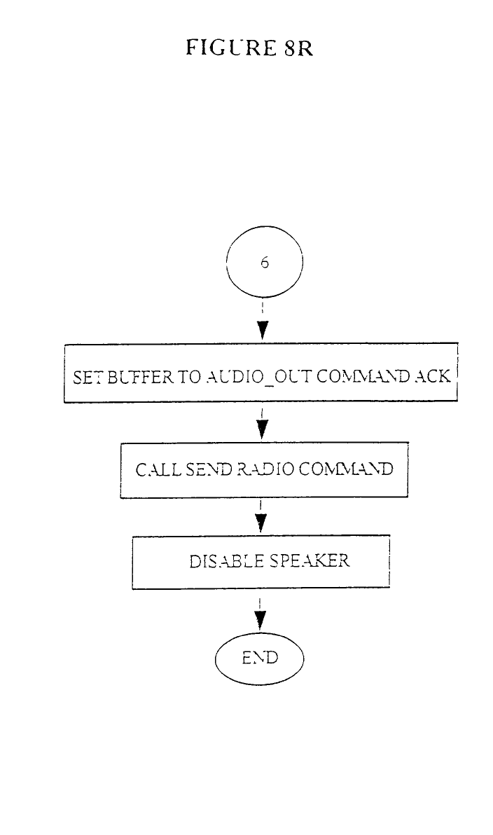

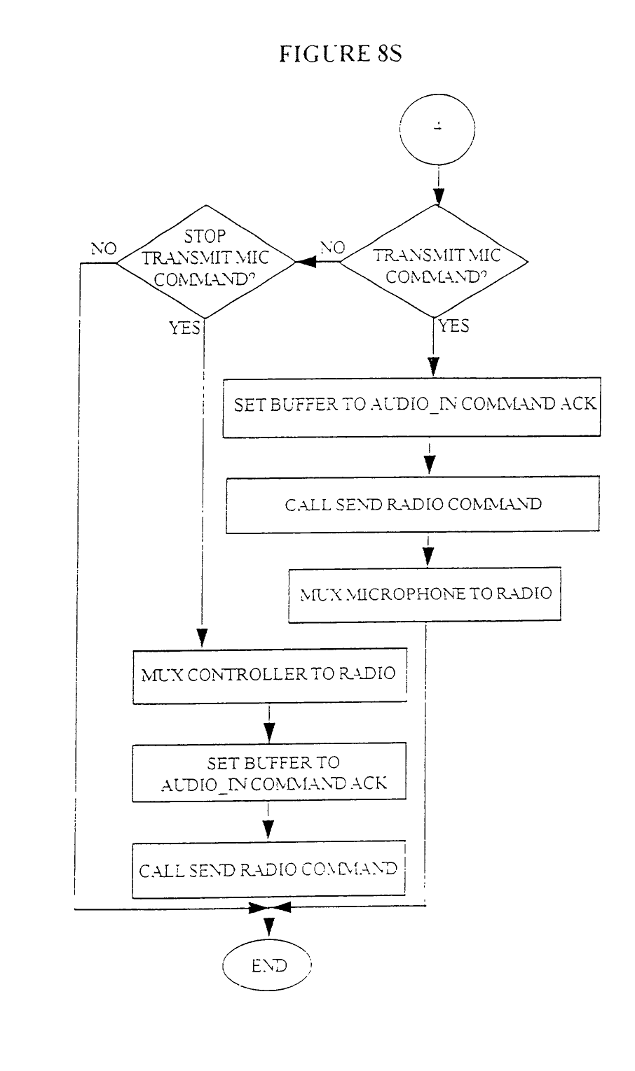

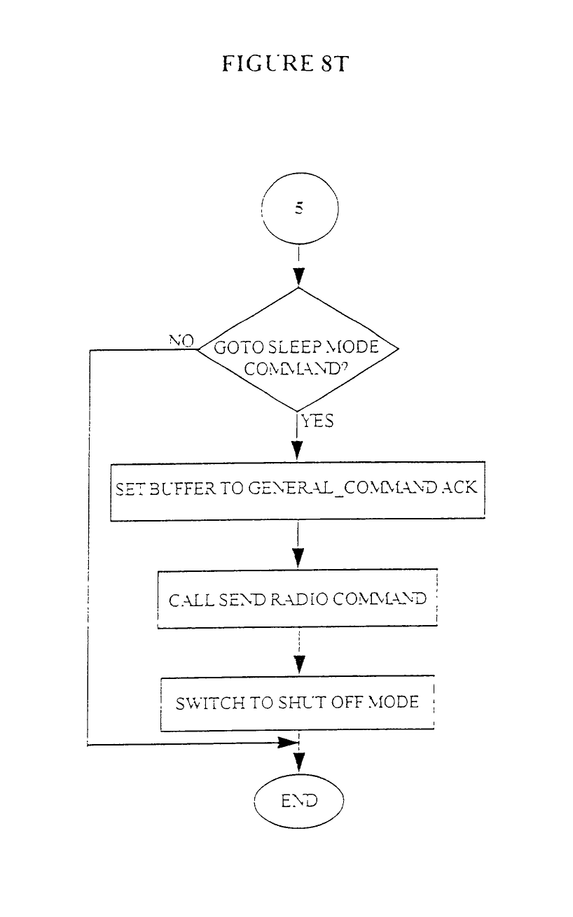

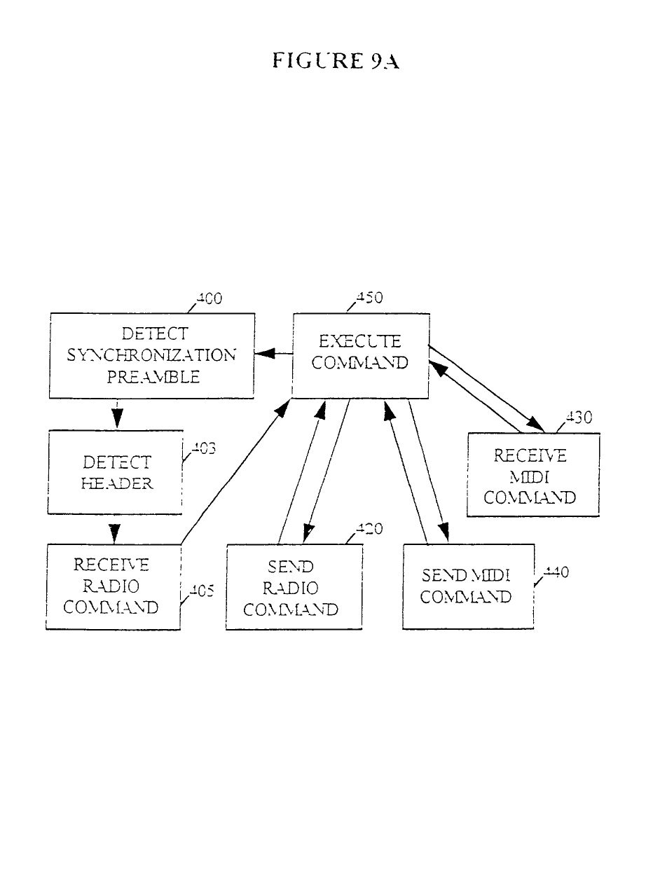

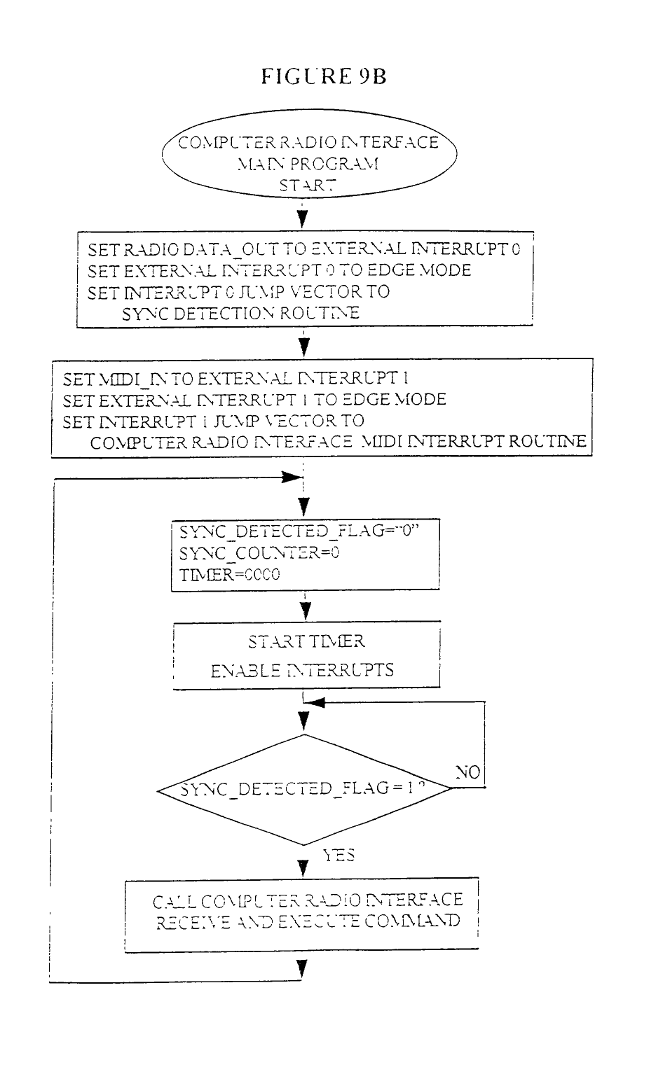

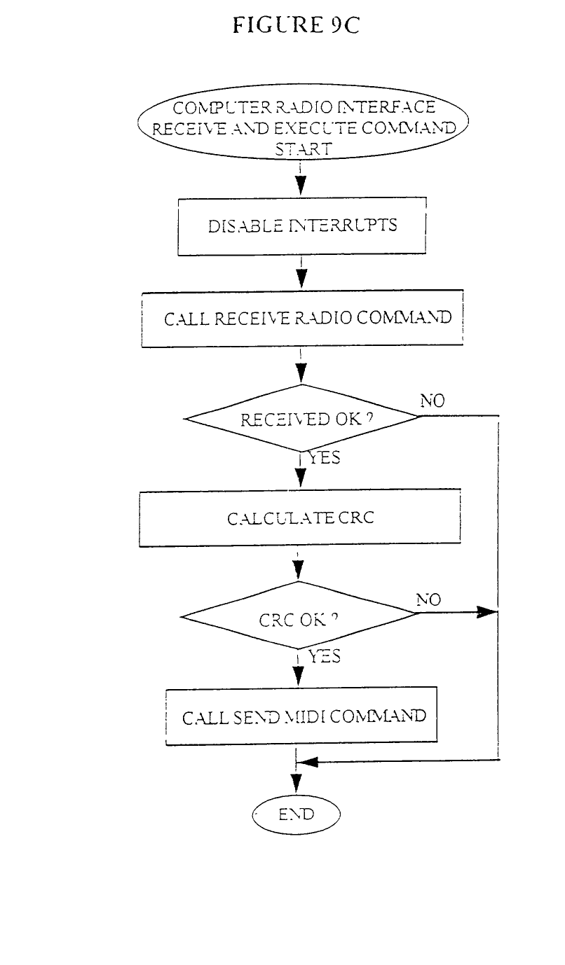

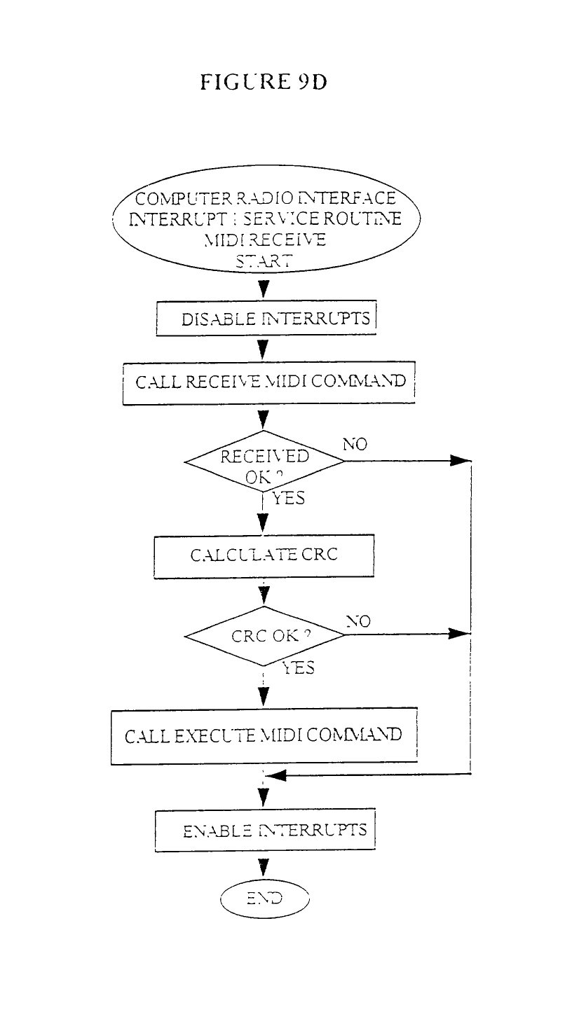

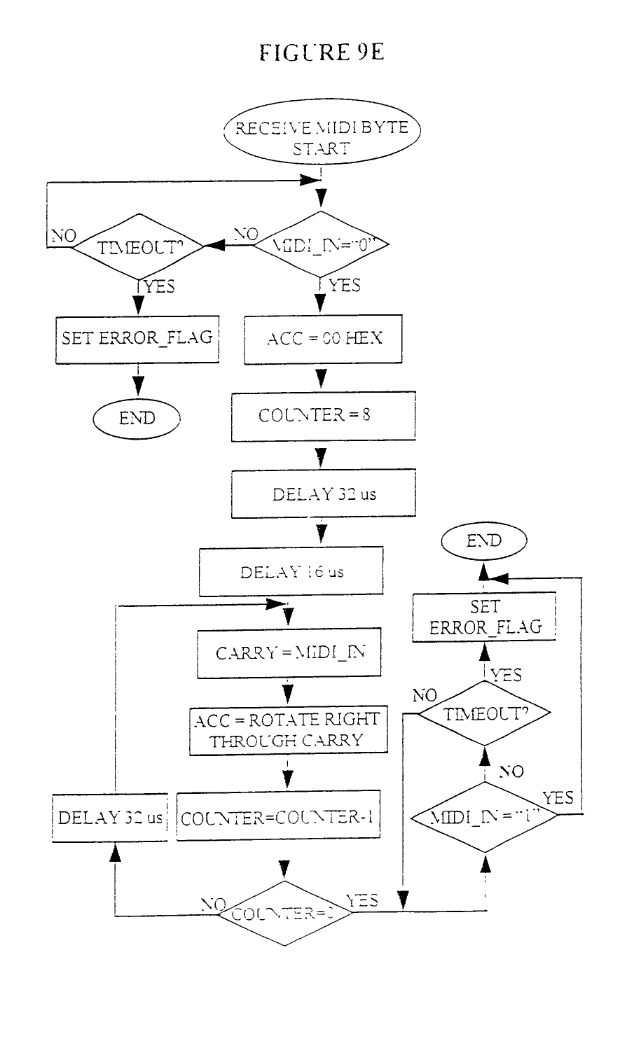

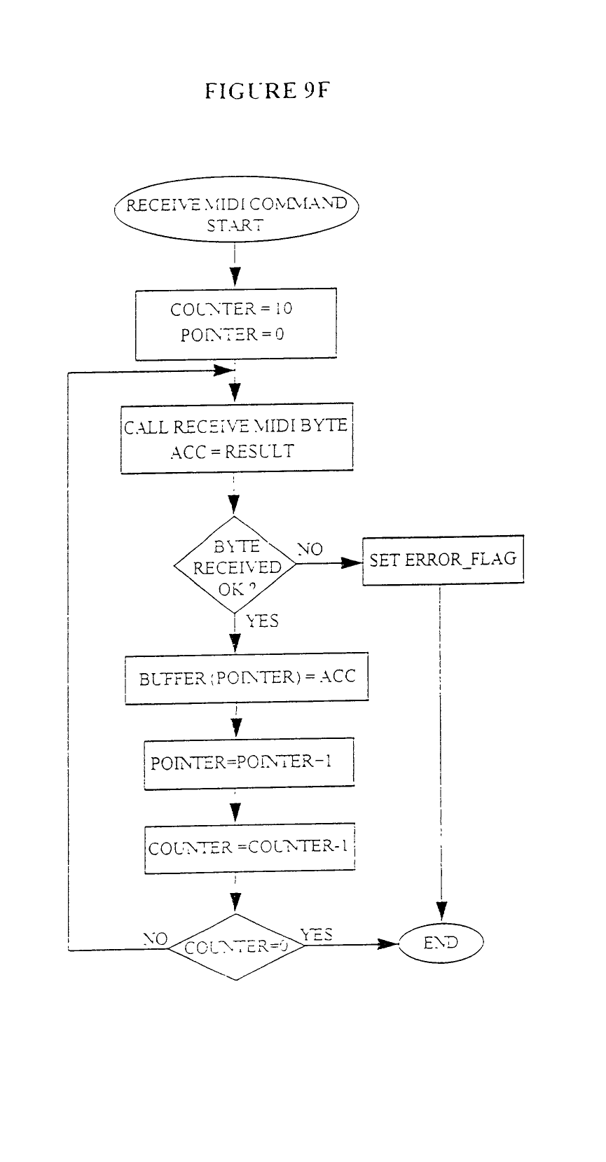

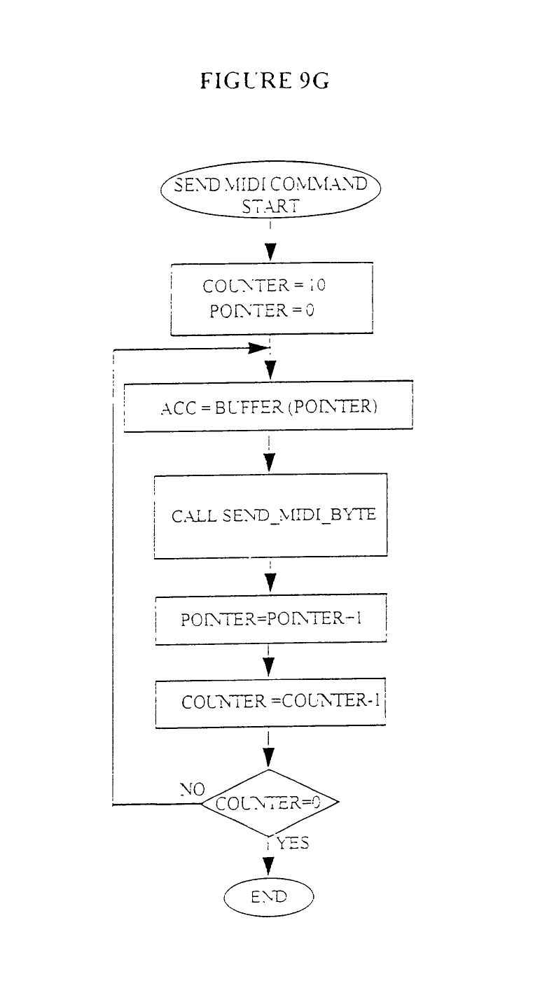

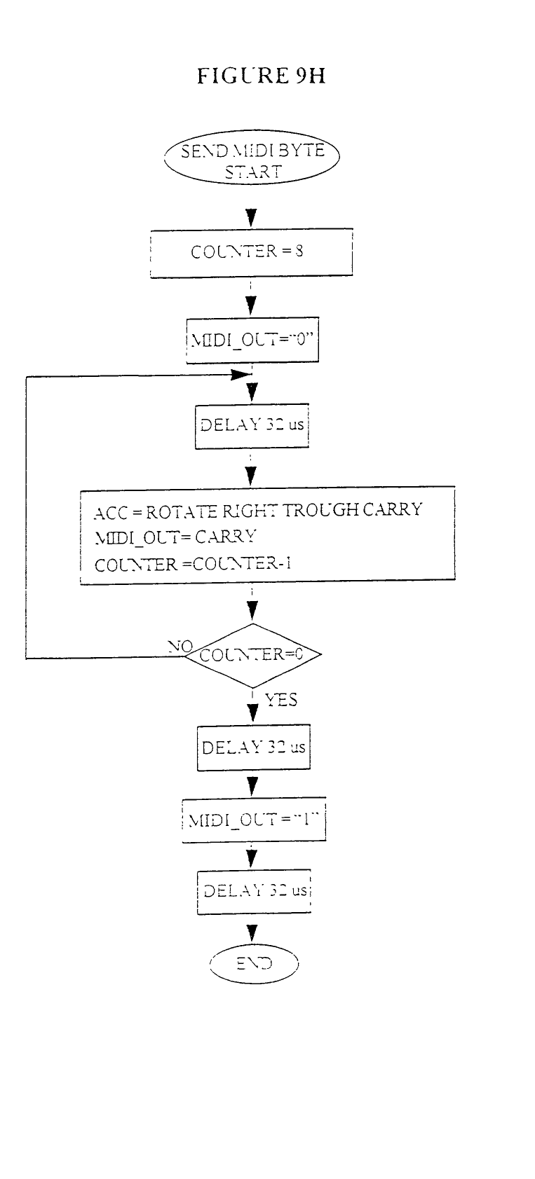

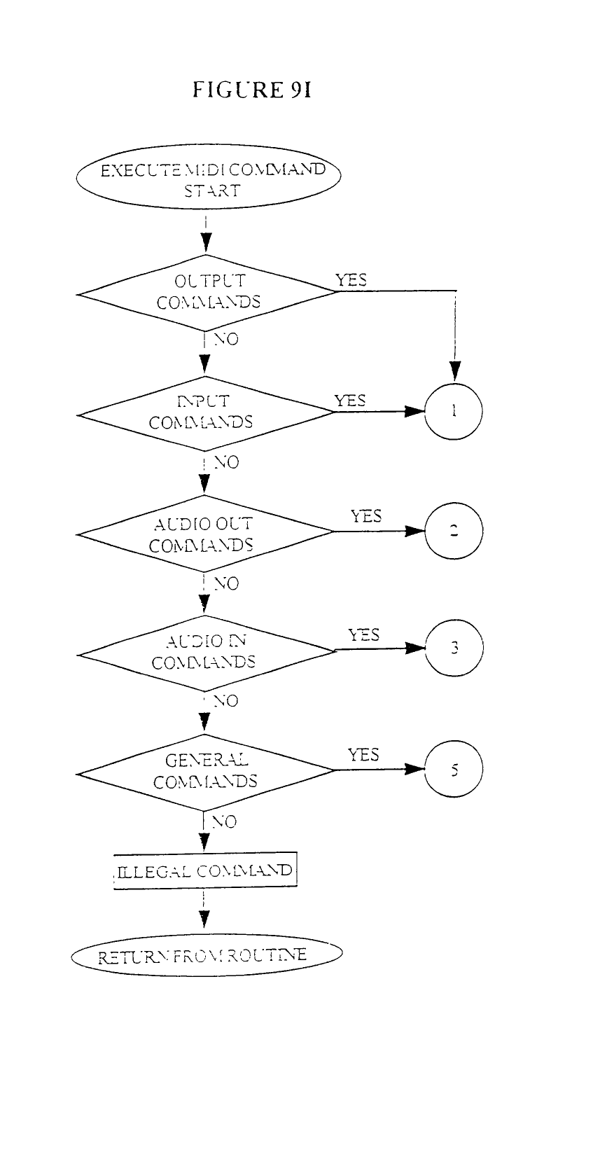

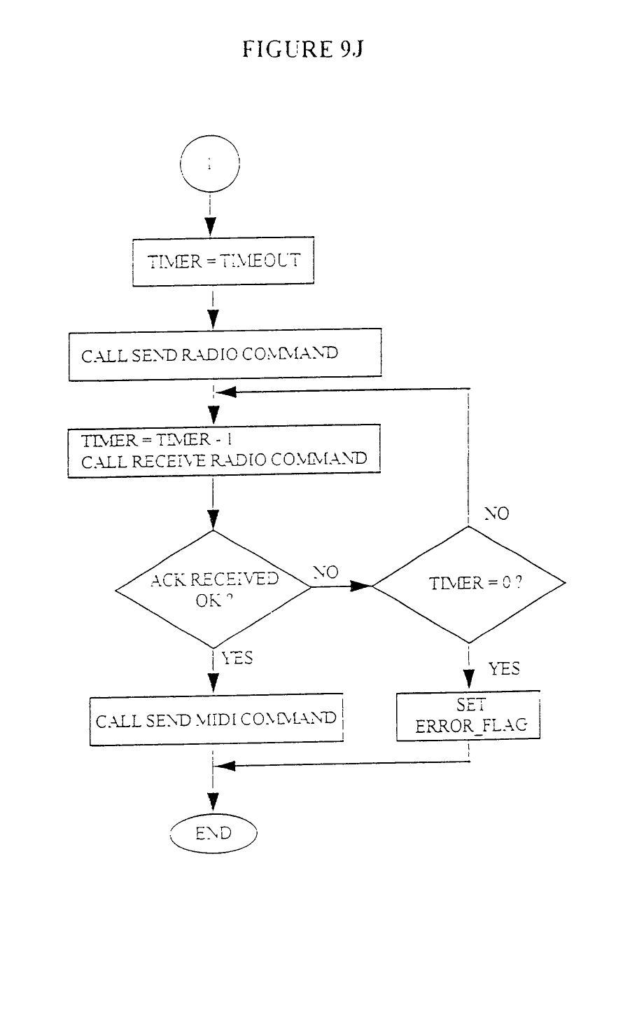

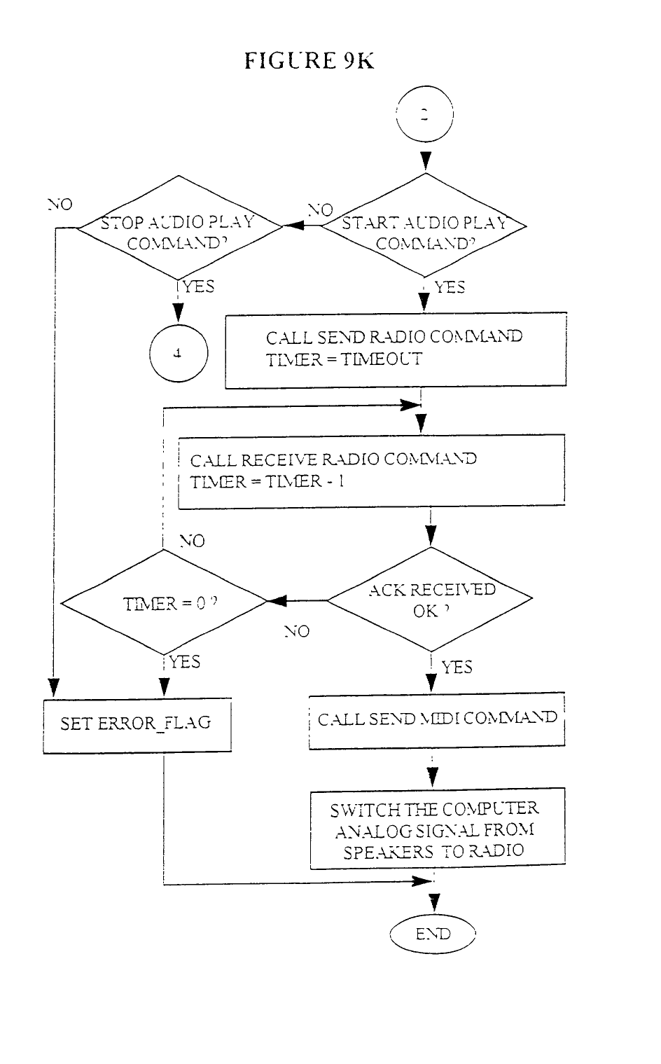

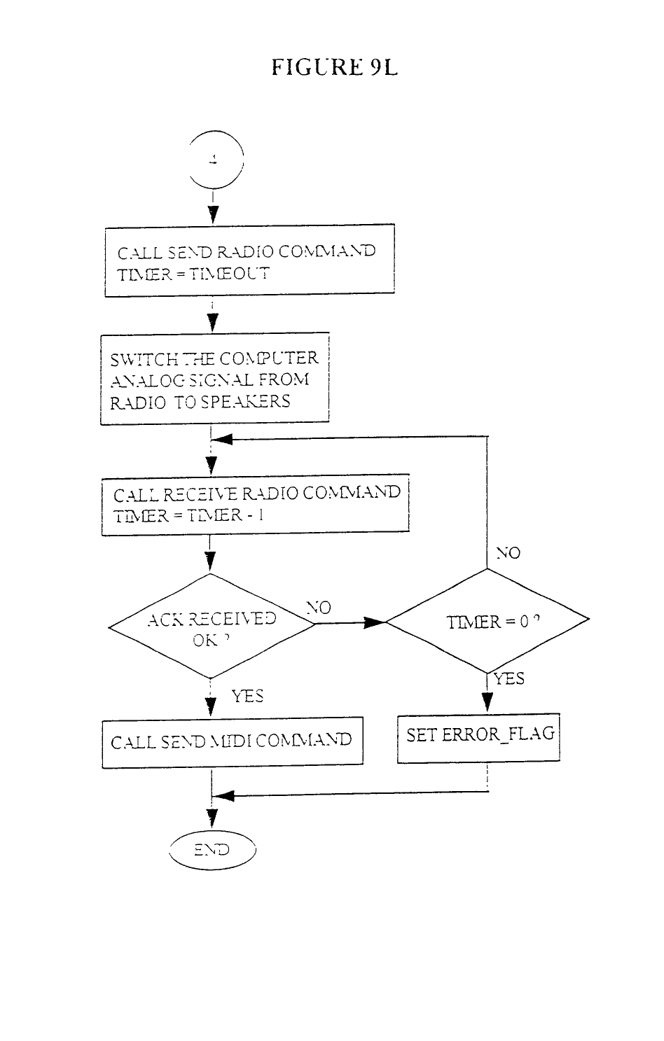

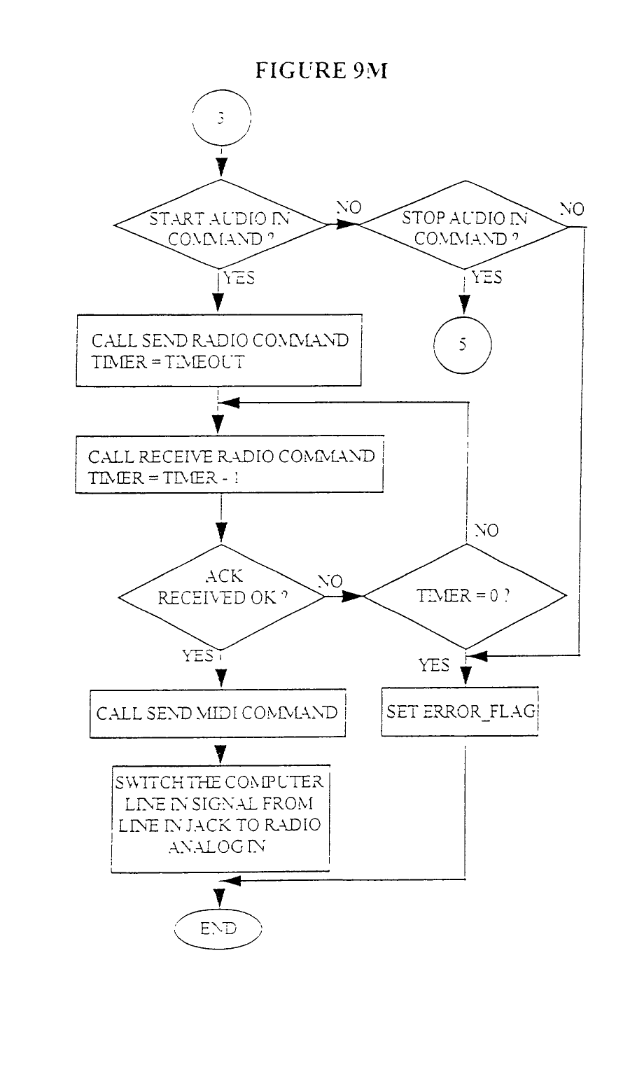

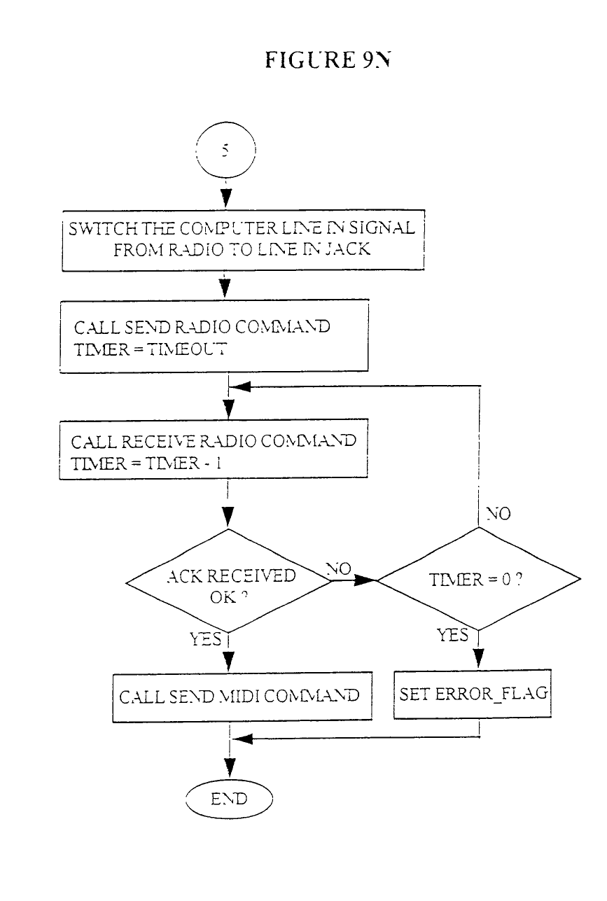

Appendix A is a computer listing of a preferred software implementation of the method of FIGS. 9A-9N, together with the method of FIGS. 8D-8M;

Appendix B is a computer listing of a preferred software implementation of the method of FIGS. 8A-8T;

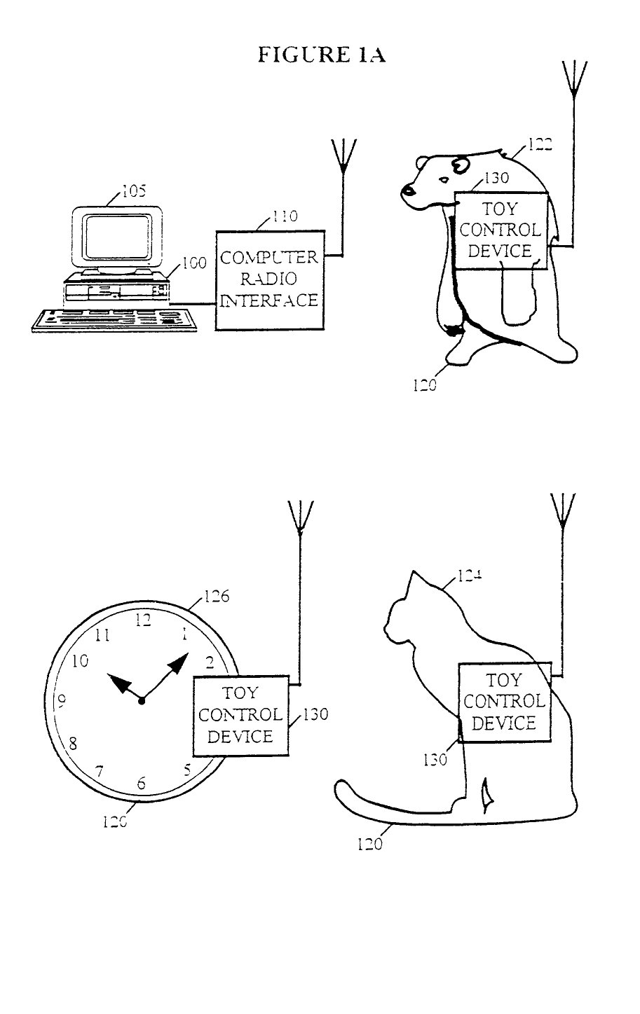

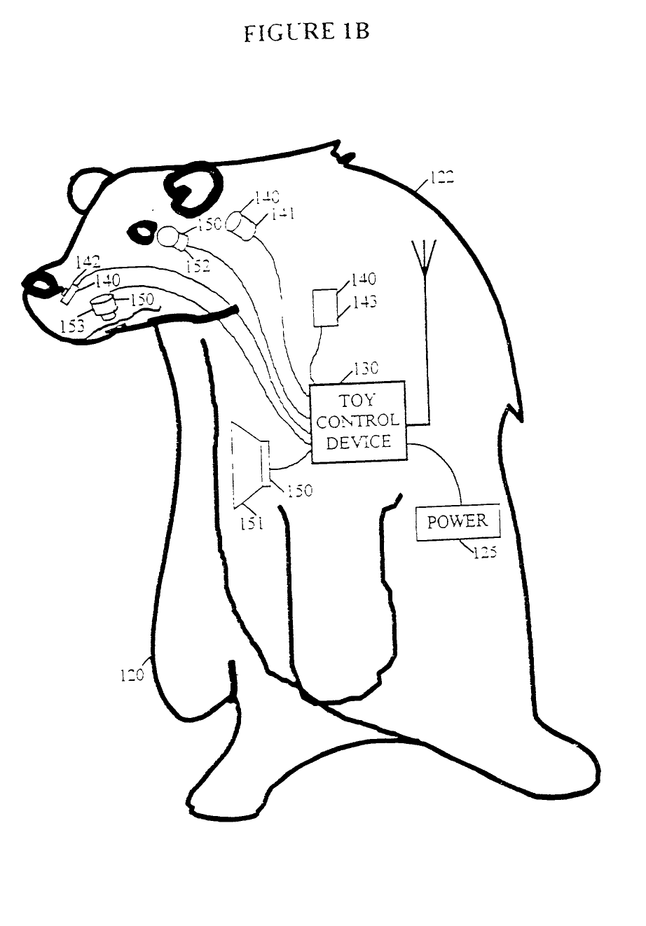

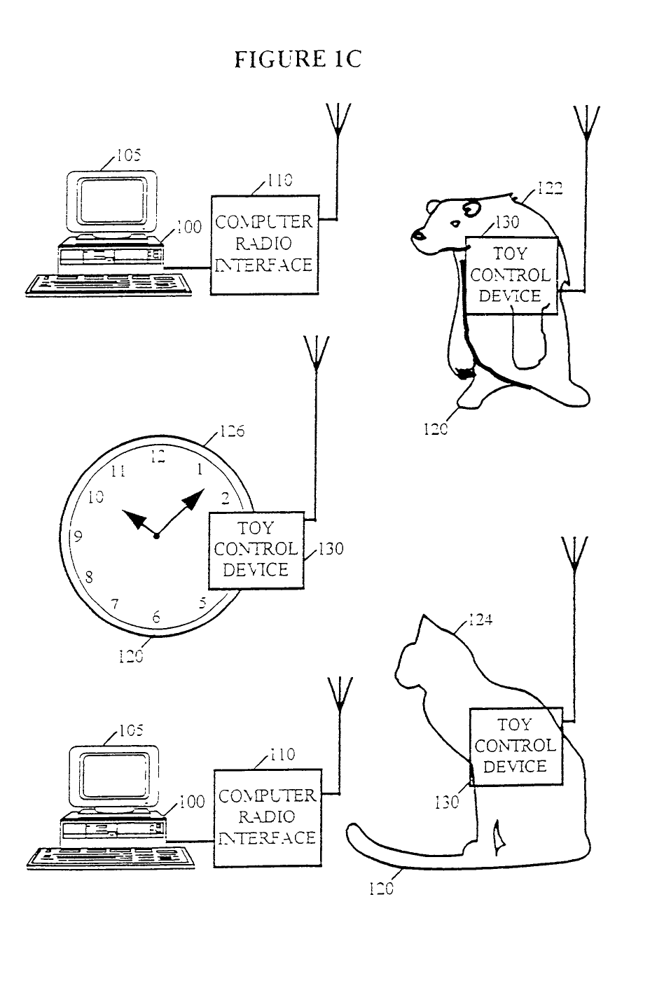

Appendix C is a computer listing of a preferred software implementation of an example of a computer game for use in the computer 100 of FIG. 1;

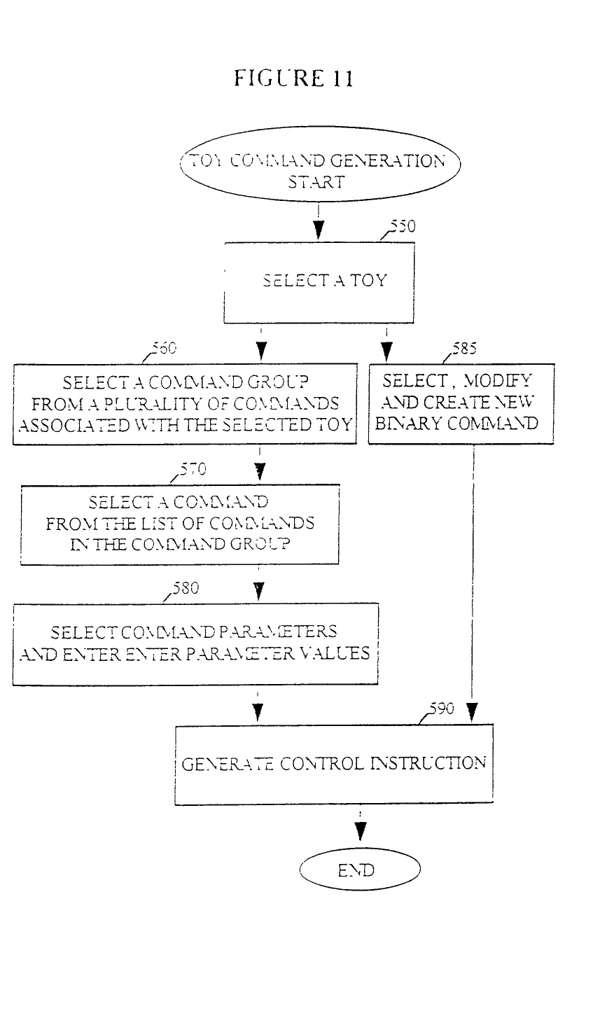

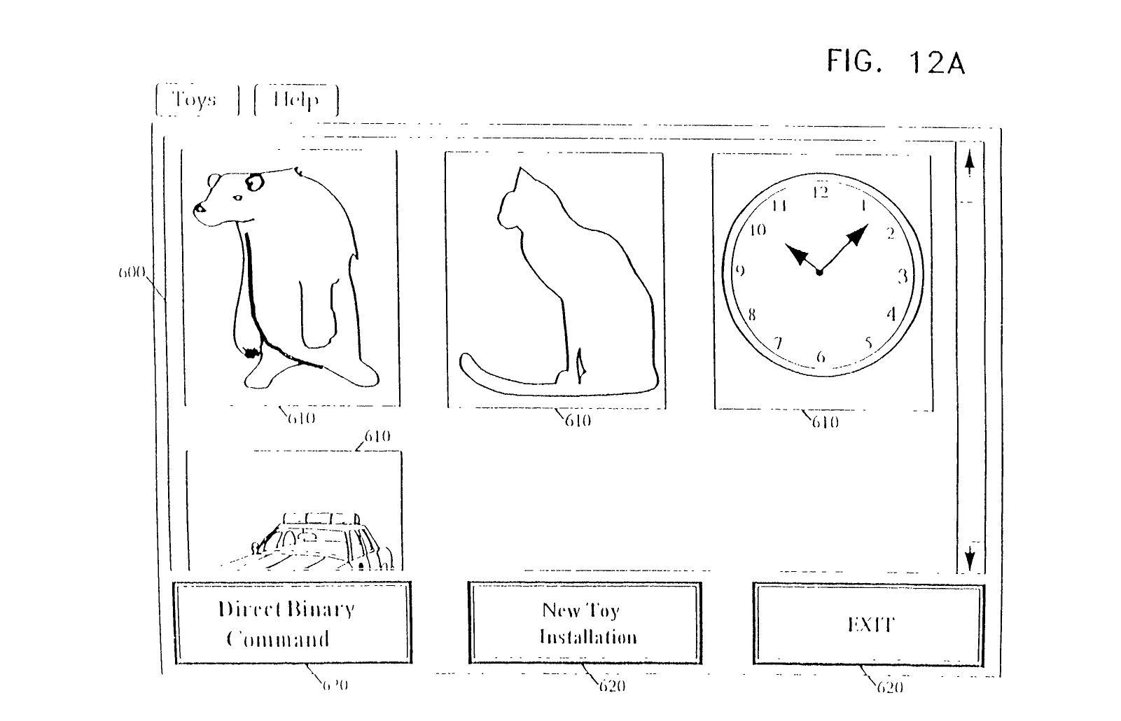

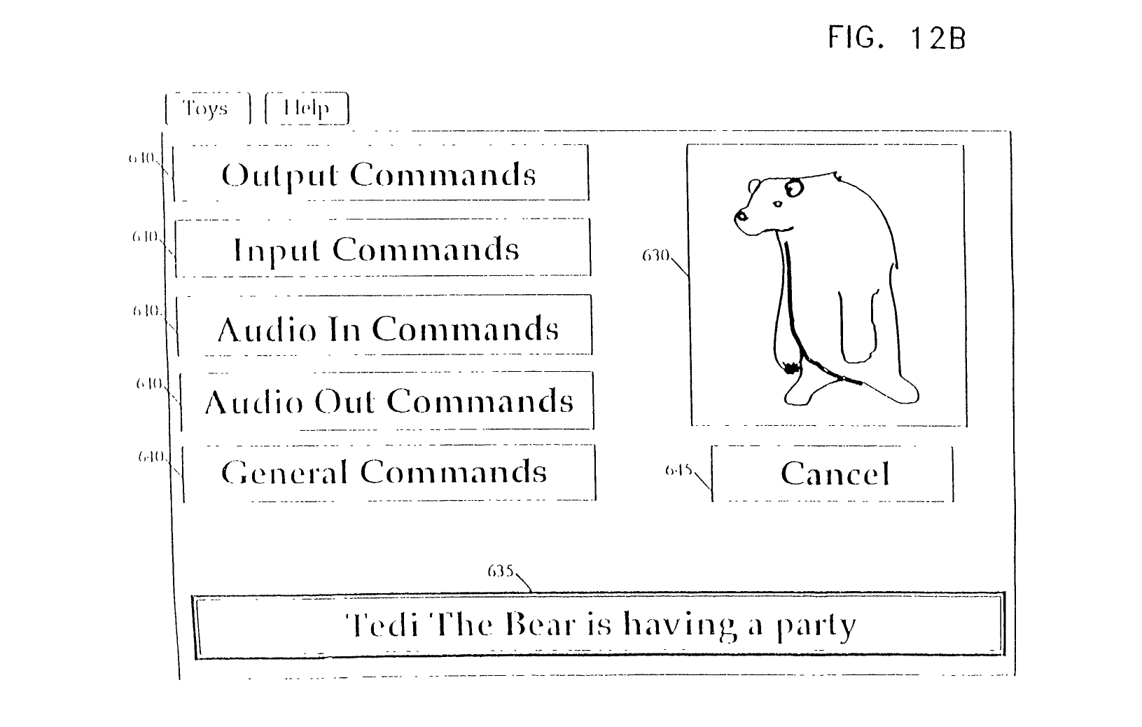

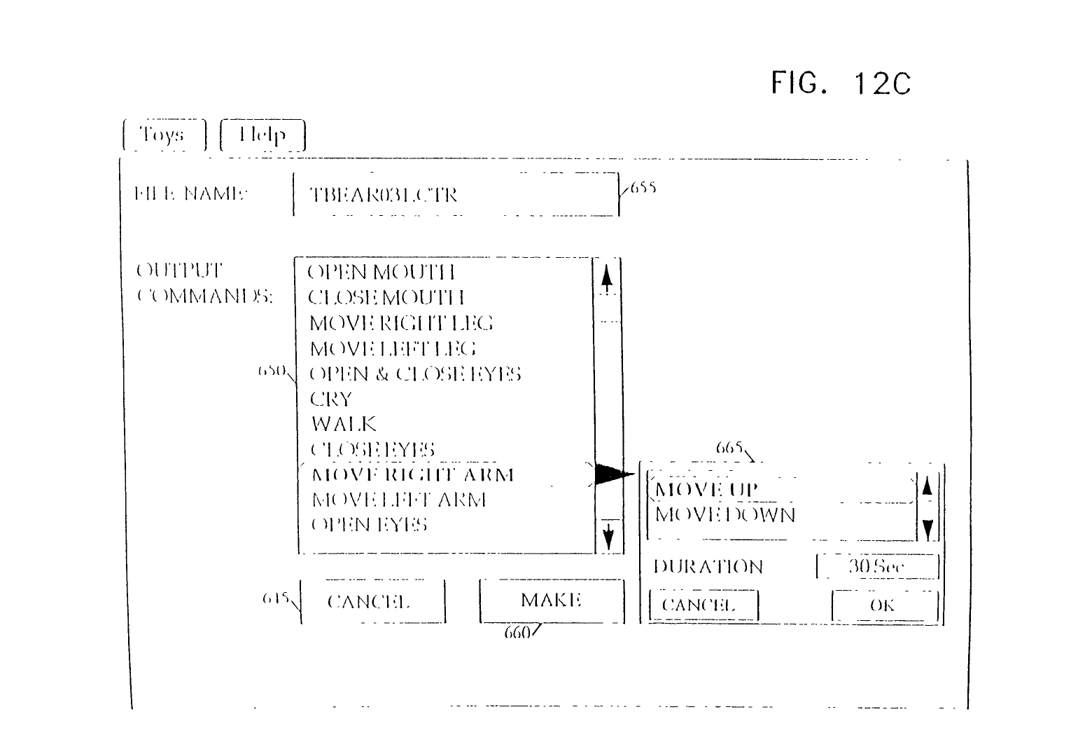

Appendix D is a computer listing of a preferred software implementation of the method of FIGS. 11 and FIGS. 12A-12C;

Appendices E-H, taken together, are computer listings from which a first, DLL-compatible, functions library may be constructed;

Appendices I-O, taken together, are computer listings of a second functions library which may be used to generate a variety of games for any of the computer control systems shown and described herein; and

Appendices P-W, taken together, are computer listings of another preferred software implementation, alternative to the implementation of Appendices A-O.

### DETAILED DESCRIPTION OF PREFERRED EMBODIMENTS

Reference is now made to FIG. 1A which is a partly pictorial, partly block diagram illustration of a computer control system including a toy, constructed and operative in accordance with a preferred embodiment of the present invention. The system of FIG. 1A comprises a computer 100, which may be any suitable computer such as, for example, an IBM-compatible personal computer. The computer 100 is equipped with a screen 105. The computer 100 is preferably equipped with a sound card such as, for example, a Sound Blaster Pro card commercially available from Creative Labs, Inc., 1901 McCarthy Boulevard, Milpitas Calif. 95035 or from Creative Technology Ltd., 67 Ayer Rajah Crescent #03-18, Singapore, 0513; a hard disk; and, optionally, a CD-ROM drive.

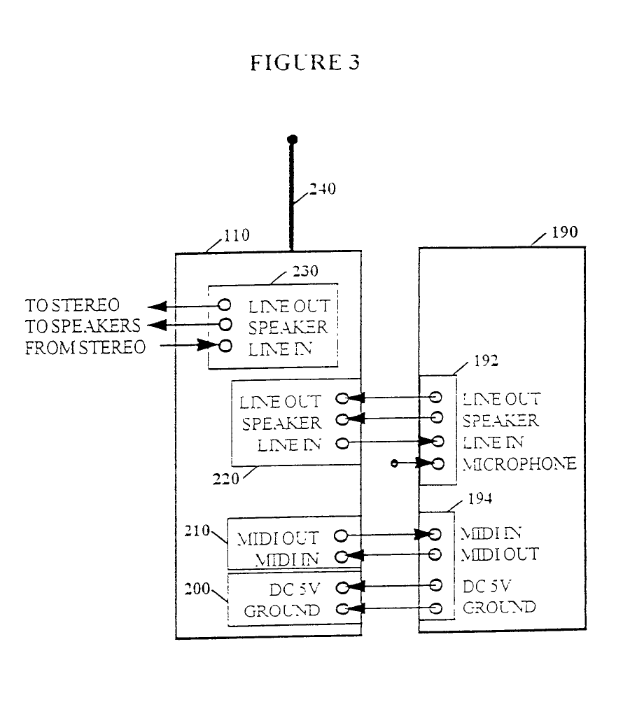

The computer 100 is equipped with a computer radio interface 110 operative to transmit signals via wireless transmission based on commands received from the computer 100 and, in a preferred embodiment of the present invention, also to receive signals transmitted elsewhere via wireless transmission and to deliver the signals to the computer 100. Typically, commands transmitted from the computer 100 to the computer radio interface 110 are transmitted via both analog signals and digital signals, with the digital signals typically being transmitted by way of a MIDI port. Transmission of the analog and digital signals is described below with reference to FIG. 3.

The transmitted signal may be an analog signal or a digital signal. The received signal may also be an analog signal or a digital signal. Each signal typically comprises a message. A preferred implementation of the computer radio interface 110 is described below with reference to FIG. 3.

The system of FIG. 1A also comprises one or more toys 120. The system of FIG. 1A comprises a plurality of toys, namely three toys 122, 124, and 126 but it is appreciated that, alternatively, either one toy only or a large plurality of toys may be used.

Reference is now additionally made to FIG. 1B, which is a partly pictorial, partly block diagram illustration of the toy 122 of FIG. 1A.

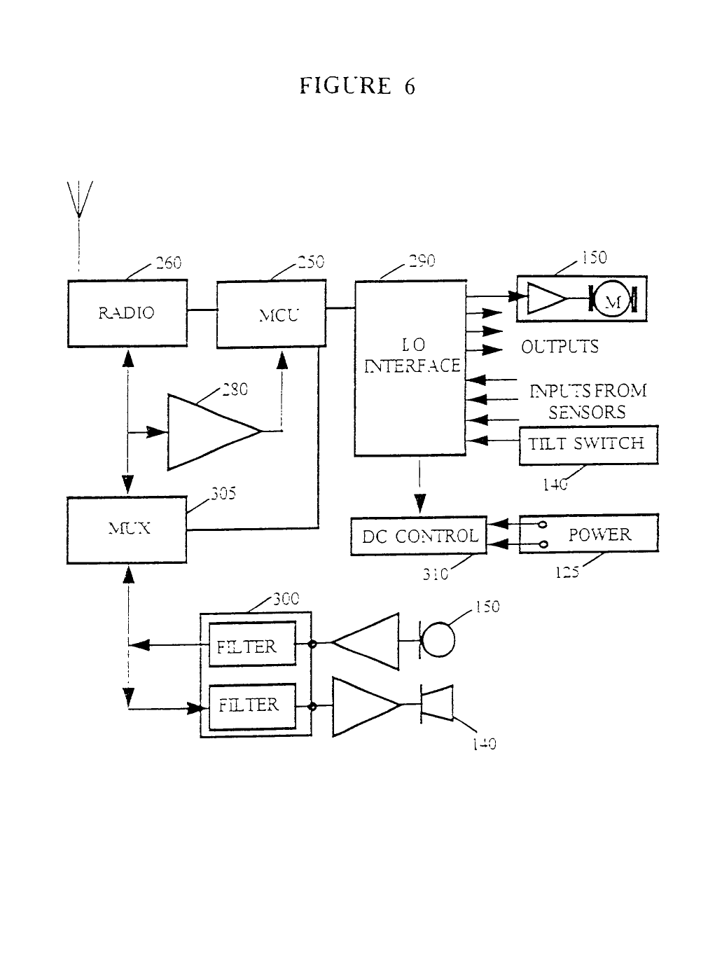

Each toy 120 comprises a power source 125, such as a battery or a connection to line power. Each toy 120 also comprises a toy control device 130, operative to receive a wireless signal transmitted by the computer 100 and to cause each toy 120 to perform an action based on the received signal. The received signal may be, as explained above, an analog signal or a digital signal. A preferred implementation of the toy control device 130 is described below with reference to FIG. 6.

Each toy 120 preferably comprises a plurality of input devices 140 and output devices 150, as seen in FIG. 1B. The input devices 140 may comprise, for example on or more of the following: a microphone 141; a microswitch sensor 142; a touch sensor (not shown in FIG. 1B); a light sensor (not shown in FIG. 1B); a movement sensor 143, which may be, for example, a tilt sensor or an acceleration sensor. Appropriate commercially available input devices include the following: position sensors available from Hamlin Inc., 612 East Lake Street, Lake Mills, Wis. 53551, USA; motion and vibration sensors available from Comus International, 263 Hillside Avenue, Nutley, N. J. 07110, USA; temperature, shock, and magnetic sensors available from Murata Electronics Ltd., Hampshire, England; and switches available from C&K Components Inc., 15 Riverdale Avenue, Newton, Mass. 02058-1082, USA or from Micro Switch Inc., a division of Honeywell, USA. The output devices 150 may comprise, for example, one or more of the following: a speaker 151; a light 152; a solenoid 153 which may be operative to move a portion of the toy; a motor, such as a stepping motor, operative to move a portion of the toy or all of the toy (not shown in FIG. 1B). Appropriate commercially available output devices include the following: DC motors available from Alkatel (dunkermotoren), Postfach 1240, D-7823, Bonndorf/Schwarzald, Germany; stepping motors and miniature motors available from Haydon Switch and Instruments, Inc. (HSI), 1500 Meriden Road, Waterbury, Conn., USA; and DC solenoids available from Communications Instruments, Inc., P.O. Box 520, Fairview, N.C. 28730, USA.

Examples of actions which the toy may perform include the following: move a portion of the toy; move the entire toy; or produce a sound, which may comprise one or more of the following: a recorded sound, a synthesized sound, music including recorded music or synthesized music, speech including recorded speech or synthesized speech.

The received signal may comprise a condition governing the action as, for example, the duration of the action, or the number of repetitions of the action.

Typically, the portion of the received signal comprising a message comprising a command to perform a specific action as, for example, to produce a sound with a given duration, comprises a digital signal. The portion of the received signal comprising a sound, for example, typically comprises an analog signal. Alternatively, in a preferred embodiment of the present invention, the portion of the received signal comprising a sound, including music, may comprise a digital signal, typically a signal comprising MIDI data.

The action the toy may perform also includes reacting to signals transmitted by another toy, such as, for example, playing sound that the other toy is monitoring and transmitting.

In a preferred embodiment of the present invention, the toy control device 130 is also operative to transmit a signal intended for the computer 100, to be received by the computer radio interface 110. In this embodiment, the computer radio interface 110 is preferably also operative to poll the toy control device 130, that is, transmit a signal comprising a request that the toy control device 130 transmit a signal to the computer radio interface 110. It is appreciated that polling is particularly preferred in the case where there are a plurality of toys having a plurality of toy control devices 130.

The signal transmitted by the toy control device 130 may comprise one or more of the following: sound, typically sound captured by a microphone input device 141; status of sensor input devices 140 as, for example, light sensors or micro switch; an indication of low power in the power source 125; or information identifying the toy.

It is appreciated that a sound signal transmitted by the device 130 may also include speech. The computer system is operative to perform a speech recognition operation on the speech signals.

Appropriate commercially available software for speech recognition is available from companies such as: Stylus Innovation Inc., One Kendall Square, Building 300, Cambridge, Mass. 02139, USA; A&G Graphics Interface, USA, Telephone No. (617) 492-0120, Telefax No. (617) 427-3625; “Dragon Dictate For Windows”, available from Dragon Systems Inc., 320 Nevada Street, Mass. 02160, USA, and “SDK” available from Lernout & Hausple Speech Products, Sint-Krispijnstraat 7, 8900 Leper, Belgium.

The signal from the radio control interface 110 may also comprise, for example, one or more of the following: a request to ignore input from one or more input devices 140; a request to activate one or more input devices 140 or to stop ignoring input from one or more input devices 140; a request to report the status of one or more input devices 140; a request to store data received from one or more input devices 140, typically by latching a transition in the state of one or more input devices 140, until a future time when another signal from the radio control interface 110 requests the toy control device 130 to transmit a signal comprising the stored data received from the one or more input devices 140; or a request to transmit analog data, typically comprising sound, typically for a specified period of time.

Typically, all signals transmitted in both directions between the computer radio interface 110 and the toy control device 130 include information identifying the toy.

Reference is now made to FIG. 1C, which is a partly pictorial, partly block diagram illustration of a computer control system including a toy, constructed and operative in accordance with an alternative preferred embodiment of the present invention. The system of FIG. 1C comprises two computers 100. It is appreciated that, in general, a plurality of computers 100 may be used. In the implementation of FIG. 1C, all signals transmitted in both directions between the computer radio interface 110 and the toy control device 130 typically include information identifying the computer.

The operation of the system of FIG. 1A is now briefly described. Typically, the computer 100 runs software comprising a computer game, typically a game including at least one animated character. Alternatively, the software may comprise educational software or any other interactive software including at least one animated object. As used herein, the term “animated object” includes any object which may be depicted on the computer screen 105 and which interacts with the user of the computer via input to and output from the computer. An animated object may be any object depicted on the screen such as, for example: a doll; an action figure; a toy, such as, for example, an activity toy, a vehicle, or a ride-on vehicle; a drawing board or sketch board; or a household object such as, for example, a clock, a lamp, a chamber pot, or an item of furniture.

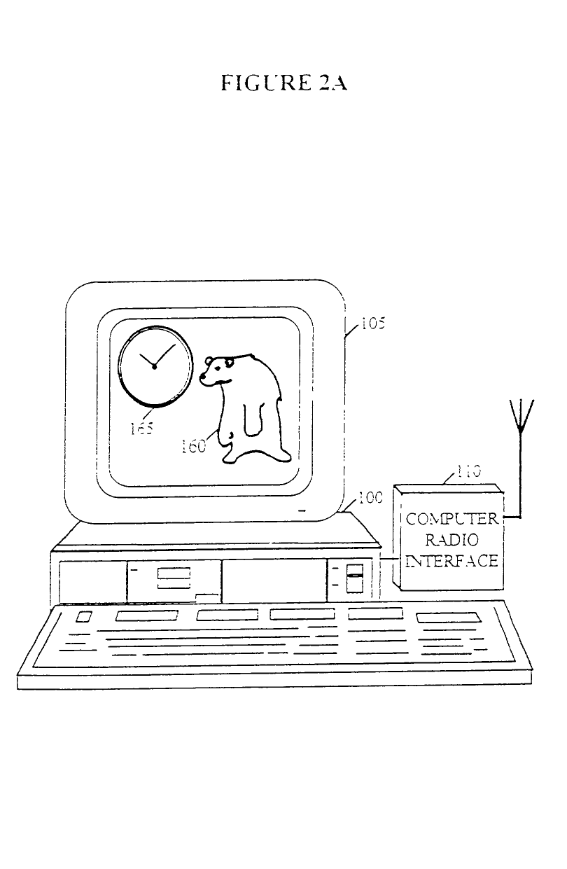

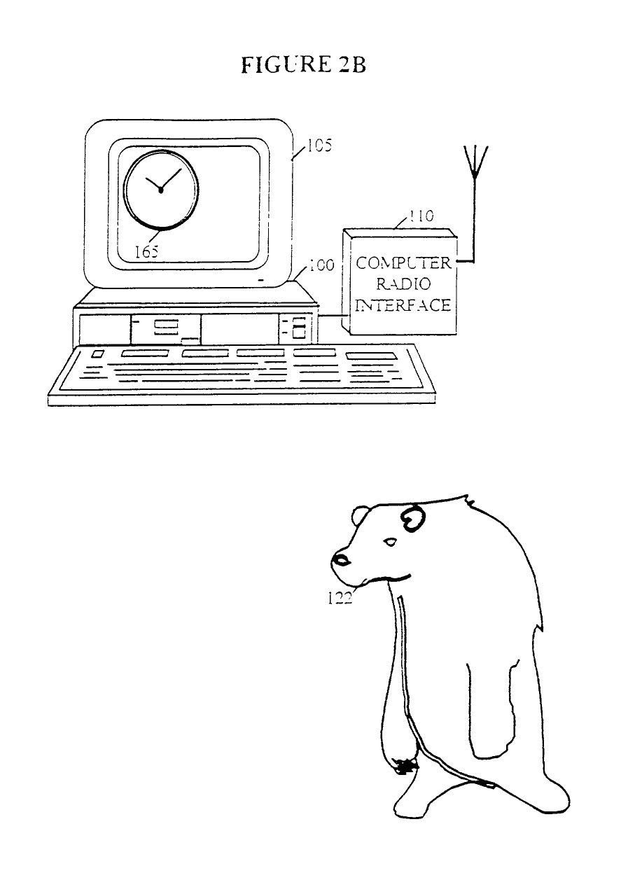

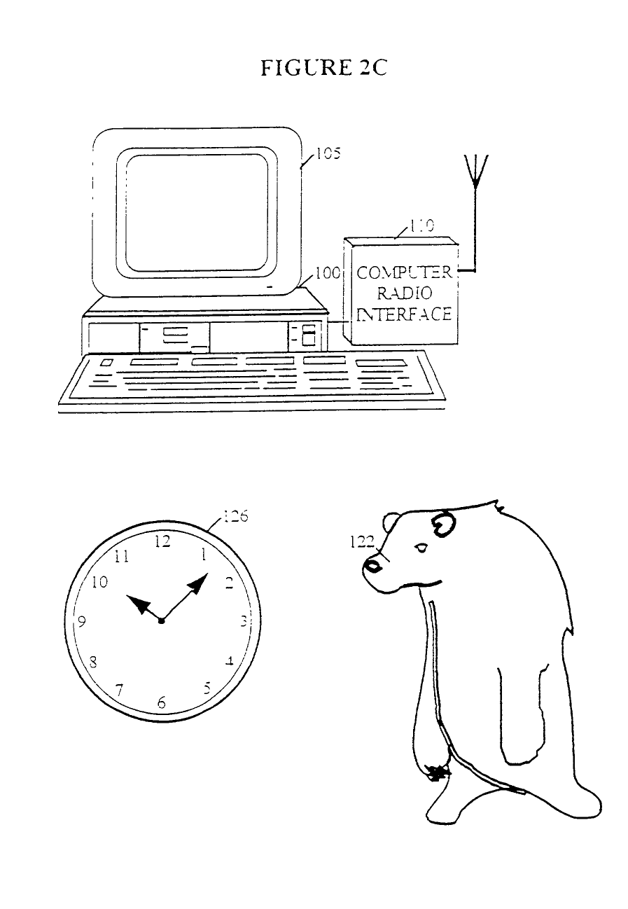

Reference is now additionally made to FIGS. 2A-2C, which depict a portion of the system of FIG. 1A in use. The apparatus of FIG. 2A comprises the computer screen 105 of FIG. 1A. On the computer screen are depicted animated objects 160 and 165.

FIG. 2B depicts the situation after the toy 122 has been brought into range of the computer radio interface 110 of FIG. 1A, typically into the same room therewith. Preferably, the toy 122 corresponds to the animated object 160. For example, in FIG. 2B the toy 122 and the animated object 160, shown in FIG. 2A, are both a teddy bear. The apparatus of FIG. 2B comprises the computer screen 105, on which is depicted the animated object 165. The apparatus of FIG. 2B also comprises the toy 122. The computer 100, having received a message via the computer radio interface 110, from the toy 122, no longer displays the animated object 160 corresponding to the toy 122. The functions of the animated object 160 are now performed through the toy 122, under control of the computer 100 through the computer radio interface 110 and the toy control device 130.

FIG. 2C depicts the situation after the toy 126 has also been brought into range of the computer radio interface 110 of FIG. 1A, typically into the same room therewith. Preferably, the toy 126 corresponds to the animated object 165. For example, in FIG. 2C the toy 126 and the animated object 165, shown in FIGS. 2A and 2B, are both a clock. The apparatus of FIG. 2C comprises the computer screen 105, on which no animated objects are depicted.

The apparatus of FIG. 2C also comprises the toy 126. The computer 100, having received a message via the computer radio interface 110 from the toy 126, no longer displays the animated object 165 corresponding to the toy 126. The functions of the animated object 165 are now performed through the toy 126, under control of the computer 100 through the computer radio interface 110 and the toy control device 130.

In FIG. 2A, the user interacts with the animated objects 160 and 165 on the computer screen, typically using conventional methods. In FIG. 2B the user also interacts with the toy 122, and in FIG. 2C typically with the toys 122 and 126, instead of interacting with the animated objects 160 and 165 respectively. It is appreciated that the user may interact with the toys 122 and 126 by moving the toys or parts of the toys; by speaking to the toys; by responding to movement of the toys which movement occurs in response to a signal received from the computer 100; by responding to a sound produced by the toys, which sound is produced in response to a signal received from the computer 100 and which may comprise music, speech, or another sound; or otherwise.

Reference is now made to FIG. 3 which is a simplified block diagram of a preferred embodiment of the computer radio interface 110 of FIG. 1A. The apparatus of FIG. 3 comprises the computer radio interface 110. The apparatus of FIG. 3 also comprises a sound card 190, as described above with reference to FIG. 1A. In FIG. 3, the connections between the computer radio interface 110 and the sound card 190 are shown.

The computer radio interface 110 comprises a DC unit 200 which is fed with power through a MIDI interface 210 from a sound card MIDI interface 194, and the following interfaces: a MIDI interface 210 which connects to the sound card MIDI interface 194; an audio interface 220 which connects to an audio interface 192 of the sound card 190; and a secondary audio interface 230 which preferably connects to a stereo sound system for producing high quality sound under control of software running on the computer 100 (not shown).

The apparatus of FIG. 3 also comprises an antenna 240, which is operative to send and receive signals between the computer radio interface 110 and one or more toy control devices 130.

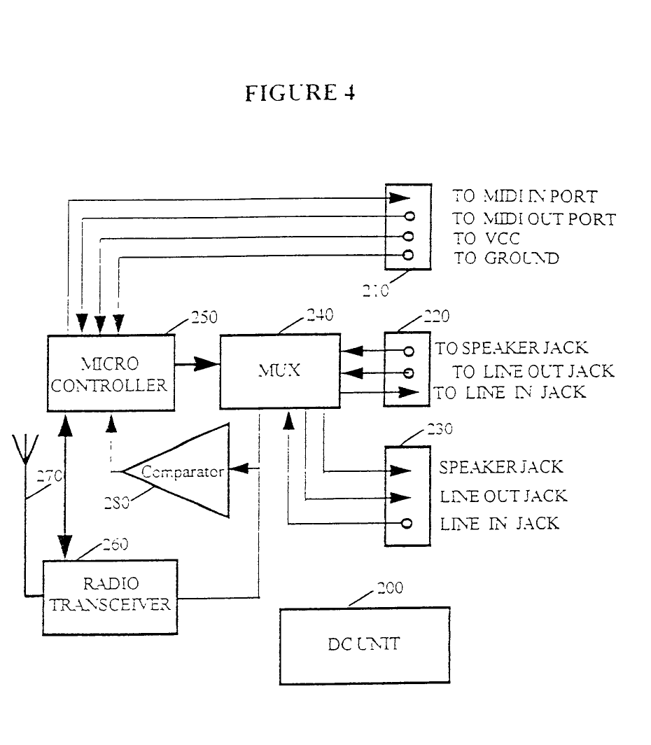

FIG. 4 is a more detailed block diagram of the computer radio interface 110 of FIG. 3. The apparatus of FIG. 4 comprises the DC unit 200, the MIDI interface 210, the audio interface 220, and the secondary audio interface 230. The apparatus of FIG. 4 also comprises a multiplexer 240, a micro controller 250, a radio transceiver 260, a connection unit 270 connecting the radio transceiver 260 to the micro controller 250, and a comparator 280.

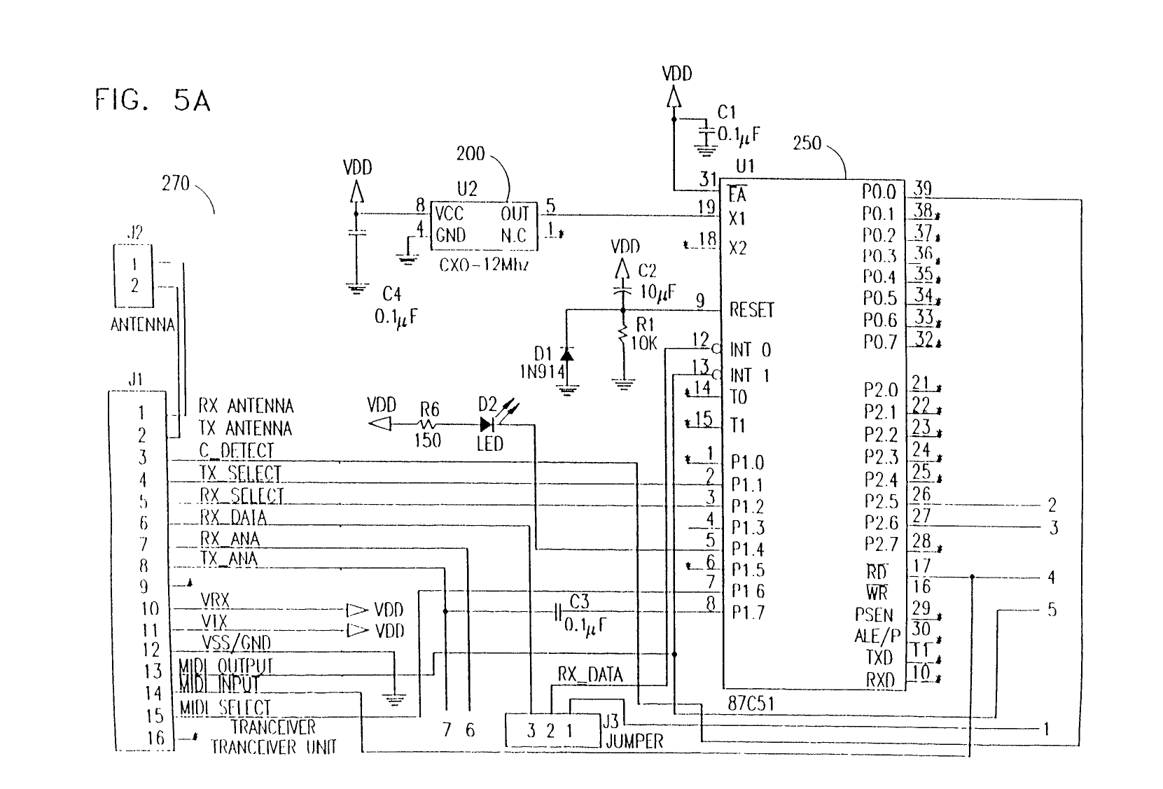

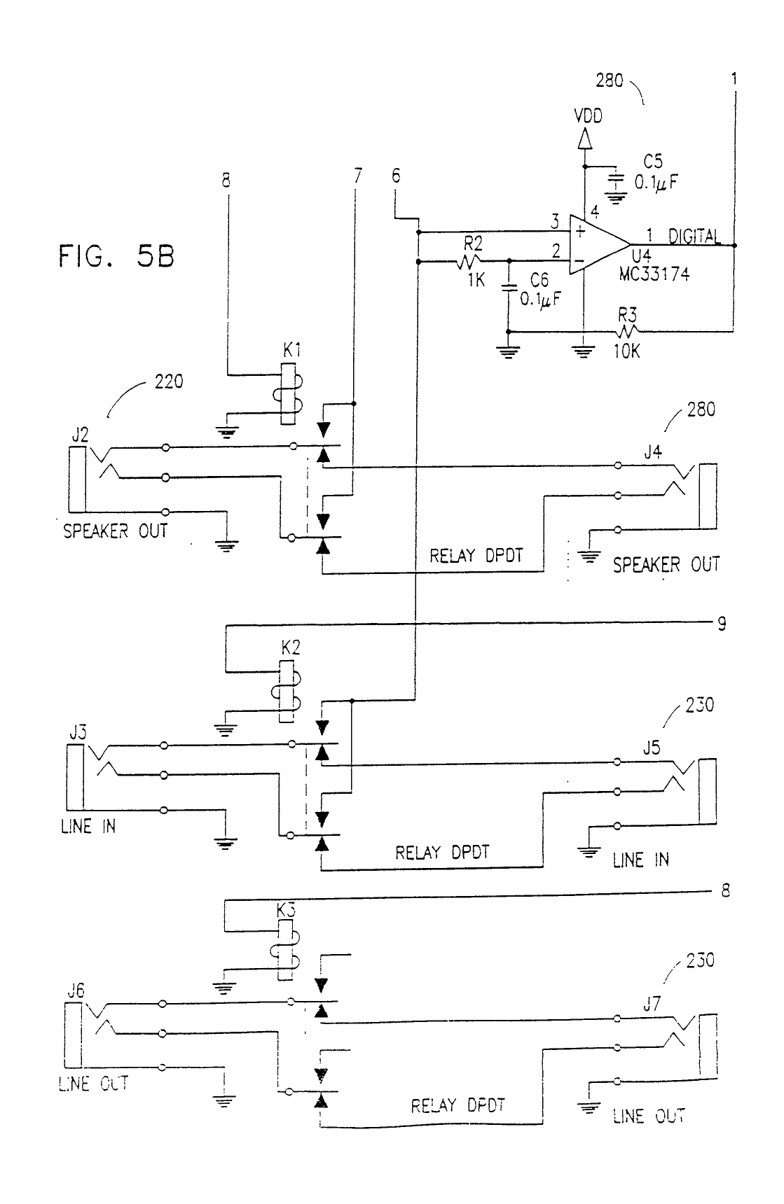

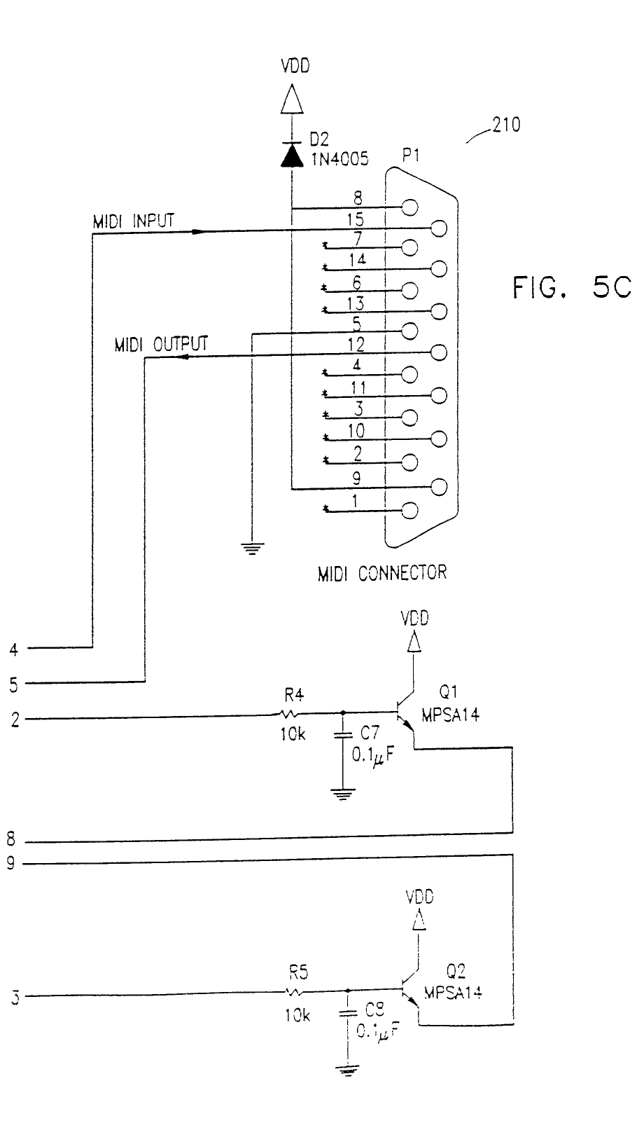

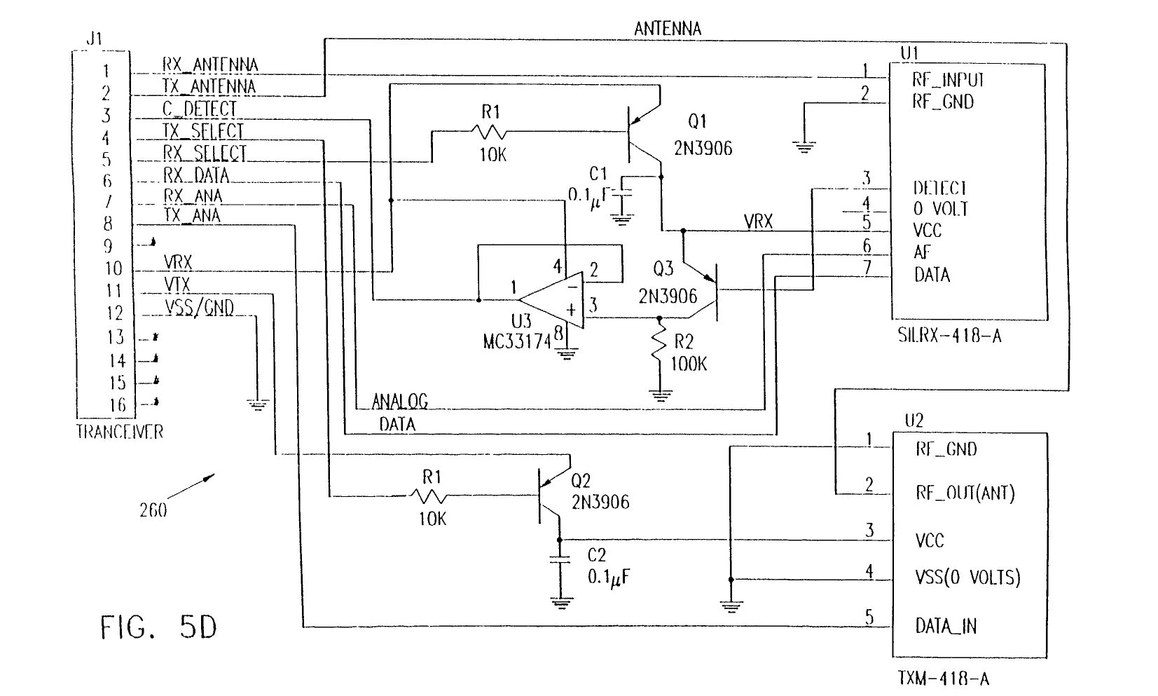

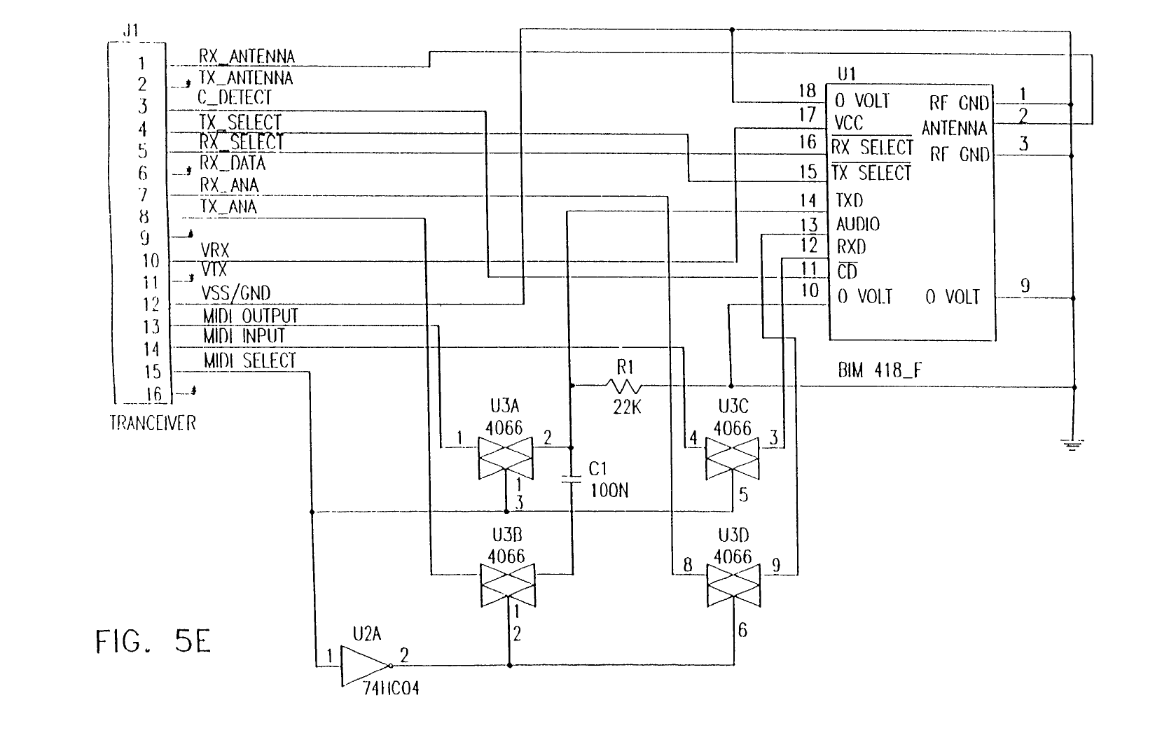

Reference is now made to FIGS. 5A-5D, which taken together comprise a schematic diagram of the apparatus of FIG. 4.

The following is a preferred parts list for the apparatus of FIGS. 5A-5C:

1. K1 Relay Dept, Idec, 1213 Elco Drive, Sunnyvale, Calif. 94089-2211, USA.

2. U1 8751 microcontroller, Intel Corporation, San Tomas 4, 2700 San Tomas Expressway, 2nd Floor, Santa Clara 95051, Calif. USA.

3. U2 CXO-12 MHZ (crystal oscillator),Raltron, 2315 N.W. 107th Avenue, Miami Fla. 33172, USA.

4. U4 MC33174, Motorola, Phoenix, Ariz., USA., Tel. No. (602) 897-5056.

5. Diodes 1N914, Motorola, Phoenix, Ariz., USA. Tel. No. (602) 897-5056.

6. Transistors 2N2222 and MPSA14, Motorola, Phoenix, Ariz., USA. Tel. No.(602) 897-5056.

The following is a preferred parts list for the apparatus of FIG. 5D:

1. U1 SILRAX-418-A UHF radio telemetry receive module, Ginsburg Electronic GmbH, Am Moosfeld 85, D-81829, Munchen, Germany.

Alternatively, U1 of FIG. 5D may be replaced by:

U1 433.92 MHz Receive Module Part No. 0927, available from CEL SALES LTD., Cel House, Unit 2, Block 6, Shenstone Trading Estate, Bromsgrove, Halesowen, West Midlands B36 3XB, UK.

2. U2 TXM418-A low power UHF radio telemetry transmit module, Ginsburg Electronic GmbH, Am Moosfeld 85, D-1829, Munchen, Germany.

Alternatively, U2 of FIG. 5D may be replaced by:

U2 433.92 SIL FM Transmitter Module Part No, 5229, available from CEL SALES LTD., Cel House, Unit 2, Block 6, Shenstone Trading Estate, Bromsgrove, Halesowen, West Midlands B36 3XB UK.

Reference is now additionally made to FIG. 5E, which is a schematic diagram of an alternative implementation of the apparatus of FIG. 5D. The following is a preferred parts list for the apparatus of FIG. 5E:

1. U1 BIM-418-F low power UHF data transceiver module, Ginsburg Electronic GmbH, Am Moosfeld 85, D-81829, Munchen, Germany.

Alternate 1. U1 S20043 spread spectrum full duplex transceiver, AMI Semiconductors—American Microsystems, Inc., Idaho, USA.

Alternate 1. U1 SDT-300 synthesized transceiver, Circuit Design, Inc., Japan.

Alternatively, U1 may be replaced by:

U1 RY3GB021 RF 900 Mhz units, available from SHARP ELECTRONIC COMPONENTS GROUP, 5700 Northwest, Pacific Rim Boulevard #20, Camas, Wash., USA.

U1 RY3GB100 RF Units For DECT, available from SHARP ELECTRONIC COMPONENTS GROUP 5700 Northwest, Pacific Rim Boulevard #20, Camas, Washington, USA.

In the parts list for FIG. 5E, one of item 1 or either of the alternate items 1 may be used for U1.

It is appreciated that the appropriate changes will have to be made to all the circuit boards for alternate embodiments of the apparatus.

The apparatus of FIG. 5E has similar functionality to the apparatus of FIG. 5D, but has higher bit rate transmission and reception capacity and is, for example, preferred when MIDI data is transmitted and received.

FIGS. 5A-5E are self-explanatory with regard to the above parts lists.

Reference is now made to FIG. 6 which is a simplified block diagram of a preferred embodiment of the toy control device 130 of FIG. 1A. The apparatus of FIG. 6 comprises a radio transceiver 260, similar to the radio transceiver 260 of FIG. 4. The apparatus of FIG. 6 also comprises a microcontroller 250 similar to the microcontroller 250 of FIG. 4.

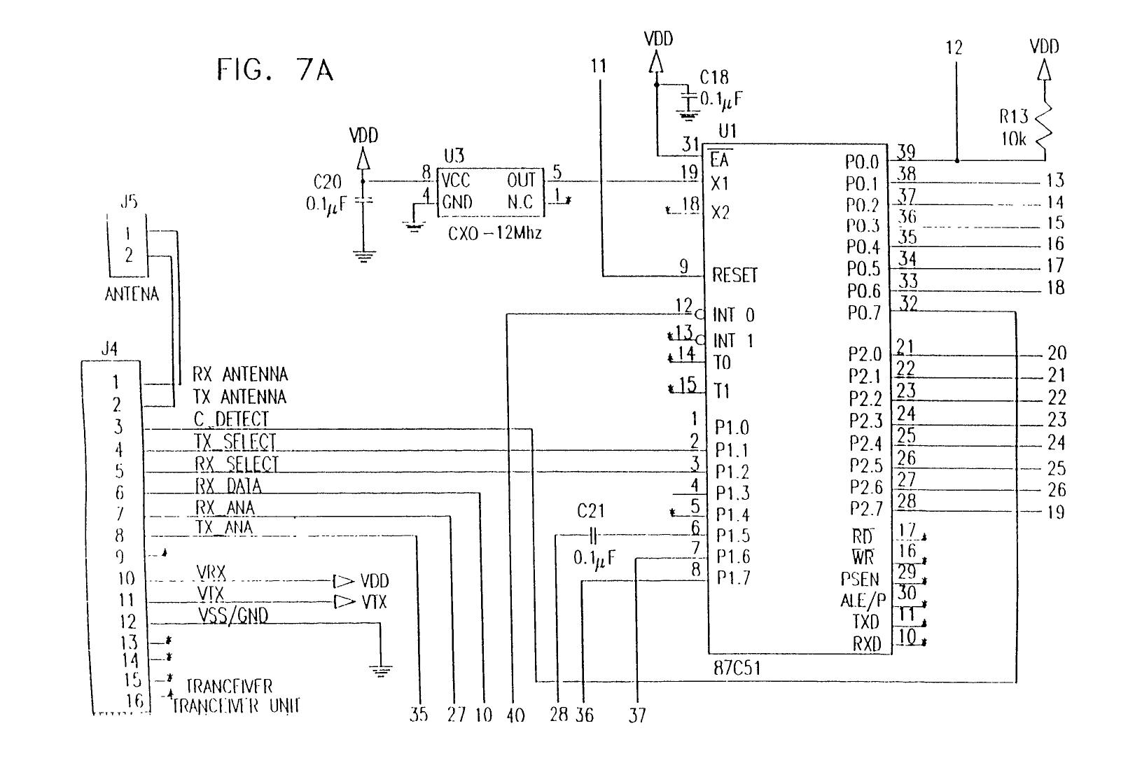

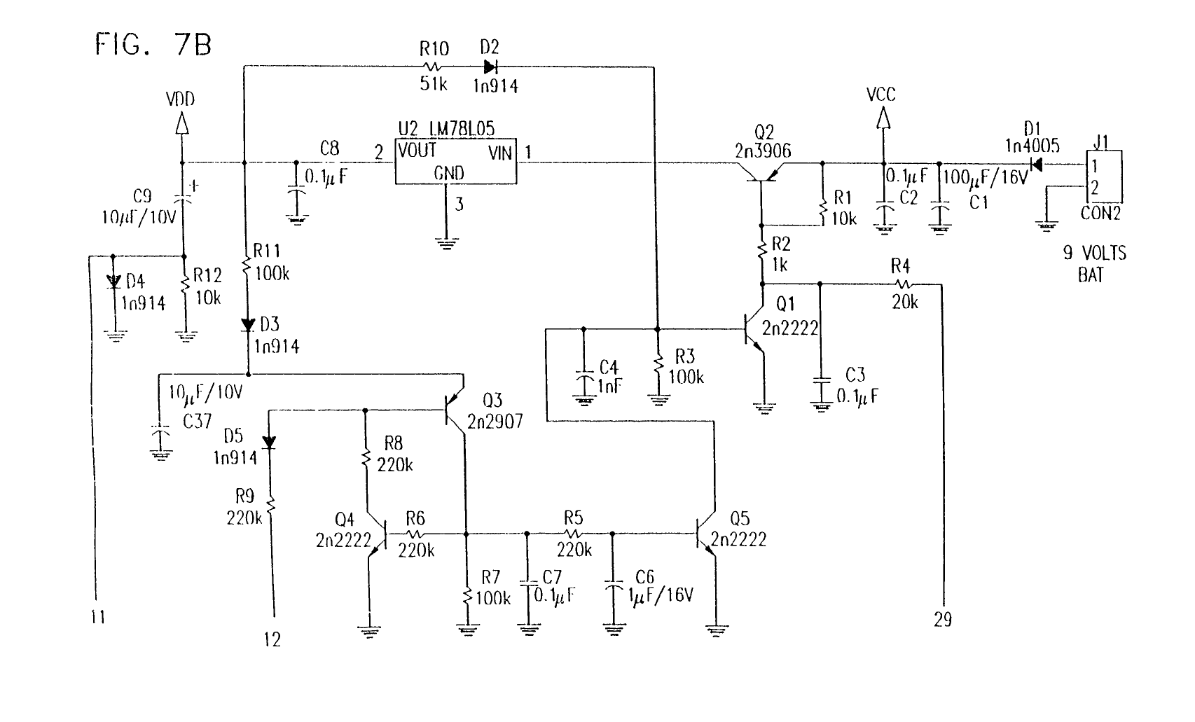

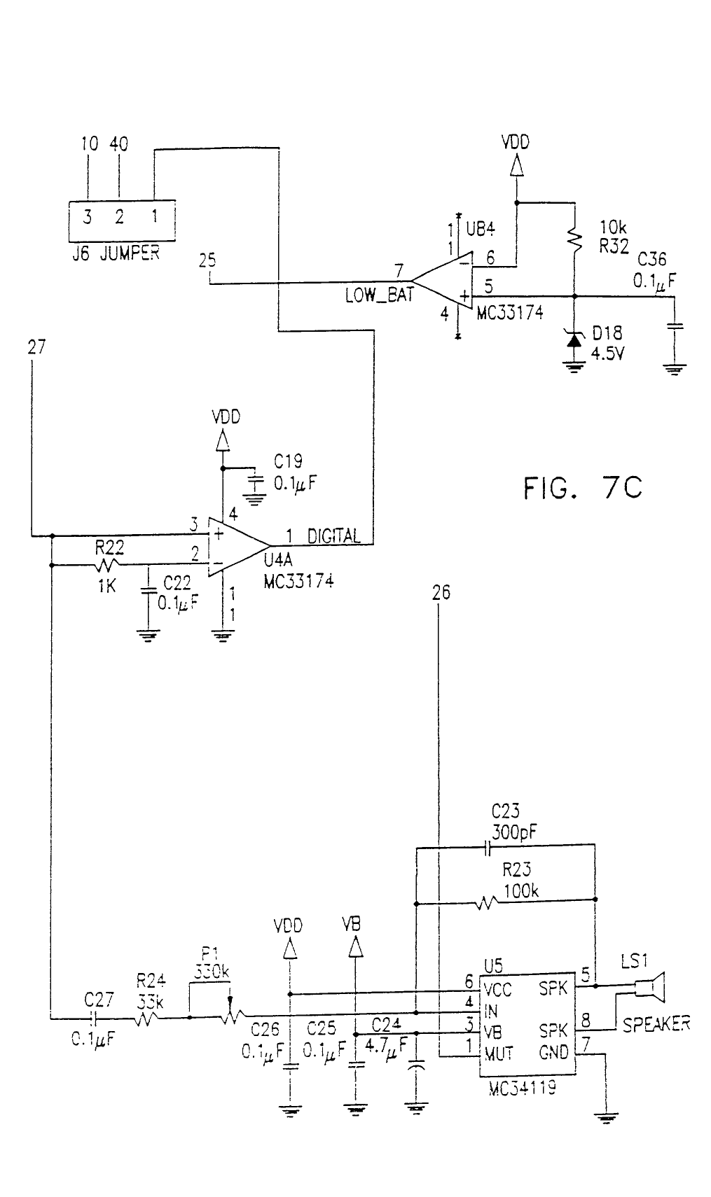

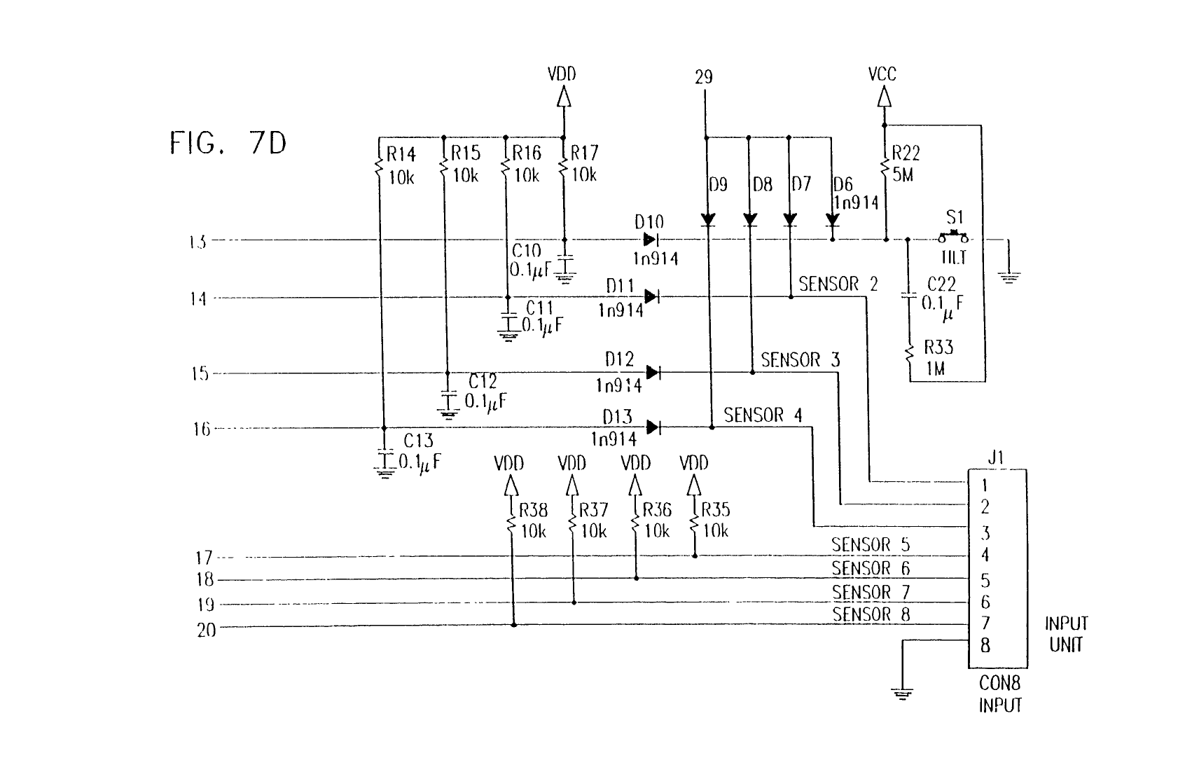

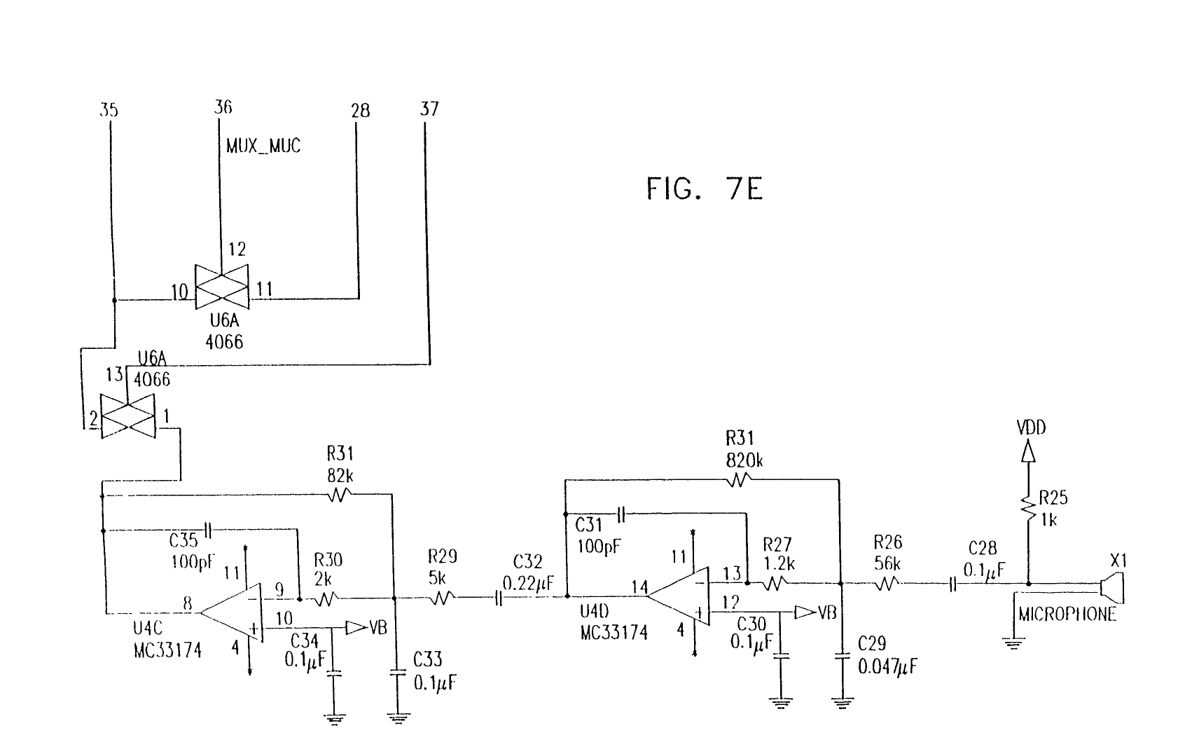

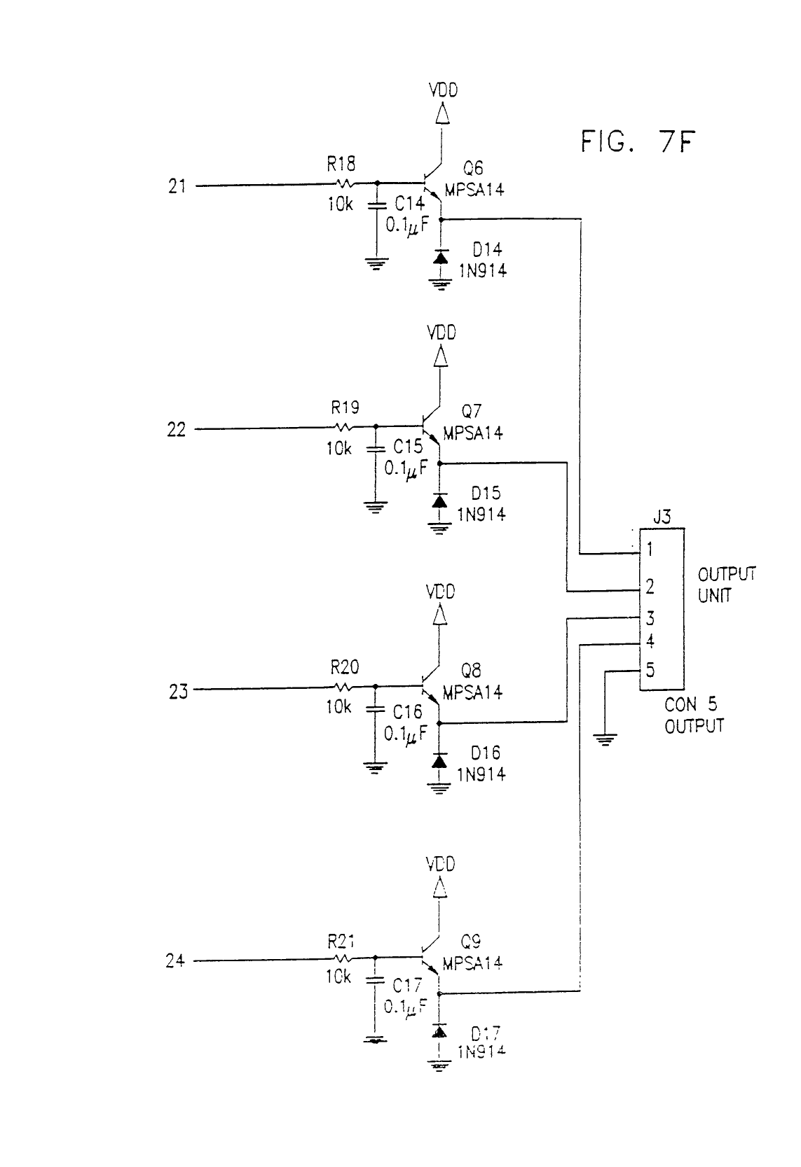

The apparatus of FIG. 6 also comprises a digital input/output interface (digital I/O interface) 290, which is operative to provide an interface between the microcontroller 250 and a plurality of input and output devices which may be connected thereto such as, for example, four input device and four output devices. A preferred implementation of the digital I/O interface 290 is described in more detail below with reference to FIG. 7A-7F.

The apparatus of FIG. 6 also comprises an analog input/output interface (analog I/O interface) 300 operatively connected to the radio transceiver 260, and operative to receive signals therefrom and to send signals thereto.

The apparatus of FIG. 6 also comprises a multiplexer 305 which is operative, in response to a signal from the microcontroller 250, to provide output to the analog I/O interface 300 only when analog signals are being transmitted by the radio transceiver 260, and to pass input from the analog I/O interface 300 only when such input is desired.

The apparatus of FIG. 6 also comprises input devices 140 and output devices 150. In FIG. 6, the input devices 140 comprise, by way of example, a tilt switch operatively connected to the digital I/O interface 290, and a microphone operatively connected to the analog I/O interface 300. It is appreciated that a wide variety of input devices 140 may be used.

In FIG. 6, the output devices 150 comprise, by way of example, a DC motor operatively connected to the digital I/O interface 290, and a speaker operatively connected to the analog I/O interface 300. It is appreciated that a wide variety of output devices 150 may be used.

The apparatus of FIG. 6 also comprises a DC control 310, a preferred implementation of which is described in more detail below with reference to FIGS. 7A-7F.

The apparatus of FIG. 6 also comprises a comparator 280, similar to the comparator 280 of FIG. 4.

The apparatus of FIG. 6 also comprises a power source 125, shown in FIG. 6 by way of example as batteries, operative to provide electrical power to the apparatus of FIG. 6 via the DC control 310.

Reference is now made to FIGS. 7A-7F which, taken together with either FIG. 5D or 5E, comprise a schematic diagram of the toy control device of FIG. 6. If the schematics of FIG. 5E is employed to implement the computer radio interface of FIG. 4, using RY3GB021 as U1 of FIG. 5E, then the same schematics of FIG. 5E are preferably employed to implement the toy control device of FIG. 6 except that RY3GH021 is used to implement U1 rather than RY3GB021.

The following is a preferred parts list for the apparatus of FIGS. 7A-7F:

1. U1 8751 microcontroller, Intel Corporation, San Tomas 4, 2700 San Tomas Expressway, 2nd Floor, Santa Clara 95051, Calif. USA.

2. U2 LM78L05, National Semiconductor, 2900 Semiconductor Drive, Santa Clara, Calif. 95052, USA.

3. U3 CXO-12 MHz (crystal oscillator), Raltron, 2315 N.W. 107th Avenue, Miami, Fla. 33172, USA.

4. U4 MC33174, Motorola, Phoenix, Ariz., USA. Tel. No. (602) 897-5056.

5. U5 MC34119, Motorola, Phoenix, Ariz., USA. Tel. No. (602) 897-5056.

6. U6 4066, Motorola, Phoenix, Ariz., USA. Tel. No. (602) 897-5056.

7. Diode 1N914, IN4005, Motorola, Phoenix, Ariz., USA. Tel. No. (602) 897-5056.

8. Transistor 2N2222, 2N3906, Motorola, Phoenix, Ariz., USA. Tel. No. (602) 897-5056.

9. Transistors 2N2907 and MPSA14, Motorola, Phoenix, AZ, USA. Tel. No. (602) 897-5056.

FIGS. 7A-7F are self-explanatory with reference to the above parts list.

As stated above with reference to FIG. 1A, the signals transmitted between the computer radio interface 110 and the toy control device 130 may be either analog signals or digital signals. It the case of digital signals, the digital signals preferably comprise a plurality of predefined messages, known to both the computer 100 and to the toy control device 130.

Each message sent by the computer radio interface 110 to the toy control device 130 comprises an indication of the intended recipient of the message. Each message sent by the toy control device 130 to the computer radio interface 110 comprises an indication of the sender of the message.

In the embodiment of FIG. 1C described above, messages also comprise the following:

each message sent by the computer radio interface 110 to the toy control device 130 comprises an indication of the sender of the message; and

each message sent by the toy control device 130 to the computer radio interface 110 comprises an indication of the intended recipient of the message.

A preferred set of predefined messages is as follows:

COMMAND STRUCTURE

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |

COMMANDS LIST
From the Computer to the Toy control device.
A. OUTPUT COMMANDS
SET_IO_TO_DATA

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 00 | 01 | 00 | IO | 00 | D | x | x | |

Set Toy control device output pin to a digital level D.

| | | |
|---|---|---|
| P: | Computer address | 00-03 H |
| A: | unit address - | 00-FF H |
| IO: | i/o number - | 00-03 H |
| D: | Data - | 00-01 H |

| | |
|---|---|
| Example | |
| 1. 01 00 00 05 00 01 03 01 00 00 | set io 3 to “1” |
| 2. 01 00 00 05 00 01 03 01 00 00 | set io 3 to “0” |
| CHANGE_IO_FOR_TIME | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 00 | 02 | 00 | IO | 00 | D | T1 | T2 | |

Change Toy control device output pin to D for a period of time and then return to previous state.

| | | |
|---|---|---|
| P: | Computer address | 00-03 H |
| A: | unit address - | 00-FF H |
| IO: | i/o number - | 00-03 H |
| T1,T2: | time - | 00-FF H |
| D: | Data - | 00-01 H |

| | |
|---|---|
| example | |
| 1. 01 00 00 05 00 02 03 05 00 00 | set io 3 to “1” for 5 seconds |
| B. INPUT COMMANDS | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 00 | x | x | x | x | x | x | |

send the Toy control device status of all sensors.

| | | |
|---|---|---|
| P: | Computer address | 00-03 H |
| A: | unit address - | 00-FF H |

| | |
|---|---|
| example: | |
| 1. 01 00 00 05 01 00 00 00 00 00 | send current status of sensors |
| SENSORS_SCAN_MODE_ON | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 01 | x | x | x | x | x | x | |

Start scanning the Toy control device sensors, and if one of them is closed (pressed to ‘0’), send back an ack.

| | | |
|---|---|---|
| P: | Computer address | 00-03 H |
| A: | unit address - | 00-FF H |

| | |
|---|---|
| example: | |
| 1. 01 00 00 05 01 01 00 00 00 00 | scan mode of sensors ON |
| SENSORS_SCAN_MODE_ON_ONCE | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 02 | x | x | x | x | x | x | |

| | | |
|---|---|---|
| P: | Computer address | 00-03 H |
| A: | unit address - | 00-FF H |

| | |
|---|---|
| 1. 01 00 00 05 01 01 02 00 00 00 | scan mode of sensors ON once |
| SENSORS_SCAN_MODE_OFF | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 01 | 03 | x | x | x | x | x | x | |

Stop scanning the Toy control device sensors.

| | | |
|---|---|---|
| P: | Computer address | 00-03 H |
| A: | unit address - | 00-FF H |

| | |
|---|---|
| example: | |
| 1. 01 00 00 05 01 03 00 00 00 00 | scan mode of sensors OFF |
| C. AUDIO OUT COMMANDS | |
| START_AUDIO_PLAY | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 02 | 00 | x | x | x | x | xx | xx | |

Start playing an audio in a speaker of the Toy control device The Audio is sent to the Toy control device by the
computer sound card and the Computer radio interface.

| | | |
|---|---|---|
| P: | Computer address | 00-03 H |
| A: | unit address - | 00-FF H |

| | |
|---|---|
| 1. 01 00 00 05 02 00 00 00 00 00 | Start audio-play |
| STOP_AUDIO_PLAY | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 02 | 01 | x | x | x | x | x | x | |

Stop playing an audio in a speaker of the Toy control device.

| | | |
|---|---|---|
| P: | Computer address | 00-03 H |
| A: | unit address - | 00-FF H |

| | |
|---|---|
| 1. 01 00 00 05 02 01 00 00 00 00 | Stop audio-play |

START_AUDIO_AND_IO_PLAY_FOR_TIME

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 02 | 04 | T1 | T2 | T0 | td | SC | IO | |

Start playing an audio in a speaker of the Toy control device and set an io pin to ‘1’. After time T, stop audio and set
IO to ‘0’. start this command after a delay td*100ms if SC=“1” then after the execution of this command, start the
input command SCAN_SENSORS_ON_ONCE (if any sensor is pressed, even during the audio play, send a
message to the computer).

| | | | |
|---|---|---|---|
| P: | Computer address | 00-03 H | |
| A: | unit address - | 00-FF H | |
| IO: | i/o number - | 0-3 H | (if IO>3 then don't set IO) |
| T0,T1,T2: | TIME | 000-FFF H | (*100ms) (T0=MMSB, T1=MSB T0=LSB) |
| td: | delay time befor execute | 0-F H | (*100ms) |

| | |
|---|---|
| 1. 01 00 00 05 02 04 80 2A 03 00 | Start audio-play and IO #3 for 6.4 second |
| | 640=280H |
| | delay before execution = 10*100ms=1sec |
| 2. 01 00 00 05 02 04 80 2A 13 00 | Start audio-play and IO #3 for 6.4 second and |
| | set scan sensors on once mode. |
| | delay before execution = 10*100ms=1sec |
| D. AUDIO IN COMMANDS | |
| TRANSMIT_MIC_FOR_TIME | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 03 | 00 | T1 | T2 | x | x | x | x | |

Requests the Toy control device to transmit microphone audio from the Toy control device to the Computer ratio
interface and to the sound card of the computer for time T.

| | | |
|---|---|---|
| P: | Computer address | 00-03 H |
| A: | unit address - | 00-FF H |
| T1,T2: | TIME | 00-FF H (SEC) |

| | |
|---|---|
| example: | |
| 1. 01 00 00 05 03 00 0A 00 00 00 | start mic mode for 10 seconds |
| E. GENERAL TOY COMMANDS | |
| GOTO_SLEEP_MODE | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 01 | x | x | x | x | x | x | |

Requests the Toy control device to go into power save mode (sleep).

| | | |
|---|---|---|
| P: | Computer address | 00-03 H |
| A: | unit address - | 00-FF H |

| | |
|---|---|
| 1. 01 00 00 05 04 01 00 00 00 00 | switch the Toy control device into sleep mode. |
| GOTO_AWAKE_MODE | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 02 | x | x | x | x | x | x | |

Requests the Toy control device to go into an awake mode.

| | | |
|---|---|---|
| P: | Computer address | 00-03 H |
| A: | unit address - | 00-FF H |

| | |
|---|---|
| 1. 01 00 00 05 04 02 00 00 00 00 | switch the Toy control device into awake mode. |
| TOY_RESET | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 0F | x | x | x | x | x | x | |

Requests the Toy control device to perform RESET

| | | |
|---|---|---|
| P: | Computer address | 00-03 H |
| A: | unit address - | 00-FF H |

| | |
|---|---|
| 1. 01 00 00 05 04 0F 00 00 00 00 | Toy reset |
| TOY_USE_NEW_RF_CHANNELS | |

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 0A | CH1 | CH2 | x | x | x | x | |

Requests the Toy control device to switch to new RF transmit and receive channels.

| | | |
|---|---|---|
| P: | Computer address | 00-03 H |
| A: | unit address - | 00-FF H |
| CH1: | Transmit RF channel number | 0-F H |
| CH2: | Receive RF Channel number | 0-F H |

| | |
|---|---|
| 1. 01 00 00 05 04 0A 12 00 00 00 | Switch to new RX and TX RF channels |

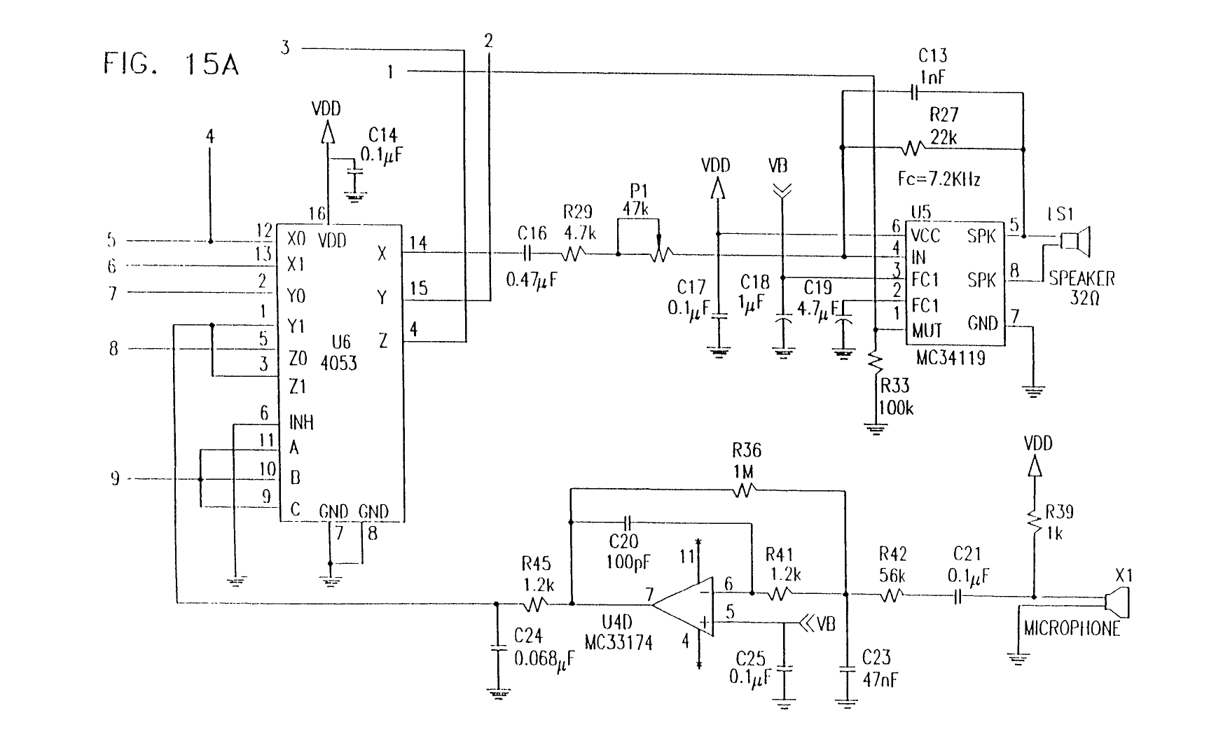

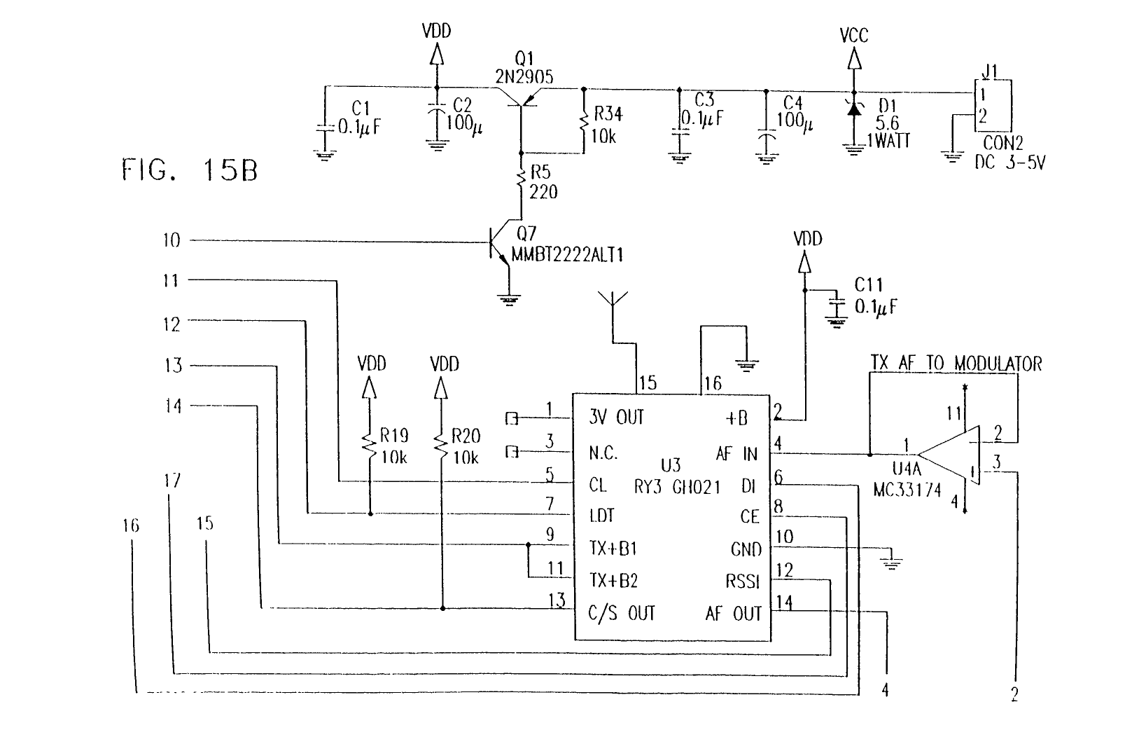

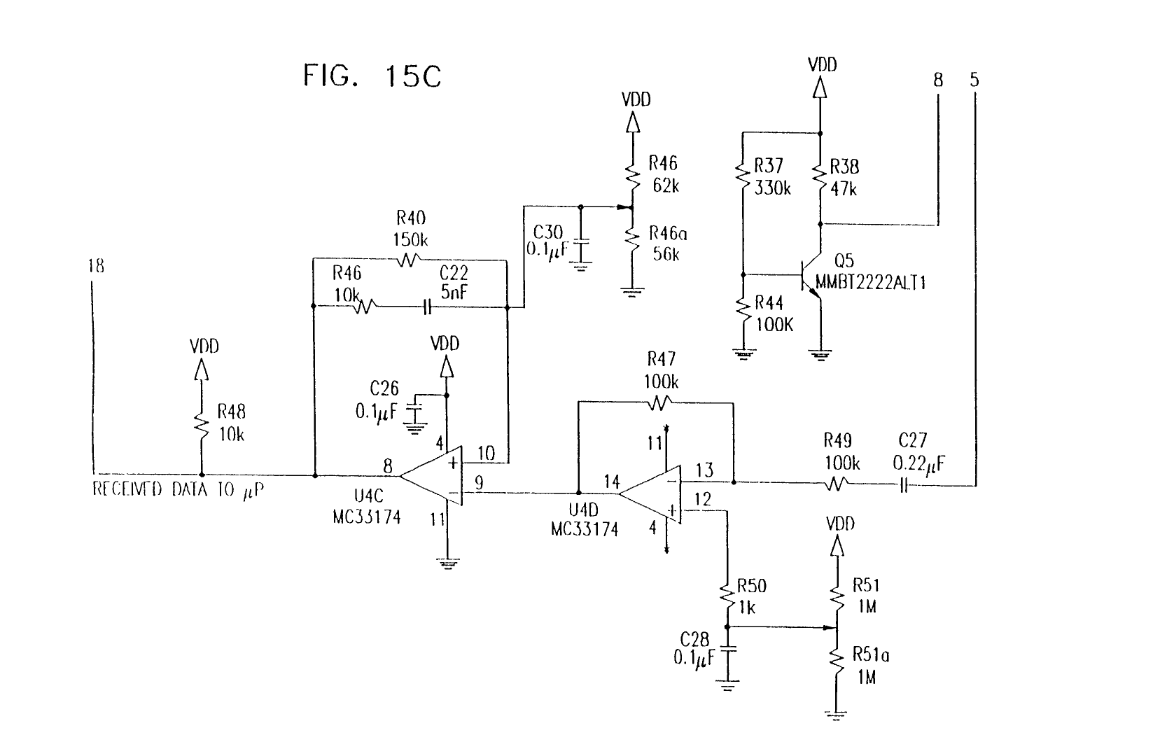

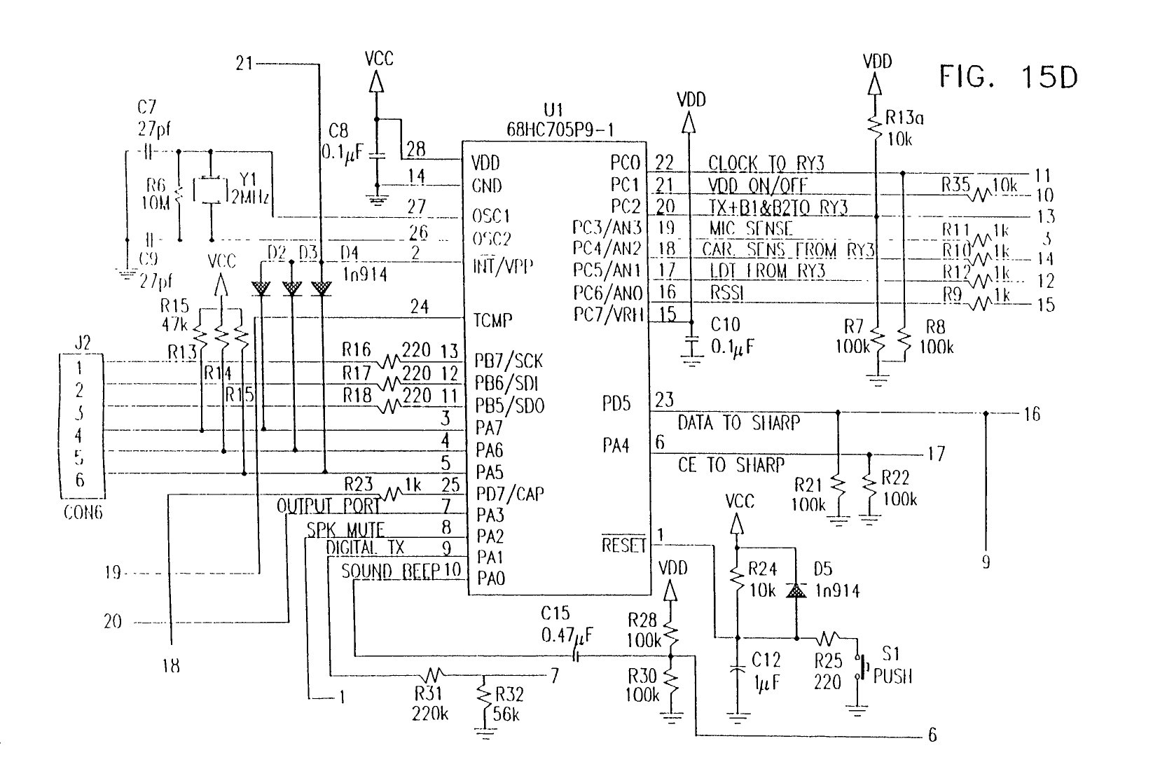

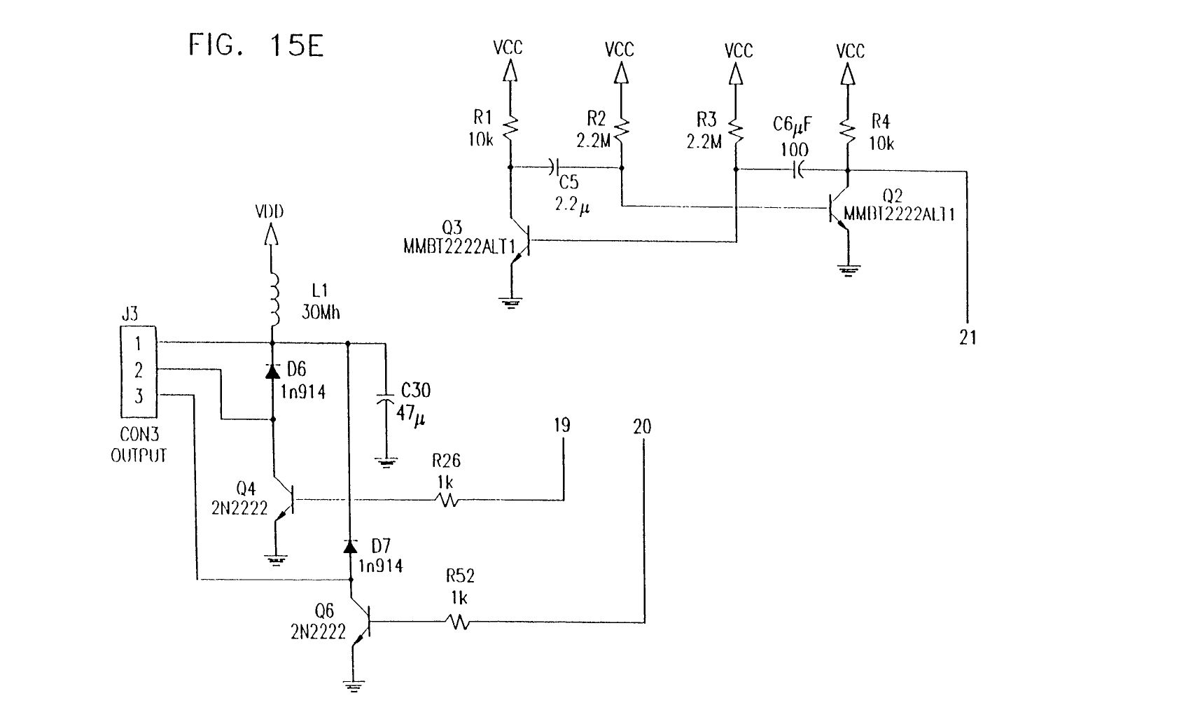

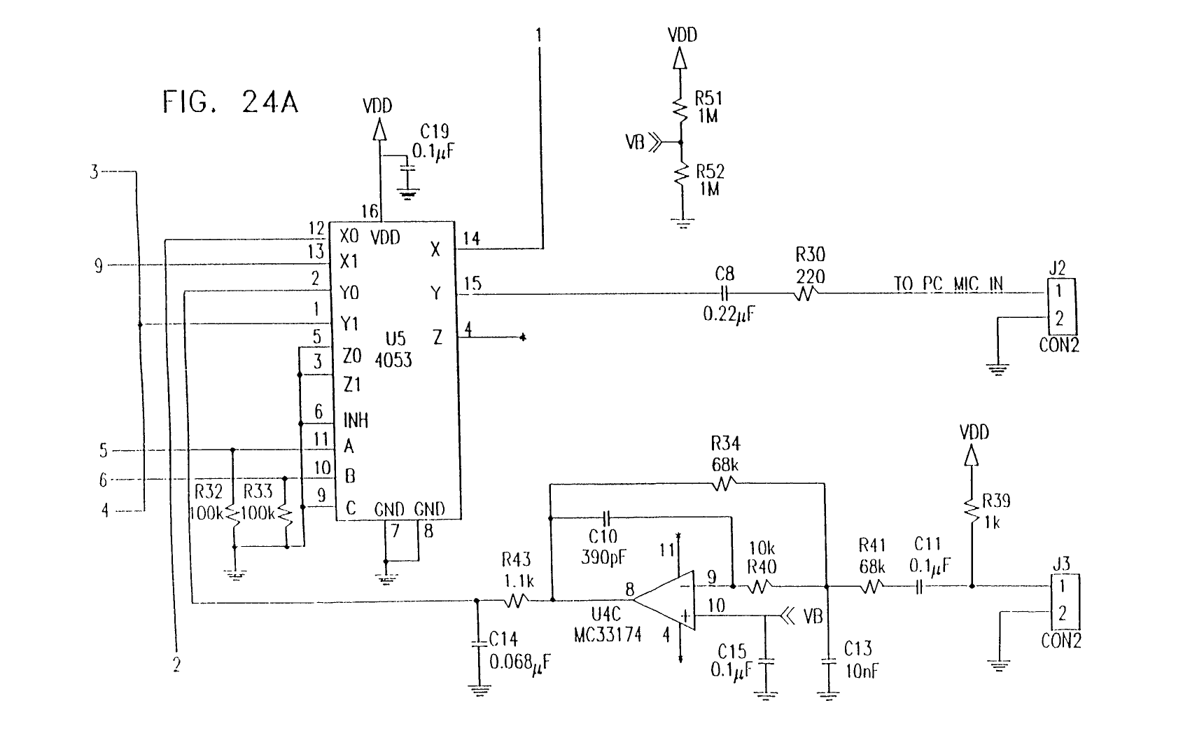

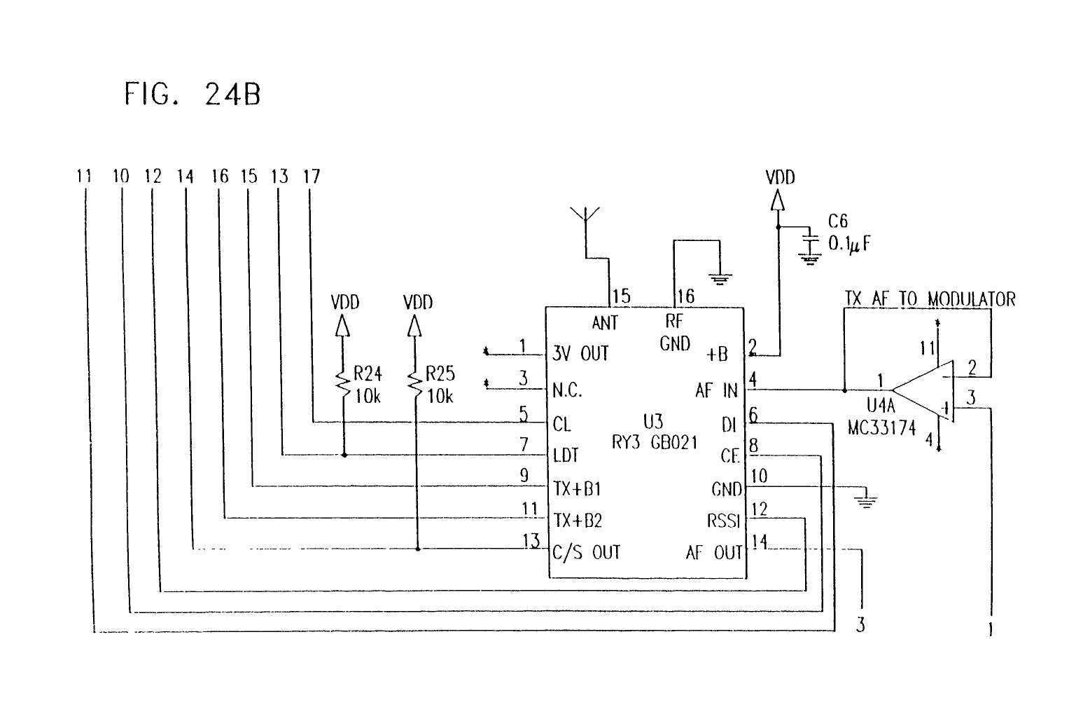

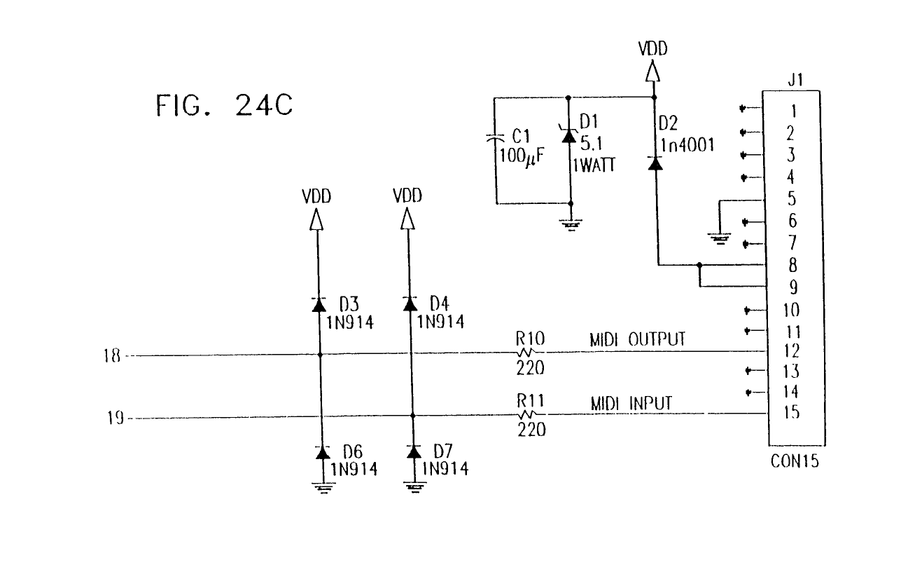

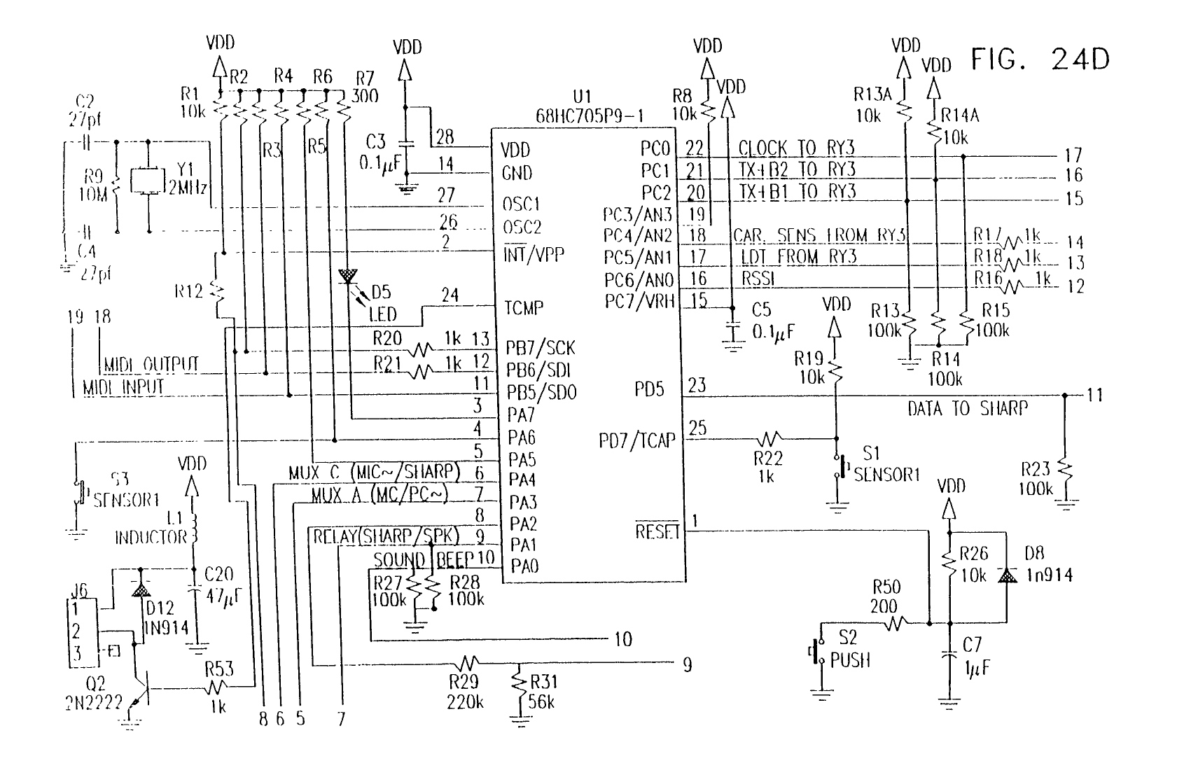

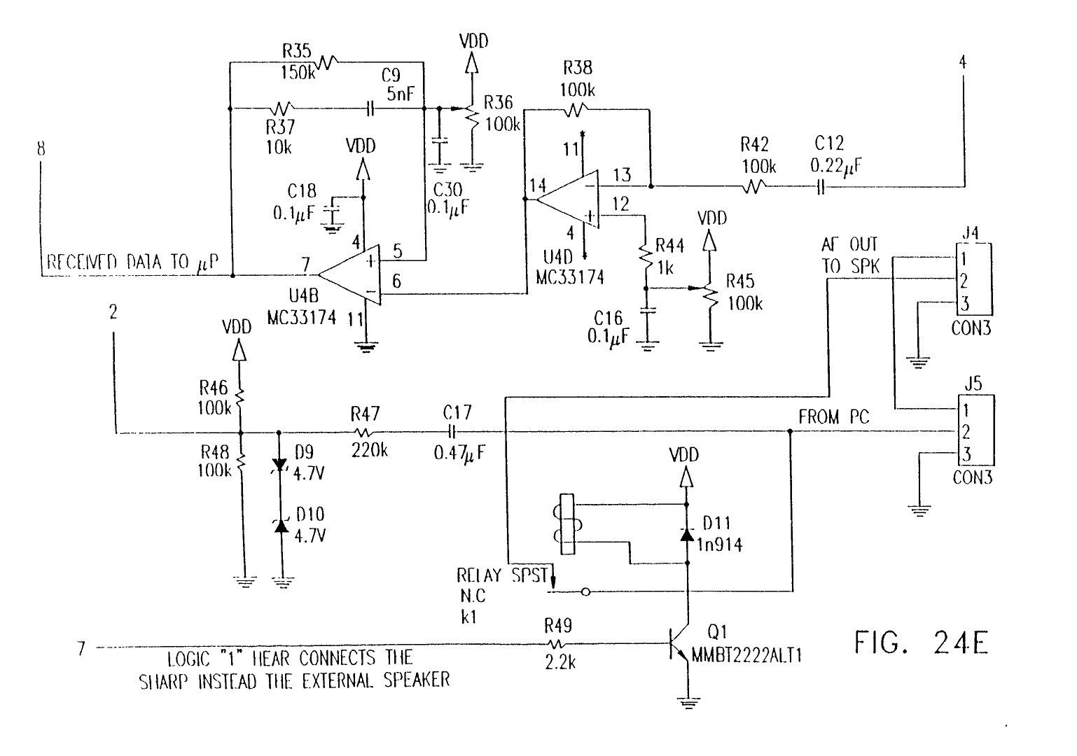

Note: This command is available only with enhanced radio modules (alternate U1 of FIG. 5E) or with the modules
described if FIG. 15A-15E and 24A-24E.
F. TELEMETRY
Information sent by the Toy control device, as an ACK to the command received from the Computer radio interface.
OK_ACK

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 0A | 00 | cmd1 | cmd2 | cmd3 | cmd4 | sen1 | sen2 | |

Send back an ACK about the command that was received ok.

| | | |
|---|---|---|
| P: | Computer address | 00-03 H |
| A: | unit address - | 00-FF H |
| cmd 1,2: | Received command MSB ok ack. | 00-FF H |
| cmd 3,4: | Received command LSB ok ack. | 00-FF H |
| sen 1,2 | Sensors 0-7 status | 00-FF H |

| | |
|---|---|
| 1. 01 60 00 05 0A 00 01 01 FF 00 | OK ack for 0101 command.(sensors scan mode |
| | on command). status: all sensors are not |
| | pressed (FF). |
| | the computer_radio_interface number is 6. |
| 2. 01 60 00 05 0A 00 01 01 FE 00 | OK ack for 0101 command.(sensors scan mode |
| | on command). status: sensor #8 is pressed |
| | (FE) |
| | the computer_radio_interface number is 6. |
| G. REQUESTS | |

Requests sent by the Toy control device, after an event.
TOY_IS_AWAKE_REQ

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 0A | 00 | c1 | c2 | x | x | x | x | |

Send a message to the Computer radio interface if the Toy control device goes from sleep mode to awake mode.

| | | |
|---|---|---|
| P: | Computer address | 00-03 H |
| A: | unit address - | 00-FF H |
| c1,c2: | status command | AB H |

| | |
|---|---|
| 1. 01 60 00 05 0A 00 AB 00 FF 00 | Toy is awake message. |

H. CRI (Computer Radio Interface) - commands
Commands that are sent only to the Computer radio interface.
SWITCH_AUDIO_OUT_TO_RADIO_&_TRANSMIT

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 00 | x | x | x | x | x | x | |

Requests the Computer radio interface to switch audio_out from the computer sound card to the radio wireless
transceiver and transmit.

| | | |
|---|---|---|
| P: | Computer address | 00-03 H |

SWITCH_AUDIO_OUT_TO_JACK_&_STOP_TRANSMIT

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 01 | x | x | x | x | x | x | |

Requests the Computer radio interface to switch audio_out from the radio RF wireless transceiver to the speakers jack
and to stop transmit.

| | | |
|---|---|---|
| P: | Computer address | 00-03 H |

MUTE_RADIO

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 02 | x | x | x | x | x | x | |

Mute the radio transmit.

| | | |
|---|---|---|
| P: | Computer address | 00-03 H |

UN-MUTE_RADIO

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | 00 | 00 | 00 | x | 0C | 03 | x | x | x | x | x | x | |

UN-Mute the radio transmit.
CRI_RESET

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0C | 0F | x | x | x | x | x | x | |

Perform software rest on the Computer radio interface unit.

| | | |
|---|---|---|
| P: | Computer address | 00-03 H |

I. CRI-ACK
ACK sent only to the Computer by the Computer radio interface, only after CRI commands.
CRI_COMMAND_ACK

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | x | 0D | 00 | cmd1 | cmd2 | cmd3 | cmd4 | x | x | |

This is an ACK for a CRI command. this ACK is sent to the computer by the computer-radio-interface, after executing
a command successfully.

| | | |
|---|---|---|
| P: | Computer address | 00-03 H |
| cmd 1,2: | Received CRI command MSB ok ack. | 00-FF H |
| cmd 3,4: | Received CRI command LSB ok ack. | 00-FF H |

| | |
|---|---|
| 1. 01 60 00 00 0D 00 0C 01 00 00 | OK ack for 0C01 CRI command (SWITCH |
| | AUDIO OUT TO JACK) |
| | the computer_radio_interface number is 6. |
| 2. 01 60 00 00 0D 00 0C 0F 00 00 | OK ack for 0C0F CRI command (CRI reset) |
| | the computer_radio_interface number is 6. |
| | This ack is also sent on POWER UP RESET |

Reference is now made to FIG. 8A, which is a simplified flowchart illustration of a preferred method for receiving radio signals, executing commands comprised therein, and sending radio signals, within the toy control device 130 of FIG. 1A. Typically, each message as described above comprises a command, which may include a command to process information also comprised in the message. The method of FIG. 8A preferably comprises the following steps:

A synchronization signal or preamble is detected (step 400). A header is detected (step 403).

A command contained in the signal is received (step 405).

The command contained in the signal is executed (step 410). Executing the command may be as described above with reference to FIG. 1A.

A signal comprising a command intended for the computer radio interface 110 is sent (step 420).

Reference is now made to FIGS. 8B-8T which, taken together, comprise a simplified flowchart illustration of a preferred implementation of the method of FIG. 8A. The method of FIGS. 8B-8T is self-explanatory.

Reference is now made to FIG. 9A, which is a simplified flowchart illustration of a preferred method for receiving MIDI signals, receiving radio signals, executing commands comprised therein, sending radio signals, and sending MIDI signals, within the computer radio interface 110 of FIG. 1A. Some of the steps of FIG. 9A are identical to steps of FIG. 8A, described above. FIG. 9A also preferably comprises the following steps:

A MIDI command is received from the computer 100 (step 430). The MIDI command may comprise a command intended to be transmitted to the toy control device 130, may comprise an audio in or audio out command, or may comprise a general command.

A MIDI command is sent to the computer 100 (step 440). The MIDI command may comprise a signal received from the toy control device 130, may comprise a response to a MIDI command previously received by the computer radio interface 110 from the computer 100, or may comprise a general command.

The command contained in the MIDI command or in the received signal is executed (step 450). Executing the command may comprise, in the case of a received signal, reporting the command to the computer 100, whereupon the computer 100 may typically carry out any appropriate action under program control as, for example, changing a screen display or taking any other appropriate action in response to the received command. In the case of a MIDI command received from the computer 100, executing the command may comprise transmitting the command to the toy control device 130. Executing a MIDI command may also comprise switching audio output of the computer control device 110 between the secondary audio interface 230 and the radio transceiver 260. Normally the secondary audio interface 230 is directly connected to the audio interface 220 preserving the connection between the computer sound board and the peripheral audio devices such as speakers, microphone and stereo system.

Reference is now made to FIGS. 9B-9N, and additionally reference is made back to FIGS. 8D-8M, all of which, taken together, comprise a simplified flowchart illustration of a preferred implementation of the method of FIG. 9A. The method of FIGS. 9B-9M, taken together with FIGS. 8D-8M, is self-explanatory.

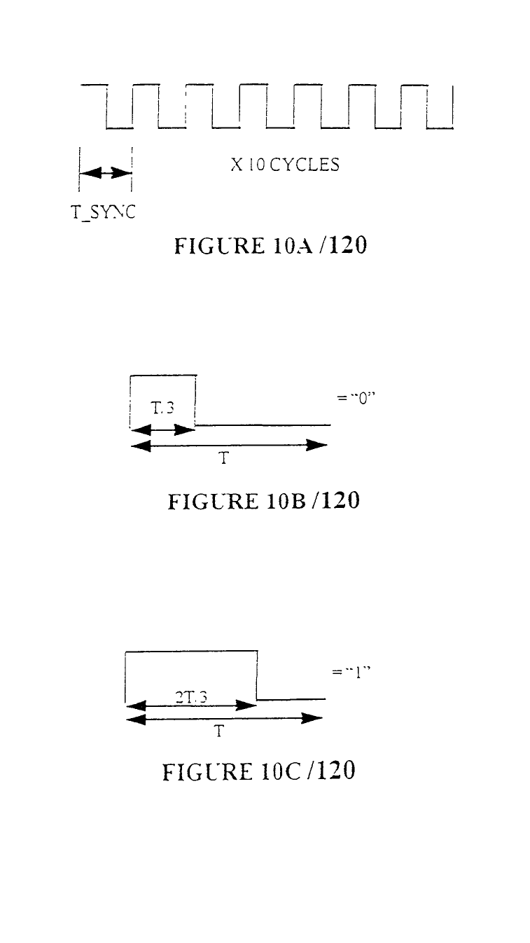

Reference is now additionally made to FIGS. 10A-10C, which are simplified pictorial illustrations of a signal transmitted between the computer radio interface 110 and the toy control device 130 of FIG. 1A. FIG. 10A comprises a synchronization preamble. The duration T_SYNC of the synchronization preamble is preferably 0.500 millisecond, being preferably substantially equally divided into on and off components.

FIG. 10B comprises a signal representing a bit with value 0, while FIG. 10C comprises a signal representing a bit with value 1.

It is appreciated that FIGS. 10B and 10C refer to the case where the apparatus of FIG. 5D is used. In the case of the apparatus of FIG. 5E, functionality corresponding to that depicted in FIGS. 10B and 10C is provided within the apparatus of FIG. 5E.

Preferably, each bit is assigned a predetermined duration T, which is the same for every bit. A frequency modulated carrier is transmitted, using the method of frequency modulation keying as is well known in the art. An “off” signal (typically less than 0.7 Volts) presented at termination 5 of U2 in FIG. 5D causes a transmission at a frequency below the median channel frequency. An “on” signal (typically over 2.3 Volts) presented at pin 5 of U2 in FIG. 5D causes a transmission at a frequency above the median frequency. These signals are received by the corresponding receiver U1. Output signal from pin 6 of U1 is fed to the comparator 280 of FIGS. 4 and 6 that is operative to determine whether the received signal is “off” or “on”, respectively.

It is also possible to use the comparator that is contained within U1 by connecting pin 7 of U1 of FIG. 5D, through pin 6 of the connector J1 of FIG. 5D, pin 6 of connector J1 of FIG. 5A, through the jumper to pin 12 of U1 of FIG. 5A.

Preferably, receipt of an on signal or spike of duration less than 0.01* T is ignored. Receipt of an on signal as shown in FIG. 10B, of duration between 0.01* T and 0.40* T is preferably taken to be a bit with value 0. Receipt of an on signal as shown in FIG. 10C, of duration greater than 0.40* T is preferably taken to be a bit with value 1. Typically, T has a value of 1.0 millisecond.

Furthermore, after receipt of an on signal, the duration of the subsequent off signal is measured. The sum of the durations of the on signal and the off signal must be between 0.90 T and 1.10 T for the bit to be considered valid. Otherwise, the bit is considered invalid and is ignored.

Reference is now made to FIG. 11, which is a simplified flowchart illustration of a method for generating control instructions for the apparatus of FIG. 1A. The method of FIG. 11 preferably includes the following steps:

A toy is selected (step 550). At least one command is selected, preferably from a plurality of commands associated with the selected toy (steps 560-580). Alternatively, a command may be entered by selecting, modifying, and creating a new binary command (step 585).

Typically, selecting a command in steps 560-580 may include choosing a command and specifying one or more control parameters associated with the command. A control parameter may include, for example, a condition depending on a result of a previous command, the previous command being associated either with the selected toy or with another toy. A control parameter may also include an execution condition governing execution of a command such as, for example: a condition stating that a specified output is to occur based on a status of the toy, that is, if and only if a specified input is received; a condition stating that the command is to be performed at a specified time; a condition stating that performance of the command is to cease at a specified time; a condition comprising a command modifier modifying execution of the command, such as, for example, to terminate execution of the command in a case where execution of the command continues over a period of time; a condition dependent on the occurrence of a future event; or another condition.

The command may comprise a command to cancel a previous command.

The output of the method of FIG. 11 typically comprises one or more control instructions implementing the specified command, generated in step 590. Typically, the one or more control instructions are comprised in a command file. Typically, the command file is called from a driver program which typically determines which command is to be executed at a given point in time and then calls the command file associated with the given command.

Preferably, a user of the method of FIG. 11 performs steps 550 and 560 using a computer having a graphical user interface. Reference is now made to FIGS. 12A-12C, which are pictorial illustrations of a preferred embodiment of a graphical user interface implementation of the method of FIG. 11.

FIG. 12A comprises a toy selection area 600, comprising a plurality of toy selection icons 610, each depicting a toy. The user of the graphical user interface of FIGS. 12A-12C typically selects one of the toy selection icons 610, indicating that a command is to be specified for the selected toy.

FIG. 12A also typically comprises action buttons 620, typically comprising one or more of the following:

a button allowing the user, typically an expert user, to enter a direct binary command implementing an advanced or particularly complex command not otherwise available through the graphical user interface of FIGS. 12A-12C;

a button allowing the user to install a new toy, thus adding a new toy selection icon 610; and

a button allowing the user to exit the graphical user interface of FIGS. 12A-12C.

FIG. 12B depicts a command generator screen typically displayed after the user has selected one of the toy selection icons 610 of FIG. 12A. FIG. 12B comprises an animation area 630, preferably comprising a depiction of the selected toy selection icon 610, and a text area 635 comprising text describing the selected toy.

FIG. 12B also comprises a plurality of command category buttons 640, each of which allow the user to select a category of commands such as, for example: output commands; input commands; audio in commands; audio out commands; and general commands.

FIG. 12B also comprises a cancel button 645 to cancel command selection and return to the screen of FIG. 12A.

FIG. 12C comprises a command selection area 650, allowing the user to specify a specific command. A wide variety of commands may be specified, and the commands shown in FIG. 12C are shown by way of example only.

FIG. 12C also comprises a file name area 655, in which the user may specify the name of the file which is to receive the generated control instructions. FIG. 12C also comprises a cancel button 645, similar to the cancel button 645 of FIG. 12B. FIG. 12C also comprises a make button 660. When the user actuates the make button 660, the control instruction generator of FIG. 11 generates control instructions implementing the chosen command for the chosen toy, and writes the control instructions to the specified file.

FIG. 12C also comprises a parameter selection area 665, in which the user may specify a parameter associated with the chosen command.

Reference is now made to Appendix A, which is a computer listing of a preferred software implementation of the method of FIGS. 8A-8T.

Appendix A is an INTEL hex format file. The data bytes start from character number 9 in each line. Each byte is represented by 2 characters. The last byte (2 characters) in each line, should be ignored.

For example, for a sample line:

| | |
|---|---|
| The original line reads: | 07000000020100020320329F |
| The data bytes: | 02010002032032 (02,01,00,02,03,20,32) |
| Starting address of the data | 0000 (00,00) |
| bytes: | |

Appendix A may be programmed into the memory of microcontroller 250 of FIG. 6.

Appendix B is a computer listing of a preferred software implementation of the method of FIGS. 9A-9N, together with the method of FIGS. 8D-8M.

Appendix B is an INTEL hex format file. The data bytes start from character number 9 in each line. Each byte is represented by 2 characters. The last byte (2 characters) in each line, should be ignored.

For example, for a sample line:

| | |
|---|---|
| The original line reads: | 070000000201000205A73216 |
| The data bytes: | 0201000205A732 (02,01,00,02,05,A7,32) |
| Starting address of the data | 0000 (00,00) |
| bytes: | |

Appendix B may be programmed into the memory of microcontroller 250 of FIG. 4.

Appendix C is a computer listing of a preferred software implementation of an example of a computer game for use in the computer 100 of FIG. 1.

Appendix D is a computer listing of a preferred software implementation of the method of FIGS. 11 and FIGS. 12A-12C.

For Appendices C and D, these programs were developed using VISUAL BASIC. To run the programs you need to install the VISUAL BASIC environment first. The application needs a Visual Basic custom control for performing MIDI I/O similar to the one called MIDIVBX. VBX. VISUAL BASIC is manufactured by Microsoft Corporation, One Microsoft Way, Redmond, Wis. 98052-6399, USA. MIDIVBX.VBX is available from Wayne Radinsky, electronic mail address a-wayner@microsoft. com.

The steps for programming the microcontrollers of the present invention include the use of a universal programmer, such as the Universal Programmer, type EXPRO 60/80, manufactured by Sunshine Electronics Co. Ltd., Taipei, Japan.

The method for programming the microcontrollers with the data of Appendices A and B, includes the following steps:

1. Run the program EXPRO.EXE, which is provided with the EXPRO 60/80″.

2. Choose from the main menu the EDIT/VIEW option.

3. Choose the EDIT BUFFER option.

4. Enter the string E 0000.

5. Enter the relevant data (given in Appendices A or B), byte after byte, starting from the address

0000. In each line there is a new starting address for each data byte which appears in this line.

6. Press ESC.

7. Enter the letter Q.

8. Choose from the main menu the DEVICE option.

9. Choose the MPU/MCU option.

10. Choose the INTEL option.

11. Choose the 87C51.

12. Choose from the main menu the RUNFUNC option.

13. Choose the PROGRAM option. 14. Place the 87C5 1 chip in the programmer's socket.

15. Enter Y and wait until the OK message.

16. The chip is now ready to be installed in the board.

The method for creating the relevant files for the computer 100, with the data of Appendices C and D, includes using a HEX EDITOR which is able to edit DOS formatted files. A typical HEX and ASCII editor is manufactured by Martin Doppelbauer, Am Spoerkel 17, 44227 Dortmund, Germany, UET401 at electronic mail address hrz.unidozr.uni-dortmund.de.

The steps necessary for creating the files by means of a HEX editor, such as by the Martin Doppelbauer editor include the following:

1. Copy any DOS file to a new file with the desired name and with the extension .EXE. (For example, write COPY AUTOEXEC.BAT TOY1.EXE).

2. Run the program ME.EXE.

3. From the main menu press the letter L (load file).

4. Write the main menu of the new file (for example TOY1.EXE).

5. From the main menu, press the letter (insert).

6. Enter the relevant data (written in Appendices C or D), byte after byte, starting from the address 0000.

7. Press ESC.

8. From the main menu, enter the letter W(write file).

9. Press the RETURN key and exit from the editor by pressing the letter Q.

The above-described embodiment of FIG. 1C includes a description of a preferred set of predefined messages including a category termed “General commands”. Other General Commands are defined by the following description:

MULTIPORT COMMANDS
AVAILABILITY_INTERROGATION_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 05 | 00 | 00 | 00 | 00 | x | x | |

A computer transmits this command to verify that the radio channel is vacant. If another computer is already
using this channel it will respond with the Availability Response Command. If no response is received within 250
msec the channel is deemed vacant.

| | | |
|---|---|---|
| P: | Computer address | 00-03 H |
| A: | unit address - | 00-FF H |

AVAILABILITY_RESPONSE_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 06 | 00 | 00 | 00 | 00 | x | x | |

A computer transmits this command in response to an Availability Interrogation Command to announce that the radio
channel is in use.

| | | |
|---|---|---|
| P: | Computer address | 00-03 H |
| A: | unit address - | 00-FF H |

TOY_AVAILABILITY_COMMAND

| byte 0 | byte 1 | | byte 2 | byte 3 | byte 4 | byte 5 | byte 6 | | byte 7 | | byte 8 | | byte 9 |
|---|---|---|---|---|---|---|---|---|---|---|---|---|---|
| Head | PC | Unit # | Unit # | Unit # | CMD | CMD | - 8 bits - | | - 8 bits - | | - 8 bits - | | CRC |
| | add | A-sb | B-sb | C-sb | msb | lsb | | | | | | | |
| | | | | | | | Dat1 | Dat1 | Dat2 | Dat2 | Dat3 | Dat3 | |
| | | | | | | | msb | lsb | msb | lsb | msb | lsb | |
| 8 bit | 2 bit | 6 bit | 8 bit | 8 bit | 8 bit | 8 bit | 4 bit | 4 bit | 4 bit | 4 bit | 4 bit | 4 bit | 8 bits |
| 01 | P | 00 | 00 | A | 04 | 08 | CH1 | CH2 | 00 | 00 | x | x | |

A computer transmits this command in response to a Toy Availability Command to inform the toy the
radio channels to be used.

| | | |
|---|---|---|
| P: | Computer address | 00-03 H |
| A: | unit address- | 00-FF H |
| CH1: | Toy transmit channel | 0-F H |
| CH1: | Toy receive channel | 0-F H |

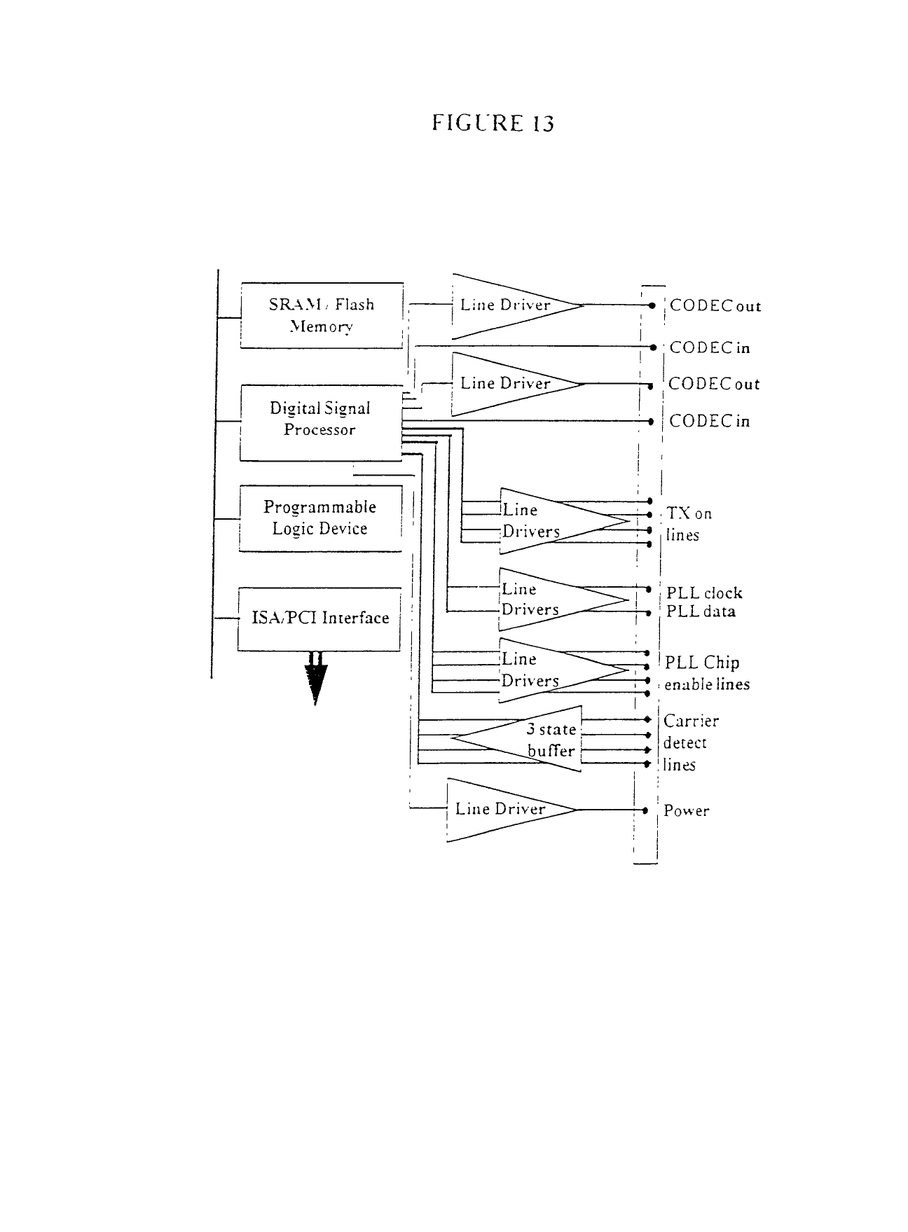

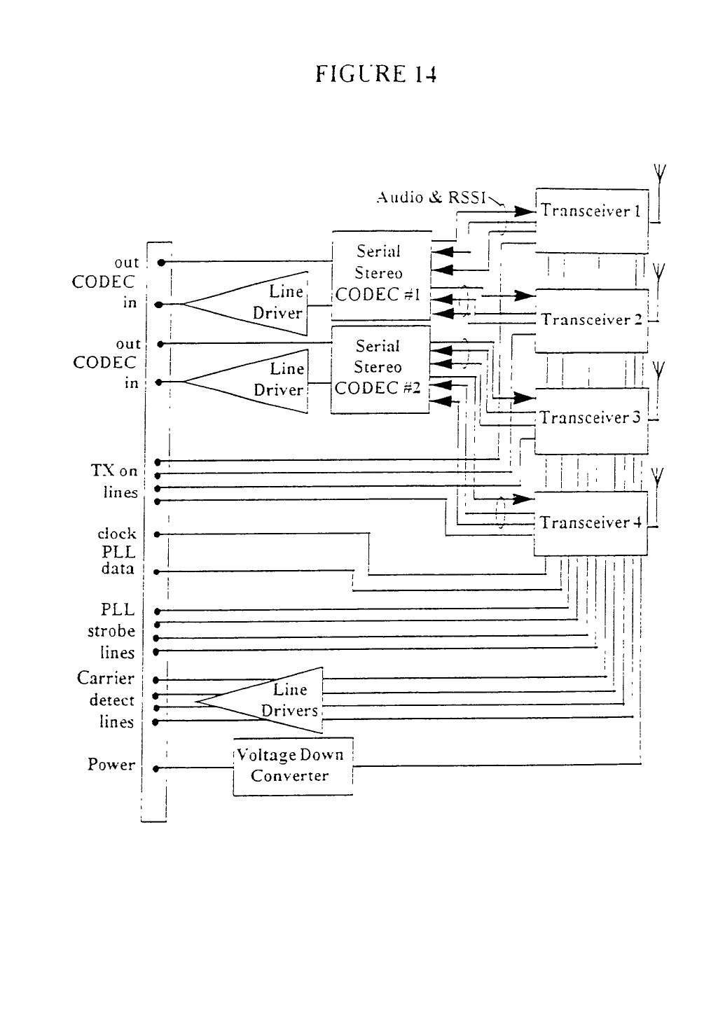

In FIGS. 13 and 14 there are illustrated block diagrams of multiport multi-channel implementation of the computer radio interface 110 of FIG. 1A. FIG. 13 illustrates the processing sub-unit of the computer interface that is implemented as an add-in board installed inside a PC. FIG. 14 is the RF transceiver which is a device external to the computer and connects to the processing subunit by means of a cable. In the present application of the RF unit there are 4 transceivers each capable of utilizing two radio channels simultaneously.

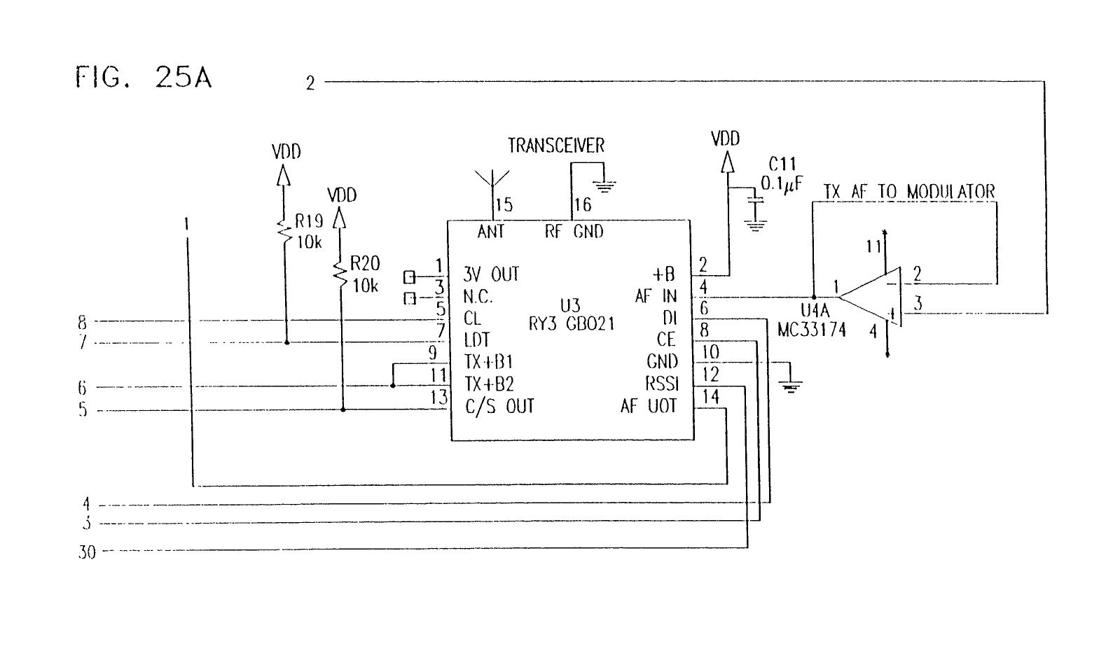

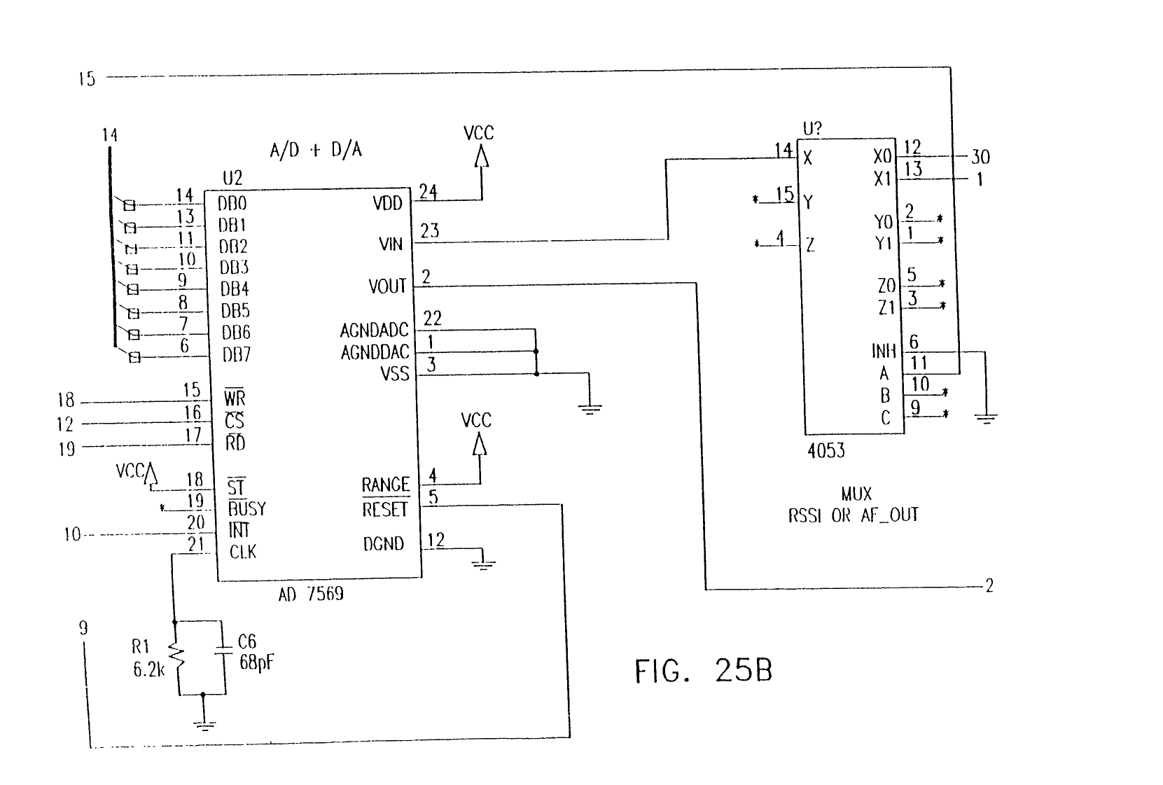

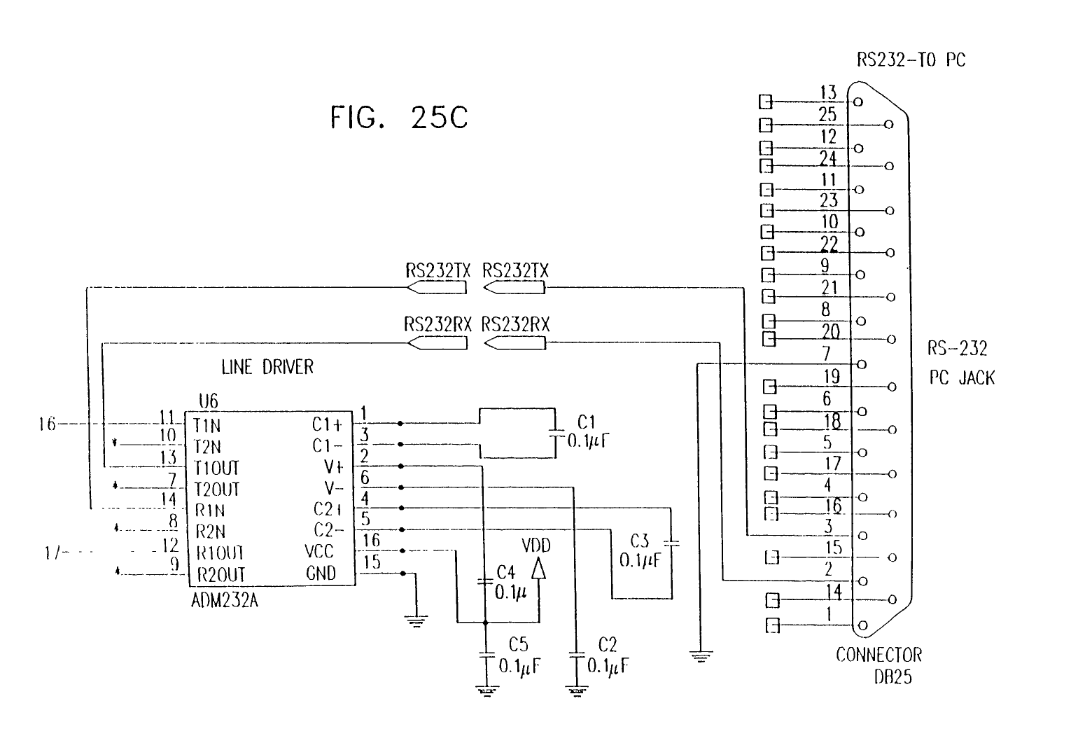

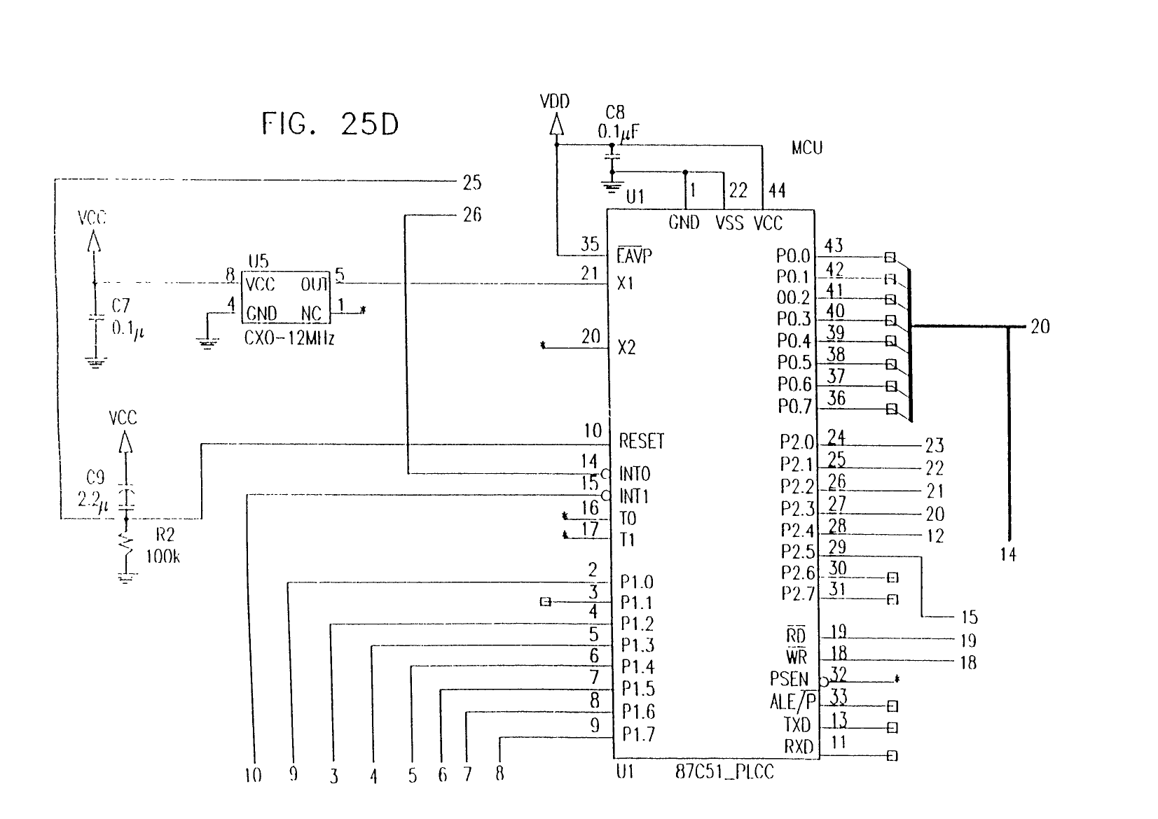

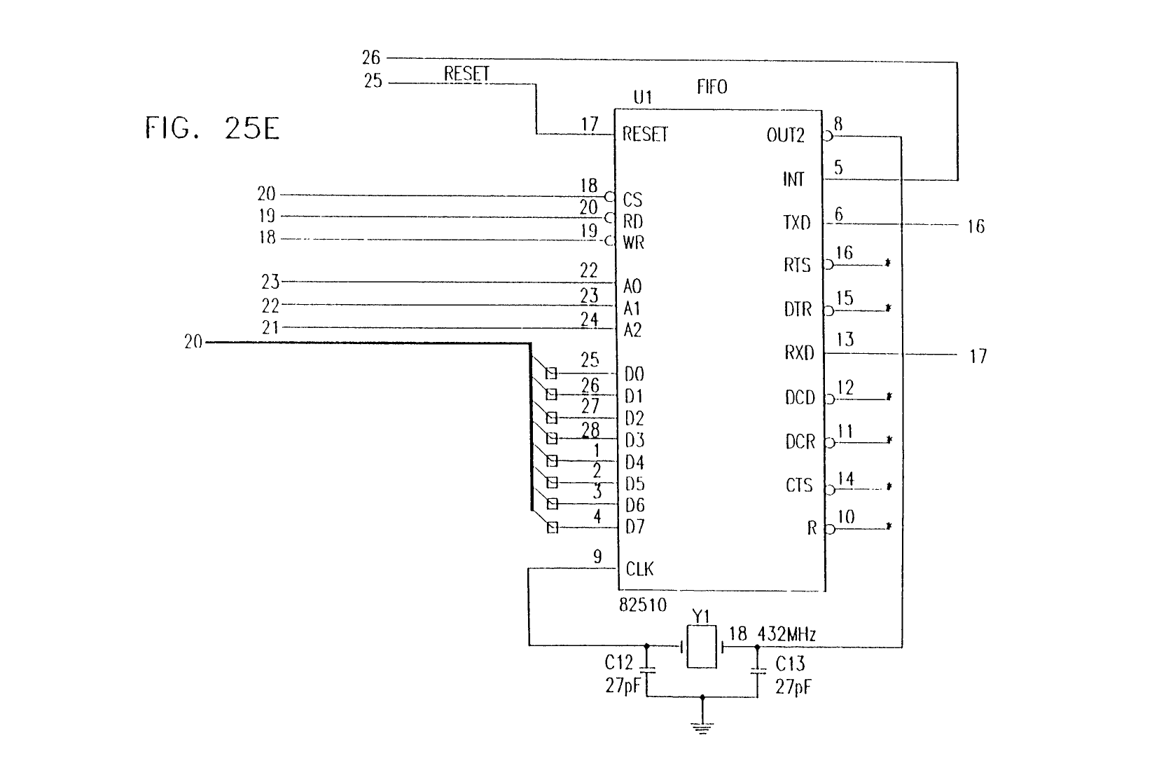

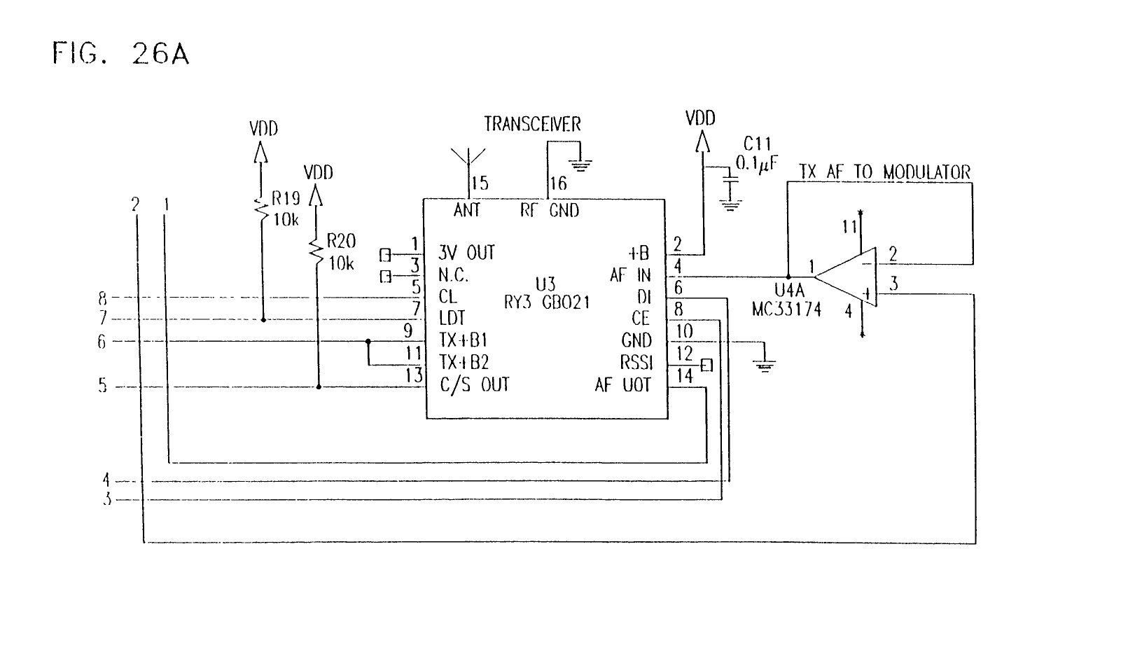

Referring briefly to FIG. 3, it is appreciated that, optionally, both sound and control commands may be transmitted via the MIDI connector 210 rather than transmitting sound commands via the analog connector 220. It is additionally appreciated that the functions of the interfaces 210 and 220 between the computer radio interface 110 and the sound card 190 may, alternatively, be implemented as connections between the computer radio interface 110 to the serial and/or parallel ports of the computer 100, as shown in FIGS. 25A-25F.

If it is desired to provide full duplex communication, each transceiver 260 which forms part of the computer radio interface 110 of FIG. 1A preferably is operative to transmit on a first channel pair and to receive on a different, second channel pair. The transceiver 260 (FIG. 4) which forms part of the toy control device 130 of FIG. 1A preferably is operative to transmit on the second channel and to receive on the first channel.

Any suitable technology may be employed to define at least two channel pairs such as narrow band technology or spread spectrum technologies such as frequency hopping technology or direct sequence technology, as illustrated in FIGS. 15A-15E, showing a Multi-Channel Computer Radio Interface, and in FIGS. 24A-24E showing a Multi-Channel Toy Control Device.

Appendices E-H, taken together, are computer listings from which a first, DLL-compatible, functions library may be constructed. The DLL-compatible functions library may be subsequently used by a suitable computer system such as an IBM PC to generate a variety of games for any of the computer control systems shown and described herein. Alternatively, games may be generated using the applications generator of FIGS. 11-12C.

To generate a DLL (dynamic loading and linking) function library based on Appendices E-H, the following operations are performed:

1) Open Visual C++4.0

2) Go to File Menu

3) Choose New from File Menu

4) Choose Project Workspace

5) Choose Dynamic-Link Library

6) The Project Name is: DLL32.MDP

7) Press Create button

8) Go to File Menu

9) Choose New from File Menu

10) Choose Text File

11) Now write the Source

12) Write on the current page a file containing the contents of Appendix E

13) Press the mouse right button and choose: Insert File Into Project

14) Click on DLL32 project

15) On the save dialog write CREATOR.C

16) Press the OK button

17) Go to File Menu

18) Choose New from File Menu

19) Choose Text File

20) Write on this page a file containing the contents of Appendix F; 21) Go to File Menu

22) Press Save

23) On the save dialog write CRMIDI.H

24) Press the OK button

25) Go to File Menu

26) Choose New from File Menu

27) Choose Text File

28) Write on this page a file containing the contents of Appendix G;

29) Go to File Menu

30) Press Save

31) On the save dialog write a file CREATOR.H

32) Press the OK button

33) Go to File Menu

34) Choose New from File Menu

35) Choose Text File

36) Write on this page a file containing the contents of Appendix H.;

37) Press the mouse right button and choose: Insert File Into Project

38) Click on DLL32 project

39) On the save dialog write CREATOR.DEF

40) Press the OK button

41) Go to Insert Menu

42) Press File Into Project . . .

43) On the List Files of Type: Choose Library Files (*.lib)

44) Go to the Visual C++ library directory and choose WINMM.LIB

45) Press the OK button

46) Go to the Build menu

47) Press Rebuild ALL

A description of the commands included in the DLL function library based on Appendices E-H now follows:

A. MIDI input functions 1-2:

1. Open MIDI input device

Syntax: long MIDIInOpen(long Device)

This function opens the MIDI device for input.

Return 0 for success, −1 otherwise.

Delphi Example:

Device:=0;

if MIDIInOpen(Device)<>0 Then

MessageDlg(‘Error opening MIDI input device’, mtError, mbOk, 0);

2. Reset MIDI input device

Syntax: long MIDIInReset(void)

this function resets MIDI input device.

Return 0 for success, −1 otherwise.

Delphi Example:

if MIDIInRest<>0 Then

MessageDlg(‘Error resetting MIDI input device’, mtError, mbOk, 0);

B. MIDI output functions 3-6:

3. Close MIDI input device

Syntax: long MIDIInClose(void)

This function close MIDI input device.

Return 0 for success, −1 otherwise.

Delphi Example:

if MIDIInClose<>0 Then

MessageDlg(‘Error closing MIDI input device’, mtError, mbOk, 0);

4. Open MIDI output device

Syntax: long MIDIOutOpen(long Device)

This function opens MIDI output device.

Return 0 if success, −1 otherwise.

Delphi Example:

Device:=0;

if MIDIOutOpen(Device)<>0 Then

MessageDlg(‘Error opening MIDI output device’, mtError, mbOk, 0);

5. Reset MIDI Output device

Syntax: long MIDIOutReset(void)

This function resets MIDI output device.

Return 0 if success, −1 otherwise.

Delphi Example:

if MIDIOutReset<>0 Then

MessageDlg(‘Error resetting MIDI output device’, mterror, mbOk, 0);

6. Close MIDI output device

Syntax: long MIDIOutClose(void)

This function close MIDI output device.

Return 0 if success, −1 otherwise.

Delphi Example:

Device:=0;

if MIDIOutClose<>0 Then

MessageDlg(‘Error opening MIDI output device’, mtError, mbOk, 0);

C. General functions 7-10:

7. Send Data

Syntax: long SendData(long Data)

This function sends 4 bytes to toy card.

Currently used to send 144 for init toy card.

Return 0 if successful, −1 otherwise.

Delphi Example:

If SendData(144)<>0 Then

MessageDlg(‘Error sending data to toy’, mterror, mbOk, 0);

8. Send Message

Syntax: long SendMessage(char *Mess)

This function sends string to toy card.

Return 1 if successful, or errorcode otherwise.

Delphi Example:

Mess: =‘00 01 00 00 00 00 00 05 00 00 00 01 00 03 00 01 00 00 00’;

If SendMessage(Mess)<>1 Then

MessageDlg(‘Error opening MIDI output device’, mtError, mbOk, 0);

9. Check message

Syntax: long CheckMessage(void)

This function returns 0 if no message found from toy card.

Delphi Example:

If CheckMessage Then

Mess:=GetMessage;

10. Get Message

Syntax: char * GetMessage(char *Mess)

This function returns 20 chars toy message if present, or “Time Out” otherwise.

Delphi Example:

If GetMessage=“Time Out” Then

MessageDlg(‘No message received’, mtError, mbOk, 0);

D. Toy control functions 11-16:

11. Get Toy Number

Syntax: char * GetToyNumber(void)

This function returns Toy Number of last receiving message, or “00 00 00 00” if no message was received.

12. Get Sensor Number

Syntax: long GetSensorNumber(void)

This function returns Sensor Number of last receiving message, or 255 if no message was received.

13. Toy Reset

Syntax: long ToyReset(char *ToyNumber)

This function sends a reset string to toy.

Return 0 if successful, or −1 otherwise.

14. Toy Transceive

Syntax: char *ToyTranceive(char *ToyNumber,char *Mess)

This function sends message to toy and waits 3 sec to acknowledge.

Return “Ack. Ok” if received, or “Time Out” if not.

15. Prepare Toy Talk

Syntax: char *PrepareToyTalk(char *ToyNumber, char *WaveFile)

This function prepares toy card to generate sound using toy speaker.

After calling this function, WaveFile may be played and heard at toy speaker.

Return “Ack. Ok” if successful, or “Time Out” otherwise.

16. Go To Sleep Mode

Syntax: char *GoSleep(char *ToyNumber)

This function sends to toy the sleep command.

Return “Ack. Ok” if successful, or “Time Out” otherwise.

Appendices I-O, taken together, are computer listings of a second functions library which may be used to generate a variety of games for any of the computer control systems shown and described herein in conjunction with a Director 5.0 software package, marketed by Macromedia Inc., 600 Townsend St., San Francisco, Calif., 94103.

To generate an XObject function library based on Appendices I-O, the following operations are performed:

1) Create a new directory: C:\XOBJECT\by writing (MD C:\XOBJECT\)

2) Open Visual C++1.5

3) On the File menu choose NEW

4) Generate a file which contains the contents of Appendix I;

5) Choose Save As from the File Menu

6) Give the file generated in step (4) a name by punching C:\XOBJECT\CREATOR.MAK

7) Press the OK button

8) On the File menu choose NEW

9) Generate a file which contains the contents of Appendix J;

10) On the File menu choose Save As.

11) In the File Name: dialog, write C:\XOBJECT\CREATOR.C

12) Press the OK button

13) On the File menu choose NEW

14) Generate a file which contains the contents of Appendix K;

15) On the File menu choose Save As.

16) In the File Name: dialog write C:\XOBJECT\CREATOR.H

17) Press the OK button

18) On the File menu choose NEW

19) Generate a file which contains the contents of Appendix L;

20) On the File menu choose Save As.

21) In the File Name: dialog write C:\XOBJECT\CRMIDI.H

22) Press the OK button

23) On the File menu choose NEW

24) Generate a file which contains the contents of Appendix M;

25) On the File menu choose Save As.

26) In the File Name: dialog write C:\XOBJECT\XOBJECT.H

27) Press the OK button

28) On the File menu choose NEW

29) Generate a file which contains the contents of Appendix N;

30) On the File menu choose Save As.

31) In the File Name: dialog write C:\XOBJECT\CREATOR.DEF

32) Press the OK button

33) On the File menu choose NEW

34) Generate a file which contains the contents of Appendix O;

35) On the File menu choose Save As.

36) In the File Name: dialog write C:\XOBJECT\CREATOR.RC

37) Press the OK button

38) On the Project Menu choose Open

39) In the File Name dialog write C:\XOBJECT\CREATOR.MAK

40) Press Rebuild All from the Project Menu

A description of the commands included in the XObject function library based on Appendices I-O now follows:

A. MIDI input functions 1-3:

1. Open MIDI input device

Syntax: long MIDIInOpen(long Device)

This function opens the MIDI device for input.

Return 0 for success, −1 otherwise.

Delphi Example:

Device:=0;

if MIDIInOpen(Device)<>0 Then

MessageDlg(‘Error opening MIDI input device’, mtError, mbOk, 0);

2. Reset MIDI input device

Syntax: long MIDIInReset(void)

This function resets MIDI input device.

Return 0 for success, −1 otherwise.

Delphi Example:

if MIDIInRest<>0 Then

MessageDlg(‘Error resetting MIDI input device’, mtError, mbOk, 0);

3. Close MIDI input device

Syntax: long MIDIInClose(void)

This function turns off MIDI input device.

Return 0 for success, −1 otherwise.

Delphi Example:

if MIDIInClose<>0 Then

MessageDlg(‘Error closing MIDI input device’, mterror, mbOk, 0);

B. MIDI output functions 4-6:

4. Open MIDI output device

Syntax: long MIDIOutOpen(long Device)

This function opens MIDI output device.

Return 0 if success, −1 otherwise.

Delphi Example:

Device:=0;

if MIDIOutOpen(Device)<>0 Then

MessageDlg(‘Error opening MIDI output device’, mtError, mbOk, 0);

5. Reset MIDI Output device

Syntax: long MIDIOutReset(void)

This function resets MIDI output device.

Return 0 if success, −1 otherwise.

Delphi Example:

if MIDIOutReset<>0 Then

MessageDlg(‘Error resetting MIDI output device’, mtError, mbOk, 0);

6. Close MIDI output device

Syntax: long MIDIOutClose(void)

This function close MIDI output device.

Return 0 if success, −1 otherwise.

Delphi Example:

Device:=0;

if MIDIOutClose<>0 Then

MessageDlg(‘Error opening MIDI output device’, mtError, mbOk, 0);

C. General functions 7-11:

7. New

Syntax: Creator(mNew)

This function creates a new instance of the XObject

The result is I if successful, or error code otherwise.

Example:

openxlib “Creator.Dll”

Creator(mNew) . . .

Creator(mDispose)

See also: Dispose

8. Dispose

Syntax: Creator(mNew)

This function disposes of XObject instance.

The result is 1 if successful, or error code otherwise.

Example:

openxlib “Creator.Dll”

Creator(mNew)

Creator(mDispose)

See also: New

9. Send Message

Syntax: long SendMessage(char *Mess)

This function sends string to toy card.

Return 1 if successful, or error code otherwise.

Delphi Example:

Mess:=‘00 01 00 00 00 00 00 05 00 00 00 01 00 03 00 01 00 00 00’;

If SendMessage(Mess)<>1 Then

MessageDlg(‘Error opening MIDI output device’, mterror, mbOk, 0);

10. Check message

Syntax: long CheckMessage(void)

This function returns 0 if no message found from toy card.

Delphi Example:

If CheckMessage Then

Mess:=GetMessage;

11. Get Toy Message

Syntax: GetToyMessage

This function receives message from toy.

The result is a message.

If during 3 sec there is no message, the result is “Time Out”.

Example:

set message GetToyMessage

If message=“Time Out” Then

put “No message receiving”

End If

See also: Check for Message

D. Toy control functions 12-17:

12. Get Toy Number

Syntax: char*GetToyNumber(void)

This function returns Toy Number of last receiving message, or “00 00 00 00” if no message was

received.

13. Get Sensor Number

Syntax: long GetSensorNumber(void)

This function returns Sensor Number of last receiving message, or 255 if no message was received.

14. Toy Reset

Syntax: long ToyReset(char *ToyNumber)

This function sends a reset string to toy.

Return 0 if successful, or −1 otherwise.

15. Toy Tranceive

Syntax: char *ToyTranceive(char *ToyNumber,char *Mess)

This function sends to toy message and waits 3 sec to acknowledge. Return “Ack. Ok” if received, or “Time Out” if not.

16. Prepare Toy Talk

Syntax: char *PrepareToyTalk(char *ToyNumber, char *WaveFile)

This function prepares toy card to generate sound using from toy speaker.

After calling this function, WaveFile may be played and heard at toy speaker.

Return “Ack. Ok” if successful, or “Time Out” otherwise.

17. Go To Sleep Mode

Syntax: char *GoSleep(char *ToyNumber)

This function sends to toy the sleep command.

Return “Ack. Ok” if successful, or “Time Out” otherwise.

To use the XObject function library in conjunction with the Director, the following method may be employed:

1) Open Director Version 5.0 program

2) From File Menu, choose New

3) Press the Movie Option

4) Go to Windows menu and press Cast

5) Go to the first Script on the cast

6) On the Window menu choose Script

7) Write the script of the desired game.

8) Repeat from step 5 until all desired script(s) have been written. Press (Ctrl+Alt+P) to run the Application.

Appendices P-W, taken together, are computer listings of another preferred software implementation, alternative to the implementation of Appendices A-O.

To construct and operate the implementation of Appendices P-W, the following operations are performed:

1) Provide a computer capable of running the WINDOWS 95 operating system;

2) Prepare computer files for each of the files contained in Appendix P and place the computer files in a directory named “ocx”;

3) Prepare a computer file for the file contained in Appendix Q, extract the compressed contents of the file using Winzip version 6.2 available from Nico Mak Computing, Inc. of Bristol, Conn. 06011 USA, and place the extracted computer files in the directory named “ocx”;

4) Prepare computer files for each of the files contained in Appendix R and place the computer files in a directory named “player”;

5) Prepare a computer file for the file contained in Appendix S, extract the compressed contents of the file using Winzip version 6.2, and place the extracted computer files in a subdirectory named “res” contained in the directory named “player”;

6) Prepare computer files for each of the files contained in Appendices T and U and place the computer files in a directory named “xmidi5”;

7) Prepare a computer file for the file contained in Appendix V, extract the compressed contents of the file using Winzip version 6.2, and place the extracted computer files in the directory named “xmidi5”;

8) Prepare a computer file named NEWDEMO.CS the file contained in Appendix W and place the files in the directory named “player”;

9) Install the Microsoft Development Studio Version 5.0 available from Microsoft Corporation, One Microsoft Way, Redmond, Wash. USA;

10) Run the Microsoft Development Studio, select FILE/OPEN WORKSPACE from the menu, select the file \OCX\NEWSR.DSW, select BUILD from the menu, select BUILD NEWDEMO.OCX, select FILE/OPEN WORKSPACE from the menu, select the file \PLAYER\PLAYER.DSW, select BUILD from the menu, select BUILD PLAYER.EXE;

11) Compile \XMIDI5\XMIDI.DSW using Visual C++ Version 5.0 and run the OCX registration program REGSVR32.EXE with XMIDI5.OCX on the command line;

12) Install the “American English Text To Speech Software Development Kit” for WINDOWS 95/WINDOWS NT from Lernout & Hauspie Speech Products, Sint-Krispisnstraat 7, 8900 Leper, Belgium;

13) Run PLAYER.EXE in DOS mode from the \PLAYER directory by invoking “player newdemo.cs”.

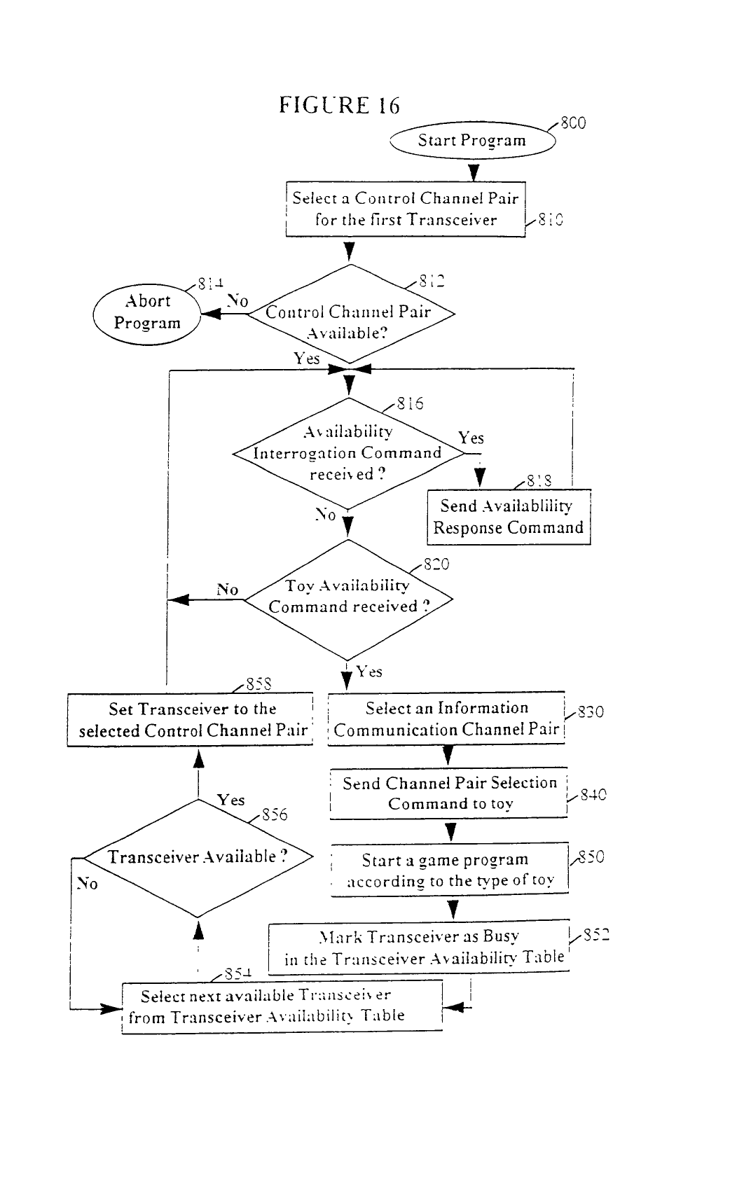

Reference is now made to FIG. 16 which is a simplified flowchart illustration of a preferred method of operation of a computer radio interface (CRI) 110 operative to service an individual computer 100 of FIG. 1A without interfering with other computers or being interfered with by the other computers, each of which is similarly serviced by a similar CRI. Typically, the method of FIG. 16 is implemented in software on the computer 100 of FIG. 1A.

The CRI includes a conventional radio transceiver (260 of FIG. 4) which may, for example, comprise an RY3 GB021 having 40 channels which are divided into 20 pairs of channels. Typically, 16 of the channel pairs are assigned to information communication and the remaining 4 channel pairs are designated as control channels.

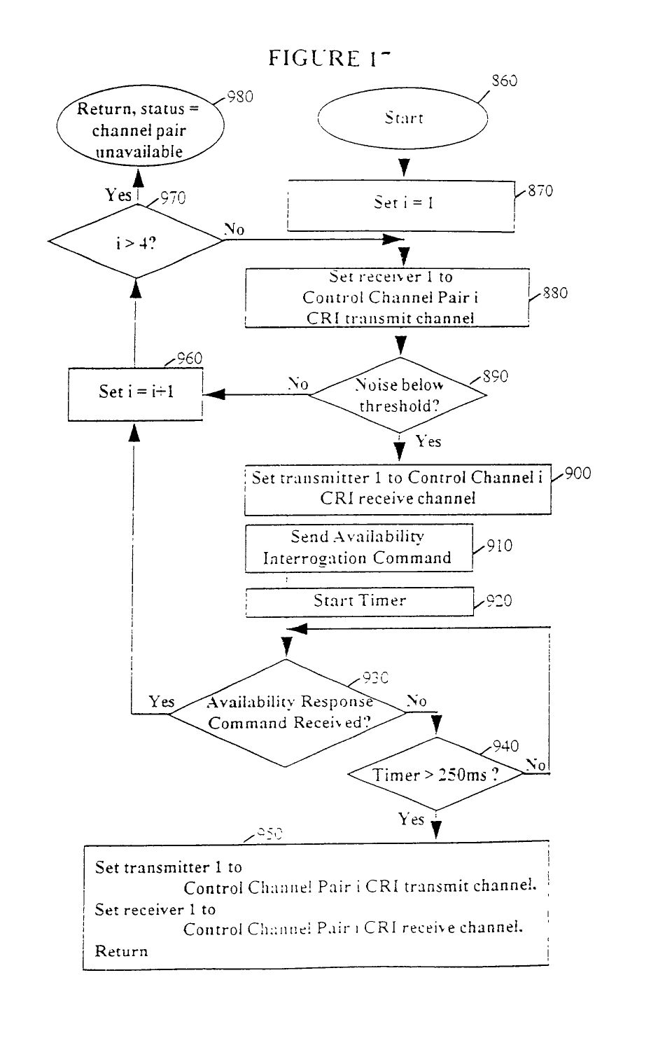

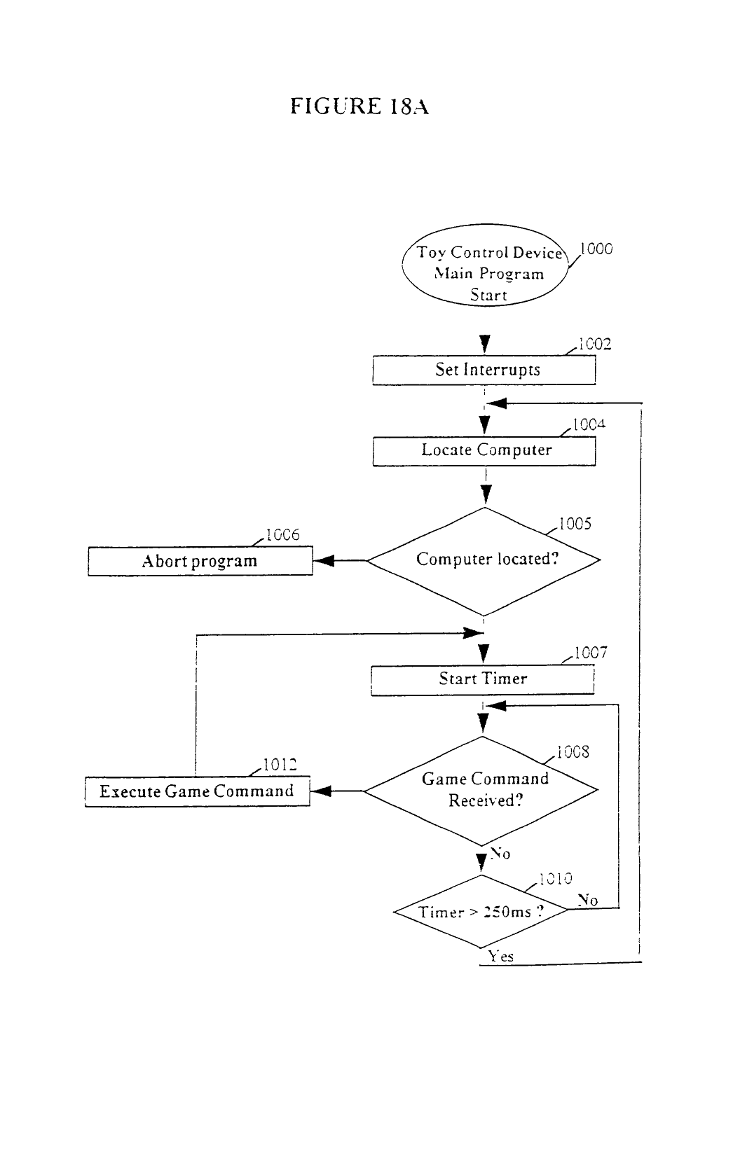

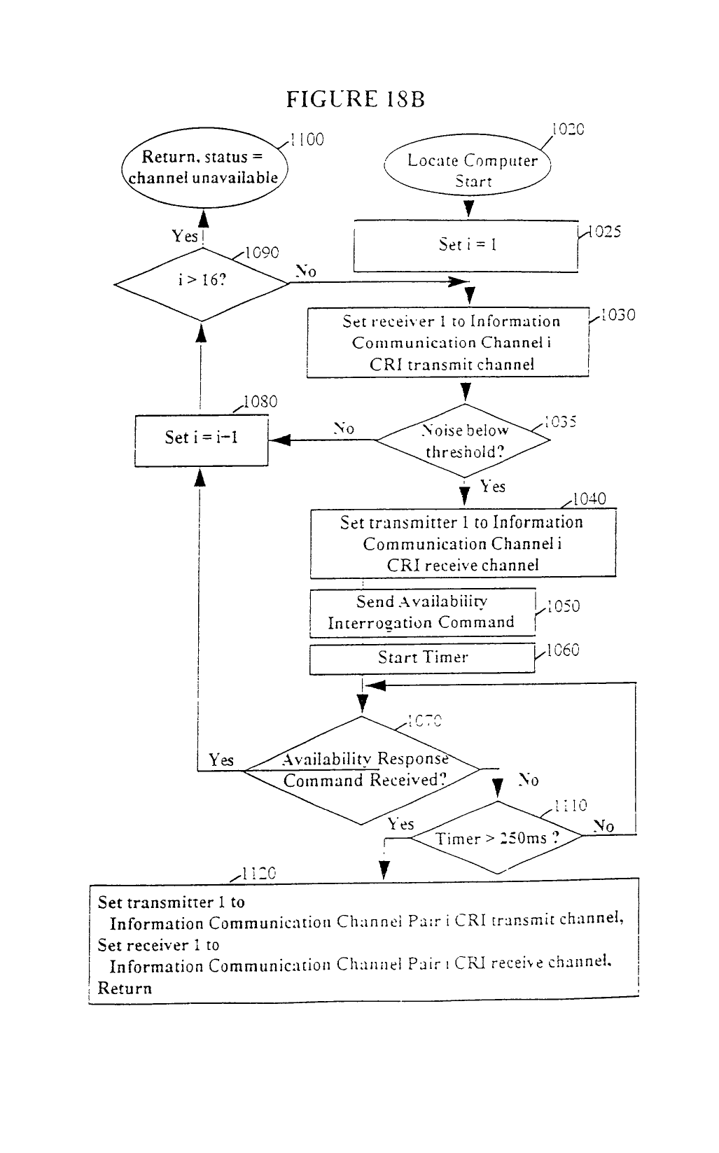

In the method of FIG. 16, one of the 4 control channel pairs is selected by the radio interface (step 810) as described in detail below in FIG. 17. The selected control channel pair i is monitored by a first transceiver (step 820) to detect the appearance of a new toy which is signaled by arrival of a toy availability command from the new toy (step 816). When the new toy is detected, an information communication channel pair is selected (step 830) from among the 16 such channel pairs provided over which game program information will be transmitted to the new toy. A preferred method for implementing step 830 is illustrated in self-explanatory flowchart FIG. 18A. The “Locate Computer” command in FIG. 18A (step 1004) is illustrated in the flowchart of FIG. 18B.

The identity of the selected information communication channel pair, also termed herein a “channel pair selection command”, is sent over the control channel pair to the new toy (step 840). A game program is then begun (step 850), using the selected information communication channel pair. The control channel pair is then free to receive and act upon a toy availability command received from another toy. Therefore, it is desirable to assign another transceiver to that control channel pair since the current transceiver is now being used to provide communication between the game and the toy.

To assign a further transceiver to the now un-monitored control channel, the transceiver which was formerly monitoring that control channel is marked as busy in a transceiver availability table (step 852). The transceiver availability table is then scanned until an available transceiver, i.e. a transceiver which is not marked as busy, is identified (step 854). This transceiver is then assigned to the control channel i (step 858).

FIG. 17 is a simplified flowchart illustration of a preferred method for implementing “select control channel pair” step 810 of FIG. 16. In FIG. 17, the four control channels are scanned. For each channel pair in which the noise level falls below a certain threshold (step 895), the computer sends an availability interrogation command (step 910) and waits for a predetermined time period, such as 250 ms, for a response (steps 930 and 940). If no other computer responds, i.e. sends back an “availability response command”, then the channel pair is deemed vacant. If the channel pair is found to be occupied the next channel is scanned. If none of the four channel pairs are found to be vacant, a “no control channel available” message is returned.

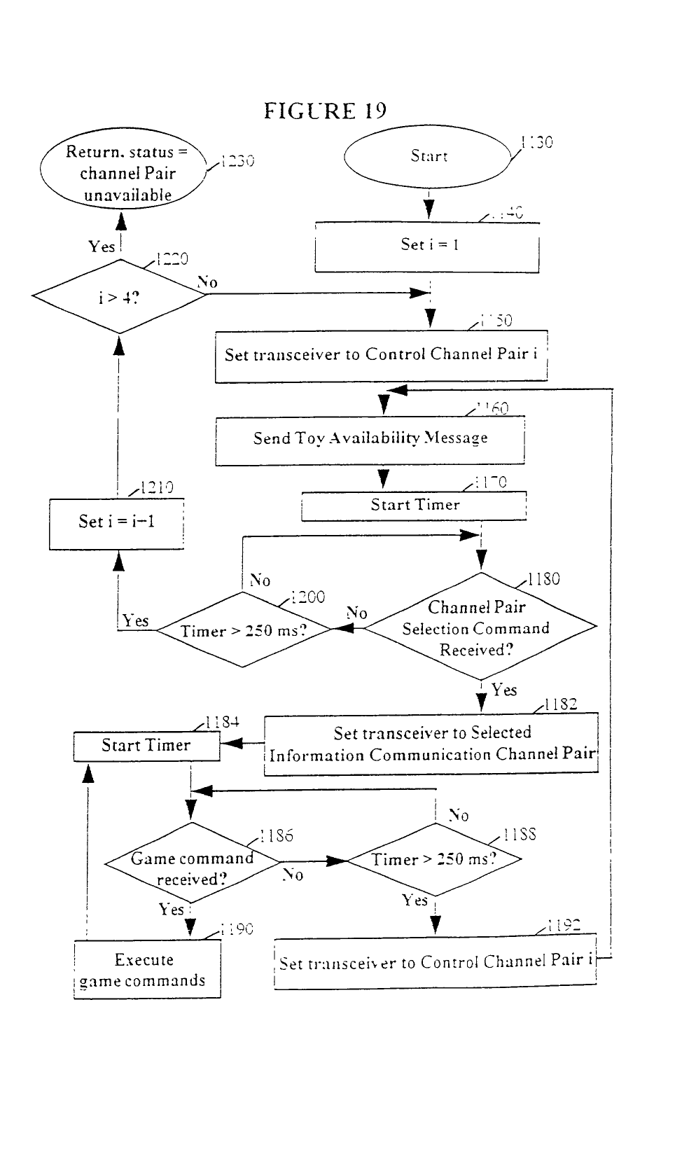

FIG. 19 is a self-explanatory flowchart illustration of a preferred method of operation of the toy control device 130 which is useful in conjunction with the “multi-channel” embodiment of FIGS. 16-18B. i=1, . . . , 4 is an index of the control channels of the system. The toy control device sends a “toy availability command” (step 1160) which is a message advertising the toy's availability, on each control channel i in turn (steps 1140, 1150, 1210), until a control channel is reached which is being monitored by a computer. This becomes apparent when the computer responds (step 1180) by transmitting a “channel pair selection command” which is a message designating the information channel pair over which the toy control device may communicate with the game running on the computer. At this point (step 1190), the toy control device may begin receiving and executing game commands which the computer transmits over the information channel pair designated in the control channel i.

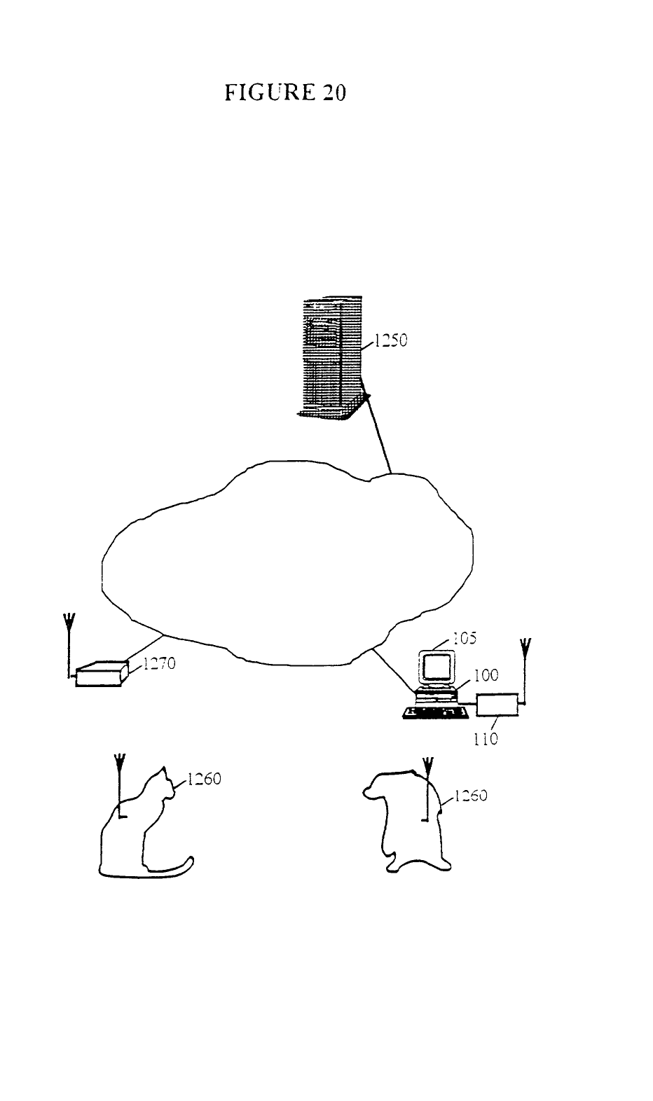

According to a preferred embodiment of the present invention, a computer system is provided, in communication with a remote game server, as shown in FIG. 20. The remote game server 1250 is operative to serve to the computer 100 at least a portion of at least one toy-operating game, which operates one or more toys 1260. Optionally, an entire game may be downloaded from the remote game server 1250. However, alternatively, a new toy action script or new text files may be downloaded from the remote game server 1250 whereas the remaining components of a particular game may already be present in the memory of computer 100.

Downloading from the remote game server 1250 to the computer 100 may take place either off-line, before the game begins, or on-line, in the course of the game. Alternatively, a first portion of the game may be received off-line whereas an additional portion of the game is received on-line.

The communication between the remote game server 1250 and the computer 100 may be based on any suitable technology such as but not limited to ISDN; X.25; Frame-Relay; and Internet.

An advantage of the embodiment of FIG. 20 is that a very simple computerized device may be provided locally, i.e. adjacent to the toy, because all “intelligence” may be provided from a remote source. In particular, the computerized device may be less sophisticated than a personal computer, may lack a display monitor of its own, and may, for example, comprise a network computer 1270.

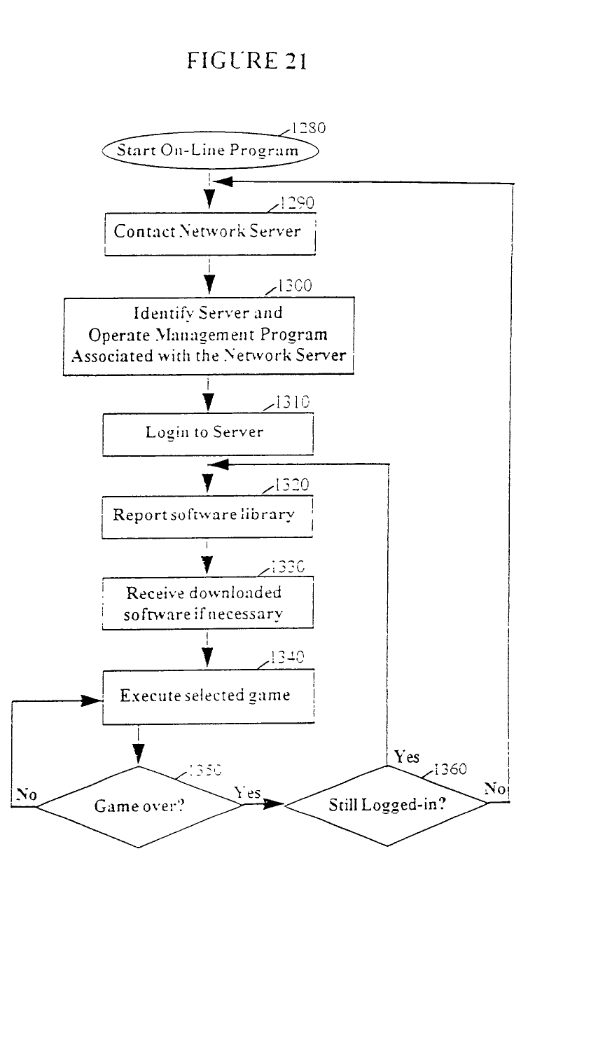

FIG. 21 is a simplified flowchart illustration of the operation of the computer 100 or of the network computer 1260 of FIG. 20, when operating in conjunction with the remote server 1250.

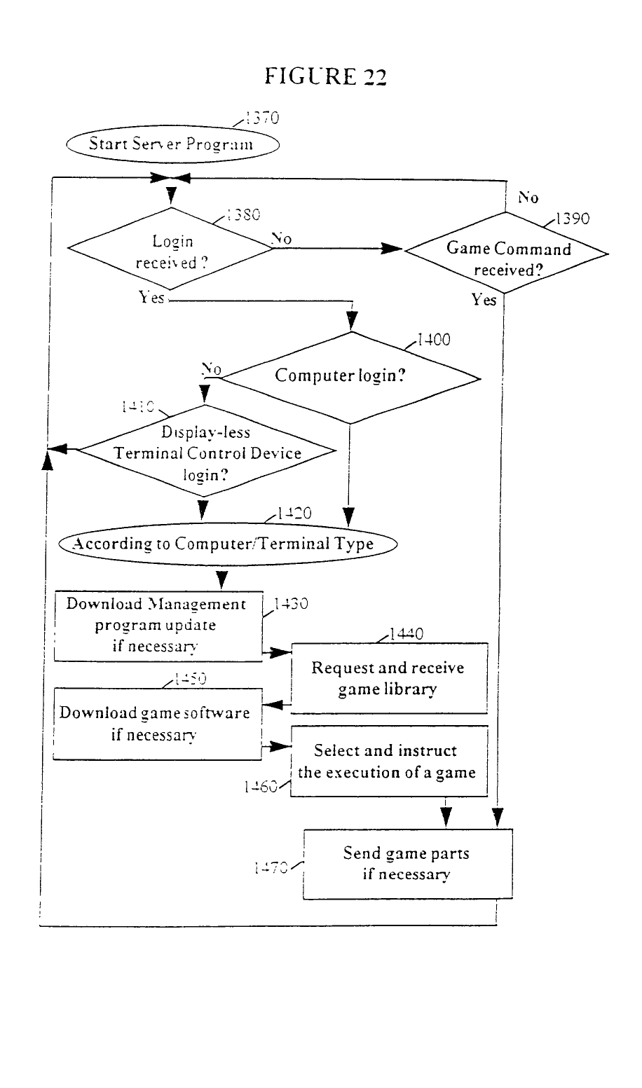

FIG. 22 is a simplified flowchart illustration of the operation of the remote game server 1250 of FIG. 20.

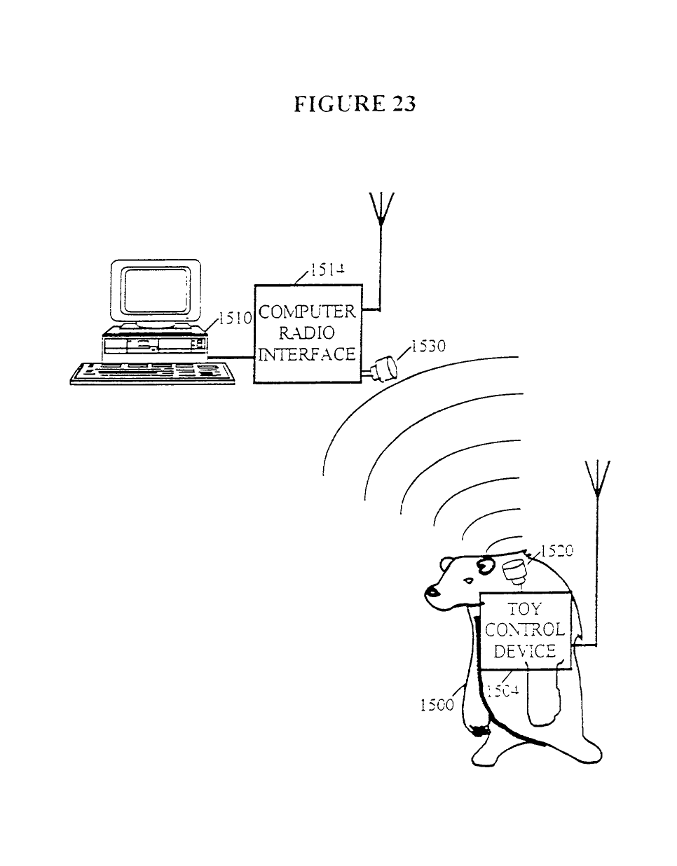

FIG. 23 is a semi-pictorial semi-block diagram illustration of a wireless computer controlled toy system including a toy 1500 having a toy control device 1504, a computer 1510 communicating with the toy control device 1504 by means of a computer-radio interface 1514 and a proximity detection subsystem operative to detect proximity between the toy and the computer. The proximity detection subsystem may for example include a pair of ultrasound transducers 1520 and 1530 associated with the toy and computer respectively. The toy's ultrasound transducer 1520 typically broadcasts ultrasonic signals which the computer's ultrasound transducer 1530 detects if the computer and toy are within ultrasonic communication range, e.g. are in the same room.

FIGS. 24A-24E, taken together, form a detailed electronic schematic diagram of a multi-channel implementation of the computer radio interface 110 of FIG. 3 which is similar to the detailed electronic schematic diagrams of FIGS. 5A-5D except for being multi-channel, therefore capable of supporting full duplex applications, rather than single-channel.

FIGS. 25A-25F, taken together, form a detailed schematic illustration of a computer radio interface which connects to a serial port of a computer rather than to the sound board of the computer.

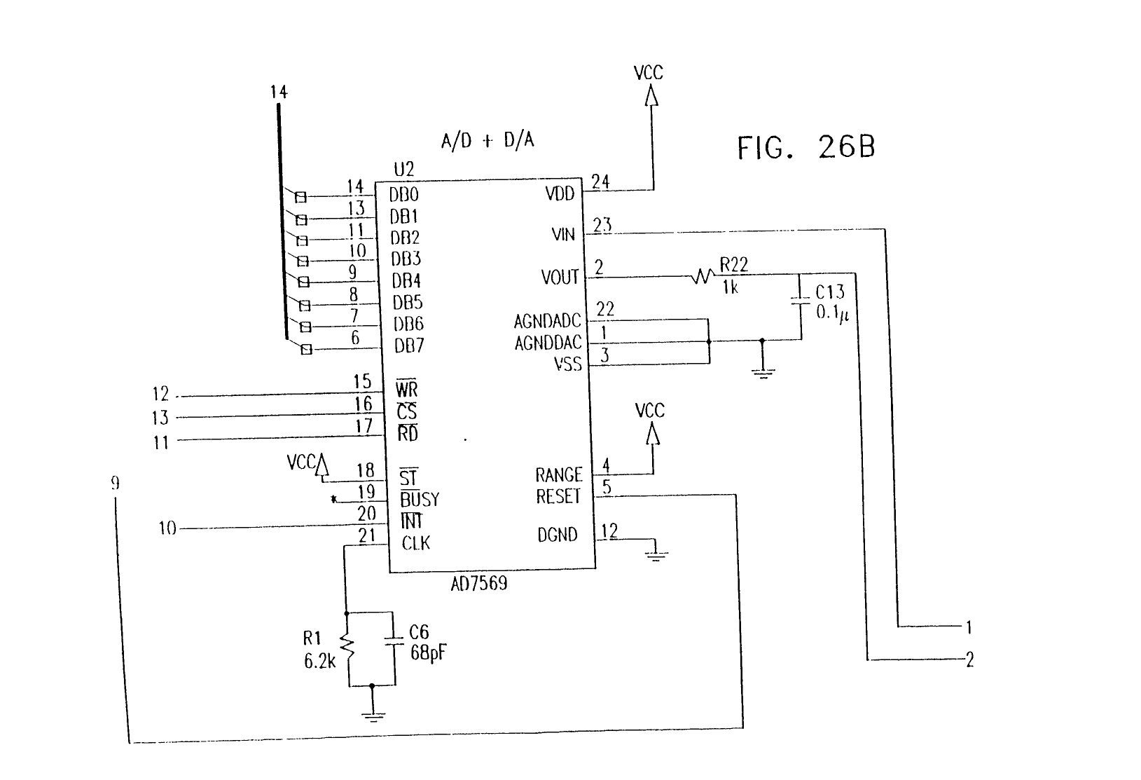

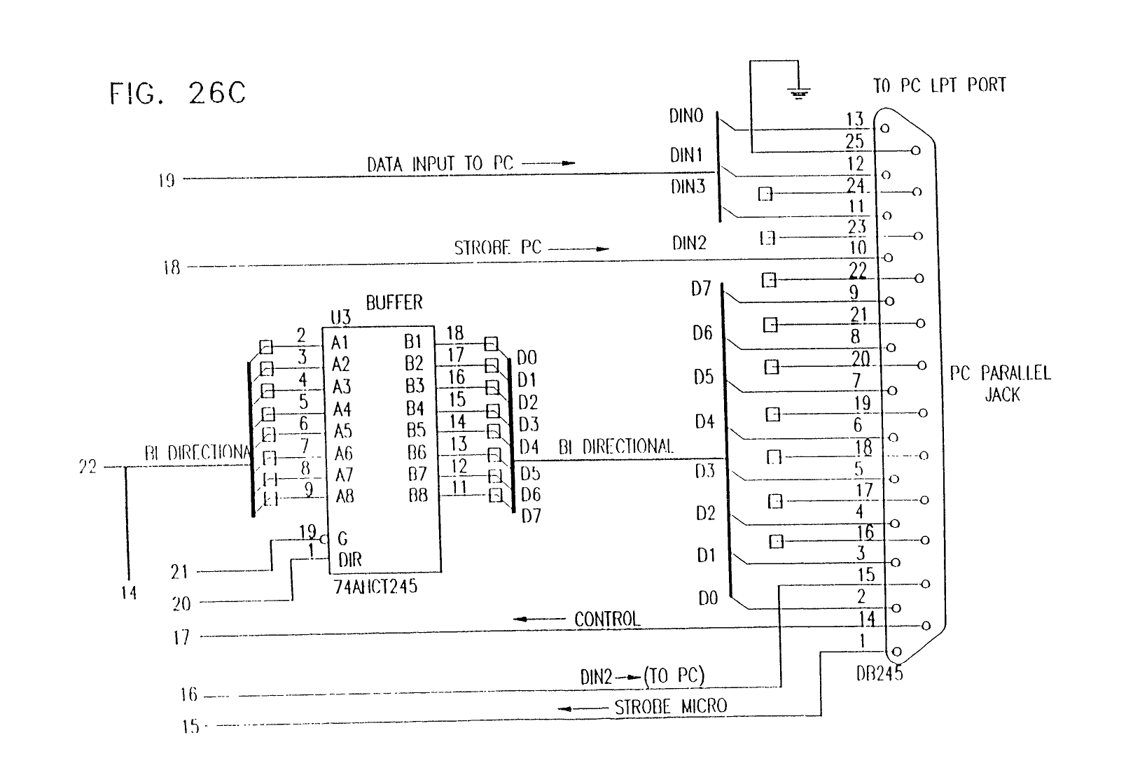

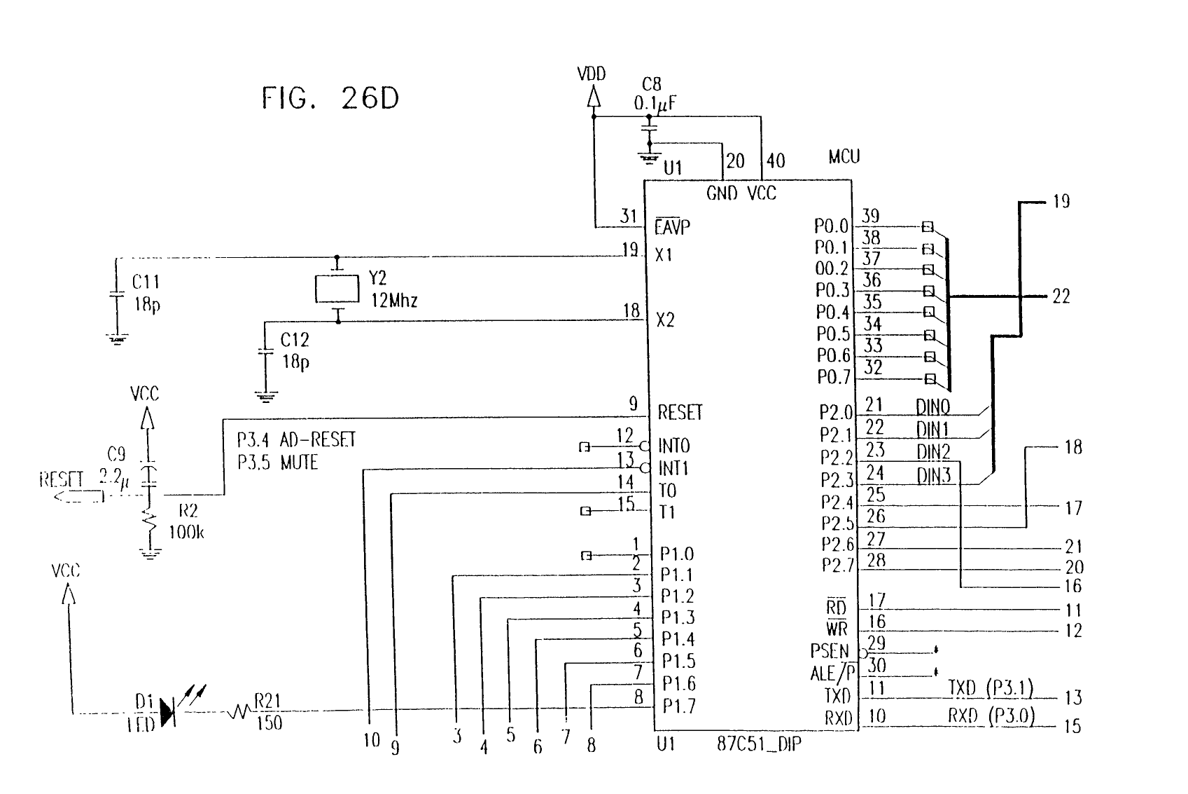

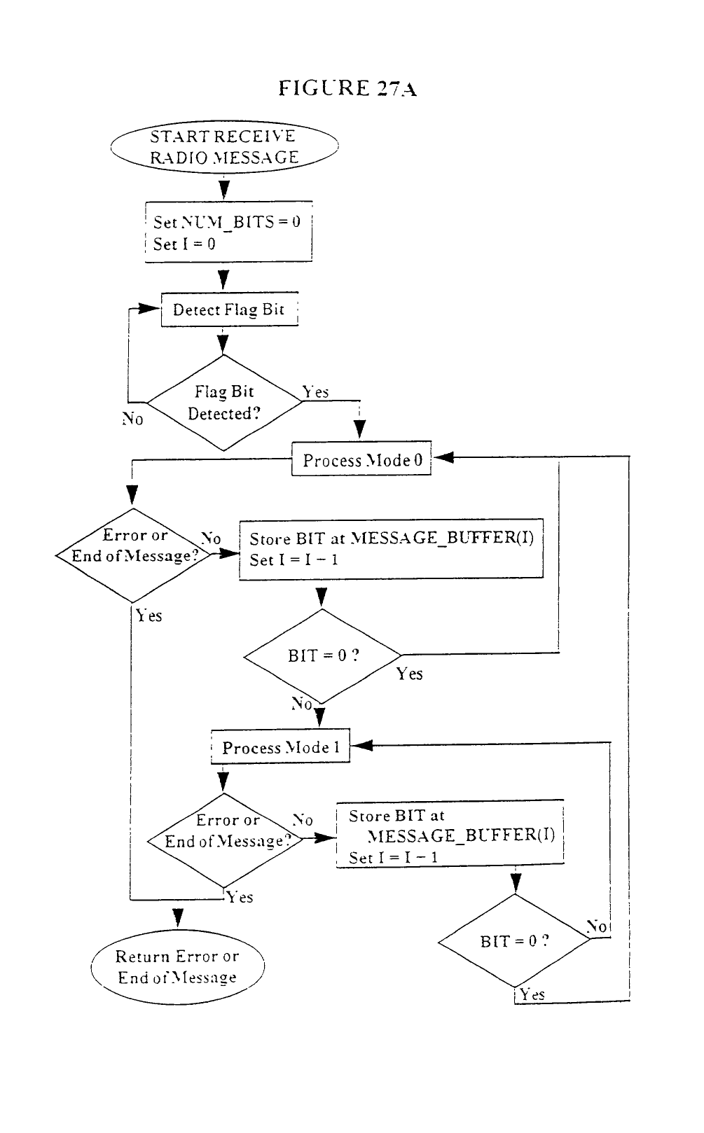

FIGS. 26A-26D, taken together, form a detailed schematic illustration of a computer radio interface which connects to a parallel port of a computer rather than to the sound board of the computer.

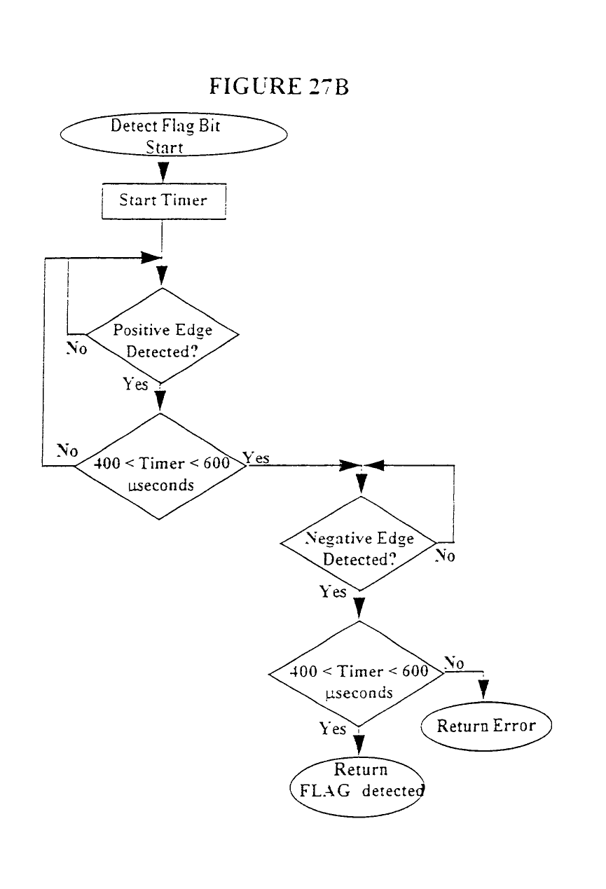

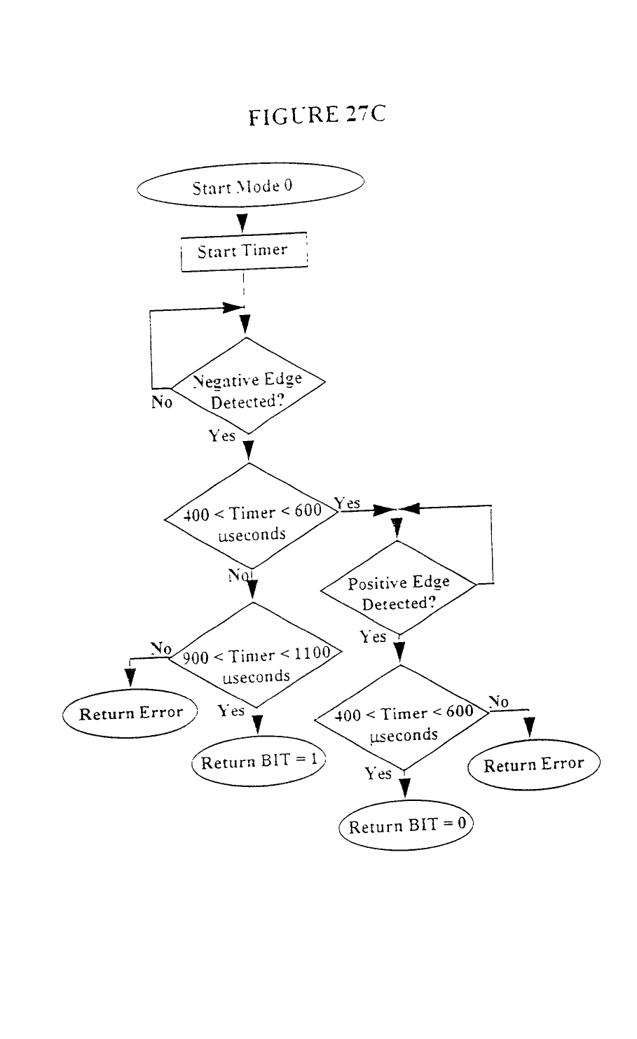

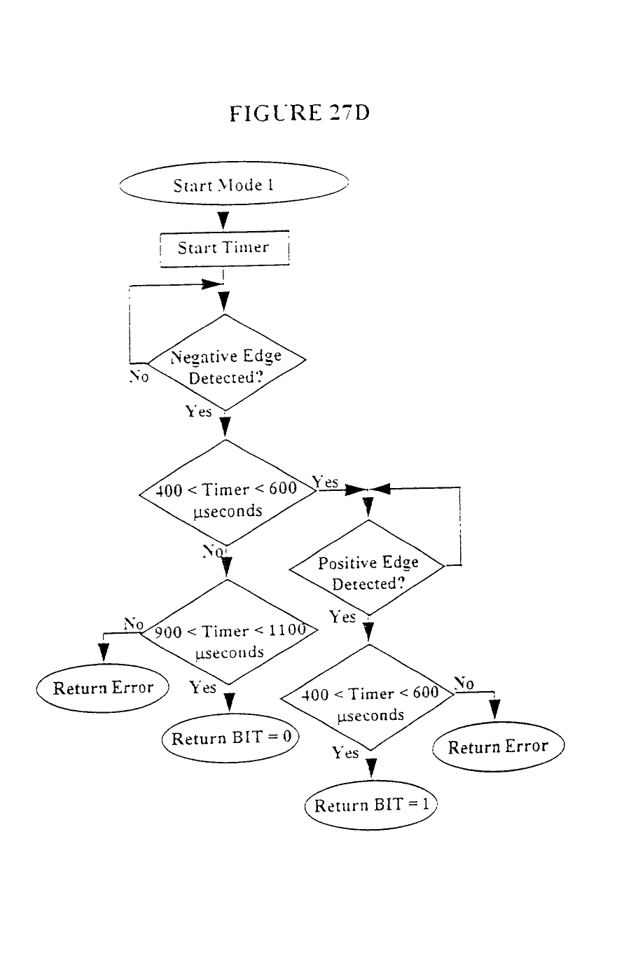

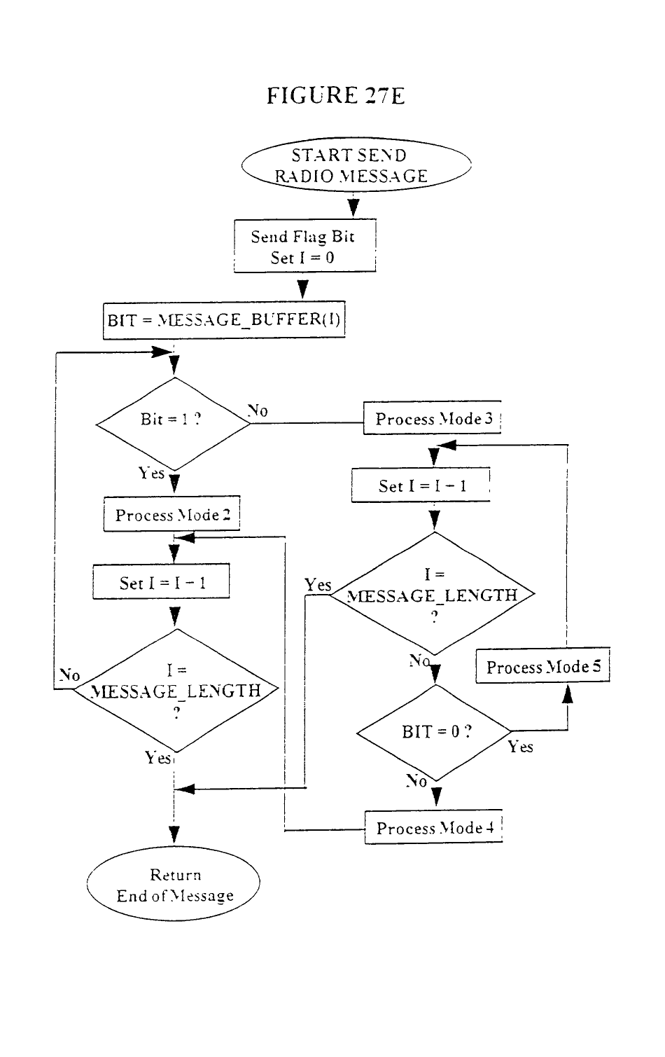

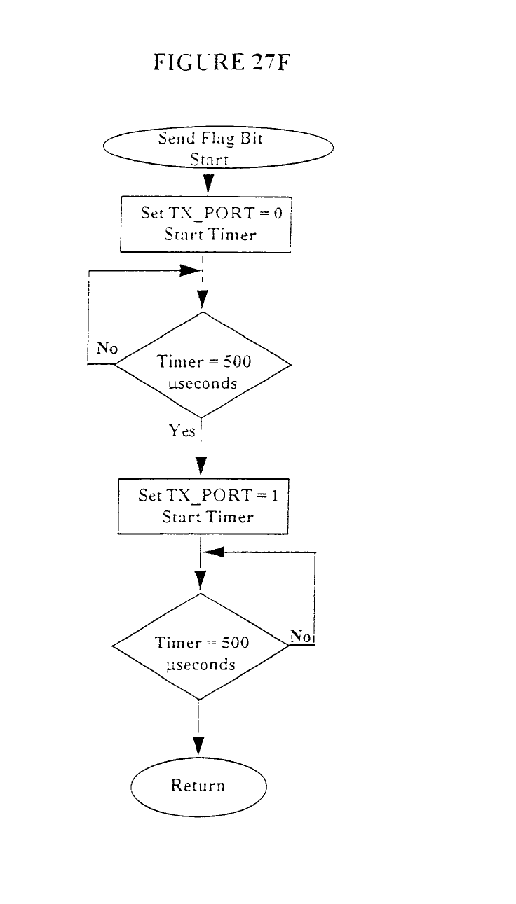

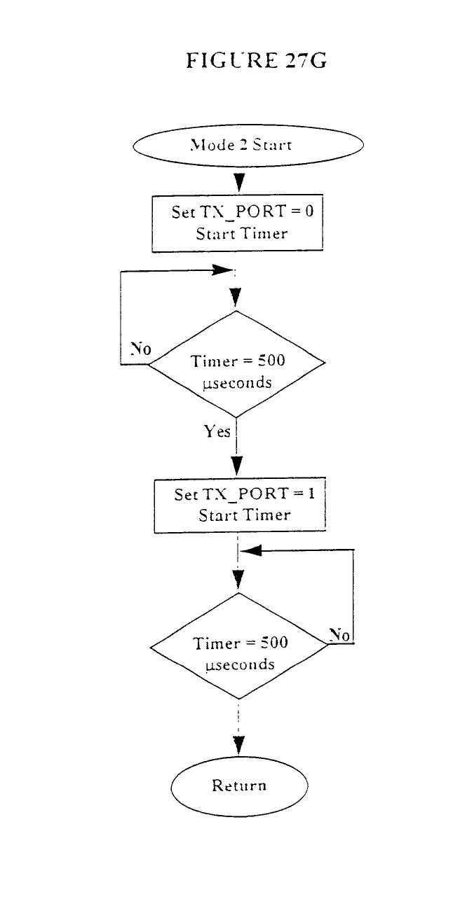

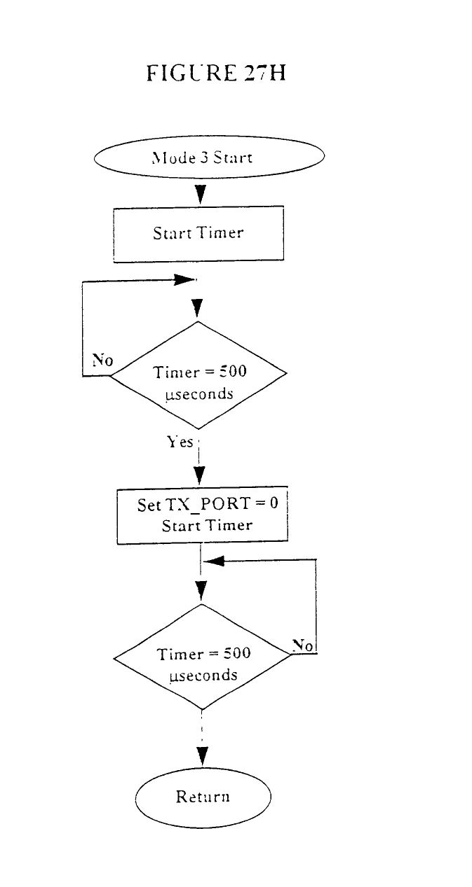

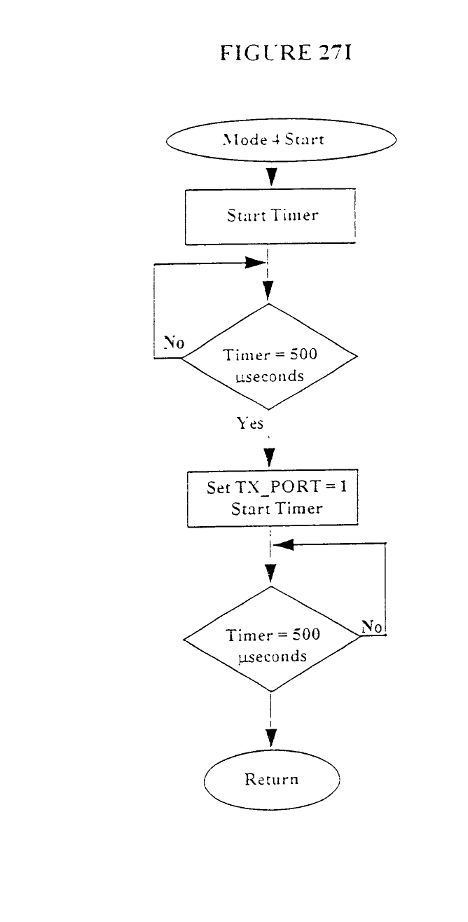

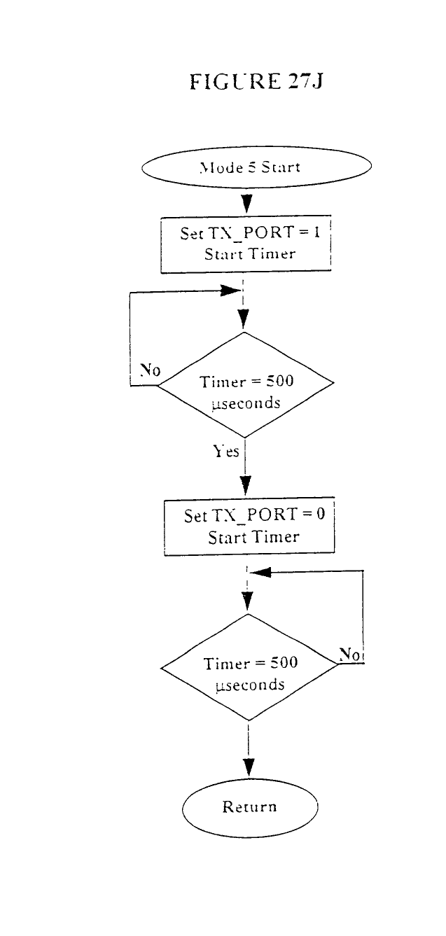

FIGS. 27A-27J are preferred self-explanatory flowchart illustrations of a preferred radio coding technique, based on the Manchester coding, which is an alternative to the radio coding technique described above with reference to FIGS. 8E, 8G-8M and 10A-C.

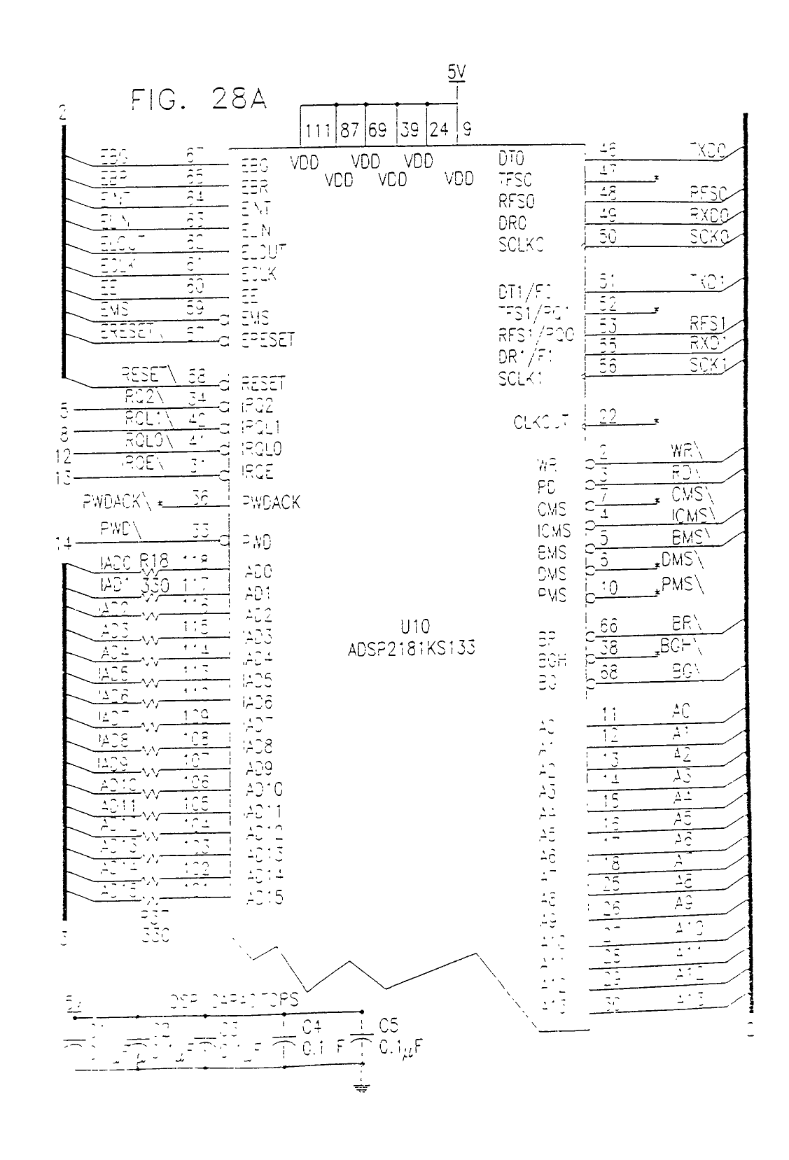

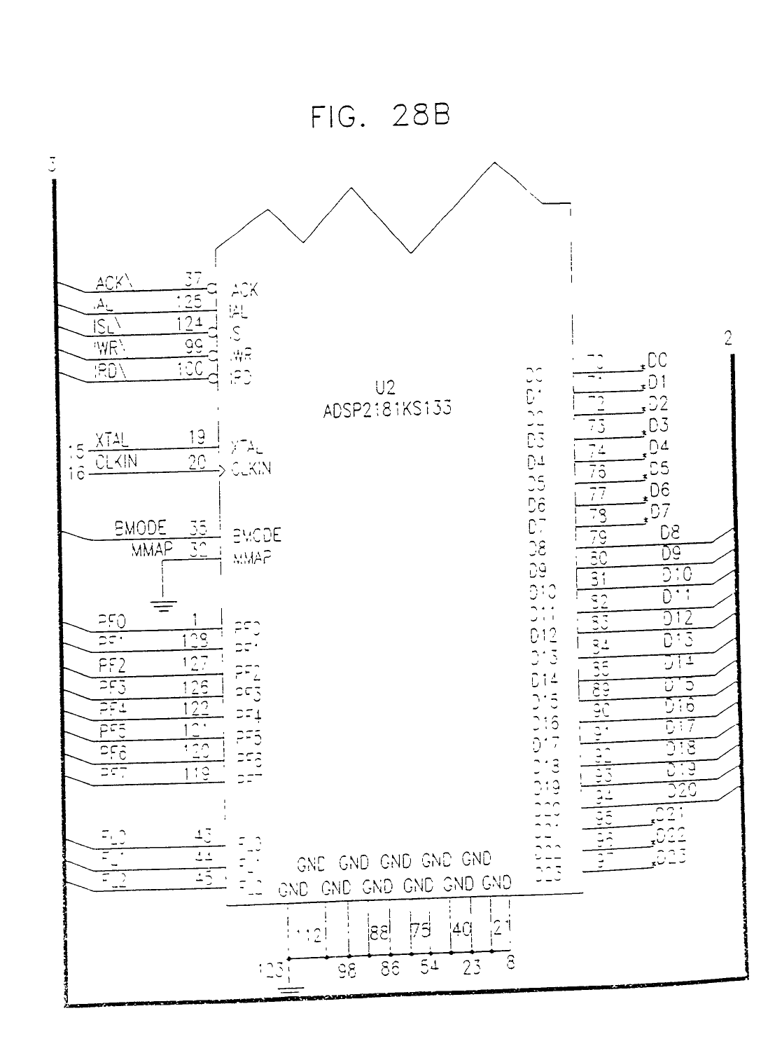

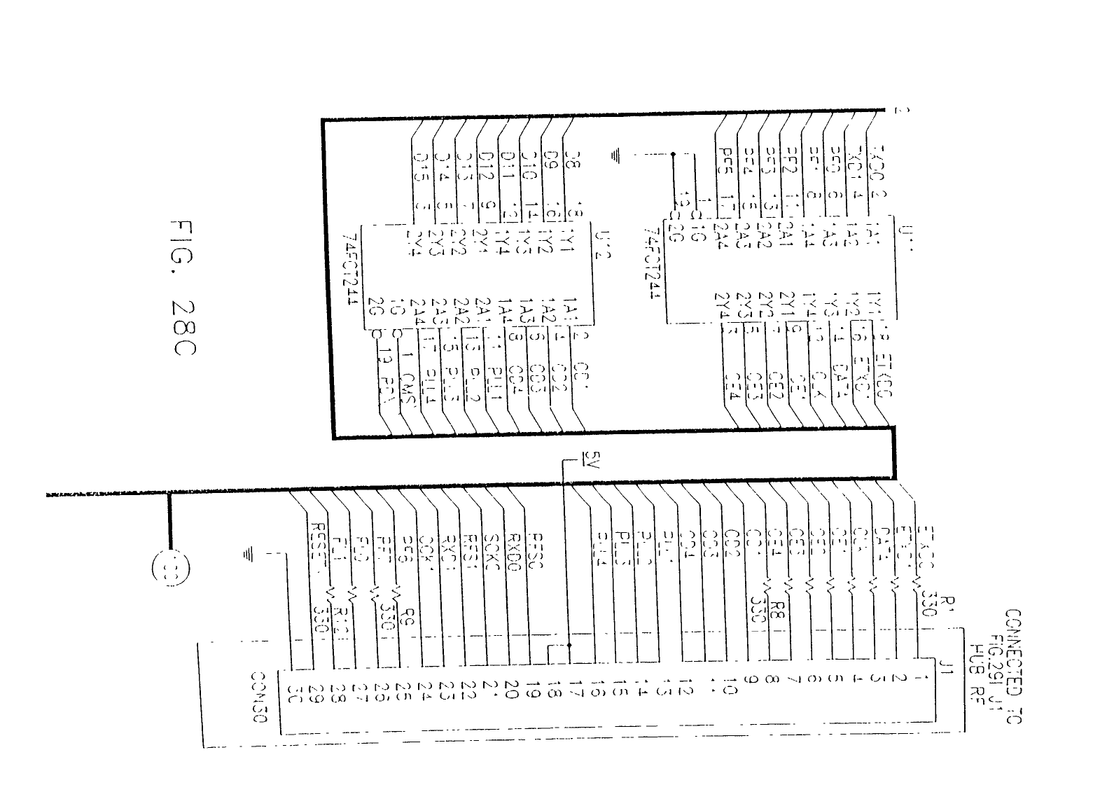

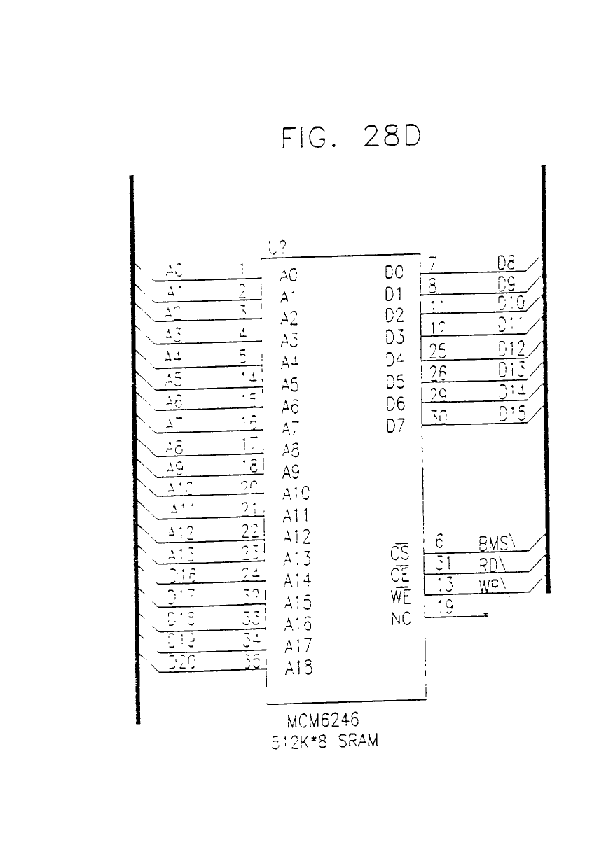

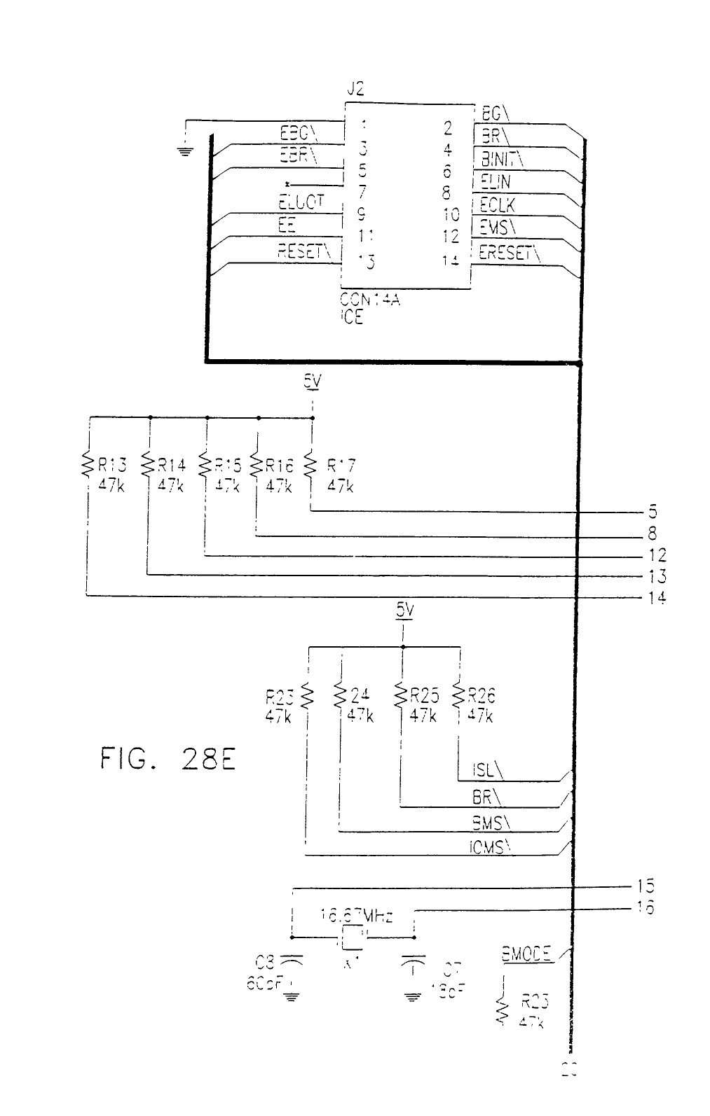

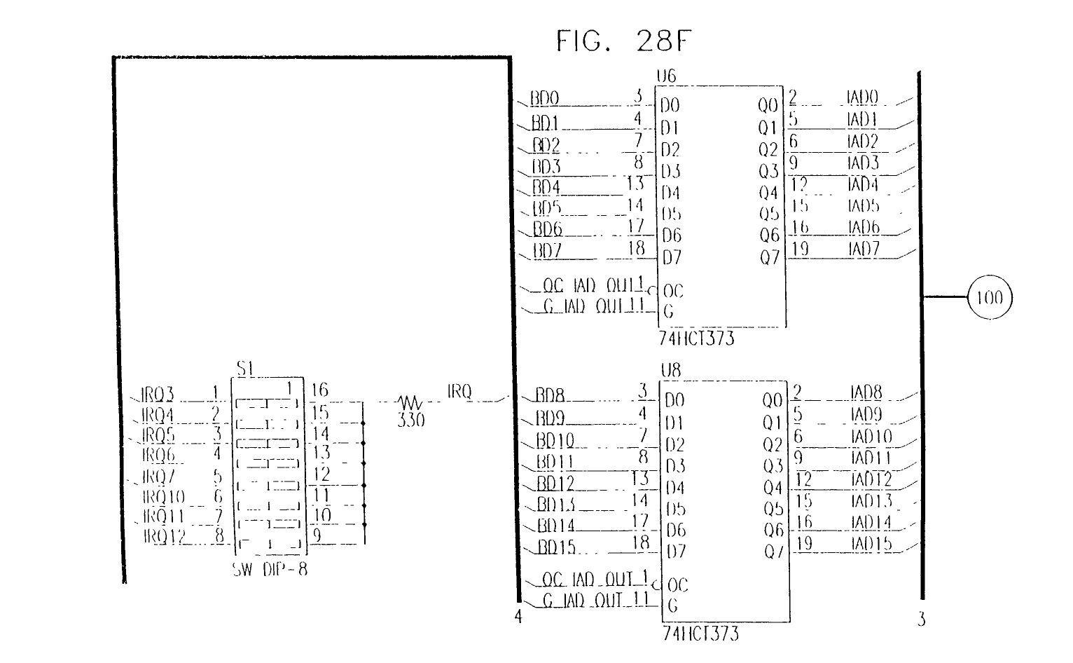

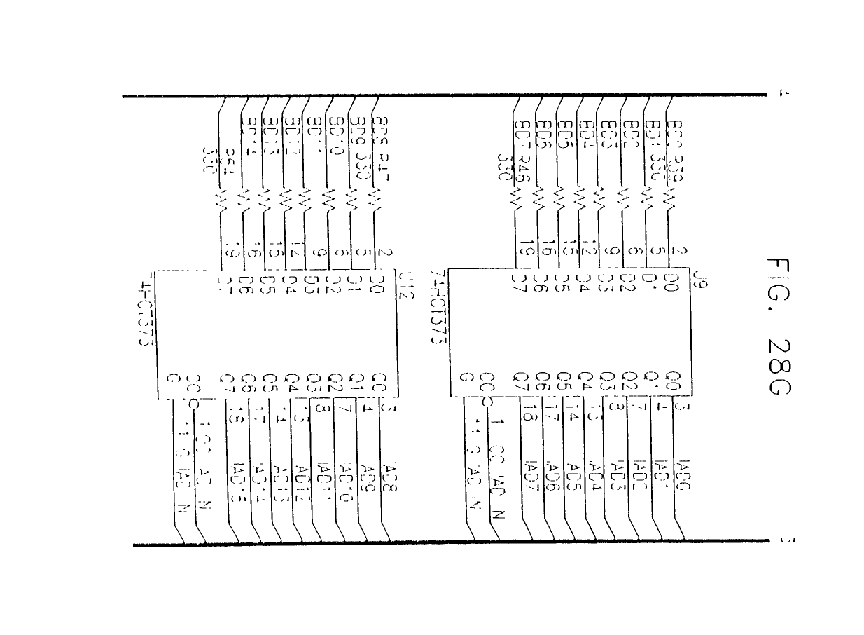

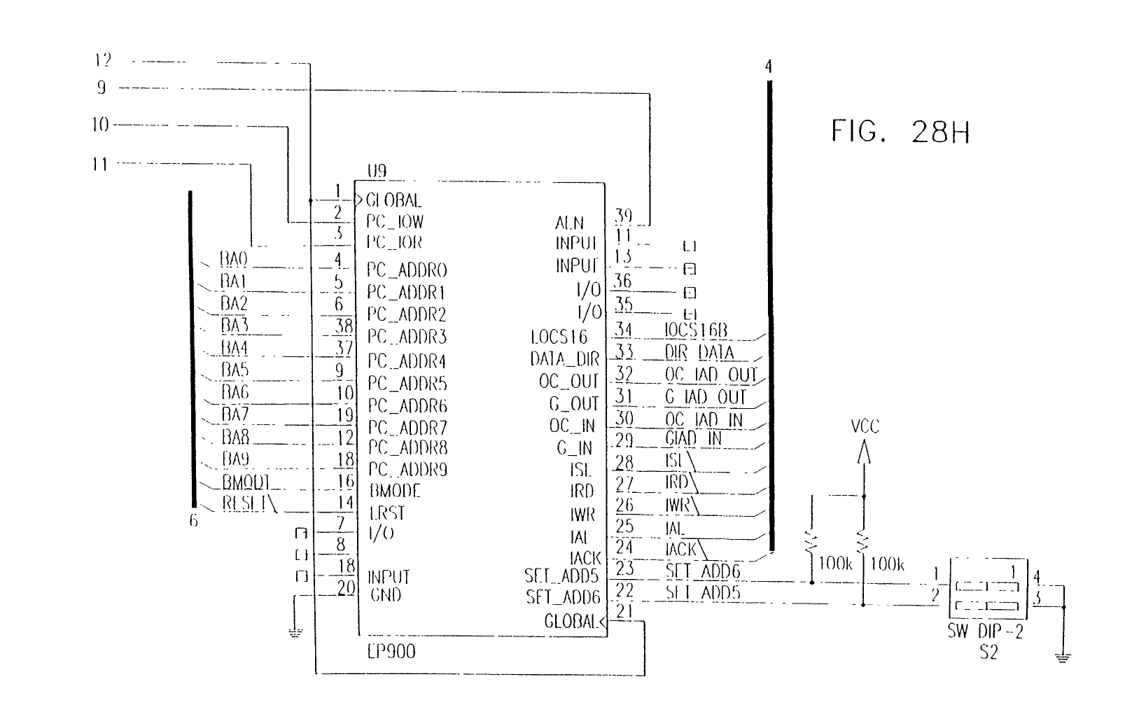

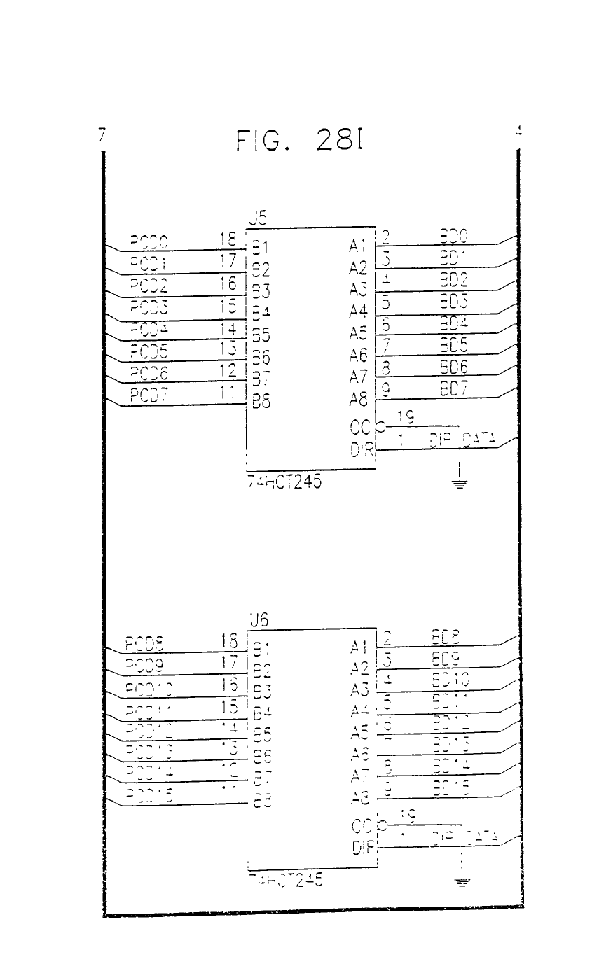

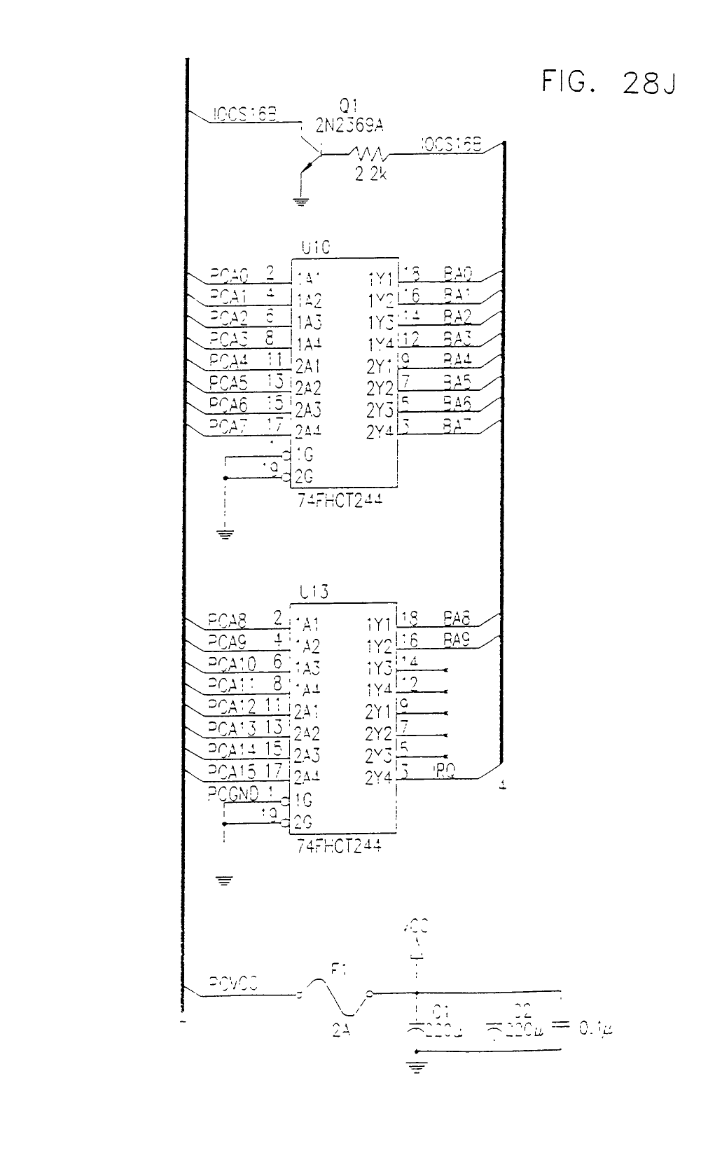

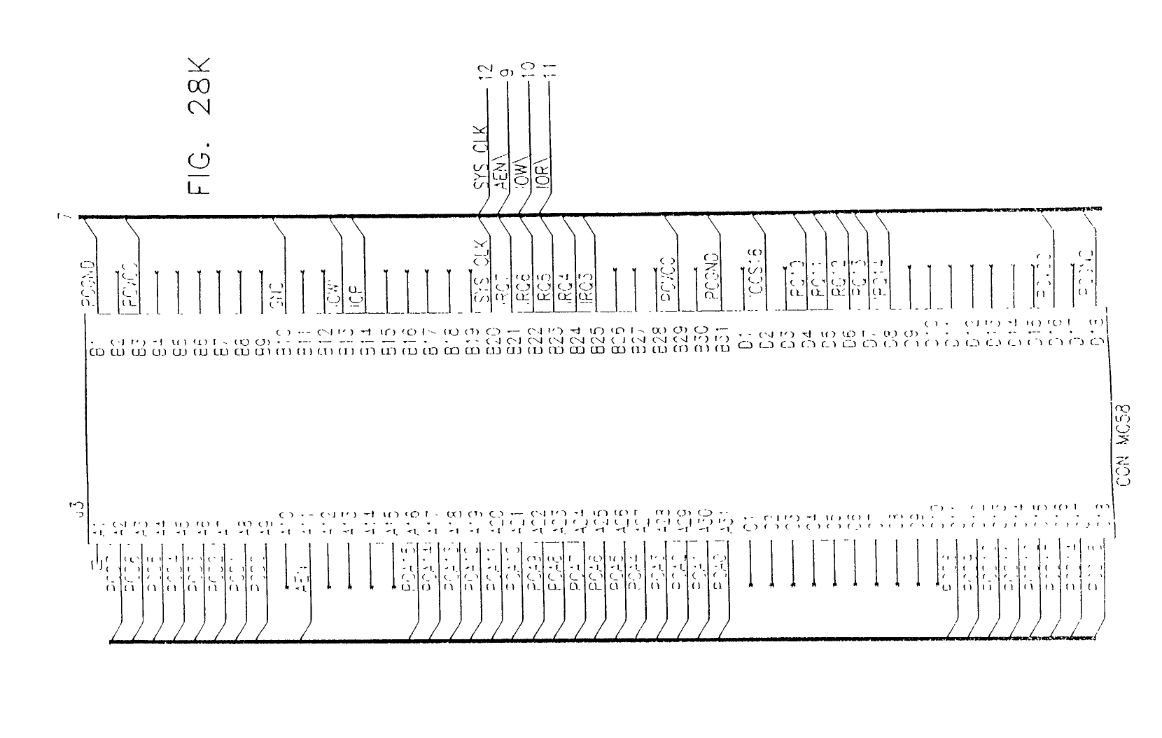

FIGS. 28A-28K, taken together, form a detailed electronic schematic diagram of the multi-port multi-channel computer radio interface sub-unit of FIG. 13.

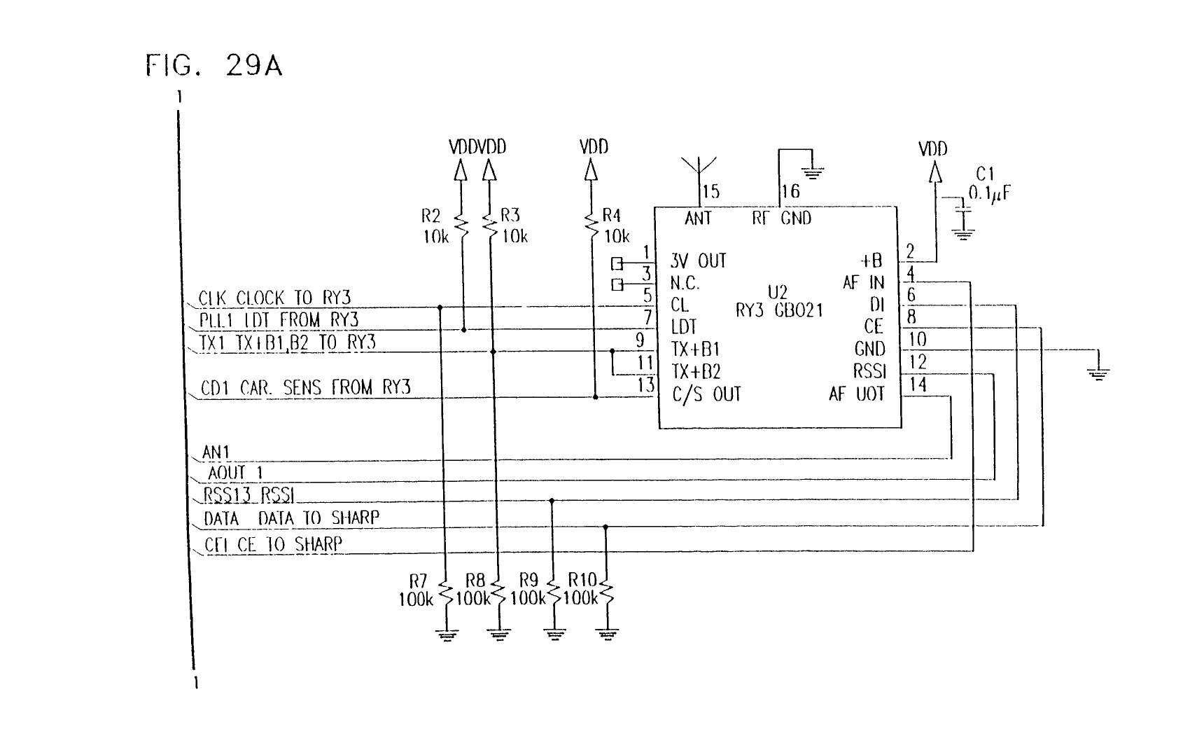

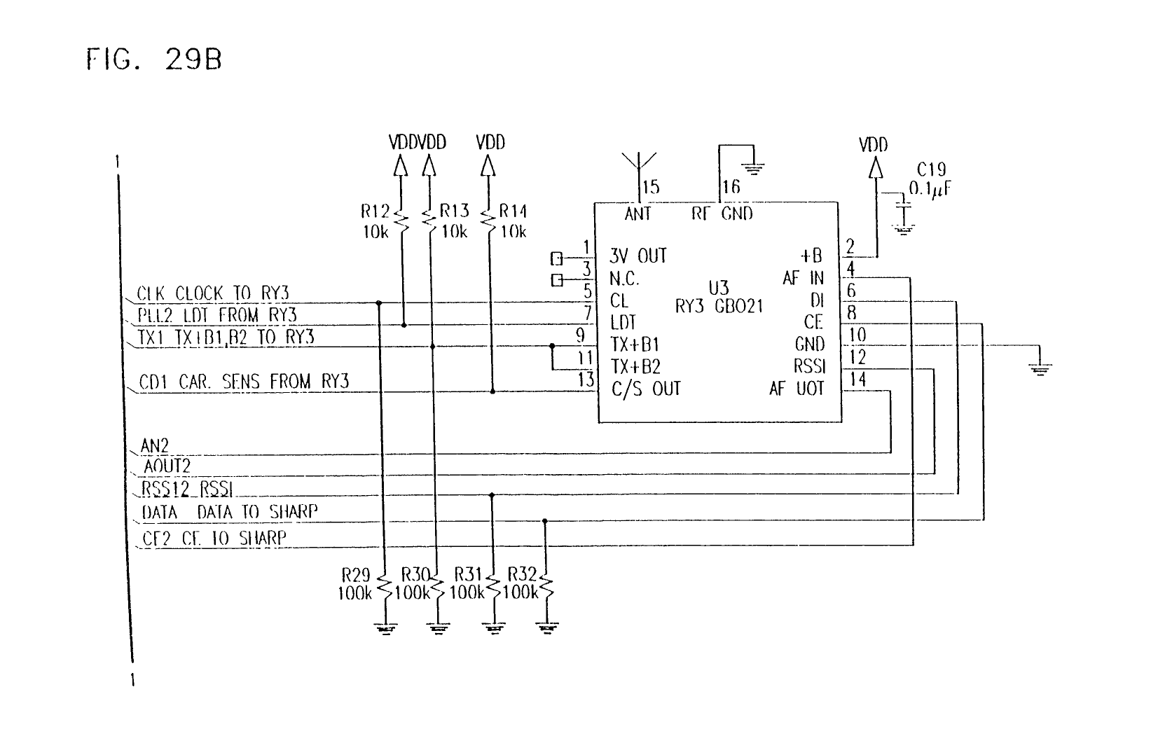

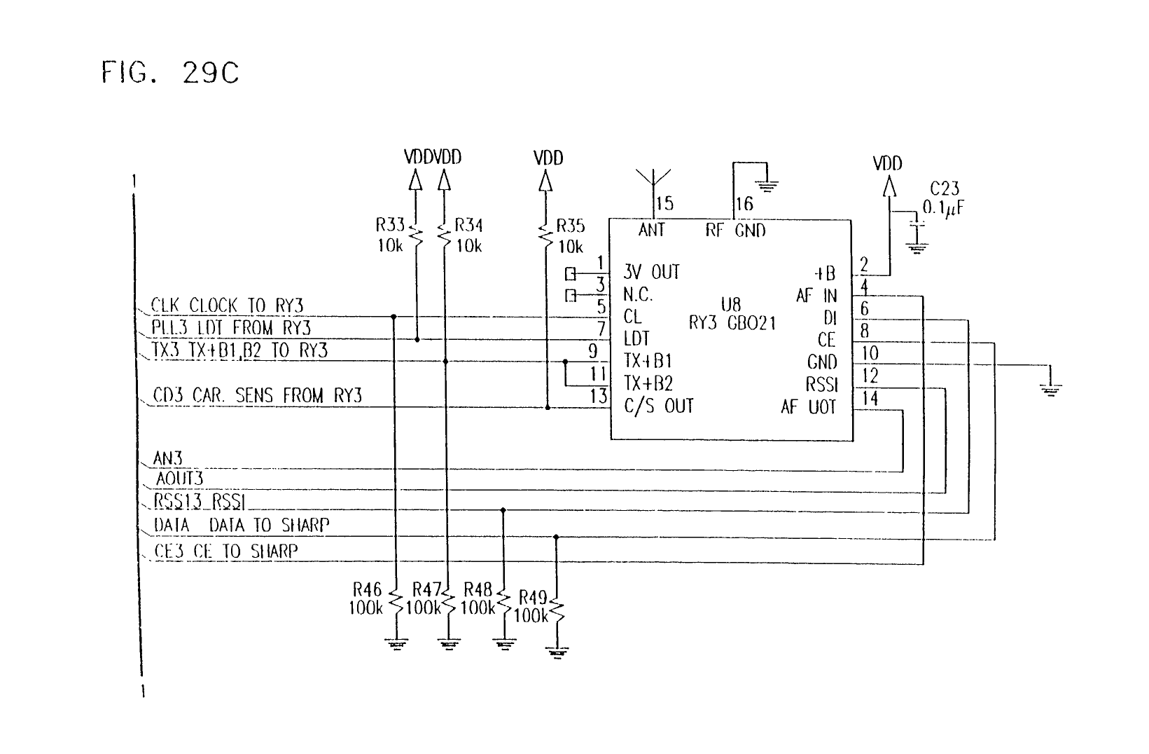

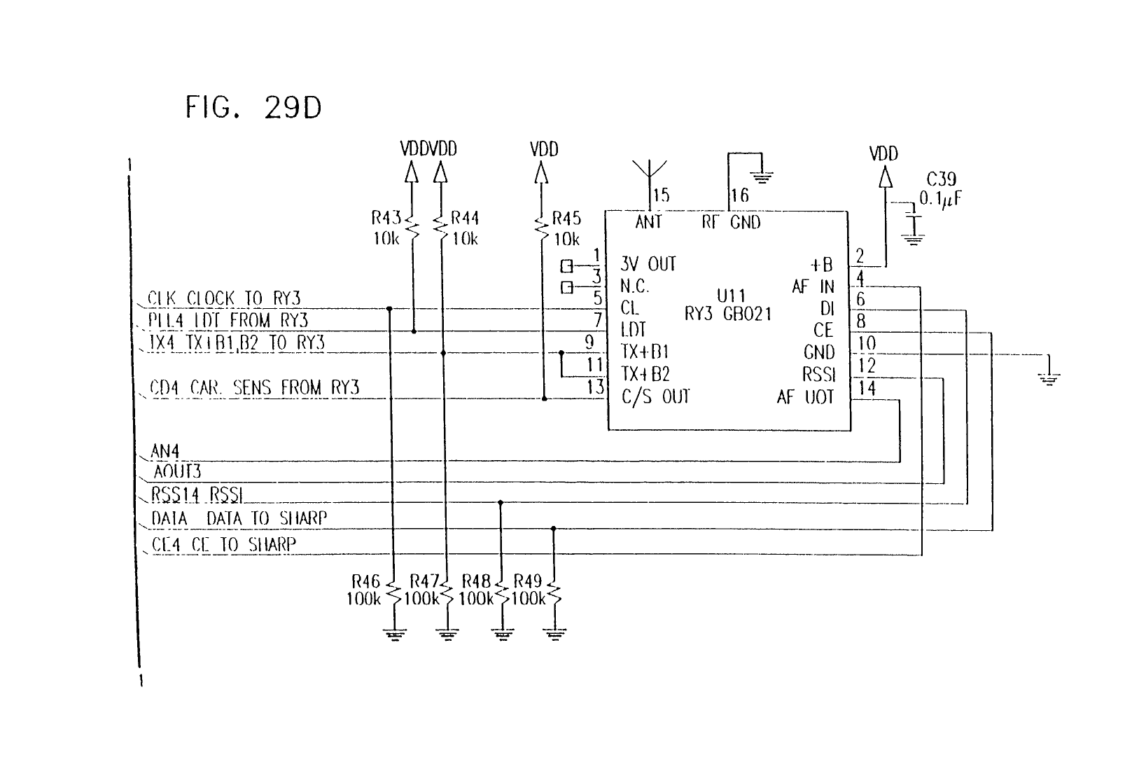

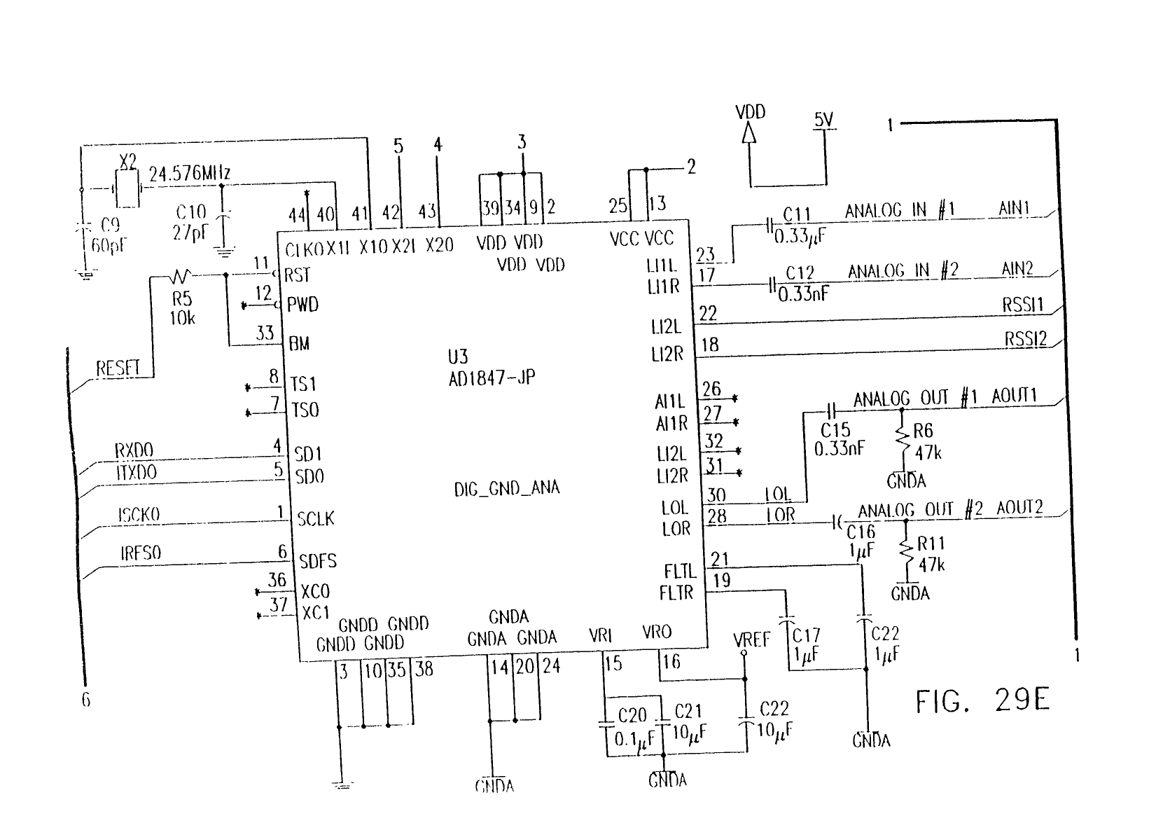

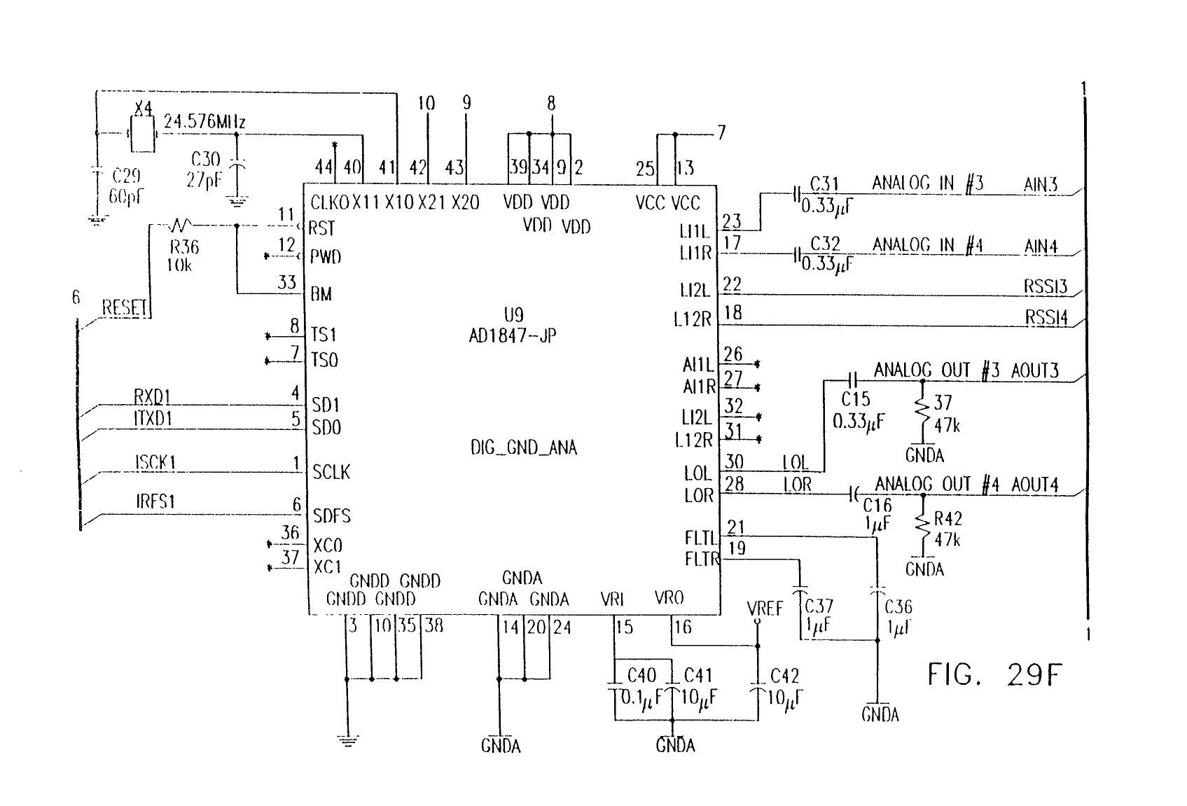

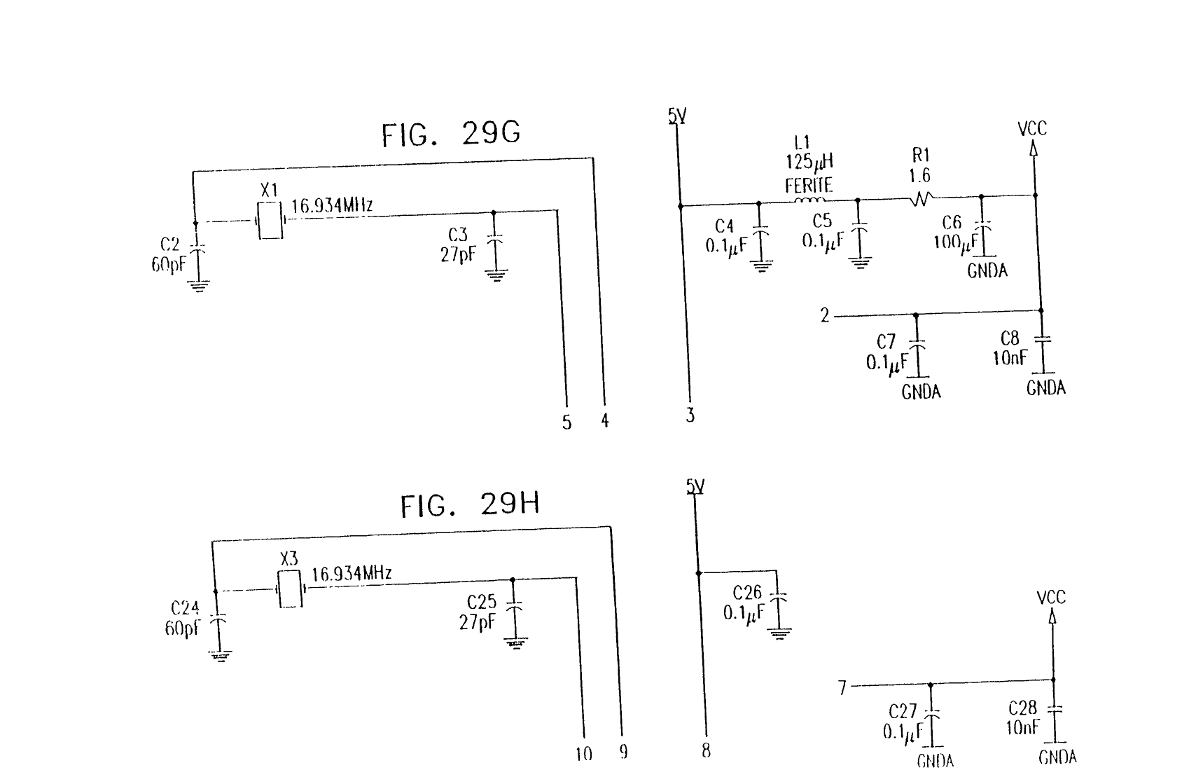

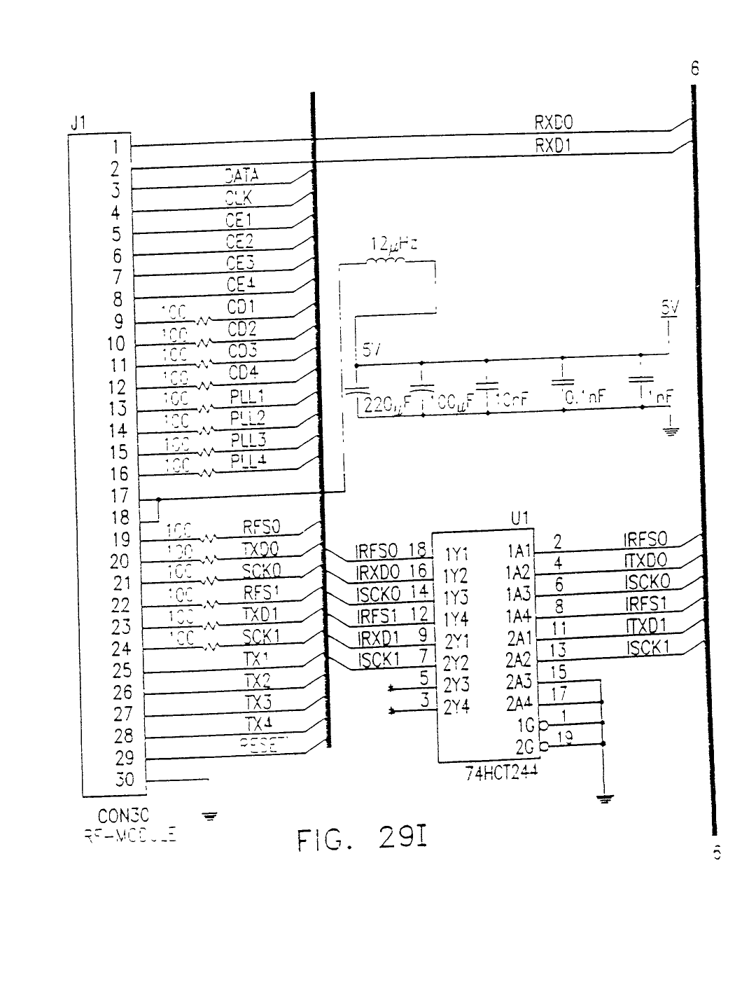

FIGS. 29A-291, taken together, form a detailed electronic schematic diagram of the multi-port multi-channel computer radio interface sub-unit of FIG. 14.

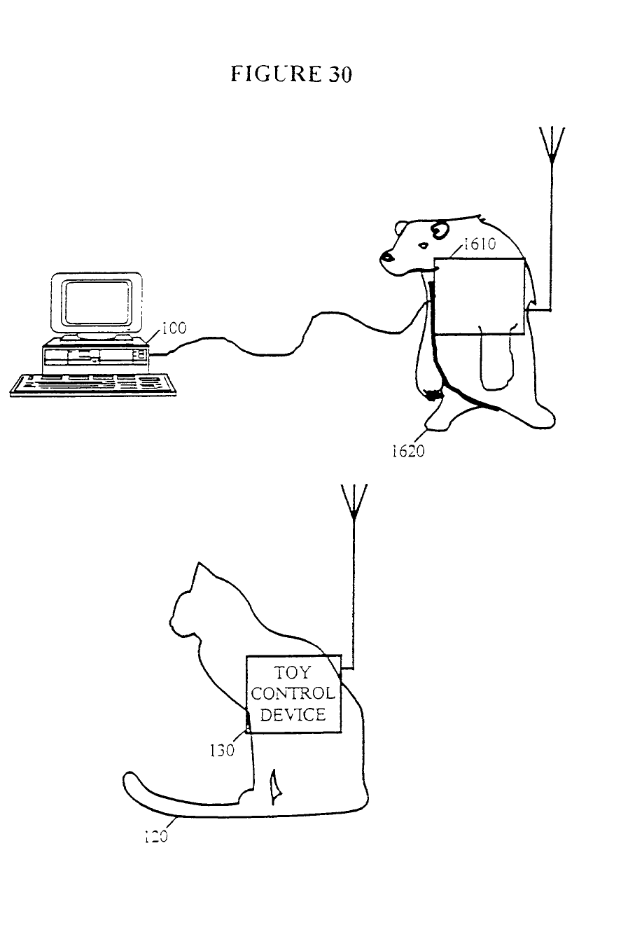

FIG. 30 illustrates a further embodiment of the present invention which includes a combination of a Computer Radio Interface (CRI) and a Toy Control Device (TCD), 1610.

The combined unit 1610 controls a toy 1620 which is connected to the computer 100 by a device, such as a cable, and communicates with other toys, 120, by means such as radio communication, using the computer radio interface 110. The toy 1620 is operated in a similar manner as the toy device 120.

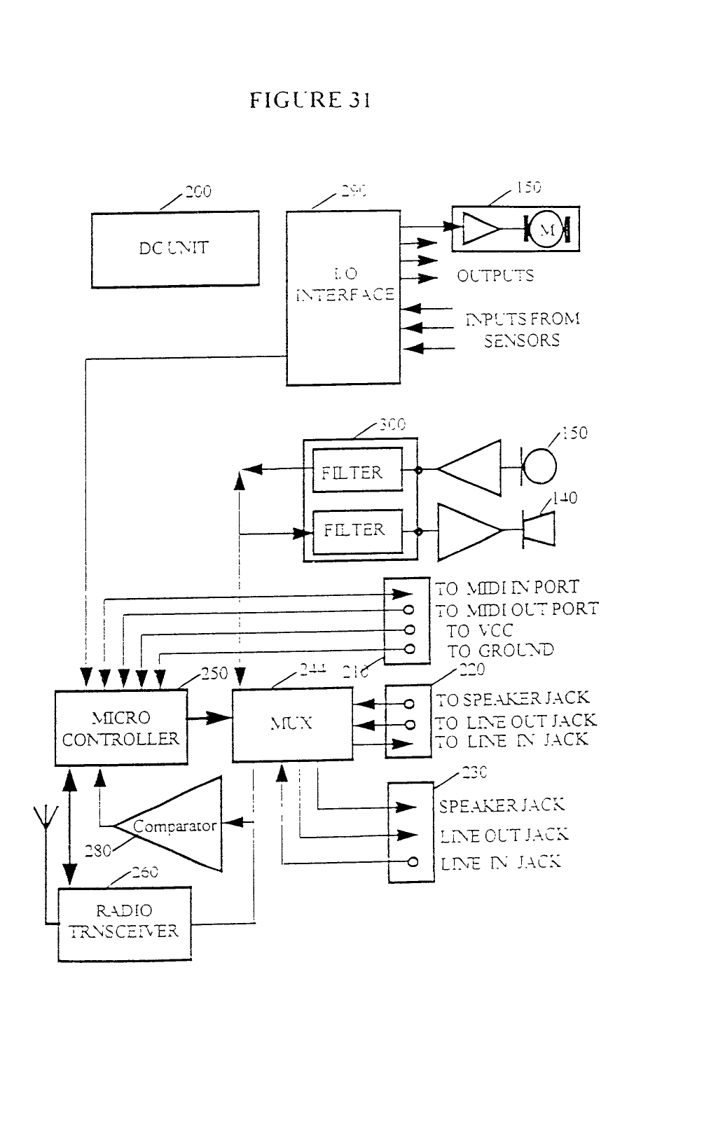

FIG. 31 illustrates a simplified block diagram of the combined unit 1610.

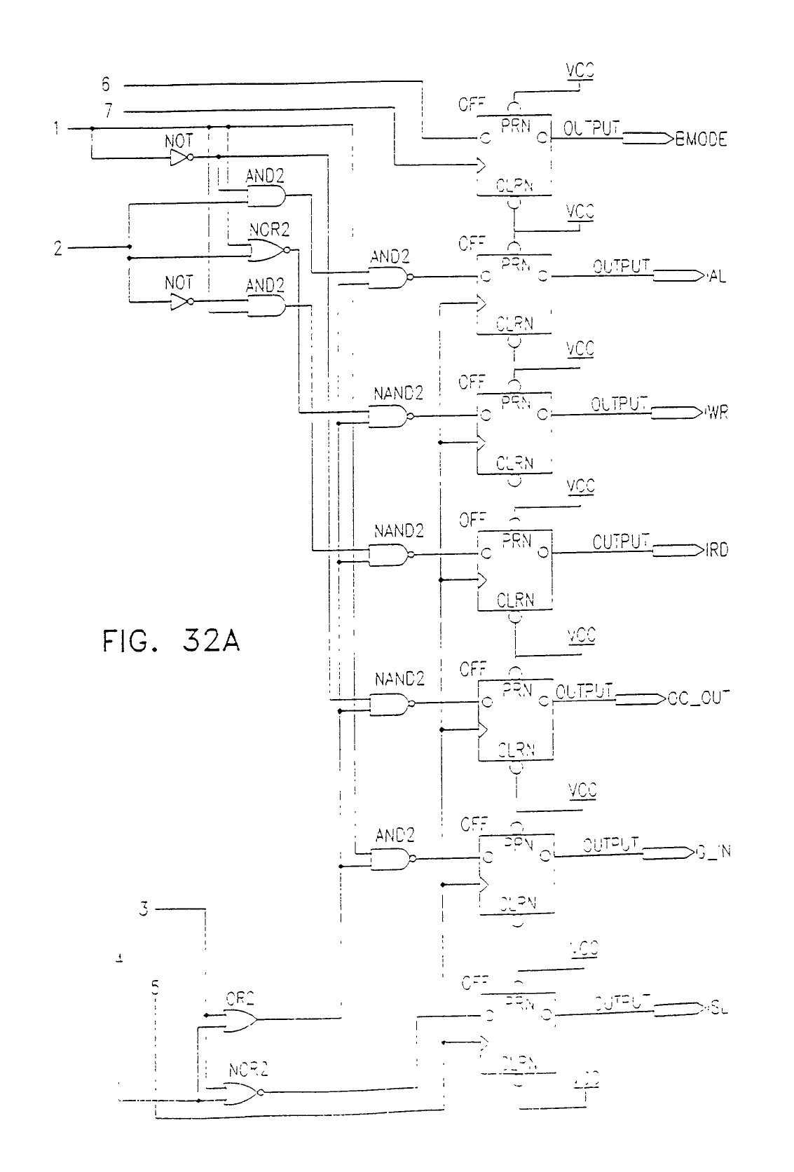

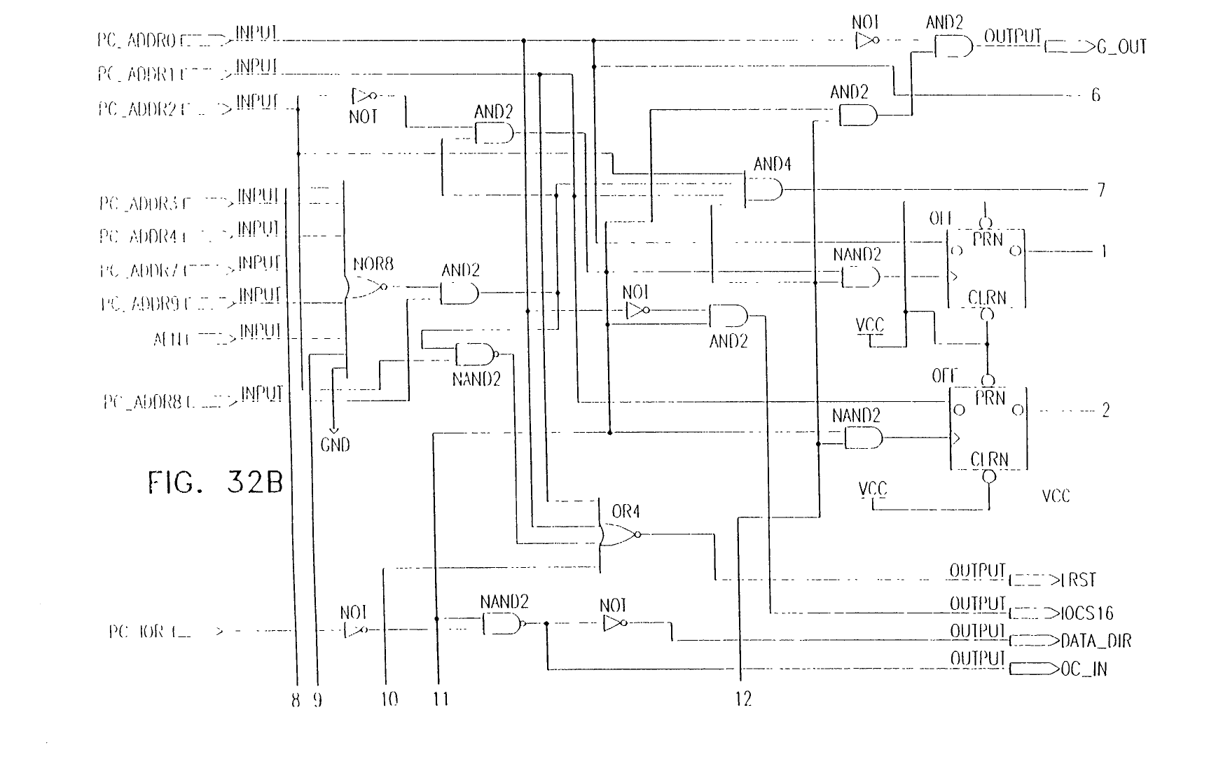

FIGS. 32A, 32B and 32C taken together form a simplified schematic diagram of the EP900 EPLD chip (U9) of FIG. 28H. The code to program the EPLD chip for this schematic diagram preferably uses the programming package “Max Plus II Ver. 6.2” available from Altera Corporation, 3525 Monroe Street, Santa Clara, Calif. 5051, USA.

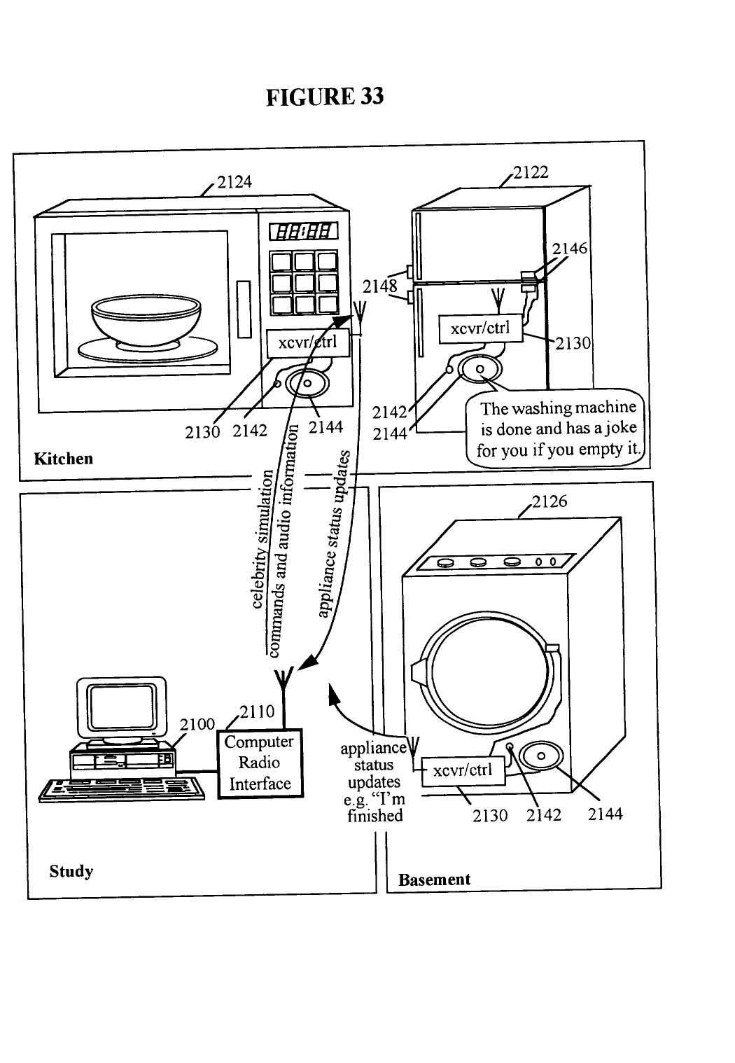

FIGS. 33-53, described hereinbelow, illustrate various embodiments of the toy system of FIGS. 1-32C.

FIG. 33 is a pictorial illustration of personified household appliances associated with a central computer 2100 by means of two-way wireless communication, typically via a computer radio interface 2110 associated with the computer and an appliance control device 2130, also termed herein transceiver/controller 2130, associated with a household appliance 2126. Suitable computer control provides a wide variety of personified household appliances such as but not limited to the following embodiments described in detail below: a refrigerator 2122 operating as a diet-mate, a microwave oven 2124 simulating a celebrity and a washing machine 2126 providing verbal or non-verbal humor or other entertainment. Each transceiver/controller 2130 is preferably associated with a suitable combination of electromechanical accessories such as microphones 2142, speakers 2144, switches 2146 and solenoids 2148.

According to one embodiment of the present invention, the presence of a user in a particular room is sensed and audio messages to the user from any one of the appliances throughout the house are provided by an appliance in that room, via the computer 2100. Any suitable method may be used to sense the user's presence in a particular room such as voice recognition, volume detection, or bidirectional paging. The user may optionally attach a conventional personal locator, e.g. a IR badge, to his clothing or body such that his or her adjacency to a particular appliance may be sensed and the loudspeaker of that appliance may then be used to convey to the user information regarding that appliance or any other appliance in the household.

Alternatively, audio messages are broadcast to the user from all appliances in the house. It is appreciated that providing a loudspeaker in association with appliances is cost-effective relative to providing separate loudspeakers mounted in rooms and not in association with appliances. Each such loudspeaker would need to be associated via wire with the central computer 2100 or alternatively would need to be associated with a transceiver/controller.

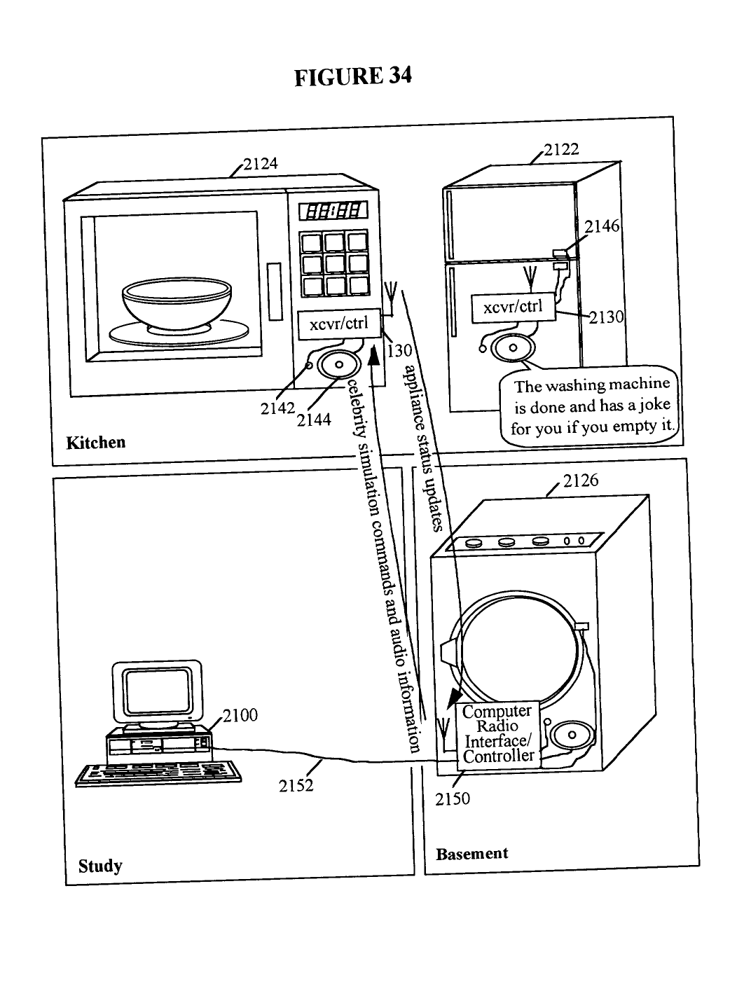

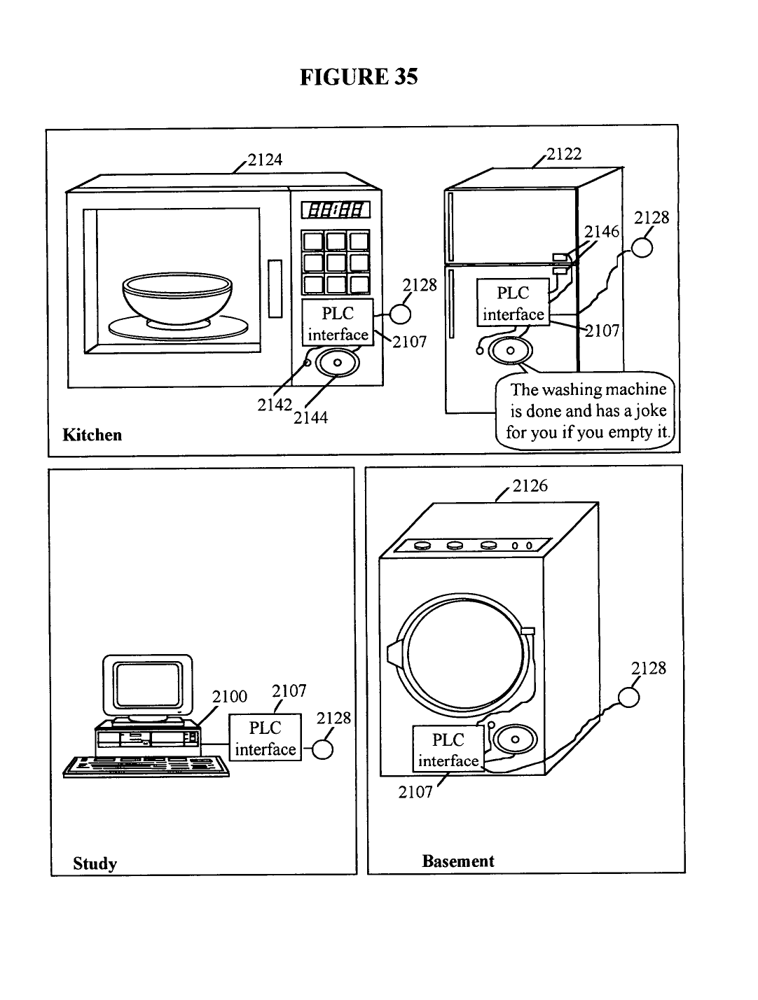

Communication between appliances and central computer 2100 as well as, preferably, communication between the appliances themselves may be either wireless (FIG. 33) or custom-wired (FIG. 34) or by means of PLC (power line carrier) i.e. the household's existing electrical wiring system (FIG. 35), such as the PLC2.5-4.0/20W system, manufactured by Intracom SA, Greece and the PLC system ACE32, manufactured by Neva, Norway. Wireless communication may be implemented by means of any suitable technology such as radio wave technology or infra-red wave technology. Preferably the radio system of the present invention is based on the following: Spread Spectrum Transceivers, AIC9001 with IRF9085DS, available from ALFA INCORPORATED, No. 15-1, Industry East Road.IV, Science-Based Industrial Park, Hsinchu, Taiwan, R.O.C.

Preferred implementations of computer radio interface 2110, some of which are operative in conjunction with an associated audio card (sound board) installed in computer 2100, are described hereinabove with reference to FIGS. 1-32C. Preferred implementations of transceiver/controller 2130, are also described hereinabove with reference to FIGS. 1-32C. It is appreciated that many modifications of the apparatus shown and described hereinabove with reference to FIGS. 1-32C are possible. For example, in the embodiment of FIGS. 6 and 7A-7F; and FIGS. 15A-15E, the motor 150 and the tilt switch 140 may be omitted.

It is appreciated that the game systems and toy system described in Appendix A can be implemented by using a home's appliances as games or causing the home appliances to function as toys. Preferably, the central computer is programmed to sense the presence of appliances and to adapt the game program so as to incorporate into the game a newly sensed appliance.

FIG. 34 is a pictorial illustration of a modification of the apparatus of FIG. 33 in which a first appliance 2126 is associated by means of a wire with the computer 2100 and other appliances 2122, 2124 communicate with the computer 2100 via the first appliance 2126, communication between the first appliance 2126 and the other appliances 2122, 2124 being wireless. Specifically, a first household appliance, such as a washing machine 2126, is associated by means of a wire with a computer 2100 and serves as a transceiver for transmitting commands and audio information to additional household appliances wirelessly associated with the first household appliance such as a refrigerator 2122 and a microwave oven 2124.

In FIG. 33, the computer radio interface 2110 provides celebrity simulation commands and audio information to the transceiver/controller 2130 of the microwave oven.

In FIG. 34, in contrast, the celebrity simulation commands and audio information are transmitted between appliances and a combined computer radio interface- transceiver/controller 2150 of the washing machine 2126. Combined unit 2150 is in turn associated by means of a wire 2152 with the computer 2100.

A preferred implementation for combined unit 2150 is described hereinabove with reference to FIG. 31.

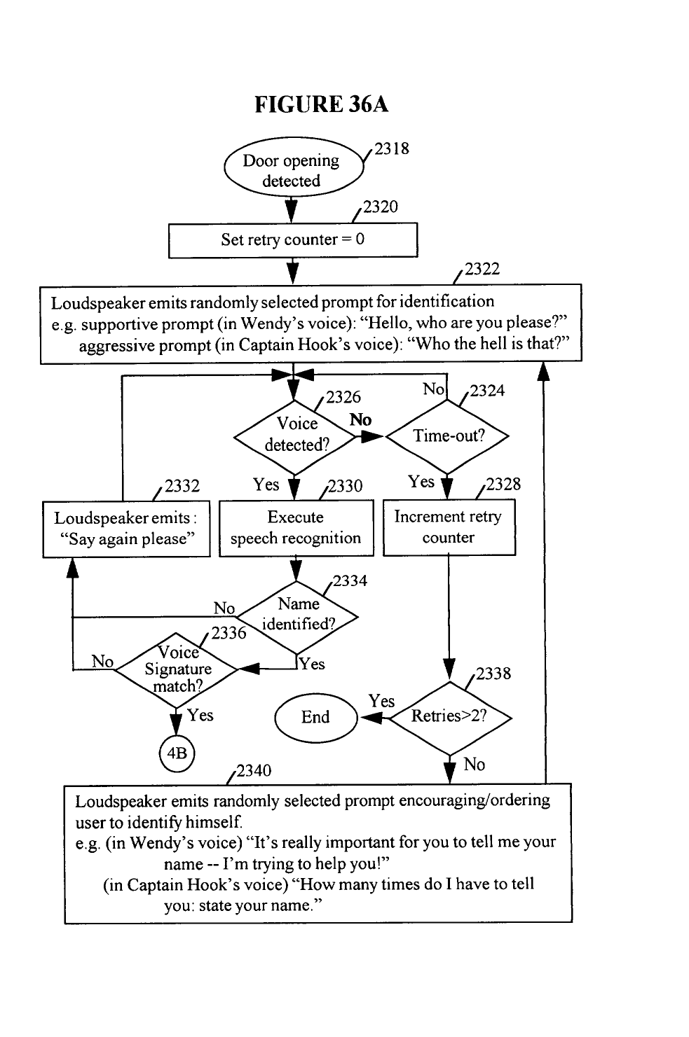

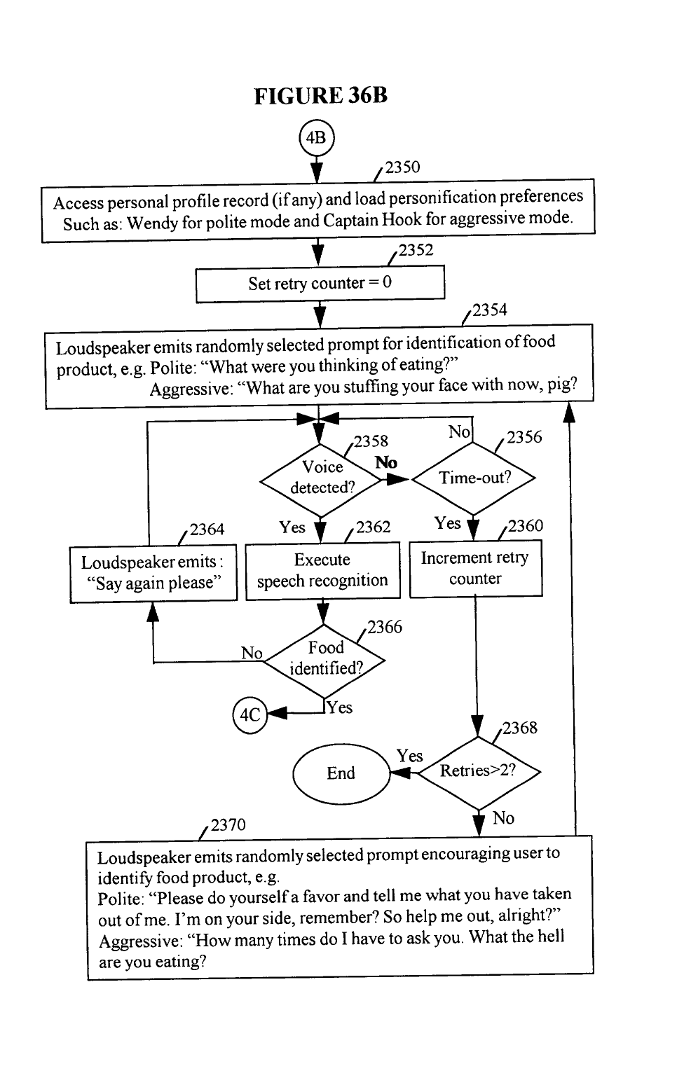

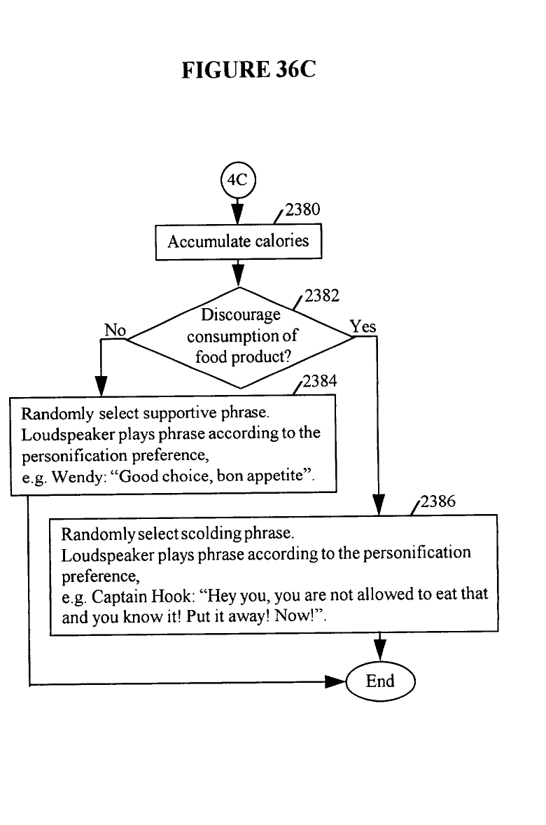

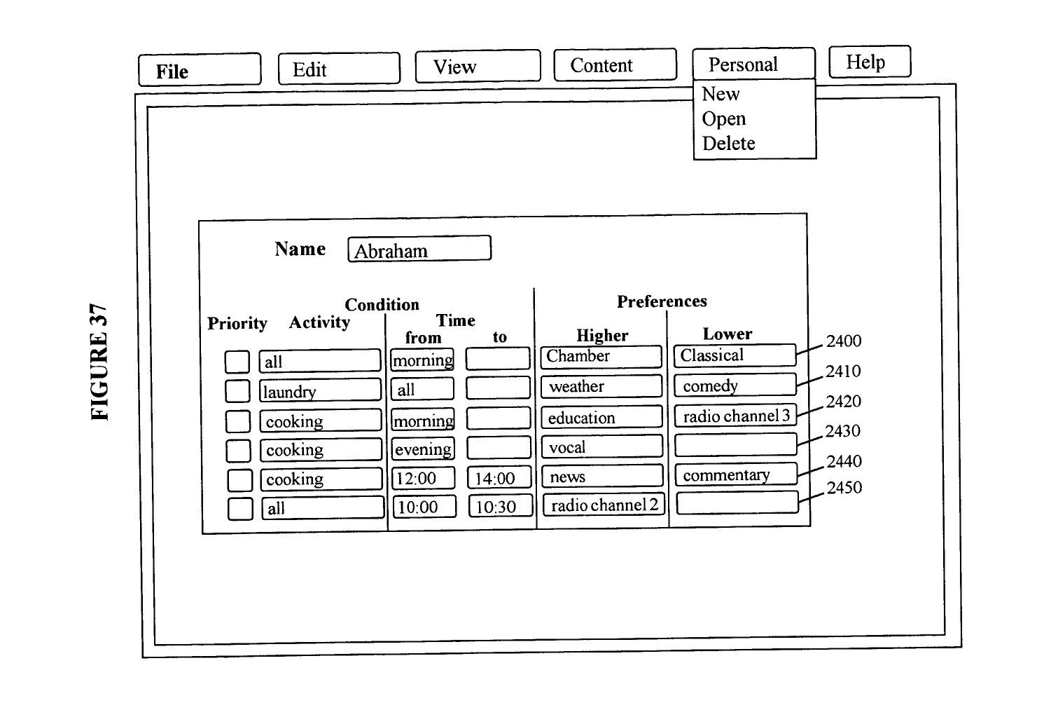

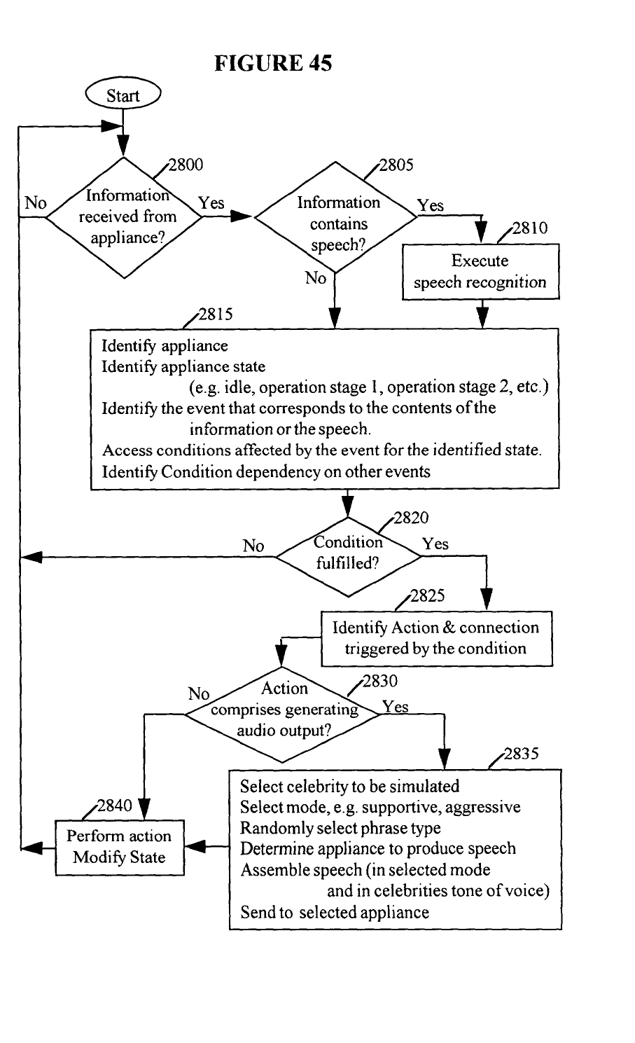

The microwave oven 2124 may, for example, simulate a celebrity in the sense that voice messages pertaining to the microwave oven are given in the voice of a particular celebrity (FIG. 45). A particular advantage of giving voice messages pertaining to different appliances in the voices of different celebrities is that users of the appliances can learn to distinguish between messages “coming from” different appliances. This facilitates use of the appliances since an appliance delivering a voice message does not need to identify itself. Also, use of distinctive voices and mannerisms for different appliances enhances the perceived “personalities” of the various appliances. It is believed that granting a personality to an appliance can have a psychological effect on a user thereof, such as development of affection for the appliance, increased willingness to operate (interact with) the appliance and increased willingness to abide by suggestions provided by, or “decisions” made by the appliance, such as the diet-mate refrigerator described herein with reference to FIGS. 36A-36C.

According to a preferred embodiment of the present invention, an appliance simulating a particular celebrity is designed to resemble the celebrity. For example, a microwave oven simulating Pooh Bear might be green and have a Pooh Bear doll mounted thereupon.

Preferably, the voice messages or other characteristics of the microwave oven's behavior are designed to resemble the personality of the celebrity. It is appreciated that any and all of the appliances, including but not limited to the microwave oven, may simulate a celebrity.

As shown in FIG. 33, appliances also preferably provide status updates to the computer 2100 via the computer radio interface 2110 (FIG. 45). Optionally, the status update signals provided to the computer are augmented by oral status updates which are audible to users of the appliances.

FIG. 35 is a pictorial illustration of personified household appliances associated with a central computer 2100 by means of an existing electrical household wiring system 2128.

FIGS. 36A-36C, taken together, form a simplified flowchart illustration of a preferred method by which the computer controls the transceiver/controller 2130 of the refrigerator 2122 of FIG. 33. The method of FIGS. 36A-36C enables the refrigerator to function as a “diet-mate”, in a first supportive mode or in a second, aggressive mode. The mode (supportive or aggressive) may be preset by the user either initially or in the course of using the appliance (step 2350 of FIG. 36B) or may be randomly selected by the computer or may be programmed by the user such that different modes are used at different times of day or under different circumstances. Alternatively, the mode may be set by the computer conditionally, depending on the behavior of the user. Typically, the supportive mode is active until the dieter has exceeded his daily calorie count at which point the aggressive mode becomes active. Optionally, different personalities or celebrities may be associated with the two modes.

Preferably, the computer performs a voice signature matching process to determine whether the user is an impostor, i.e. whether or not the user's name as supplied matches his voice. Conventional voice signature matching methods may be employed for this purpose (step 2326).

As shown, the refrigerator preferably includes a microswitch 2146 (FIG. 33) which detects opening of the refrigerator door (step 2318). The refrigerator's loudspeaker 2144 prompts the person opening the refrigerator to identify himself (step 2322). If the user does not identify himself within a predetermined time period, the loudspeaker emits a message pleasantly urging or aggressively insisting that the user identify himself (steps 2322 to 2340).

The refrigerator's loudspeaker 2144 then asks the person to identify the food product or products he is removing from the refrigerator (step 2354).

The user's utterance is then recognized by a conventional speaker-dependent or speaker-independent speech recognition unit of the computer 2100 (steps 2358 to 2368).

If the user does not identify the food product/s within a predetermined time period, the loudspeaker emits a message pleasantly urging the user to do so or aggressively insisting that the user do so (step 2370).

Preferably, the calories corresponding to a typical portion of the food substance being removed are added to the sum total of calories consumed that day by the identified person (step 2380).

If the sum total of calories exceeds a predetermined daily total, which may for example be input in advance by the user, the loudspeaker preferably emits a randomly selected message politely requesting the user not to eat the foodstuffs in question or, in aggressive mode, blasting the user for eating the foodstuffs and demanding that s/he cease (step 2386). Alternatively or in addition, the above message may be provided if the food substance is in and of itself forbidden to the user, e.g. in accordance with a list of forbidden food items input in advance by the user.

In the illustrated embodiment, the apparatus does not prevent the dieter from opening the refrigerator. Alternatively, however, solenoid 2148 of FIG. 33 is employed to prevent the refrigerator from being opened if, for example, the dieter has exceeded his calorie quota for the day.

FIG. 37 is an example of a portion of a user interface by which the computer is set up by a user of an appliance, such as washing machine 2126 of FIG. 33, to provide the user of the appliance with infotainment or entertainment.

In the set up session, the user is preferably prompted to generate a “personal entertainment preference record”. Specifically, the user is prompted to indicate his name, and to indicate any number of preference statements. Typically, each preference statement includes an activity, a time period and a sequence of preferences, such as only two preferences in the present embodiment.

According to one embodiment of the present invention, priorities are assigned by the system to the various preference statements. For example, preference statements stipulating a specific activity may take precedence over preference statements for “all” activities. Then, preference statements stipulating a narrow time period take precedence over preference statements stipulating a broad time period which includes the narrow time period.

Therefore, in the illustrated embodiment, preference statement 2410 has the highest priority for the laundry activity. Consequently, the user, when doing laundry, will be exposed to the weather report and, once it is over or if the user rejects the weather report, the system exposes the user to humor selections. If the user rejects the humor selections, then radio channel 2 is played to the user if the time is between 10:00 hours and 10:30 hours because the preference statement with the next highest priority is preference statement 2450. Otherwise, or if radio channel 2 was rejected by the user, chamber music is played to the user, assuming that it is morning, as stipulated by preference statement 2400. If the chamber music is rejected, the “next preference”, i.e. classical music, is presented.

It is appreciated that many other formats may be used to elicit information from the user regarding his or her infotainment/entertainment preferences.

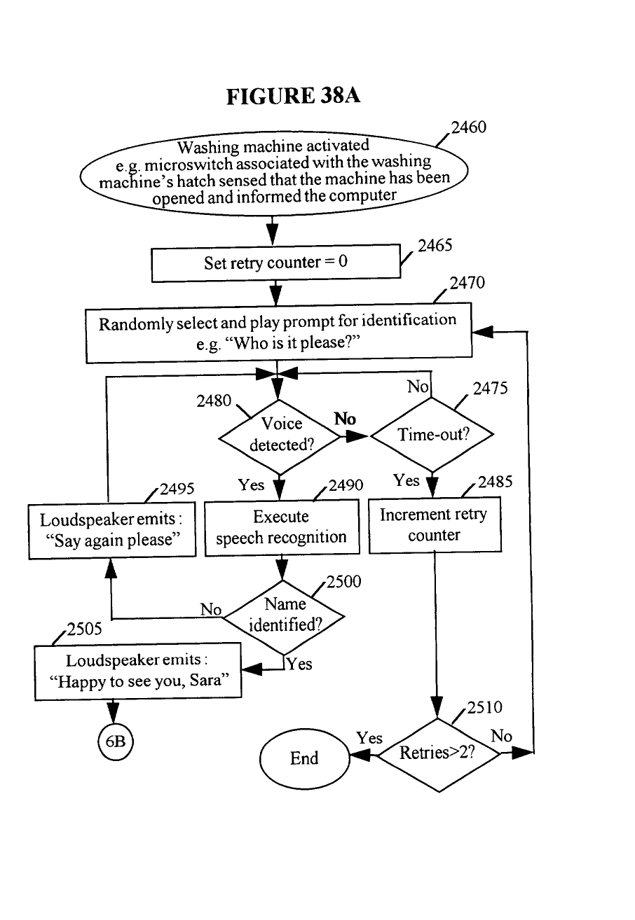

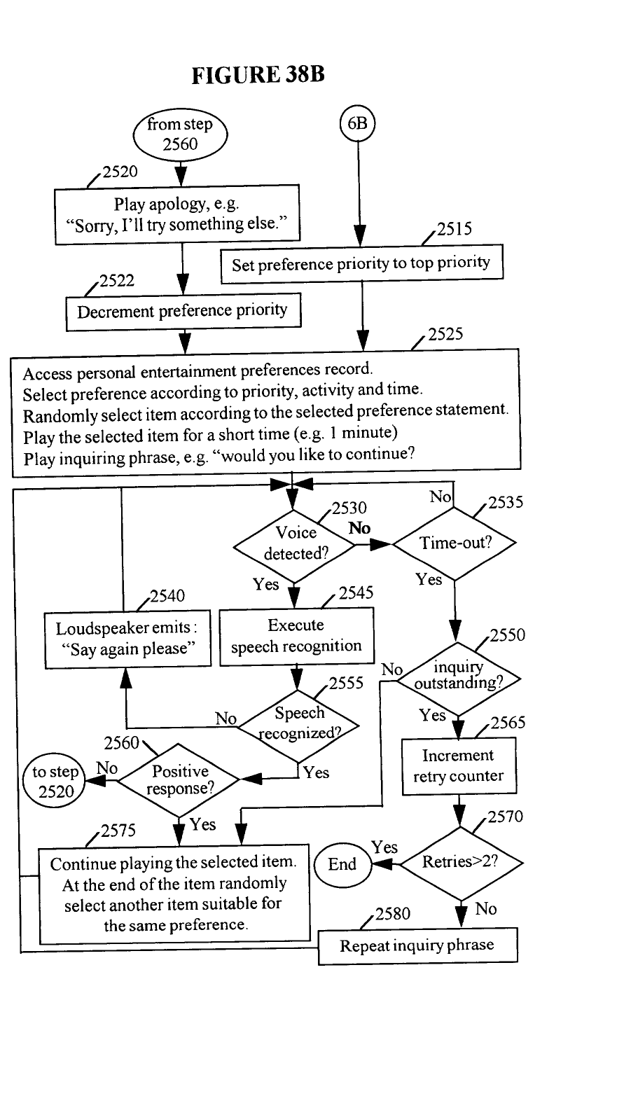

FIGS. 38A-38B, taken together, form a simplified flowchart illustration of a preferred method of operation by which the computer 2100 provides the user of a washing machine with infotainment or entertainment.

Reference is now made to FIG. 38A which illustrates the process of identifying the homemaker. After the user voice recognition procedure has been successfully completed, steps 2460 to 2505, the system then proceeds to present to the user the personal entertainment using his or hers personal preference record as illustrated in FIG. 38B.

Typically, once the system has selected the preference statement appropriate to a particular situation, the system presents the user with his top preference (step 2515) and stands by to receive a rejection message from the user, typically orally. If a rejection message is received, the system presents the user with his next preference. Once the user's last preference has been exhausted within the current preference statement, the system preferably advances to the next lower priority preference statement, according to a priority scheme between preference statements which may be either system-defined or user-defined (steps 2520 to 2522).

Preferably, the computer is operative to terminate provision of entertainment by the washing machine if the computer is informed that another appliance has detected the presence of the homemaker, indicating that the homemaker has left the vicinity of the washing machine.

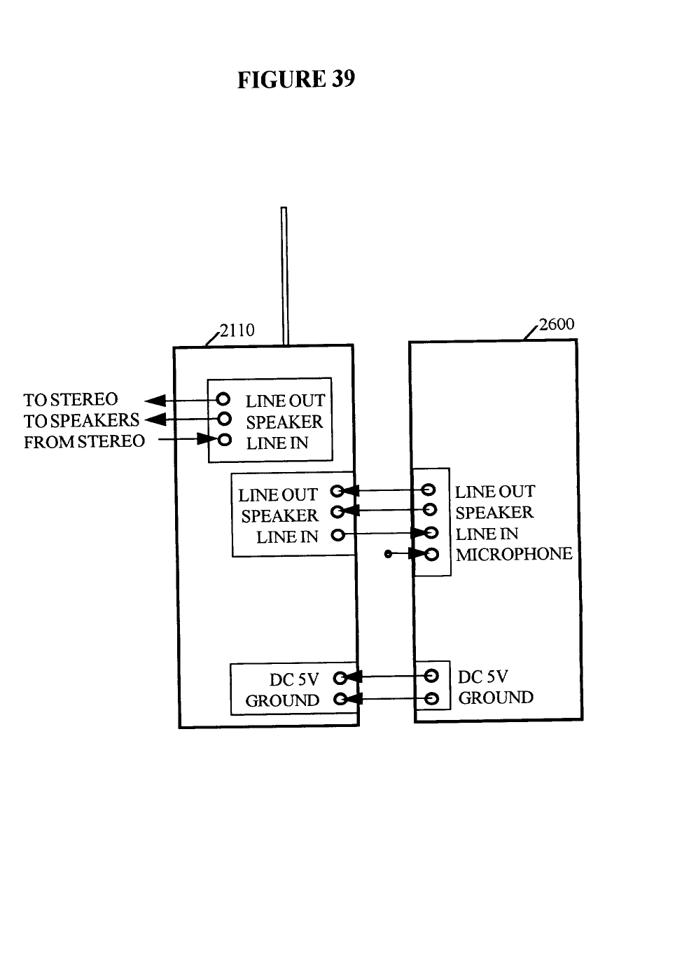

FIG. 39 is a simplified diagram of the interface between computer radio interface 2110 and a soundboard 2600 of the computer 2110. The apparatus of FIG. 39 is a modification of the apparatus of FIG. 3 except that the MIDI connectors are omitted, such that the apparatus of FIG. 39 is useful in conjunction with sound-boards or computers which lack MIDI connectors.

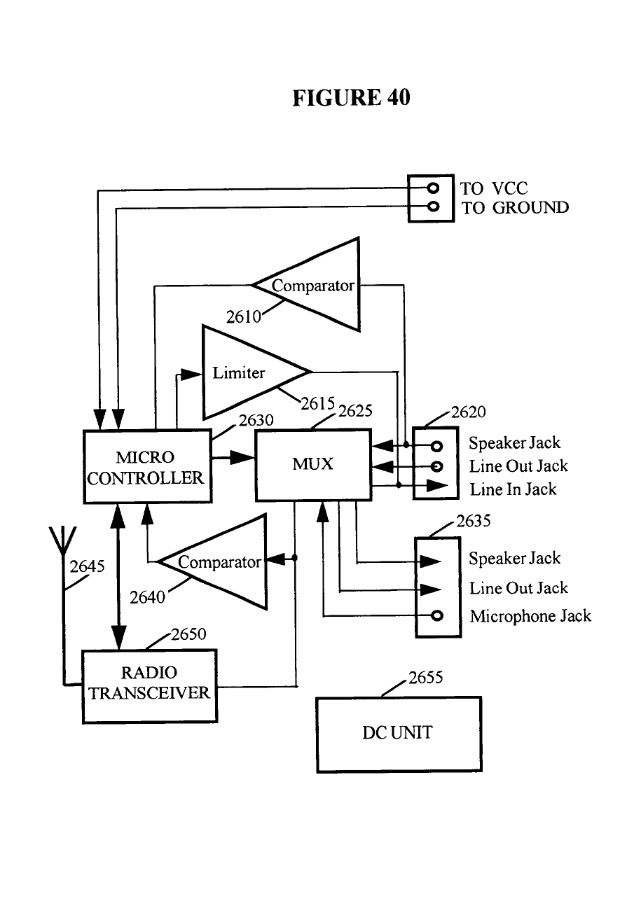

FIG. 40 is a simplified block diagram of computer radio interface 2110. FIG. 40 is a modification of the apparatus of FIG. 4 except that the MIDI connectors are omitted, such that the apparatus of FIG. 40 is useful in conjunction with sound-boards or computers which lack MIDI connectors.

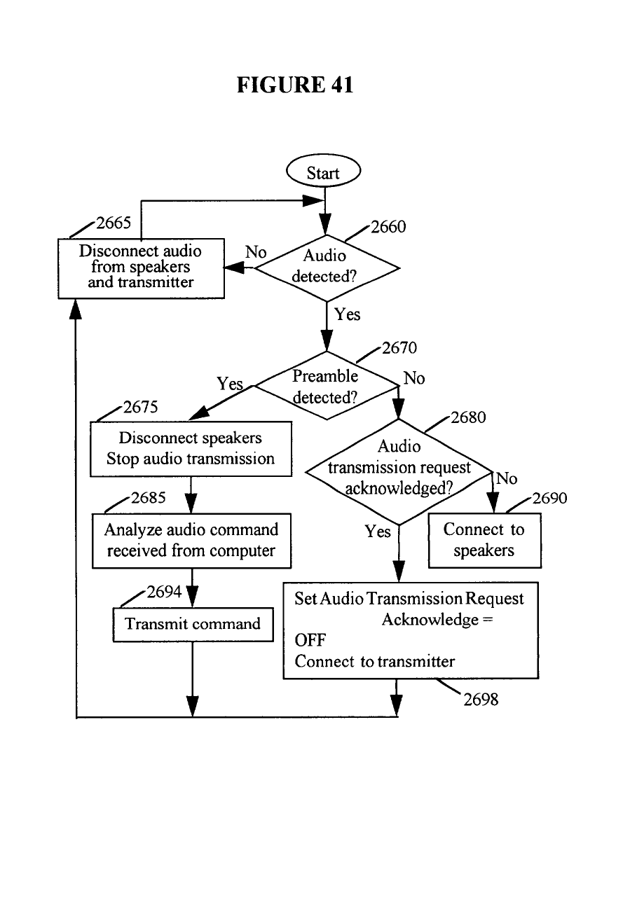

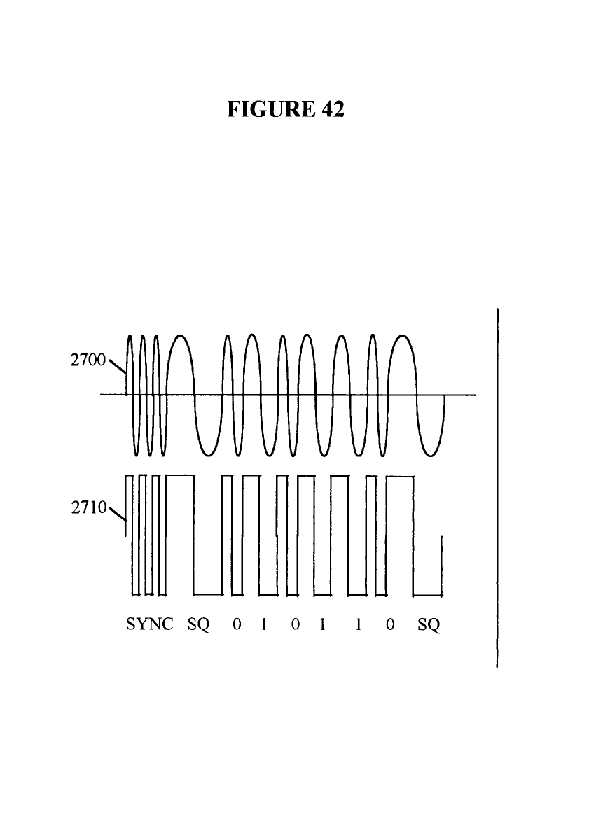

FIG. 41 is a simplified flowchart illustration of a preferred communication method allowing one of the computer radio interface 21 10 and the computer 2100 to receive commands over the audio channel, rather than over the MIDI channel, from the other one of the computer radio interface 2110 and the computer 2100. The method of FIG. 41 first detects whether an audio signal is currently arriving (step 2660) and if so, detects whether the audio signal comprises audio information (i.e. comprises the contents of an utterance which one of the appliances' speakers is supposed to emit) or a command. This is preferably effected by detecting whether or not a command-characterizing preamble has been received (step 2670). The command-characterizing preamble typically comprises SYNC followed by SQ signals as described in detail below with reference to FIG. 42.

FIG. 42 is a diagram of analog and digital representations 2700 and 2710 respectively of the following signals: SYNC, SQ, zero-valued bit and one-valued bit.

The frequencies and time durations of each of the above signals are as follows:

| | | TIME |
|---|---|---|
| SIGNAL | FREQUENCY | DURATION |
| SYNC | 2 KHz | 0.5 msec |
| SQ | 500 Hz | 2 msec |
| zero | 1 Hz | 1 msec |
| one | 666 Hz | 1.5 msec |

Preferably, more than one audio channel connects the sound board 2600 and the computer radio interface 2110, and typically a first audio channel transmits audio signals from the sound board 2600 to the computer radio interface and a second audio channel transmits audio signals in the opposite direction.

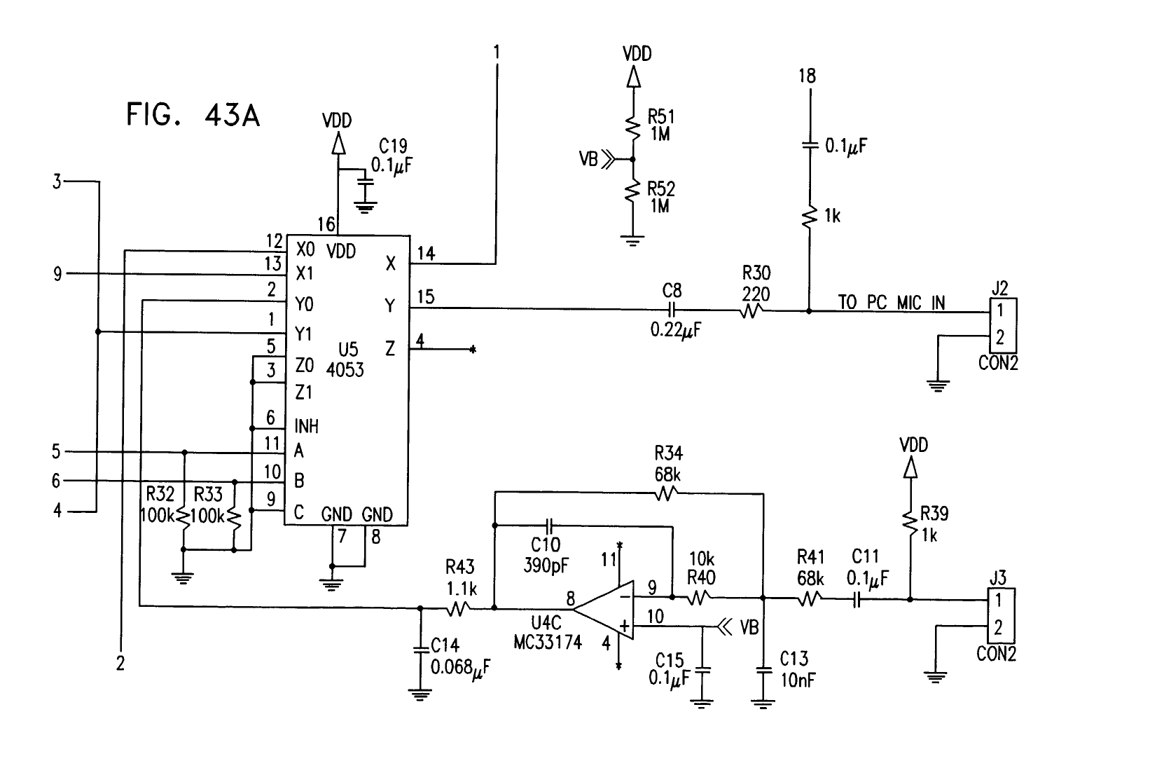

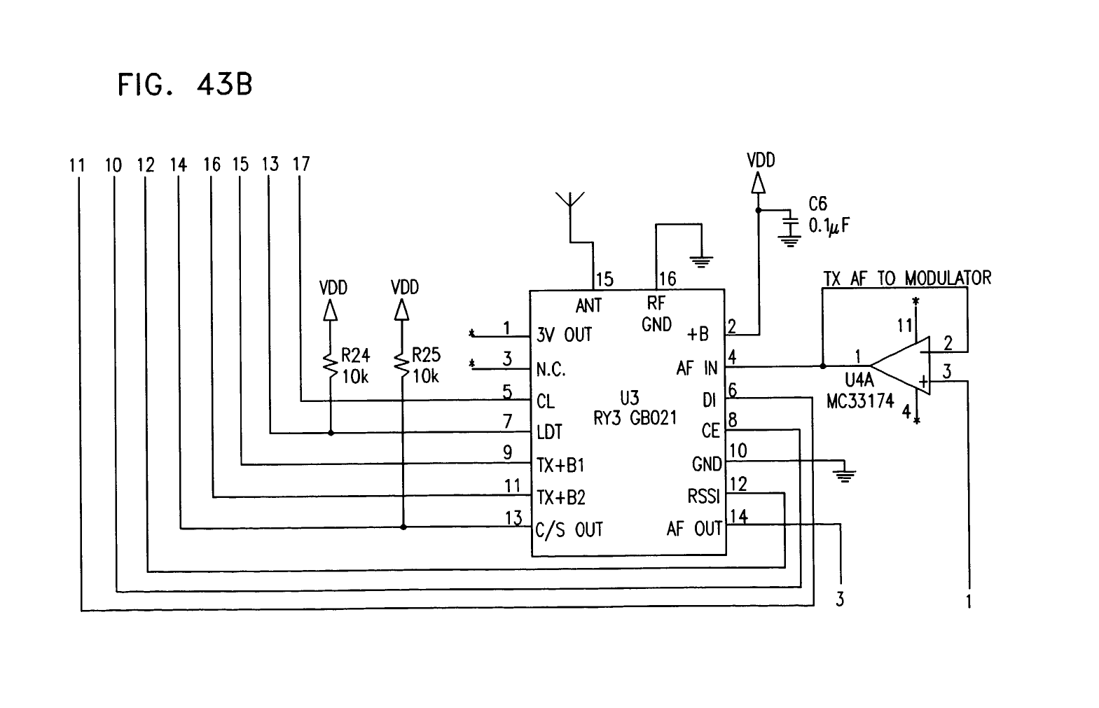

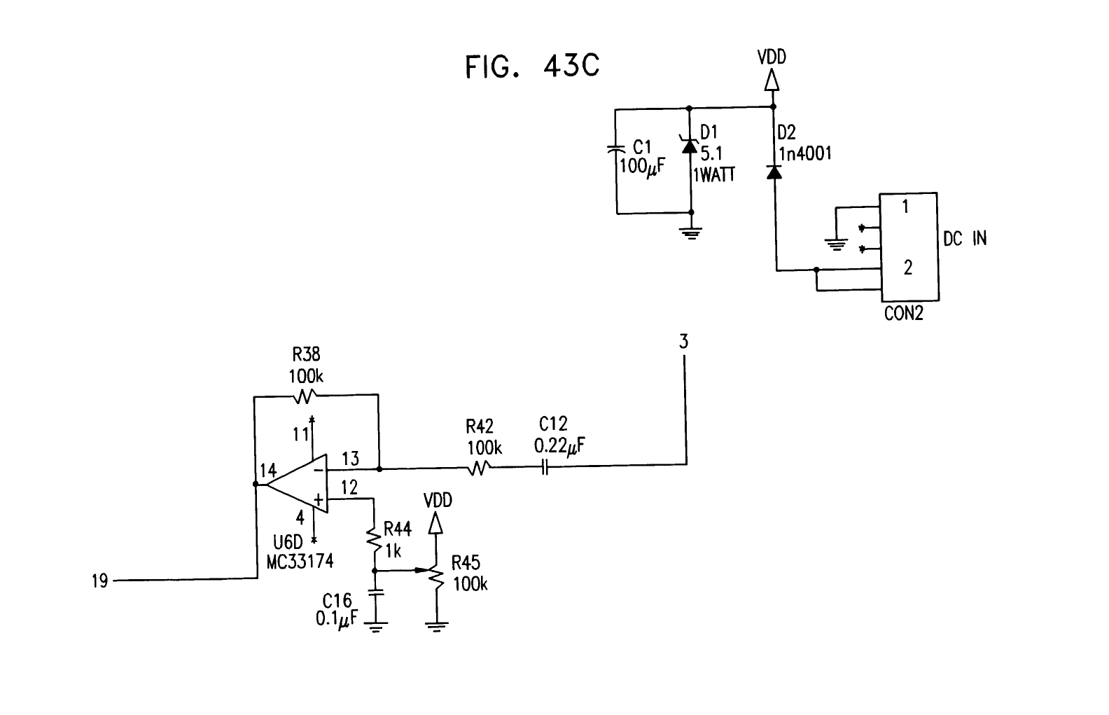

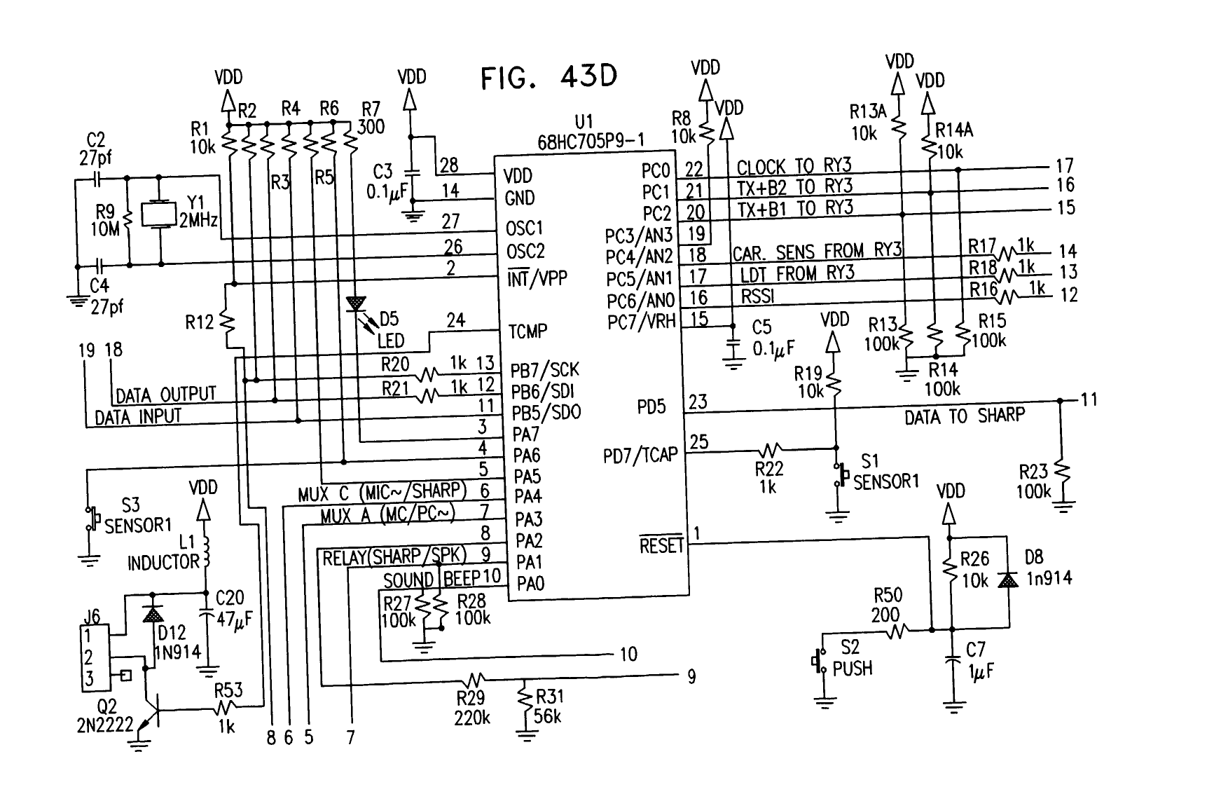

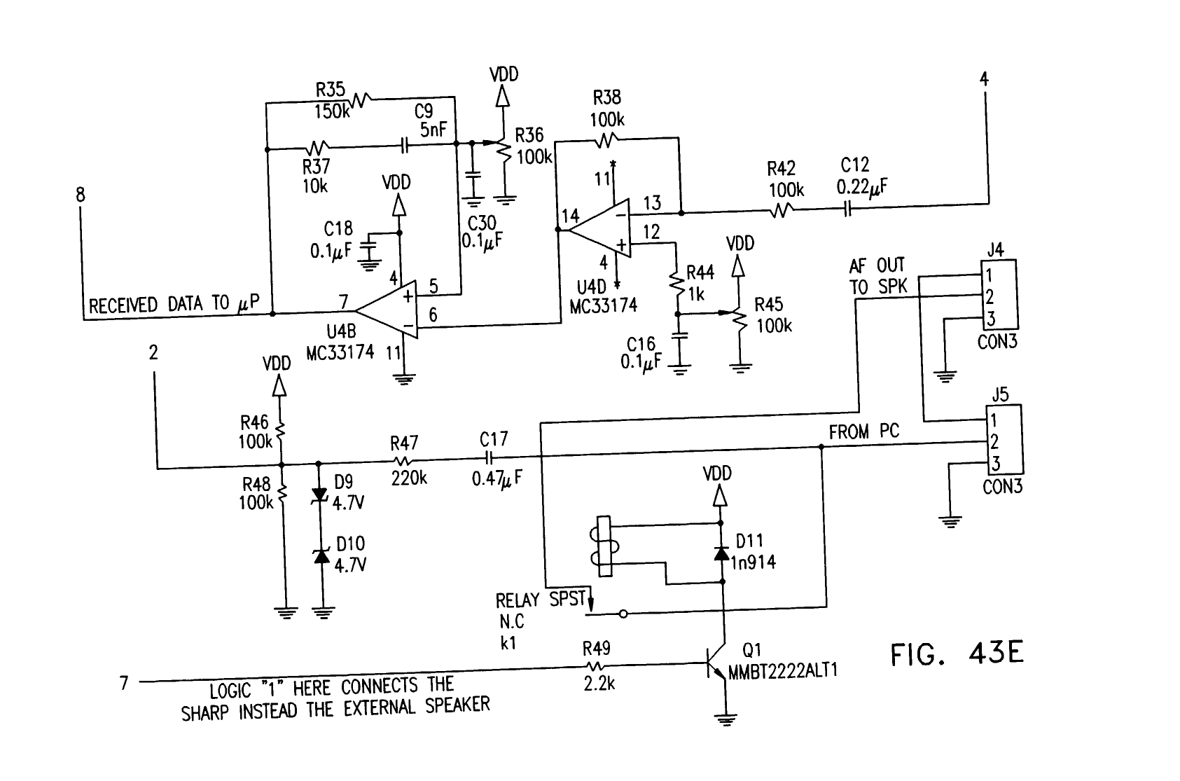

FIGS. 43A-43E, taken together, form a detailed electronic schematic diagram of a preferred implementation of the apparatus of FIG. 40.

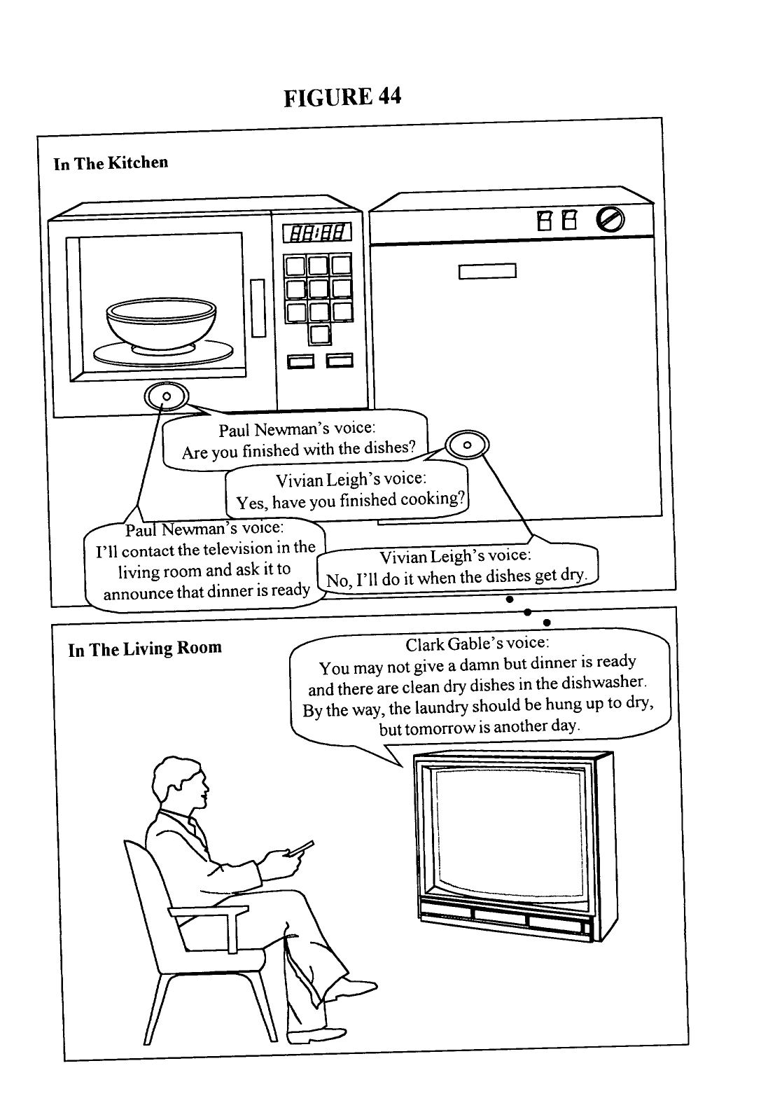

FIG. 44 is an example of a dialogue between a personified microwave oven and a personified dishwasher culminating in a verbal message emitted by a television. The dialog is managed by the computer 2100. Preferably, the tone of voice of the personified microwave oven and of the personified dishwasher differ to allow listeners to differentiate therebetween. For example, the microwave oven's voice may simulate Paul Newman's voice and the dishwasher's voice may simulate Vivian Leigh's voice.

According to one embodiment of the present invention, simulations of a celebrity's voice may be provided by pre-recording sentences, phrases or words produced by a human model mimicking the celebrity or by the celebrity herself. Alternatively, commercially available text-to-speech systems exist which convert text to oral speech having a variety of characteristics such that the voices of different appliances can be made distinguishable.

FIG. 45 is a simplified flowchart illustration of a method of operation for a central computer according to a first preferred implementation of an inter-appliance dialogue such as the dialog of FIG. 44. In the embodiment of FIG. 45, a central computer controls all appliances and simulates, for the amusement of a user, a dialogue therebetween.

Preferably, the computer maintains a state machine representing the possible states that the household appliances may be in and/or a plurality of separate state machines representing the possible states that each of a plurality of household appliances respectively may be in. Each state defines at least one condition, each condition comprising a logical combination of events triggering a connection to another state and/or an action to be performed by one or other of the appliances.

The events may include at least one of the following types of events: Counter events, timer events, events in which an input such as speech is received from a user, events in which a change in the environment is detected, events defined in terms of computations carried out by the computer, etc.

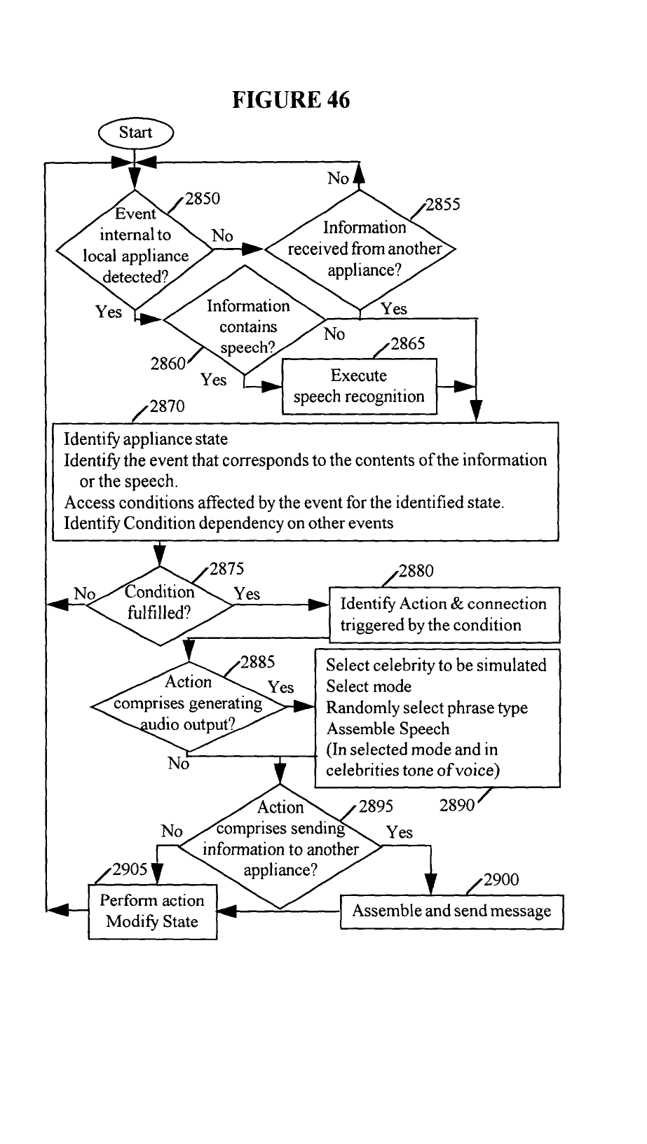

FIG. 46 is a flowchart illustration of a method of operation for an appliance according to a second preferred implementation of the dialogue of FIG. 45 in which each appliance is intelligent and preferably has speech recognition capabilities. Therefore, the dialogue is a real dialogue rather than a simulation of a dialogue which is in fact generated by the central computer.

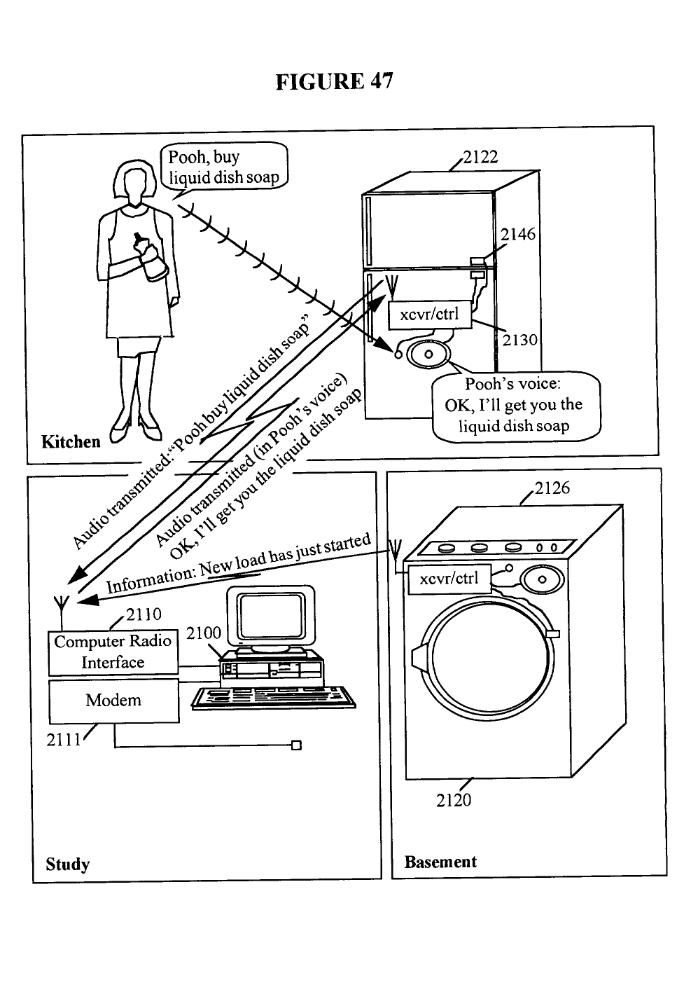

FIG. 47 is a pictorial illustration of a central computer 2100 accumulating information from users, via microphone bearing appliances, regarding consumable supplies to be replenished. Preferably, the central computer 2100 also accumulates messages from the appliances themselves, e.g. indications of the number of times they have operated, which impacts on the supply of consumables for that appliance. The central computer then generates a shopping list, and communicates the shopping list, e.g. via modem 2111, to a shopping facility. In the illustrated embodiment, the central computer receives an indication of each operation of the washing machine and accumulates these indications. After a predetermined number of operations, the computer may add laundry powder to the list.

Typically, the computer automatically generates a shopping list, sends it to the store e.g. electronically, and zeroes all consumable supply counters. Preferably, oral messages regarding a particular task such as shopping are provided in the tone of voice of a celebrity.

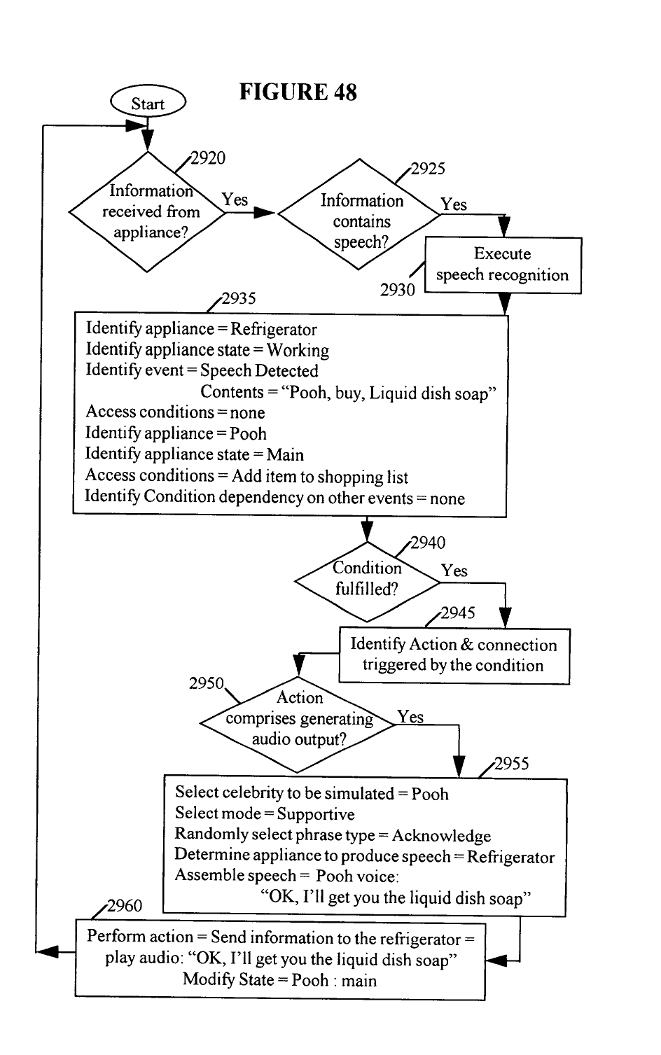

FIG. 48 is a script for the flowchart of FIG. 45 by which the computer 2100 implements the refrigerator's role in the interaction of FIG. 47.

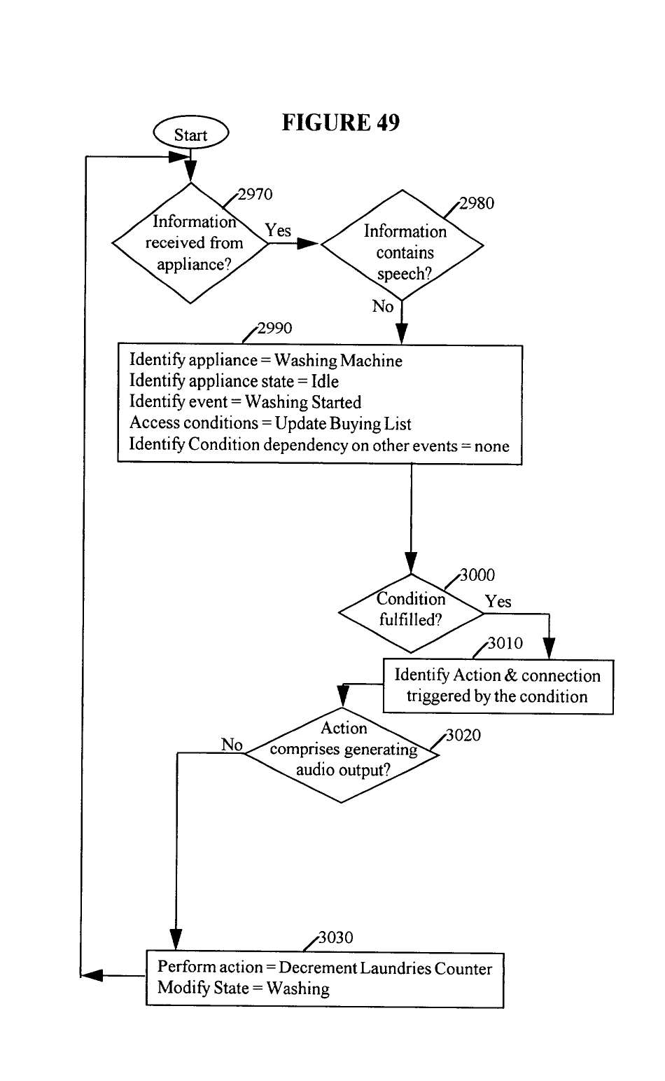

FIG. 49 is a script for the flowchart of FIG. 45 by which the computer 2100 implements the washing machine's role in the interaction of FIG. 47.

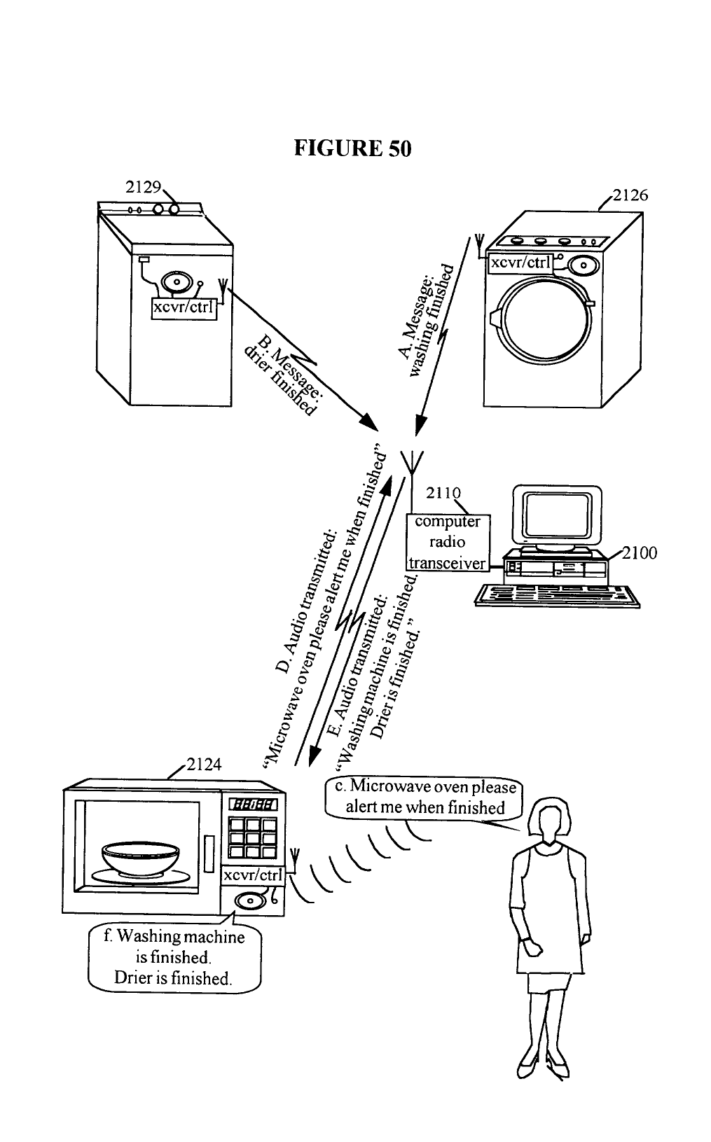

FIG. 50 is a pictorial illustration of a scenario in which a central computer is accumulating information regarding household chore monitoring and timing. This information may be provided by users, via sensor- bearing appliances, and/or by the appliances themselves. For example, in the illustrated scenario, the washing machine and dryer notify the homemaker, via the central computer, via the amplifier of the microwave oven, that washing and drying operations have both terminated. This facilitates coordination of household tasks since the home-maker is not only alerted to go downstairs and deal with the laundry but is alerted only once allowing him or her to go downstairs only once and deal with both the washer and the dryer.

In the illustrated embodiment, the messages to the home-maker are coordinated such that, for example, the alert that two laundry tasks can now be performed (communication F) is not provided in the midst of a food preparation task (microwave oven operation), even though the information is available to the computer. Instead, the alert regarding the two laundry tasks is delayed by the computer until such time that the food preparation task has terminated, i.e. until after communication D, which indicates that the home-maker has completed a food preparation task and is leaving the microwave oven.

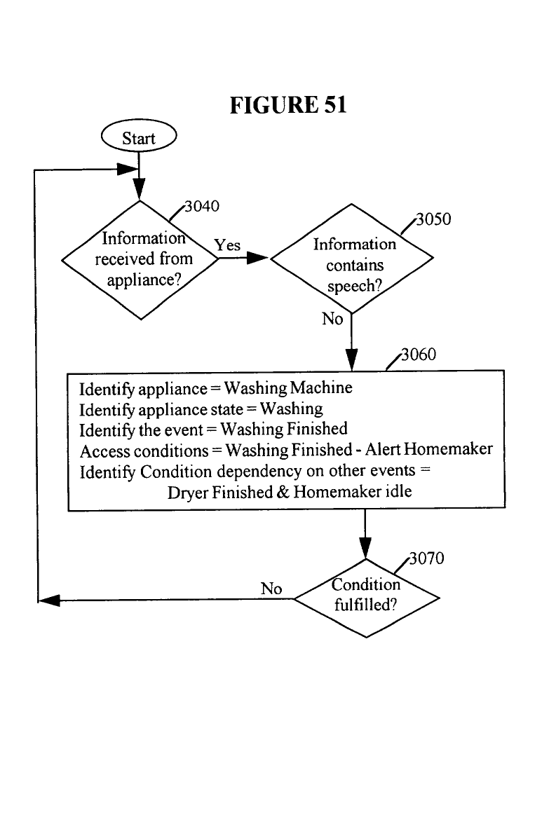

FIG. 51 is a script for the flowchart of FIG. 45 by which the computer 2100 implements the washing machine's role in the interaction of FIG. 50.

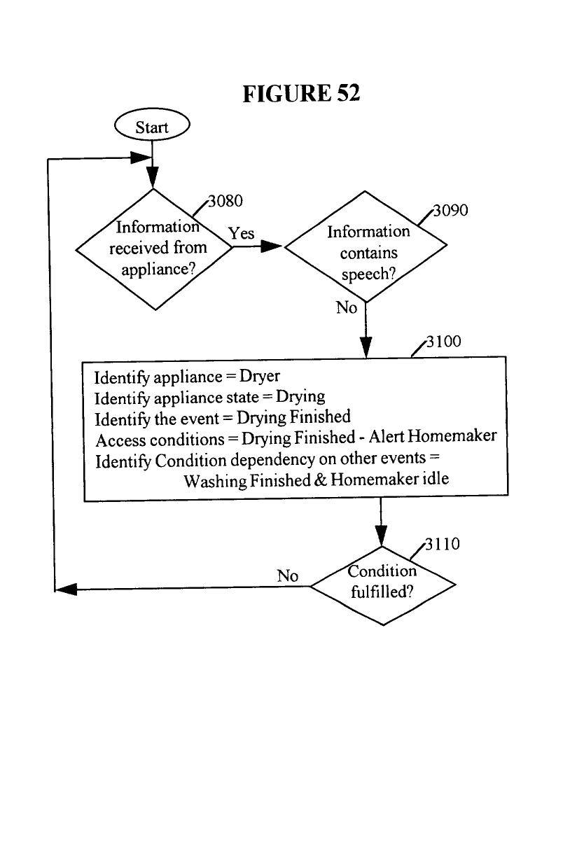

FIG. 52 is a script for the flowchart of FIG. 45 by which the computer 2100 implements the dryer's role in the interaction of FIG. 50.

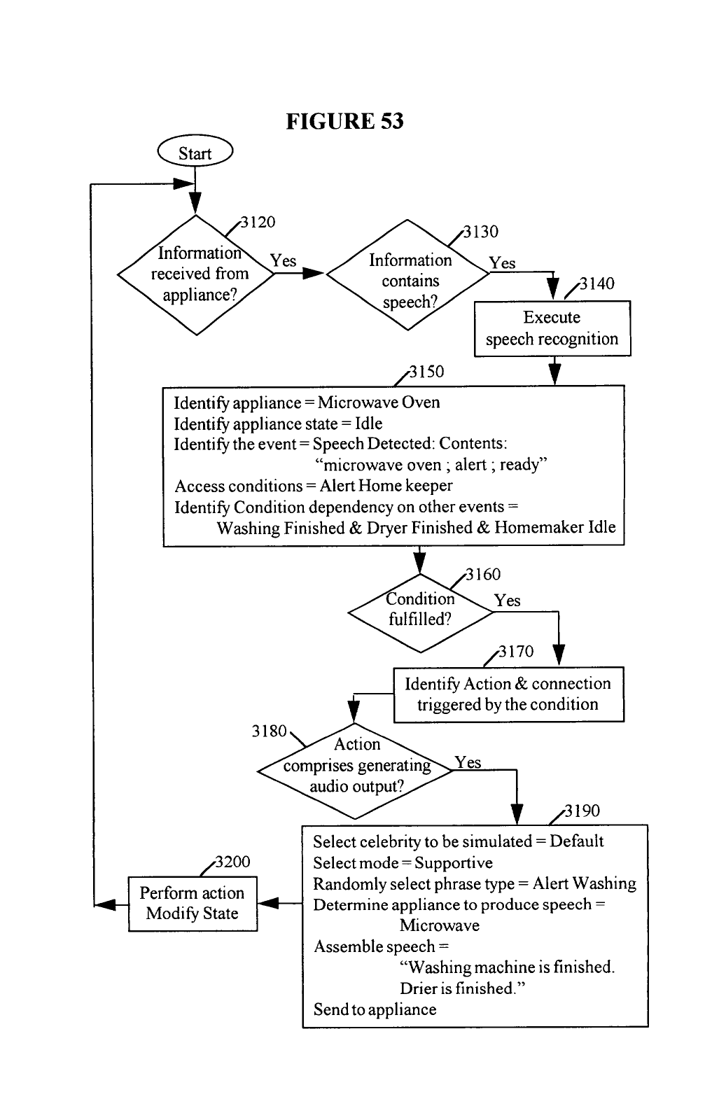

FIG. 53 is a script for the flowchart of FIG. 45 by which the computer 2100 implements the microwave oven's role in the interaction of FIG. 50.

The following variations of the illustrated embodiments may easily be provided:

a. Each appliance may have substantial computing power and therefore have independent intelligence, rather than being a “slave” to a central computer providing intelligence to a plurality of household appliances.

b. Intelligence may be provided to “slave” appliances by a “master” appliance associated with each of the “slave” appliances either wirelessly or by means of wire.

It is appreciated that different appliances are illustrated and described in the present invention as implementing different embodiments of the present invention. It is appreciated that generally, any embodiment of the invention may be implemented in any appliance and that the particular embodiment-appliance relationships shown and described herein are not intended to be limiting.

It is appreciated that the software components of the present invention may, if desired, be implemented in ROM (read-only memory) form. The software components may, generally, be implemented in hardware, if desired, using conventional techniques.

It is appreciated that the particular embodiment described in the Appendices is intended only to provide an extremely detailed disclosure of the present invention and is not intended to be limiting.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow the appendices which are:

We claim:

1. A wireless computer controlled household appliance system comprising:
a computer system including a first wireless transmitter and a first wireless receiver and operative to transmit a first transmission via the first wireless transmitter; and
at least one household appliance including a second wireless transmitter and a second wireless receiver, said household appliance receiving said first transmission via said second wireless receiver and operative to carry out at least one action based on said first transmission, said household appliance being operative to transmit a second transmission via the second wireless transmitter and wherein the computer system is operative to receive the second transmission via said first wireless receiver.

2. Household appliance apparatus comprising:
at least one functional unit operative to perform a household operation; and
an appliance personifier operative to simulate a personification of the functional unit for a user of the functional unit.

3. A household appliance comprising:
a functional unit operative to perform a household operation; and
an entertainment generator operative to provide entertainment to a user of the functional unit.

4. Speaking household appliance apparatus comprising:
a functional unit operative to perform a household operation; and
a speech generator operative to generate speech specimens audible to a user of the functional unit.

5. Apparatus according to claim 4 wherein the speech generator is operative to generate speech specimens having entertainment value for the user of the functional unit.

6. Apparatus according to claim 4 wherein the functional unit comprises at least one sensor operative to sense at least one ambient condition relevant to the functionality of the functional unit and wherein the speech generator is operative responsive to said at least one sensor.

7. Apparatus according to claim 4 and also comprising an inter-appliance communication unit operative to receive messages from at least one other household appliance and wherein said speech generator is operative responsive to said messages.

8. Apparatus according to claim 5 wherein said entertainment generator comprises a random entertainment generator operative to provide entertainment selected at least partly randomly from an entertainment repertoire.

9. Apparatus according to claim 2 wherein said appliance personifier comprises a celebrity simulator operative to generate outputs causing a perception, on the part of the user of at least one functional units, that said at least one functional units behave similarly to a celebrity.

10. Apparatus according to claim 9 wherein said functional unit comprises a loudspeaker and said celebrity simulator comprises a personified audio message provider operative to provide verbal messages in a voice resembling the voice of a celebrity, to said loudspeaker.

11. A computerized household appliance system comprising:
a plurality of household chore performing appliances distributed in a corresponding plurality of rooms throughout a dwelling-place, each household chore performing appliance comprising:
a functional unit; and
a loudspeaker for conveying audio messages to a user; and
a computer operative to generate audio messages for a user, and to convey said audio messages to the user using at least one of said plurality of loudspeakers.

12. A system according to claim 11 wherein each said appliance also comprises a sensor operative to sense presence of the user and wherein said computer is operative to monitor said user's location by receiving information from said plurality of sensors and to convey said audio messages to the user using only those ones of said plurality of loudspeakers which are proximate to the user's current location as defined by said information received from said plurality of sensors.

13. A system according to claim 11 wherein said sensor comprises a microphone.

14. A system according to claim 1 wherein said computer system comprises:
a computer;
a computer radio interface communicating commands to the at least one household appliance; and
a sound board device having at least one audio channel and transmitting commands from the computer to the computer radio interface over the at least one audio channel.

15. A system according to claim 14 wherein said at least one audio channel also comprises an audio channel from the computer radio interface to the sound board device over which digital information arriving from at least one appliance is transmitted to the computer.

16. Apparatus according to claim 2 wherein said functional unit comprises a loudspeaker and said appliance personifier comprises a personified audio message provider operative to provide personified audio messages to said loudspeaker.

17. Apparatus according to claim 2 wherein said functional unit comprises a food-related appliance and wherein said appliance personifier is operative to simulate a diet-facilitating personification of the food-related appliance.

18. A wireless computer controlled household appliance system comprising:
a computer system including a wireless transmitter for transmitting a command to perform at least one appliance action; and
at least one household appliance including a wireless receiver, said receiver receiving said command from said transmitter, said appliance being operative to carry out at least one action based on said command.

19. A wireless computer controlled household appliance system comprising:
a computer system including a wireless receiver; and
at least one household appliance including a wireless transmitter, said household appliance being operative to transmit a transmission via the wireless transmitter to the wireless receiver, the computer system being operative to receive the transmission via said wireless receiver and to perform at least one action based on said transmission.

20. A method for wireless computer control of household appliances comprising:
transmitting a first transmission from a computer via a first wireless transmitter;
receiving said first transmission at at least one household appliance and carrying out at least one action based on said first transmission; and
transmitting a second transmission from said at least one household appliance to the computer.

21. A household appliance personification method comprising:
providing a household appliance including a functional unit operative to perform a household operation; and
using the household appliance to simulate a personification of the functional unit for a user of the functional unit.

22. A household entertainment method comprising:
providing a household appliance including a functional unit operative to perform a household operation; and
using the household appliance to provide entertainment to a user of the functional unit.

23. A method for performing household operations comprising:
providing a household appliance including a functional unit operative to perform a household operation; and
generating speech specimens audible to a user of the functional unit.

24. A computerized household appliance running method comprising:
distributing a plurality of household chore performing appliances in a corresponding plurality of rooms throughout a dwelling-place, each household chore performing appliance comprising a functional unit and a loudspeaker for conveying audio messages to a user;
using a computer to generate audio messages for a user; and
conveying said audio messages to the user using at least one of said plurality of loudspeakers.

25. A wireless computer controlled household appliance communication method comprising:
transmitting a command to perform at least one appliance action from a computer system including a wireless transmitter to at least one household appliance including a wireless receiver; and
using said appliance to carry out at least one action based on said command.

26. A wireless computer controlled household appliance communication method comprising:
transmitting a message to a computer system including a wireless receiver from at least one household appliance including a wireless transmitter; and
using said computer to perform at least one computer action based on said transmission.
